(19) United States
(12) Patent Application Publication
(10) Pub. No.: US 2026/0200575 A1
(43) Pub. Date: Jul. 16, 2026

(54) AEROLIFT SYSTEMS AND METHODS USING AIR DUCTS AND LIFTING BODIES

(71) Applicant: Bansi Aviation, LLC, Sunrise, FL (US)

(72) Inventors: Atal Bansal, Southwest Ranches, FL (US); Todd R. Quackenbush, Ewing, NJ (US); Mayank Tyagi, Baton Rouge, LA (US); Jim Knight, Portland, OR (US)

(21) Appl. No.: 19/447,976

(22) Filed: Jan. 13, 2026

Related U.S. Application Data
(60) Provisional application No. 63/745,506, filed on Jan. 15, 2025.
(60) Provisional application No. 63/791,091, filed on Apr. 18, 2025.
(60) Provisional application No. 63/900,494, filed on Oct. 16, 2025.

(51) Int. Cl. B64C 29/00; F01D 9/04

(52) U.S. Cl. CPC B64C 29/0025; B64C 29/0033; F01D 9/042

(57) ABSTRACT

Aerolift systems and methods using annular airflow ducts and one or more lifting bodies. The annular duct may have a turn angle from an annular inlet to an annular outlet along a conical or flared trumpet flow path. The lifting body may be an airfoil. The lifting body and/or the duct outlet may be oriented substantially vertically or at a small angle relative to a longitudinal axis of the system. One or more propulsion units may move air through the duct and to the lifting body to create a lifting force, e.g. to fly an aircraft or flying system. The flow of air downward may also provide lift. One or more vanes and/or stators may deswirl airflow and/or control the attitude stability when used in a flying system. A tandem aircraft system may connect two distinct aerolifts or aircrafts. Other aircraft systems may connect four aerolifts in a grid-like formation.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application is a U.S. Non-Provisional Application and claims priority to U.S. Provisional Application No. 63/745,506, filed Jan. 15, 2025, titled AEROLIFT SYSTEMS AND METHODS USING AIR DUCTS AND LIFTING BODIES; to U.S. Provisional Application No. 63/791,091, filed Apr. 18, 2025, titled AEROLIFT SYSTEMS AND METHODS USING AIR DUCTS AND LIFTING BODIES; and to U.S. Provisional Application No. 63/900,494, filed Oct. 16, 2025. The entire contents of each of the foregoing applications is hereby incorporated by reference herein and forms a part of this specification for all purposes.

### BACKGROUND

### Field

The disclosure relates generally to systems for generating forces and movement, and more particularly to systems and methods for various machines and aircraft, that incorporate aerodynamics to create lifting forces and movements by flowing air via a propulsion unit through an angled duct and over a lifting body. Examples of such “aerolift” systems in the context of aircraft and industrial lifting systems are described, and more generally systems and methods of lifting, and example aircraft capable of vertical takeoff and landing (VTOL) with one or more wings surrounding a central portion and one or more distributed air ducts using such lifting systems, are described.

### Description

Since the industrial revolution, machines have replaced or supplemented human strength and greatly expanded the amount of work and productivity of humans. Motive power is used to cause the machines to do useful work. Existing machines use electrical generators, chemical combustion, or fluid pressure and hydraulics to provide the motive power for machines to generate forces and movement. These machines all require great cost and complexity and have efficiency limits to create and operate. Greater efficiency in motive power is desirable at reduced cost and improved simplicity and reliability.

Such improvements to existing solutions for motive power would improve many applications where such power is needed. For example, elevator systems, construction vehicles, skycranes, electric vertical take-off and landing (eVTOL) vehicles, helicopters, hovercrafts, hover drones, ski-lifts, power drills, other flying machines, weather drones, and other uses would benefit from improved approaches to motive power for lifting.

For example, aircraft are used for transportation, aerial photography, surveillance, package delivery, and military operations, among other uses. Conventional aircraft (e.g., aerial/aeronautical vehicles and devices) consist of a central longitudinal fuselage with two laterally extending wings having an airfoil shape (e.g., having a curved shape on top and a flatter bottom) to generate lift. As air flows past the leading edge of the airfoil or wing and over the curved upper surface of the wing, the air increases in speed and creates a lower pressure zone at the upper surface. Simultaneously, the air passing under the flatter surface of the wing travels at a slower speed than the upper surface, creating a relatively higher pressure zone at the upper surface. This pressure differential leads to lift which may enable an aircraft to overcome gravity and stay airborne. Such aircraft cannot take off and land vertically, limiting the locations where they may take off and land.

Conventional unmanned aerial vehicles (UAV) or “drones,” as well as rotorcraft such as helicopters, use rotors or propellors mounted on the top of the vehicle to expel air in a downward-facing direction to provide lift to the vehicle. The rotors create upward thrust which may counteract the forces of gravity to enable the vehicle to remain airborne. Such vehicles may take off and land vertically, but they require large amounts of power in order to provide the necessary lifting forces. Such vehicles are thereby limited in range, have shorter durations of use between resupplying energy, and limited in payload capacity. There is therefore a need for improvements to these and other drawbacks of existing solutions to generating lifting motive forces for aerial vehicles and other applications.

### SUMMARY

The disclosure herein presents various embodiments of “aerolift” systems for generating motive power using aerodynamic lifting forces which may include one or more lifting bodies and one or more ducts. A propulsion unit may be mounted to a rotor attached to the inlet of a duct to draw in air. The rotor can have a plurality of propellor blades configured to rotate and drive ambient air into the duct inlet. The speed of the driven air may increase as it moves from the duct inlet to its outlet. Lifting force may be provided due to the downward flow of air through and out of the duct. The duct may have a turn angle from the inlet to the outlet, for example from 20 to 45 degrees. The duct may have an interior cross-sectional area that is larger at the outlet than at the inlet. The cross-sectional area may increase, for example increase continuously, from the inlet to the outlet or over portions of the duct channel between the inlet and outlet. The lifting body can provide additional lift. The lifting body can be mounted in or outside the duct outlet where the flow of air driven by the rotor may flow around or against the lifting body. There may be multiple lifting bodies at the outlet. The multiple lifting bodies may be staggered, with a main lifting body closer to the outlet and an additional one or more lifting bodies farther from the outlet at a different height than the main lifting body. The one or more lifting bodies may be oriented substantially vertically, for example no more than 45 degrees relative to a reference axis, such as a vertical axis of the system. The lifting body cross section may resemble an airfoil design. For lifting bodies embodied as airfoils and the like, a pressure differential between the air flowing over the upper and lower surfaces of the lifting body may generate additional lift. The flow of air may increase in speed along the curved upper surface and past the leading edge, which may create a lower pressure zone at the upper surface. Simultaneously, the air passing under the flatter lower surface may travel at a slower speed than the upper surface, creating a relatively higher-pressure zone at the upper surface. Various example systems and methods using the “aerolift” lifting technology, such as aircraft, elevators, and other systems, are described.

The disclosure herein further presents the aerolift system as implemented in various embodiments of aircrafts having an annular duct. The annular duct may have a conical shape, or a flared, “trumpet bell” shape. The annular duct may have a propulsion system or blades for a propulsion system within the annular duct. The propulsion system may be at or near an annular inlet. The propulsion system may deliver a flow of air through the annular duct. The annular duct may extend from the annular inlet and to an annular outlet. The annular inlet may be angled relative to the annular outlet. The angle between the annual inlet and the annular outlet may be defined by a turn angle. The turn angle may be optimized in order to deliver a desired amount of air from the annular inlet, to the annular outlet, and over one or more lifting bodies. The turn angle may generate lift for the aerolift system. The annular duct may have one or more vanes located adjacent to the annular outlet. The annular duct may also have one or more stators located within the annular duct. The stators may provide yaw control, as the flow of incoming air through the annular duct and over the stators may create a counter torque. The stators may provide lift for the aerolift system. The vanes may also be used to control the yaw of the aircraft to assist in the stabilization of the aircraft, even in a stationary hover, such as to account for turbulence, wind, movement of payloads, passengers, or the like. The vanes may also be may be angled relative to a direction of flow of air through the duct to induce the yaw forces, and/or may move in response to an increase in rotational speed of the blades.

The disclosure herein further presents the aerolift system as implemented in various embodiments of aircrafts having an annular shaped lifting body such as an airfoil or wing (and/or a plurality of lifting body or wing sections arranged in a generally annular configuration and/or positioned generally about a periphery of an aircraft) and a number of propulsion units. As used herein, “lifting body” includes any structure that generates lift in response to airflow against and/or around the structure, and includes but is not limited to wings, airfoils, flow diverters, or segments thereof. The aircraft is capable of vertical takeoff and landing (VTOL) and forward/backward motion. In some embodiments disclosed herein, an aircraft may have an annular shaped wing (e.g., “doughnut” or “toroid” or other circumferential shapes) with the cross-sectional profile of an airfoil. The aircraft may have a plurality of propulsion units, such as rotors or propellors, mounted to the aircraft and distributed along an annular path about a longitudinal area of the main body of the aircraft. Furthermore, the plurality of propulsion units may be mounted onto a plurality of ducts (e.g., tunnels) affixed to the aircraft. The plurality of propulsion units may be mounted to the top/opening of the plurality of ducts (or may be positioned within the ducts) and the bottom/exit of the plurality of ducts may be located at or near the leading edge of the airfoil. Therefore, when the rotors are operating (e.g., spinning), airflow is directed downward through the ducts and to the leading edge of the annular wing to provide lift. The ducts may be distributed about or around a central compartment, such as a passenger compartment, of the vehicle. The annular wing may be transformable, e.g., rotatable and/or shape-changing (e.g., have a flap), to alter its angle of attack relative to the airflow and/or to adjust other lifting characteristics of the airfoil. The annular wing may be segmented with individual segments that are each independently transformable. Some embodiments may position one or more wings or wing segments about or around a central compartment in configurations that generally form an annular shape, a doughnut shape, a toroid shape, a triangular shape, a square shape, a rectangular shape, a polygonal shape, a round shape, and/or the like.

In one aspect, an aerolift system is described. The aerolift systems comprises a propulsion unit, a duct and a lifting body. The propulsion unit is configured to move air. The duct is configured to receive the air moved by the propulsion unit into an inlet of the duct and to expel the air out of an outlet of the duct. The duct inlet extends along an inlet axis and the outlet extends along an outlet axis, and the inlet axis and the outlet axis define a turn angle therebetween. The lifting body is configured to receive the air expelled from the outlet of the duct such that the air imparts a lifting force on the lifting body.

Embodiments of the above and other aspects described herein can have one or more of the following features in any combination: the inlet axis is angled no more than 45 degrees relative to a reference axis; the turn angle is from 20 degrees to 45 degrees; the lifting body defines a chord that is angled no more than 45 degrees relative to a reference axis; the inlet axis is parallel with a reference axis; the lifting body comprises an airfoil cross-sectional shape or the lifting body does not comprise an airfoil cross-sectional shape; the propulsion unit comprises an electric motor configured to rotate one or more blades; the reference axis is parallel with a gravity vector; the outlet extends from a vertically lower portion to a vertically higher portion, and the lifting body comprises a leading edge positioned closer to the vertically lower portion than to the vertically higher portion; the outlet extends from a vertically lower portion to a vertically higher portion, and the lifting body comprises a leading edge positioned closer to the vertically higher portion than to the vertically lower portion; a cross-sectional area of the outlet of the duct is greater than a cross-sectional area of the inlet of the duct; a cross-sectional area of the duct increases along at least one section of the duct in a direction from the inlet to the outlet of the duct; the duct outlet comprises a width that is greater than a height of the duct outlet; the duct outlet is rectangular or rounded; the lifting body is a first lifting body, and further comprising a second lifting body configured to receive the air expelled from the outlet of the duct such that the air imparts a lifting force on the second lifting body; the second lifting body is positioned farther away from the outlet of the duct than the first lifting body; further comprising a third lifting body configured to receive the air expelled from the outlet of the duct such that the air imparts a lifting force on the third lifting body, wherein the third lifting body is positioned farther away from the outlet of the duct than the second lifting body; the duct outlet extends from a vertically lower portion to a vertically higher portion, and wherein the first lifting body comprises a leading edge positioned closer to the lower portion than to the higher portion; the lifting body comprises a stationary inward portion and a moveable outward portion rotatably attached to the stationary inward portion; the duct comprising one or more vents along a portion thereof between the inlet and the outlet and configured to expel part of the air through the vent; the duct comprising a series of openings along a bottom portion thereof at the duct outlet; further comprising one or more vanes within the inlet of the duct; further comprising a sleeve on a top and/or bottom of the lifting body; and/or the duct inlet comprises a rounded lip.

In another aspect, an aircraft is described. The aircraft comprises a central body and one or more aerolift systems. The central body defines a reference axis. The one or more aerolift systems is/are attached with the central body. Each aerolift system comprises a propulsion unit, a duct and a lifting body. The propulsion unit is configured to move air. The duct is configured to receive the air moved by the propulsion unit into an inlet of the duct and to expel the air out of an outlet of the duct. The inlet extends along an inlet axis and the outlet extends along an outlet axis, and the inlet axis and the outlet axis define a turn angle therebetween. The lifting body is configured to receive the air expelled from the outlet of the duct such that the air imparts a lifting force on the lifting body.

Embodiments of the above and other aspects described herein can have one or more of the following features in any combination: the inlet axis is angled no more than 45 degrees relative to a reference axis; the turn angle is from 20 degrees to 45 degrees; the lifting body defines a chord that is angled no more than 45 degrees relative to a reference axis; comprising a plurality of the aerolift systems distributed annularly about the central body; comprising a plurality of the aerolift systems and wherein the lifting body of each aerolift system is a segment of an annular wing of the aircraft; the annular wing is a discontinuous, multi-segment wing of the aircraft; the annular wing is polygonal; comprising a plurality of the aerolift systems spaced outwardly from the central body to define an airflow channel between the central body and the plurality of aerolift systems; comprising a plurality of the aerolift systems spaced circumferentially from each other to define airflow channels between adjacent aerolift systems; further comprising supporting structure attaching one or more of the one or more aerolift systems with the central body; the supporting structure is configured to expand or collapse; comprising a plurality of the aerolift systems and the central body is located at least partially between the plurality of aerolift systems; the central body is located at least partially below the one or more aerolift systems; the outlet extends from a vertically lower portion to a vertically higher portion, and the lifting body comprises a leading edge positioned closer to the lower portion than to the higher portion; the outlet extends from a vertically lower portion to a vertically higher portion, and the lifting body comprises a leading edge positioned closer to the higher portion than to the lower portion; a cross-sectional area of the outlet of the duct is greater than a cross-sectional area of the inlet of the duct; the propulsion unit comprises an electric motor configured to rotate one or more blades; the lifting body is a first lifting body, and each aerolift system further comprises a second lifting body configured to receive the air expelled from the outlet of the duct such that the air imparts a lifting force on the second lifting body, and the second lifting body is positioned farther away from the outlet of the duct than the first lifting body; each aerolift system further comprises a third lifting body configured to receive the air expelled from the outlet of the duct such that the air imparts a lifting force on the third lifting body, and the third lifting body is positioned farther away from the outlet of the duct than the second lifting body; the duct outlet extends from a vertically lower portion to a vertically higher portion, and wherein the first lifting body comprises a leading edge positioned closer to the lower portion than to the higher portion; the lifting body comprises a stationary forward portion and a moveable rearward portion rotatably attached to the stationary forward portion; the duct comprising a series of openings along a bottom portion thereof at the duct outlet; the central body comprises a passenger compartment or a cargo compartment; comprising a plurality of the aerolift systems, and two or more ducts of the plurality of the aerolift systems are fluidly connected to each other; further comprising one or more additional propulsion units configured to provide a thrust force in a direction for forward flight; further comprising landing gear; further comprising one or more deployable parachutes; and/or further comprising one or more solar panels.

In another aspect, a system for generating movement via aerodynamic lifting forces is described. The system comprises a machine structure and an aerolift system. The machine structure has a moveable component. The aerolift system is attached to the moveable component. The aerolift system comprises a propulsion unit, a duct, and a lifting body. The propulsion unit is configured to move air. The duct is configured to receive the air moved by the propulsion unit into an inlet of the duct and to expel the air out of an outlet of the duct. The lifting body is configured to receive the air expelled from the outlet of the duct such that the air imparts a lifting force on the lifting body to thereby cause the moveable component to move.

Embodiments of the above and other aspects described herein can have one or more of the following features in any combination: the inlet extends along an inlet axis that is angled no more than 30 degrees relative to a gravity vector; the lifting body defines a chord that is angled no more than 45 degrees relative to a gravity vector; a turn angle, between an inlet axis defined by the inlet of the duct and an outlet axis defined by the outlet of the duct, is from 20 degrees to 45 degrees; further comprising a plurality of the aerolift systems; each aerolift system is supported outwardly of the moveable component to define an airflow channel between the moveable component and the plurality of aerolift systems; the machine structure includes a supporting structure, and a movable component is configured to move relative to the supporting structure; the supporting structure is an elevator shaft; the moveable component is an elevator cab; the propulsion unit is configured to move varying amounts of air to cause the elevator cab to rise and lower in vertical directions at varying speeds; the supporting structure is a body of a vehicle; the moveable component is a lifting arm; the moveable component is a digger or forklift; the supporting structure is a wall or a building; the moveable component is a cargo compartment; the moveable component is a lifting arm; the movable component is coupled to the supporting structure via a geared system; the propulsion unit comprises a motor configured to spin a plurality of blades; the propulsion unit is configured to move varying amounts of air to cause the moveable component to move at varying speeds; and/or further comprising a control system configured to control the propulsion unit to adjust movement of the moveable component.

In another aspect, an aerolift system is described. The aerolift system may include a propulsion unit configured to move air. The aerolift system may also include a duct configured to receive the air moved by the propulsion unit into an inlet of the duct and to expel the air out of an outlet of the duct. The inlet may extend along an inlet axis that is angled no more than 30 degrees relative to a reference axis. A turn angle may be between the inlet axis and an outlet axis defined by the outlet of the duct. The turn angle may be from 20 degrees to 45 degrees. A lifting body may receive the air expelled from the outlet of the duct such that the air imparts a lifting force on the lifting body. The lifting body defines a chord that is angled no more than 45 degrees relative to the reference axis.

In another aspect, an aircraft is described. The aircraft may include a central body defining a reference axis. The aircraft may also include aerolift systems attached to the central body. Each aerolift system may include a propulsion unit configured to move air. Each aerolift system may also include a duct configured to receive the air moved by the propulsion unit into an inlet of the duct and to expel the air out of an outlet of the duct. The inlet may extend along an inlet axis that is angled no more than 30 degrees relative to the reference axis. A turn angle between the inlet axis and an outlet axis defined by the outlet of the duct and may be from 20 degrees to 45 degrees. Each aerolift system may include a lifting body to receive the air expelled from the outlet of the duct such that the air imparts a lifting force on the lifting body. The lifting body may define a chord that is angled no more than 45 degrees relative to the reference axis.

In another aspect, a system for generating movement via aerodynamic lifting forces is described. The system may include a machine structure having a moveable component. The system may also include an aerolift system attached to the moveable component. The aerolift system may include a propulsion unit configured to move air. The aerolift system may also include a duct configured to receive the air moved by the propulsion unit into an inlet of the duct and to expel the air out of an outlet of the duct. Further, the aerolift system may include a lifting body configured to receive the air expelled from the outlet of the duct such that the air imparts a lifting force on the lifting body to thereby cause the moveable component to move.

In some aspects disclosed herein, an aerolift system may include a central body. The aerolift system may include a propulsion unit configured to move air. The aerolift system may include a duct having an annular inlet extending around the central body. The annular inlet may be configured to receive the air moved by the propulsion unit and to expel the air out of an annular outlet of the duct. The annular inlet may extend along an inlet axis and the annular outlet may extend along an outlet axis. The inlet axis and the outlet axis may define a turn angle therebetween. At least one lifting body may be configured to receive the air expelled from the annular outlet of the duct such that the air imparts a lifting force on the at least one lifting body.

In some aspects, the annular outlet may include a plurality of vanes. In some aspects, the plurality of vanes may include one or more vanes that are movable to adjust an angle at which the one or more vanes are oriented with respect to the outlet axis. In some aspects, the plurality of vanes may include one or more vanes that are fixed at an angle with respect to the outlet axis. In some aspects, the annular inlet may include a plurality of stators. In some aspects, the plurality of stators may include one or more stators that are fixed with respect to the inlet axis. In some aspects, the plurality of stators may include one or more stators that include an airfoil shape.

In some aspects, the propulsion unit may include a first hub having a first plurality of blades extending therefrom configured to rotate about a longitudinal axis of the central body in a first direction. The aerolift system further may include a second propulsion unit including a second hub coaxial with the first hub. The second hub may have a plurality of blades extending therefrom configured to rotate about the longitudinal axis of the central body in a second direction that is opposite to the first direction. In some aspects, the aerolift system may include one or more baffles located at a bottom of the aerolift system.

In some aspects, the aerolift system may include a lip positioned at the annular inlet and configured to direct a flow of air into the duct. In some aspects, an angle of attack between the at least one lifting body and the outlet axis is from 5 degrees to 25 degrees. In some aspects, the duct defines a trumpet bell flow path from the annular inlet to the annular outlet. In some aspects, the at least one lifting body may be oriented substantially vertical relative to a longitudinal axis of the central body.

In some aspects disclosed herein, the aerolift system including may include a main body. The aerolift system may include a first propulsion system and a second propulsion system. The first propulsion system and the second propulsion system may be interconnected by the main body. The first propulsion system and the second propulsion system each may include a central body. The first propulsion system and the second propulsion system each may include a propulsion unit connected to the central body and configured to move air. The first propulsion system and the second propulsion system each may include a duct having an annular inlet extending around the central body. The annular inlet may be configured to receive the air moved by the propulsion unit and to expel the air out of an annular outlet of the duct. The annular inlet may extend along an inlet axis and the annular outlet may extend along an outlet axis. The inlet axis and the outlet axis may define a turn angle therebetween. At least one lifting body may be configured to receive the air expelled from the annular outlet of the duct such that the air imparts a lifting force on the at least one lifting body. A motor may be positioned within the main body. A transmission may be positioned within the main body connecting the motor to the first propulsion system and to the second propulsion system to power the propulsion unit of the first propulsion system and the second propulsion system.

In some aspects, an angle of attack between the at least one lifting body and the outlet axis may be from 5 degrees to 25 degrees. In some aspects, the duct may define a conical flow path from the annular inlet to the annular outlet. In some aspects, the annular outlet may include a plurality of vanes. In some aspects, the annular inlet may include a plurality of stators. In some aspects, the plurality of stators may include one or more stators that include an airfoil shape.

In some aspects disclosed herein, an aerolift system may include a plurality of propulsion systems arranged in a grid about a central axis. The plurality of propulsion systems may be interconnected by a plurality of support rods. The plurality of propulsion systems each may include a central body. The plurality of propulsion systems each may include a propulsion unit connected to the central body and configured to move air. The plurality of propulsion systems each may include a duct having an annular inlet extending around the central body. The annular inlet may be configured to receive the air moved by the propulsion unit and to expel the air out of an annular outlet of the duct. The annular inlet may extend along an inlet axis and the annular outlet may extend along an outlet axis. The inlet axis and the outlet axis may define a turn angle therebetween. At least one lifting body may be configured to receive the air expelled from the annular outlet of the duct such that the air imparts a lifting force on the at least one lifting body.

In some aspects, the at least one lifting body may be oriented vertically downward relative to a longitudinal axis of the central body. In some aspects, the duct may define a conical flow path from the annular inlet to the annular outlet.

### BRIEF DESCRIPTION OF THE DRAWINGS

The foregoing and other features, aspects, and advantages of the present disclosure are described in detail below with reference to the drawings of various embodiments, which are intended to illustrate and not to limit the disclosure. The drawings comprise the following figures in which:

FIG. 1A illustrates a perspective view of an embodiment of an aircraft, having an annular lifting body shown as an annular wing, with a plurality of propulsion units and airflow ducts.

FIG. 1B illustrates a top view of the aircraft of FIG. 1A.

FIG. 1C illustrates a bottom view of the aircraft of FIG. 1A.

FIG. 2 illustrates a cross-sectional view of the aircraft of FIG. 1A.

FIG. 3A illustrates a top view of an annular wing shown in isolation from the aircraft of FIG. 1A.

FIG. 3B illustrates a cross-sectional view of the annular wing of FIG. 3A.

FIGS. 4A and 4B are cross-sectional views of embodiments of one of the airflow ducts and annular wing of the aircraft of FIG. 1A, showing the wing in two rotational positions.

FIGS. 5A, 5B and 5C illustrate partial perspective views of different embodiments of ducts that may be used with the aircraft of FIG. 1A and having, respectively, a J-shape, a hook shape, and a C-shape.

FIG. 5D illustrates a partial perspective view of a duct which may be used with the aircraft of FIG. 1A which may extend longitudinally past a main body and to an annular wing.

FIG. 5E is a partial perspective view of two ducts having a connecting duct that may selectively connect the airflow paths of the two ducts together.

FIG. 6A illustrates a perspective view of another embodiment of an aircraft having a lifting body shown as an annular wing with a plurality of propulsion units and airflow ducts and deployed landing gear.

FIG. 6B illustrates a side view of the aircraft of FIG. 6A with deployed loading ladder.

FIG. 7 illustrates a block diagram of an embodiment of hardware and/or software modules that may be included in any of the aerolift, aircraft or other systems described herein.

FIG. 8 illustrates a flow chart diagram of an embodiment of a process for operating an aircraft having an annular wing with a plurality of propulsion units and airflow ducts.

FIG. 9 illustrates a flow chart diagram of an embodiment of a process for operating a lifting system or an aircraft having an annular wing with one or more propulsion units and airflow ducts.

FIG. 10 illustrates a side view of another embodiment of an aircraft having a lifting body embodied as a wing with a plurality of propellers and a deployed landing gear with lateral-thrusting propulsion units.

FIG. 11A illustrates a cross-sectional view of another embodiment of an aircraft having a lifting body embodied as a wing with ailerons and with a plurality of propulsion units and airflow ducts and connecting structure.

FIG. 11B illustrates a top view of the wing shown in isolation from the aircraft of FIG. 11A.

FIG. 11C illustrates a cross-sectional view of the wing of FIG. 11B.

FIG. 11D illustrates a cross-sectional view of another embodiment of a wing that could be used with the aircraft of FIG. 11A.

FIG. 11E illustrates a cross-sectional view of the wing of the aircraft of FIG. 11A, with sleeves above and below the wing.

FIG. 11F illustrates a cross-sectional view of an alternative embodiment of the wing of the aircraft of FIG. 11A, with a sleeve only below the wing.

FIG. 11G illustrates a cross-sectional view of an alternative embodiment of the wing of the aircraft of FIG. 11A, with a sleeve only above the wing.

FIG. 12A illustrates another embodiment of a lifting body embodied as an annular wing shown as a triangular-shaped wing, in isolation.

FIG. 12B illustrates another embodiment of a lifting body embodied as an annular wing shown as a polygonal-shaped wing, in isolation.

FIG. 13A illustrates a perspective view of another embodiment of an aircraft having a lifting body embodied as an annular wing with a central propulsion unit and an annular airflow duct.

FIG. 13B illustrates a top view of the aircraft shown in FIG. 13A.

FIG. 13C illustrates a bottom view of the aircraft shown in FIG. 13A.

FIG. 13D illustrates a cross-sectional view of the aircraft shown in FIG. 13A.

FIG. 14 illustrates a top view of another embodiment of an aircraft having a lifting body embodied as an annular wing with a propulsion unit and an annular airflow duct with radially outer blades in the propulsion unit.

FIG. 15A illustrates a perspective view of another embodiment of an aircraft having a lifting body embodied an annular wing with a propulsion unit and a plurality of airflow ducts.

FIG. 15B illustrates a top view of the aircraft shown in FIG. 15A.

FIG. 15C illustrates a bottom view of the aircraft shown in FIG. 15A.

FIG. 16 illustrates a cross-sectional view of the aircraft shown in FIG. 15A.

FIG. 17 illustrates a side view of another embodiment of an aircraft having a lifting body embodied as an annular wing and airflow ducts with a deployed parachute.

FIG. 18 illustrates a side view of another embodiment of an aircraft having a lifting body embodied as an annular wing and airflow ducts with deployed inflatable landing gear.

FIG. 19A illustrates a perspective view of another embodiment of an aircraft having an elongated main body and two lifting bodies embodied as wings extending longitudinally along the elongated main body with longitudinally distributed airflow ducts.

FIG. 19B illustrates a top view of an aircraft having aerolift systems arranged about a main body forming a four-sided (e.g. rectangular) contour.

FIG. 20A illustrates a perspective view of another embodiment of an aircraft having two lifting bodies embodied as partial annular wings shown as crescent wings with a plurality of propulsion units and a plurality of airflow ducts.

FIG. 20B illustrates a top view of the aircraft shown in FIG. 20A.

FIG. 20C illustrates a bottom view of the aircraft shown in FIG. 20A.

FIG. 21 illustrates a cross-sectional view of the aircraft shown in FIG. 20A.

FIG. 22A is a partial perspective view of an embodiment of an airflow duct feeding air to multiple stacked wings of an aircraft.

FIG. 22B is a partial perspective view of an embodiment of an airflow duct and a lifting body embodied as a flow diverter mounted to a top portion of the airflow duct to deflect air downward.

FIG. 22C is a partial perspective view of an embodiment of an airflow duct and a lifting body embodied as a flow diverter mounted to a bottom portion of the airflow duct to deflect air upward.

FIG. 22D is a partial perspective view of another embodiment of a rotor and airflow duct, the airflow duct having an outlet with a different shape and/or cross-sectional area than the inlet, and the outlet conforming to the shape of a lifting body embodied as a wing at the outlet.

FIG. 23A illustrates a perspective view of another embodiment of an aircraft having a first section of ducts and a second section of ducts with inlets spaced radially outward from and lower than inlets of the first set of ducts, along with a plurality of propulsion units.

FIG. 23B illustrates a cross-sectional view of the aircraft shown in FIG. 23A.

FIG. 24A illustrates a perspective view of another embodiment of an aircraft having a first section of ducts and a second section of ducts with inlets spaced radially outward from and vertically even with inlets of the first set of ducts, along with a plurality of propulsion units.

FIG. 24B illustrates a cross-sectional view of the aircraft shown in FIG. 24A.

FIG. 25A illustrates a cross-sectional view of another embodiment of an aircraft having a curved tip at the trailing edge of the lifting body embodied as a wing.

FIG. 25B illustrates a cross-sectional view of another embodiment of an aircraft having a lifting body embodied as a flow diverter positioned near the trailing edge of the wing.

FIG. 26 illustrates a cross-sectional view of another embodiment of an aircraft having a lifting body embodied as a wing and one or more additional wings spaced away from the wing.

FIG. 27A illustrates a perspective detail view of the outlet end of the airflow duct of FIG. 26 having the wing and the additional wing spaced away from the wing.

FIG. 27B illustrates a cross-sectional view of an additional embodiment of the outlet end of the airflow duct of FIG. 26 having the wing and the additional wing spaced away from the wing and the duct.

FIG. 27C illustrates a cross-sectional view of an additional embodiment of the outlet end of the airflow duct of FIG. 26 having a relatively larger outlet opening.

FIG. 27D illustrates a cross-sectional view of an additional embodiment of the outlet end of the airflow duct of FIG. 26 having a relatively thinner wing.

FIG. 27E illustrates a cross-sectional view of an additional embodiment of the outlet end of the airflow duct of FIG. 26 having a wing with a leading edge spaced relatively farther from the outlet end of the duct.

FIG. 28A is a graphical representation of data for the predicted lift coefficient versus the angle of attack of the wing of FIG. 26 for various geometries of the wing.

FIG. 28B is a graphical representation of data for the predicted drag versus the angle of attack of the wing of FIG. 26 for various geometries of the wing.

FIG. 28C is a graphical representation of analytical data for the lift coefficient relative to the height/chord ratio of the wing versus the angle of attack of the wing of FIG. 26.

FIG. 29A illustrates a perspective view of another embodiment of an airflow duct for use in an aircraft with axes indicating a turn angle of the duct.

FIG. 29B illustrates a side view of the airflow duct of FIG. 29A.

FIG. 29C illustrates a side view of the airflow duct of FIG. 29A having a wing extending from the outlet end of the airflow duct.

FIG. 29D illustrates a cross-sectional view of the airflow duct of FIG. 29A delivering a flow of air to the wing.

FIG. 29E is a graphical representation showing a qualitative relationship expected between the amount of lift generated versus the duct turn angle for an aircraft or lifting system.

FIG. 30A illustrates a perspective view of another embodiment of an airflow duct having a moderate turn angle for use in an aircraft.

FIG. 30B illustrates a side view of the airflow duct of FIG. 30A.

FIG. 30C illustrates a perspective view of another embodiment of an airflow duct having a sharper turn angle for use in an aircraft.

FIG. 30D illustrates a side view of the airflow duct of FIG. 30C.

FIG. 30E illustrates a cross-sectional view of the airflow duct of FIG. 30A.

FIG. 30F illustrates a cross-sectional view of the airflow duct of FIG. 30C.

FIG. 31A illustrates a side view of another embodiment of an airflow duct having an inlet lip.

FIG. 31B illustrates a side view of the outlet end of the airflow duct of FIG. 31A.

FIG. 31C illustrates a flow of air entering the inlet end of the airflow duct of FIG. 31A.

FIG. 31D illustrates a flow of air traveling through the airflow duct of FIG. 31A from the inlet end to the outlet end and around the wing.

FIG. 32A illustrates an additional embodiment of an inlet end of an airflow duct having one or more vanes.

FIG. 32B illustrates an additional embodiment of the exit end of an airflow duct having one or more deswirling vanes.

FIG. 32C illustrates a perspective view of an additional embodiment of an airflow duct having one or more vanes at an inlet end and one or more deswirling vanes at an exit end of the airflow duct.

FIG. 32D illustrates a cross-sectional view of the airflow duct of FIG. 32C.

FIG. 33A illustrates an additional embodiment of the exit end of an airflow duct having one or more holes for diverting flow.

FIG. 33B illustrates a perspective view of an additional embodiment of an airflow duct having one or more vanes at an inlet end and one or more sidewall openings at an exit end of the airflow duct.

FIG. 33C illustrates a cross-sectional view of the airflow duct of FIG. 32B having a wing extending from the exit end.

FIG. 33D illustrates a perspective view of an additional embodiment of an airflow duct having one or more sidewall openings along an airflow duct.

FIG. 33E illustrates a perspective view of an additional embodiment of an airflow duct having a sidewall openings along an airflow duct.

FIG. 34 is a graphical representation of analytical data for an amount of thrust generated versus an amount of power delivered by a propulsion unit, for various airflow ducts and wing configurations.

FIG. 35A illustrates a perspective view of an additional embodiment of an aircraft having a wing positioned in a substantially vertical orientation.

FIG. 35B illustrates a cross-sectional view of the aircraft of FIG. 35A.

FIG. 35C illustrates a set of equations for characterizing thrust based on the selected parameters of the aircraft of FIG. 35A.

FIGS. 36A and 36B are cross-sectional views of an example system for generating movement using aerodynamic lifting forces, having a supporting structure shown schematically attached with an example aerolift system having a propulsion unit, duct, and a lifting body.

FIG. 37 illustrates a cross-sectional view of an example embodiment of a system for generating movement via aerodynamic lifting forces shown as an elevator lift system including the airflow ducts and the lifting body of FIG. 36A, including three vertically stacked aerolift systems.

FIG. 38 illustrates a cross-sectional view of an embodiment of a system for generating movement via aerodynamic lifting forces shown as an elevator lift system.

FIG. 39 illustrates a cross-sectional view of an alternative embodiment of the aerolift system including the airflow ducts and the lifting body of FIG. 36A, with one or more gears coupled to the system.

FIG. 40A illustrates a cross-sectional view of an alternative embodiment of the aerolift system including the airflow ducts and the lifting body of FIG. 36A, coupled to a building.

FIG. 40B illustrates a top view of an alternative embodiment of the aerolift system including the airflow ducts and the lifting body of FIG. 36A, coupled to a building.

FIG. 41 illustrates a top view of an alternative embodiment of the aerolift system including the airflow ducts and the lifting body of FIG. 36A integrated with an end of a building.

FIG. 42 illustrates a top view of an alternative embodiment of two of the aerolift systems, including the airflow ducts and the lifting body of FIG. 36A, integrated at two ends of a building.

FIG. 43 illustrates a flow chart diagram of an embodiment of a process for operating the lift system with a plurality of propulsion units and airflow ducts.

FIG. 44 illustrates a cross-sectional view of an alternative embodiment of the aerolift system including the airflow ducts and the lifting body of FIG. 36A, with a lift platform for supporting a payload thereon, such as a human.

FIG. 45 illustrates a cross-sectional view of an alternative embodiment of the aerolift system including the airflow ducts and the lifting body of FIG. 36A, with a system for lifting and carrying a payload such as objects or packages.

FIG. 46A illustrates a perspective detail view of another embodiment of an aircraft having one or more wings, one or more ducts, and one or more propulsion units spaced about the aircraft.

FIG. 46B illustrates a top view of the aircraft of FIG. 46A.

FIGS. 46C and 46D show close up partial views of embodiments of the inlet ends having inlet lips that protrude and inlet lips that are flush with the inlet end, respectively.

FIG. 47A illustrates a top view of another embodiment of an aircraft having one or more ducts and one or more bypass vents to direct a flow of air outside of the of the one or more ducts before reaching an outlet end of the one or more ducts.

FIG. 47B illustrates a perspective detail view of the outlet end of one of the ducts of FIG. 47A.

FIG. 48A illustrates a bottom perspective view of another embodiment of an aircraft having one or more ducts and one or more bypass vents to direct a flow of air outside of the of the one or more ducts before reaching an outlet end of the one or more ducts.

FIG. 48B illustrates a top view of the aircraft of FIG. 48A, including one or more ducts and one or more airfoils.

FIG. 48C illustrates a cross-sectional view of the aircraft of FIG. 48A, including the one or more ducts and one or more airfoils.

FIG. 49A illustrates a cross-sectional view of an airflow duct without a bypass vent delivering a flow of air to one or more airfoils.

FIG. 49B illustrates a cross-sectional view of an airflow duct having a bypass vent delivering a flow of air to one or more airfoils.

FIG. 50 illustrates a partial perspective view of an additional embodiment of an aircraft having one or more airfoils and one or more separators positioned between each of the one or more airfoils.

FIG. 51A illustrates a partial side cross-sectional view of part of multiple canted duct inlets.

FIG. 51B illustrates a partial side cross-sectional view of multiple vertical duct inlets.

FIG. 52A illustrates a top view of another embodiment of an aircraft having aerolift systems arranged about a central axis forming an octagonal contour and configured to have a central body at least partially in between the aerolift systems.

FIG. 52B illustrates a top view of the aircraft of FIG. 52A including the central body positioned at least partially in between the aerolift systems.

FIG. 52C illustrates a partial side view of the aircraft of FIG. 52B.

FIG. 52D illustrates a partial cross-sectional view of the aircraft of FIG. 52C including the aerolift systems supported radially away from the central body.

FIG. 52E illustrates a top view of an aircraft having aerolift systems arranged about a central axis forming a four-sided (e.g. square) contour.

FIG. 53A illustrates cross-sectional view of another embodiment of an aircraft including the aerolift systems and various components of the aircraft.

FIG. 53B illustrates a partial perspective view of the aircraft of FIG. 53A, including one or more actuatable hinges to move the one or more movable lifting bodies.

FIG. 54A illustrates a side view of another embodiment of an airflow duct having a first lifting body positioned at the outlet end and a second lifting body positioned radially outward from the first lifting body.

FIG. 54B illustrates a side view of another embodiment of an airflow duct having a lifting body positioned outside of the outlet end of the airflow duct.

FIG. 54C illustrates a side view of another embodiment of an airflow duct.

FIG. 54D illustrates a graphical representation of analytical data for an amount of thrust generated based on selected parameters of the airflow ducts and lifting bodies.

FIG. 54E illustrates a side view of another embodiment of an airflow duct having a first lifting body positioned at the outlet end, a second lifting body positioned radially outward (rearward) from the first lifting body, and a third lifting body positioned radially outward from the second lifting body.

FIG. 55A illustrates a bottom perspective view of another embodiment of an aircraft having a central body positioned at least partially above the aerolift systems.

FIG. 55B illustrates a cross-sectional view of the aircraft of FIG. 55A.

FIG. 56A illustrates a bottom perspective view of another embodiment of an aircraft having a central body positioned at least partially below the aerolift systems.

FIG. 56B illustrates a cross-sectional view of the aircraft of FIG. 56A.

FIG. 57A illustrates a bottom perspective view of another embodiment of an aircraft having one or more ducts and a skirt configured to reduce suction at the bottom of the aircraft.

FIG. 57B illustrates a bottom end view of the aircraft of FIG. 57A.

FIG. 57C illustrates a bottom perspective view of another embodiment of an aircraft having one or more ducts and a skirt configured to reduce suction at the bottom of the aircraft.

FIG. 58A illustrates a bottom perspective view of another embodiment of an aircraft having one or more ducts and a skirt configured to reduce suction at the bottom of the aircraft.

FIG. 58B illustrates a bottom perspective view of another embodiment of an aircraft having one or more ducts and a skirt configured to reduce suction at the bottom of the aircraft.

FIG. 58C illustrates a bottom perspective view of another embodiment of an aircraft having one or more ducts and a skirt configured to reduce suction at the bottom of the aircraft.

FIG. 59A illustrates a side perspective view of another embodiment of an aircraft having one or more ducts and a skirt configured to reduce suction at the bottom of the aircraft.

FIG. 59B illustrates a top view of the aircraft of FIG. 59A including an inlet section area having a first lip region and a second lip region.

FIG. 59C illustrates a detail view of the first lip region of the aircraft of FIG. 59A.

FIG. 59D illustrates a detail view of the second lip region of the aircraft of FIG. 59A.

FIG. 59E illustrates a cross-sectional view of the aircraft of FIG. 59A.

FIG. 60A illustrates an embodiment of the exit end of an airflow duct having deflectors for diverting flow.

FIG. 60B illustrates another embodiment of the exit end of an airflow duct having deflectors for diverting flow.

FIG. 60C illustrates another embodiment of the exit end of an airflow duct having deflectors for diverting flow positioned within the exit end.

FIG. 61A illustrates a bottom perspective view of another embodiment of an aircraft coupled to a power cable and power supply.

FIG. 61B illustrates a top perspective view of the aircraft coupled to a power cable and a power supply in FIG. 61A.

FIG. 62A illustrates a cross-sectional view of another embodiment of an aircraft having one or more shrouded propulsion units positioned on an open duct of the aircraft.

FIG. 62B illustrates a cross-sectional view of another embodiment of the aircraft of FIG. 62A having one or more propulsion units spaced positioned on an open duct of the aircraft.

FIG. 62C illustrates a cross-sectional view of another embodiment of an aircraft having one or more shrouded propulsion units positioned on an open duct of the aircraft.

FIG. 62D illustrates a perspective view of an aerolift system where the shrouded propulsion unit is positioned along an open duct of the aircraft of FIG. 62A.

FIG. 62E illustrates a perspective view of an aerolift system where the shrouded propulsion unit is positioned along an open duct having one or more lateral walls.

FIG. 62F illustrates a perspective view of an aerolift system where the shrouded propulsion unit is positioned along an open duct having one or more partial tunnels.

FIG. 62G illustrates a top view of an aircraft having the one or more shrouded propulsion units spaced outward from a body of the aircraft.

FIG. 62H illustrates a bottom perspective view of the aircraft of FIG. 62A coupled to a power cable and power supply.

FIG. 63A illustrates a top perspective view of another embodiment of an aircraft having a central propulsion unit and an annular airflow duct.

FIG. 63B illustrates a front view of the aircraft shown in FIG. 63A.

FIG. 63C illustrates a cross-sectional view of the aircraft shown in FIG. 63A.

FIG. 63D illustrates a bottom perspective view of the aircraft shown in FIG. 63A.

FIG. 63E illustrates a top view of the aircraft shown in FIG. 63A.

FIG. 63F illustrates a bottom view of the aircraft shown in FIG. 63A.

FIG. 63G illustrates a perspective view of an aircraft having features that may be used with the aircraft of FIG. 63A, including one or more actuatable hinges to move the lifting bodies.

FIG. 63H illustrates a bottom perspective view of an additional embodiment of an airfoil that may be used with the aircraft shown in FIG. 63A, having one or more end plates positioned along one or more edges of the airfoil.

FIG. 63I illustrates a perspective view of an additional embodiment of the annular outlet that may be used with the aircraft shown in FIG. 63A, having one or more endplates coupled to the one or more vanes.

FIG. 64 illustrates a partial front view of another embodiment of an aircraft having features that may be used with the aircraft of FIG. 63A, including a rounded skirt to reduce suction at the bottom of the aircraft.

FIG. 65 illustrates a perspective view of an embodiment of the aircraft shown in FIG. 63A coupled to transportation equipment and movable from one location to a second location.

FIG. 66 illustrates a cross-sectional view of another embodiment of an aircraft having features that may be used with the aircraft of FIG. 63A, including a first central propulsion unit, a second central propulsion unit, and an annular airflow duct.

FIG. 67A illustrates a top perspective view of another embodiment of an aircraft having an annular airflow duct and an opening extending through the main body of the aircraft.

FIG. 67B illustrates a bottom perspective view of the aircraft shown in FIG. 67A.

FIG. 67C illustrates a cross-sectional view of the aircraft of FIG. 67A.

FIG. 67D illustrates a partial transparent view of the aircraft of FIG. 67A, where the outer wall of the aircraft is shown in dashed lines for illustrative purposes.

FIG. 68A illustrates a top perspective view of an example embodiment of a tandem aircraft system including two interconnected propulsion systems.

FIG. 68B illustrates a front view of the tandem aircraft system of FIG. 68A.

FIG. 69 illustrates a top perspective view of an example embodiment of a quad aircraft having multiple propulsion systems arranged in a grid-like configuration.

FIG. 70 illustrates a top perspective view of another example embodiment of a tandem aircraft system having two interconnected propulsion systems.

FIG. 71A illustrates a top perspective view of another example embodiment of a tandem aircraft system including two interconnected propulsion systems.

FIG. 71B illustrates a top view of the tandem aircraft system of FIG. 71A, with some portions shown transparent.

FIG. 71C illustrates a side view of the tandem aircraft system of FIG. 71A, with some portions shown transparent.

FIG. 71D illustrates a detail perspective view of a portion of the tandem aircraft system of FIG. 71A including a drivetrain, with some portions shown transparent.

### DETAILED DESCRIPTION

Although embodiments, examples, and illustrations are disclosed below, the disclosure described herein extends beyond the specifically disclosed embodiments, examples, and illustrations and includes other uses of the disclosure and obvious modifications and equivalents thereof. Embodiments of the disclosure are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the disclosure. In addition, embodiments of the disclosure may comprise several novel features and no single feature is solely responsible for its desirable attributes or is essential to practicing the disclosures herein described unless otherwise indicated as such.

The disclosure herein provides systems, methods, and devices for generating motive power using aerodynamic lifting forces. An aerolift system is included as part of a machine or other system such as an aircraft for generating desired movements. The aerolift system includes one or more propulsion units for moving air, one or more ducts for receiving the moved air, and one or more lifting bodies over which the air is blown from the duct for generating lifting forces to cause movement of the lifting body. The aerolift system is attached to a moveable component in order to move the moveable component relative to a supporting structure. The moveable component may be an aircraft wing, elevator or lift arm and the supporting structure may be an aircraft body, elevator shaft and construction vehicle respectively. These are just some example applications of the aerolift system, and many other applications may incorporate the aerolift system.

In the case of an elevator, the aerolift system may enable an elevator or lift system (e.g., aerolift) to travel vertically within or externally to a building or another structure. Elevators can improve vertical transportation, which can allow people to effortlessly move between floors, which can be important in larger structures (e.g., skyscrapers and high-rise buildings). Traditional elevators or lift systems may consist of cables and pulleys or fluid based hydraulics, along with a motor to move an elevator car upwards or downwards. These traditional elevators can be essential for ensuring accessibility to individuals with disabilities, complying with various regulations, and promoting inclusivity. However, for buildings with different structures, utilizing the aerolift system can improve the efficiency of moving between floors.

The positioning of elevators in different buildings can depend on the structure's design and function. In some residential buildings, elevators may be centrally located or positioned near common areas to provide easy access. In other buildings (e.g., commercial and/or office buildings), the elevators can be placed to better facilitate the flow of people in and out of the buildings. Additionally, in medical buildings or hospitals, elevators or lift systems can be positioned to efficiently move patients to critical areas. The aerolift system may improve the ability to place any elevator in a desired location (internally or externally as an attachment).

The systems disclosed herein may include one or more lifting bodies, a plurality of ducts, and a plurality of rotors. The rotors (e.g., propulsion units) may have a plurality of propellors, which may be configured to rotate to draw external (e.g., environmental) air though an inlet portion or inlet end of the plurality of ducts. The flow of air may then be drawn towards an outlet portion or outlet end of the plurality of ducts and to the leading edge of the lifting body. The propulsion units and ducts may be distributed annularly about an optional central compartment, such as a passenger, payload, or cargo area or above or below the Aerolift systems. While particular example uses of the aerolift machines are shown and described herein, the machine may be used in a variety of other applications and include a variety of other features.

For aircraft, the disclosure herein provides systems, methods, and devices that enable flight for a vertical takeoff and landing (VTOL) aircraft with a wing (e.g., annular wing) which may completely or partially extend around a central main body (and/or a plurality of annular wing segments arranged about a periphery of the aircraft and/or in a generally annular configuration). As used in this document, “annular” includes shapes that are generally circumferential including but not limited to circular, elliptical, triangular, square, rectangular, pentagonal, hexagonal, heptagonal, octagonal, other polygonal or segmented shapes, or combinations thereof. A plurality of propulsion units expel air into a respective airflow duct which directs the air over the wing. The propulsion units and ducts may be distributed annularly about a central compartment, such as a passenger, payload, or cargo area. The annular (e.g., circular) wing may have a cross-sectional shape of an airfoil. The wing may be generally symmetrical about a longitudinal axis. The cross-sectional profile of the airfoil may be configured so that the top (e.g., upper) side of the airfoil is more curved than a bottom (e.g., lower) side of the airfoil. The airfoil configuration may be useful since it may be capable of generating lift in an aircraft. Advantageously, by having an airfoil profile, a flow of air may increase in speed upon reaching a leading edge of the wing and traveling over a top side of the wing. By having this upper, curved shape, a lower pressure zone may be created. Additionally, in some embodiments, the flow of air may decrease in speed (relative to the speed of air traveling over the top side of the wing) when traveling under the lower (e.g., flatter) side of the airfoil profile of the wing (relative to the top surface) and may create a high-pressure zone than at the top side of the wing. Advantageously, a pressure differential between the upper surface and a lower surface may lead to lift which may enable the aircraft to overcome gravity. In some embodiments, having a singular, annular wing may further increase the amount of pressure underneath the wing and may improve the lift/drag coefficient (e.g. similar to “Ground Effect”) and may increase flight efficiency.

In some embodiments, the aircraft may have one or more (e.g., a plurality) propulsion units (e.g., rotors, propellers, ducted fans, turbofans, and/or the like) coupled to the aircraft. The propulsion units may be used to direct a flow of air from an upper area (e.g., above the aircraft) through one or more ducts and to a leading edge of the annular wing of the aircraft. In some embodiments, the propulsion units may be oriented in a vertical and/or downward facing direction to provide lift to the device. Other embodiments may orient the propulsion units angled, vertical, or other orientations. The propulsion units may be further mounted to and/or within a single or series of ducts (e.g., tunnels, channels, with or without grooves that streamline airflow and/or the like) which may channel the flow of air being drawn into and propelled out of the propulsion units. The ducts may be designed such that the flow of air from the propulsion units flows to a leading edge of the annular wing. Advantageously, the flow of air which travels past the top surface and lower surface of the annular wing may lift the aircraft. Furthermore, the plurality of propulsion units delivering the flow of air may assist the device in VTOL and/or short takeoff and landing (STOL). It should be noted that, although various embodiments described herein depict the propulsion units at the inlet end of the ducts, other embodiments may position the propulsion units differently. For example, the propulsion units may be positioned within the ducts, such as at an intermediate point between the duct inlet and duct outlet.

The propulsion units may be equidistantly distributed along a circular path around the central area and/or annular wing or may be spaced differently. The series of ducts may be coupled to each of the propulsion units and equidistantly spaced or spaced differently. The propulsion units may be configured, such that a flow of air being drawn into the channels reaches a particular area (e.g., segment) of the annular wing. Therefore, the aircraft may have the optimal amount of airflow drawn to the entire annular wing (and/or to a substantial portion of the annular wing) to maintain optimal lift.

In some embodiments, each of the propulsion units may be independently controlled (e.g., different pitch, spin/rotate to generate a flow of air independently of each other, such that each propulsion unit may generate a different flow level than the others). Independently controlling the propulsion units may allow each propulsion unit to rotate at a particular speed or deliver a different amount of air to a section of the leading edge of the annular wing. Independent control permits the aircraft to ascend, descend, hover, tilt, rotate, or translate based on the amount of flow delivered to each section of the aircraft. For example, in some embodiments, there may be four propulsion units equally spaced around the annular wing. When at least one of the propulsion units either rotates at a different speed or delivers a different flow of air (e.g., environmental air) at a different velocity to a section of the annular wing, the aircraft may rotate, lift and/or tilt. By having each propulsion unit independently controlled, the aircraft may be exceptionally maneuverable while potentially being more efficient than alternative aircraft designs. Furthermore, by varying the individual speed of each propulsion unit, the aircraft may effectively change altitude, pitch, roll, and yaw to make the aircraft capable of navigating complex environments with ease (e.g., improve banking), increase control takeoff and landing, and improve maneuverability during unstable atmospheric conditions (e.g., high winds, humidity, extreme weather conditions). It may be useful for certain types of aircraft to conduct photography, surveillance, cargo, package delivery, transportation and military operations and having increased maneuverability may be advantageous.

In some embodiments, it may be useful for the aircraft to have a main body, which may include a passenger compartment or cockpit. The main body may have flight instruments (e.g., radio communications, transponders etc.) which may be used to fly or operate the aircraft. The main body may be located medially to the leading edge of the annular wing of the aircraft. By placing the main body medially to the leading edge, and in some embodiments, in the center of the aircraft, the center of gravity of the aircraft is located at the true centerline or center point of the device (e.g., the centerline of the annular wing). Therefore, the aircraft may be exceptionally more balanced and stable than alternative aircraft designs.

In some embodiments, the ducts may be configured to thrust the aircraft in a desired direction. For example, the ducts may have a first outlet configured to deliver the flow of air to the leading edge of the annular wing and a second outlet (e.g., hatch, rudder) configured to open when directional thrust is desired. In some embodiments, a hatch or rudder located on each duct configured to open independently of each other may move the device forward (or assist during landing). For example, in embodiments where the aircraft comprises four propulsion units and therefore four ducts equally spaced around the annular wing, by opening the two frontmost ducts the device may thrust in a forward direction.

Various embodiments disclosed herein may be configured for an aircraft which has an empty main portion (e.g., central portion that is radially inward of the propulsion units and/or the ducts). However, the disclosures herein may be used for an aircraft which may be designed to house persons, items, packages, other payloads, and/or the like within the empty main portion or central portion, which may also be referred to as a payload compartment, passenger compartment, and the like). In some embodiments, the aircraft may be designed to lift 50 lbs., to transport packages from one destination to another. Additionally, the aircraft may be designed to assist with farming and agriculture. For example, the aircraft may be designed to pick fruits (e.g., apples, mangos, avocado, etc.) from fruit trees. Furthermore, the device may be designed and sized to hold 2500 lbs., which may include a number of individuals and their personal items. In some embodiments, the aircraft may be designed to hold 25 lbs., 100 lbs., 500 lbs., 1000 lbs., 2000 lbs., and/or 3000 lbs.

In some embodiments disclosed herein, the aircraft may have an annular duct. The annular duct may have a conical shape, or a flared, “trumpet bell” shape. The annular duct may have a propulsion system or blades for a propulsion system within the annular duct. The propulsion system may be at or near an annular inlet. The propulsion system may deliver a flow of air through the annular duct. The annular duct may extend from the annular inlet and to an annular outlet. The annular inlet may be angled relative to the annular outlet. The angle between the annual inlet and the annular outlet may be defined by a turn angle. The turn angle may be optimized in order to deliver a desired amount of air from the annular inlet, to the annular outlet, and over one or more lifting bodies. The one or more lifting bodies may be a plurality of lifting bodies spaced around the annular outlet in order to receive the flow of air. The annular duct may have one or more vanes located adjacent to the annular outlet. The annular duct may also have one or more stators located within the annular duct. The stators may provide yaw control, as the flow of incoming air through the annular duct and over the stators may create a counter torque. The vanes may also be used to control the yaw of the aircraft to assist in the stabilization of the aircraft, even in a stationary hover, such as to account for turbulence, wind, movement of payloads, passengers, or the like. The vanes may also be angled relative to a direction of flow of air through the duct to induce the yaw forces, and/or may move in response to an increase in rotational speed of the blades.

### Example Aircraft

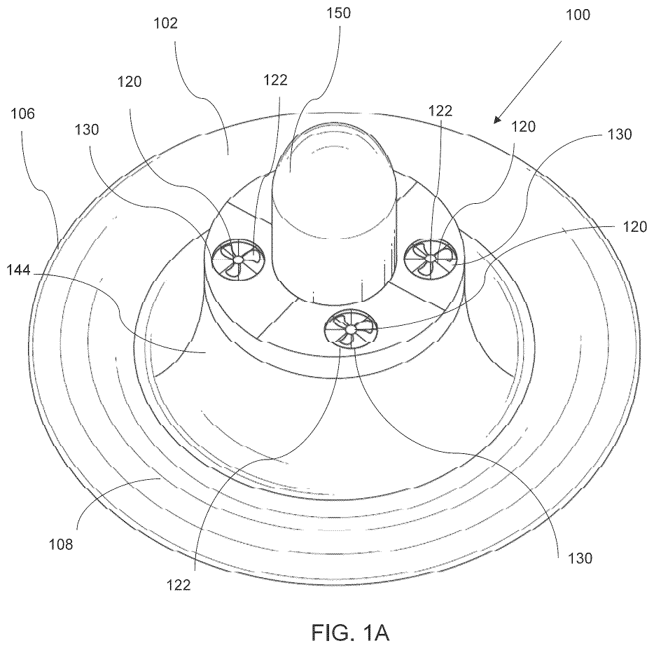

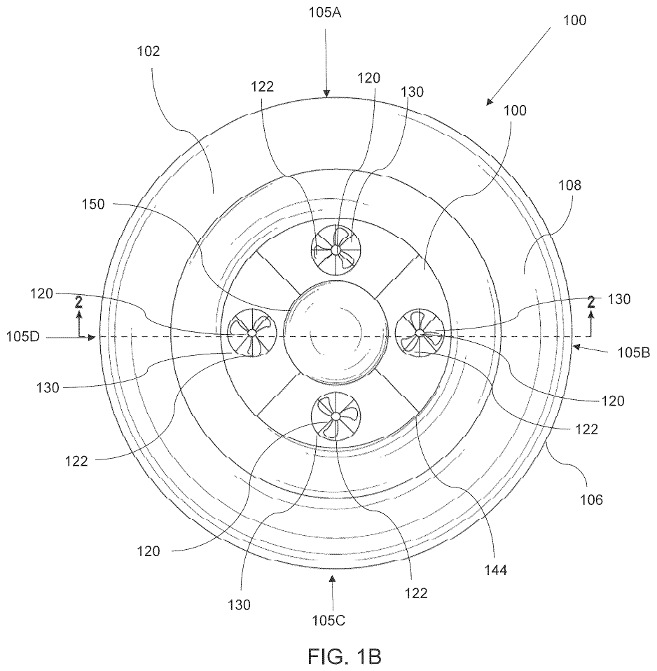

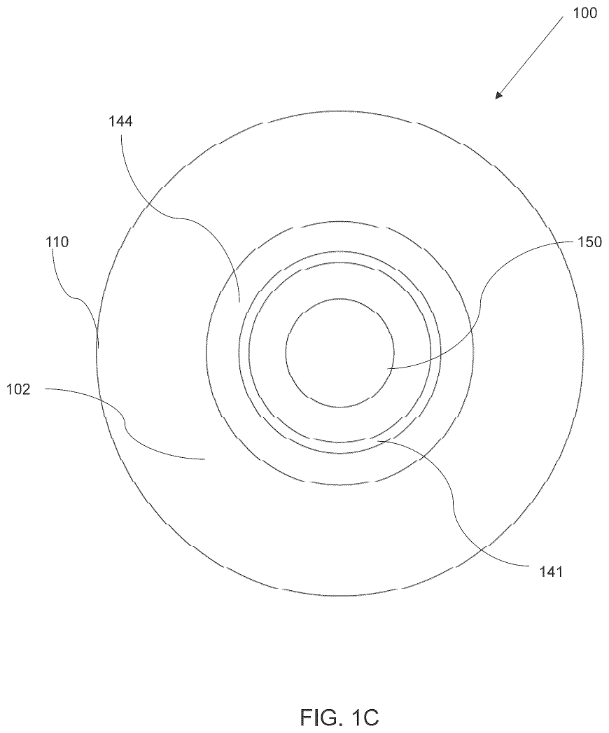

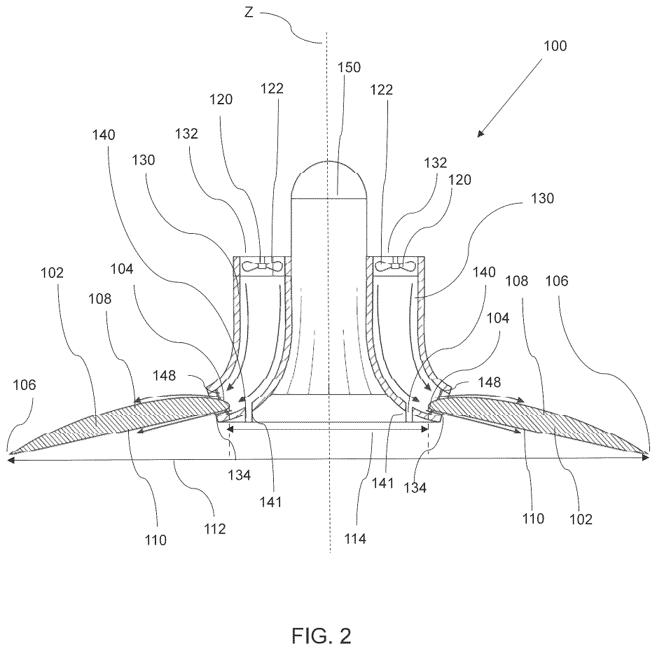

FIGS. 1A-1C and 2 illustrate an example embodiment of a system, shown as an aircraft 100, that includes a plurality of aerolift systems, with each aerolift system having a propulsion unit blowing air through a duct and over a lifting body, with the lifting body in this particular application shown as an annular wing 102 (shown disc-shaped in this example). Various other systems and applications for the aerolift system are shown and described throughout this disclosure.

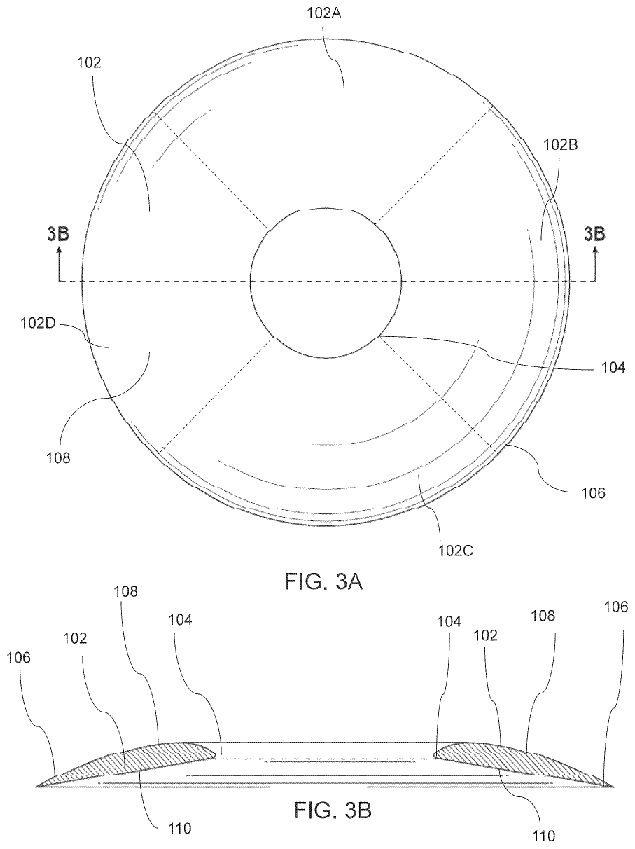

FIG. 1A is a perspective view, FIG. 1B is a top view, FIG. 1C is a bottom view, and FIG. 2 is a cross-sectional view as taken along the line in FIG. 1B, of the aircraft 100 having multiple aerolift systems. The aircraft 100 thus may have a plurality of propulsion units 120, a plurality of ducts 130 (e.g., plurality of ducts 130), and a main portion 150 which may be empty, or which may contain a payload compartment, passenger area, cockpit, and/or the like. The main portion 150 may be covered with an ovular or dome shaped covering. The wing 102 may surround the plurality of ducts 130 and may be coupled to a portion of the plurality of ducts 130. Additionally, the wing 102 may have a leading edge 104 and a trailing edge 106 (see, for example, FIG. 2). The leading edge 104 may be located near or within a lower or outlet end 134 of the ducts 130. The wing 102 may have a top surface 108, where the top surface 108 may have a curved profile. The wing 102 may have a bottom surface 110, where the bottom surface 110 has a flatter surface relative to the top surface 108. Therefore, when viewing a cross-sectional profile of the wing 102 (see, for example, FIGS. 2 and 3B), the wing 102 may have the profile of an airfoil. In some embodiments, the wing 102 may be a lifting body with a curved bottom surface 110. Furthermore, the aircraft 100 may be symmetrical about a longitudinal axis Z (see, for example FIG. 2).

In some embodiments, a flow of air (e.g., flow of environmental air) is delivered to the leading edge 104 of the wing 102 from the outlet end 134 of each of the ducts 130. The flow of air may first be delivered to the leading edge 104 and travel over the top surface 108 and the bottom surface 110. The flow of air traveling from the leading edge 104 to the trailing edge 106 along the top surface 108 may flow at a relatively greater speed, compared to air flowing along the bottom surface 110, due to the curved profile of the top surface 108, resulting in a relatively lower air pressure exerted on the upper portion of the wing as compared to the pressure on the bottom surface 110. The flow of air from the leading edge 104 to the trailing edge 106 along the bottom surface 110 may flow at a relatively lower speed, compared to air flowing along the top surface 108, due to the flatter profile (e.g., compared to the top surface 108) of the bottom surface 110, resulting in a relatively greater air pressure exerted on the bottom surface 110 of the wing 102 as compared to the pressure on the top surface 108. The pressure differential between the bottom surface 110 and the top surface 108 causes a lifting force applied upward to the wing 102, which is transferred to the aircraft 100.

The plurality of ducts 130 may be coupled to the wing 102. Additionally, or alternatively, the wing 102 may be coupled to the main portion 150. The plurality of ducts 130 may extend from an inlet end 132 to an outlet end 134. In some examples, the length or shape of the ducts 130 may be configured to provide a desired speed and direction of airflow to provide streamlined airflow, maneuverability to the aircraft 100 and a desired amount of lift necessary for the operational requirements of the aircraft 100 (e.g., size or weight of the payload). The length of the ducts 130 may determine how long of a path the flow of air has to travel from the inlet end 132 to the outlet end 134. The longer the length of the ducts 130, the lower the flow rate of the air is at the outlet end 134 due to friction and turbulence experienced by the air in the ducts 130. Therefore, in some embodiments, the length of the ducts 130 may be configured to be as short as possible to increase the flow rate of air at the outlet end 134. In some embodiments, the extended length of the ducts 130 may be two feet. Additionally, the extended length of the ducts 130 may be ten feet. In some embodiments, the extended length of the ducts 130 may be between one foot and twelve feet. Furthermore, the ratio of length of the ducts 130 to a blade 122 diameter may be 2:1 (e.g., length of the ducts is two times longer than the diameter of the blades 122 of the propulsion units 120). Additionally, in some embodiments, the ratio between the length of the ducts 130 and the blade 122 diameter may be between 1:1 to 4:1.

The inlet end 132 and the outlet end 134 may be circular or generally circular (e.g., ovular). The inlet end 132 and outlet end 134 may be shaped to permit a desired flow of air to enter the propulsion units 120. The inlet end 132 and outlet end 134 of the ducts 130 may have a diameter configured to provide a desired amount of airflow to the leading edge 104 of the wing 102. In some examples, the diameter of inlet end 132 may be approximately two feet. Additionally, in some examples, the diameter of the inlet end 132 may range from eight inches to sixteen inches, from sixteen inches to thirty-two inches, or from thirty-two inches to seventy-two inches. In some embodiments, the diameter of the inlet end 132 of the ducts 130 corresponds to the diameter of the propulsion units 120. In some examples, the diameter of the outlet end 134 may be approximately two feet. Additionally, in some examples, the diameter of the outlet end 134 may range from eight inches to sixteen inches, from sixteen inches to thirty-two inches, or from thirty-two inches to seventy-two inches. The ratio of diameter between the inlet end 132 and the outlet end 134 may be between 1:1 to 4:1. Therefore, the ducts 130 may taper from the inlet end 132 to the outlet end 134.

The plurality of propulsion units 120 may be coupled to the inlet end 132 of the plurality of ducts 130 and be designed such that a flow of air is drawn (e.g., directed, delivered) through the propulsion units 120 to the inlet 132 of the plurality of ducts 130. By mounting the plurality of propulsion units 120 in a vertical and/or downward facing direction, the flow of air may originate from above the wing 102. Advantageously, this may reduce the amount of air pressure above the aircraft 100 and/or at the top surface 108 of the wing, which may improve lift. Furthermore, by delivering the flow of air to the wing 102 the aircraft 100 may vertically takeoff, vertically ascend, vertically descend, and vertically land. In some embodiments, the propulsion units 120 may alternatively be positioned at an intermediate location of the ducts 130 (such as at a location along the length of the duct 130 between the inlet end 132 and the outlet 134). In such a configuration, the flow of air may still originate from above the wing 102, even if the propulsion units 120 are in a different location. Positioning the propulsion units 120 in an intermediate location of the ducts may maintain the flow rate of air at the outlet end 134 of the ducts 130 which may improve operational efficiency of the propulsion units 120. In some embodiments, the propulsion units 120 may be positioned above the inlet end 132 of the plurality of ducts 130, where at least a portion of the propulsion units 120 may extend from the inlet end 132. The propulsion units 120 may be spaced circumferentially around the wing 102 and may be equidistantly separated. Additionally, the propulsion units 120 may be spaced annularly about the longitudinal axis Z of the aircraft 100.

The number of ducts 130 may equal the number of propulsion units 120 (e.g., 1:1 ratio of ducts 130 to propulsion units 120). There may be one propulsion unit 120 providing air to a respective one of the ducts 130. The plurality of ducts 130 may be spaced circumferentially around the wing 102 and may be equidistantly separated. The plurality of ducts 130 may be spaced annularly around the longitudinal axis Z of the aircraft 100. In some embodiments, such as in the aircraft 100 of FIGS. 1A-1C and 2, the number of ducts 130 and the number of propulsion units 120 may be four units/ducts. Further, although FIG. 2 only shows the details of two of the ducts 130, the other two ducts may be the same or similar in design. Alternatively, the number of ducts 130 and the number of propulsion units 120 may be any number which may provide the desired amount of airflow to the leading edge 104 of the wing 102. (e.g., two, four, six, eight, ten, etc.). Further, some embodiments may have a different number of ducts 130 than the number of propulsion units 120 (such as, for example, by having one or more propulsion units 120 sharing a duct and/or by having one or more ducts 130 sharing a propulsion unit 120). For instance, a single propulsion unit 120 may provide airflow to two, three, four or more ducts 130. As another example, a single duct 130 may include two, three, or four propulsion units 120, for instance, at the inlet 132, outlet 134, and/or one or more propulsion units 120 there between.

In some embodiments, the plurality of ducts 130 may be configured such that a flow of air may be delivered to a particular region (e.g., one or more of sections 105A, 105B, 105C, 105D) of the wing 102. For example, in some embodiments, there may be four ducts 130 and four propulsion units 120, where the four ducts 130 deliver a flow of air to the leading edge 104 for four sections (e.g., one or more of sections 105A, 105B, 105C, 105D) of the wing 102. Therefore, the wing 102 may receive flows of air from each of the propulsion units 120. This may be advantageous when the plurality of propulsion units 120 are configured to operate independently. However, this is not limited to embodiments with four ducts 130 and four propulsion units 120. This may include any number of propulsion units 120 and ducts 130.

When the plurality of propulsion units 120 are configured to deliver different speeds (e.g., flows) of air to different sections of the aircraft 100, then the aircraft 100 may have different pressure differentials at each section. Therefore, the aircraft 100 may pitch, yaw, and/or roll. For example, section 105B of the wing 102 may receive a faster flow of air, as compared to section 105D of wing 102 (e.g., the section spaced 180 degrees from 105B), which may cause section 105B to generate more lift and tilt in a forward direction (e.g. towards section 105D) to move the aircraft forward Additionally, in some examples, sections 105A of the wing 102 may receive a faster flow of air, when compared to second 105C of the wing 102 (e.g., the section spaced 180 degrees from section 105A), which may cause section 105A to generate more lift and tilt the aircraft 100 to a side which may move the aircraft towards that side. In some embodiments, the propulsion units 120 may be configured to move the aircraft 100 at slow speeds (e.g., 5-10 mph). However, the aircraft 100 may be configured such that the device may travel at speeds of up to 25-30 mph. In some embodiments, the plurality of ducts 130 may be created in a larger channel (e.g., walled structure) 144, as further described.

In some embodiments, the aircraft 100 may have a main portion 150, such as a body. The main portion 150 may be disposed radially inwardly of the wing 102 and/or ducts 130, for example within a central opening or space defined by the wing 102 and/or ducts 130. The main portion 150 may be located medially (radially inwardly) to the leading edge 104. The main portion 150 may be cylindrical or generally cylindrical as shown, or other shapes. A sidewall of the main portion 150 may extend annularly about the longitudinal axis Z. In some configurations, the main portion 150 may be empty. Additionally, the main portion 150 may extend above the inlet 132 of the plurality of ducts 130. The main portion 150 may also be configured to contain people and/or objects. For example, in some embodiments, the main portion 150 may include a passenger compartment which may comfortably contain one or more persons. The passenger compartment may have an upper room and a lower room. Additionally, the main portion 150 may be configured to contain packages, people, and/or vehicles. In some embodiments, the main portion 150 may be configured to contain 50 lbs. to 100 lbs. Additionally, in some embodiments, the main portion 150 may be configured to contain 25 lbs. (e.g., a package) or 2000 lbs. (e.g., a group of people). The main portion 150 may be configured to contain anywhere between 5 lbs, and 3500 lbs, or more. In some embodiments, the main portion 150 may be configured to hold smaller payloads and/or electronics, for example in smaller “drone” versions of the aircraft 100. The volume of the main portion 150 may thus range from one to ten cubic inches, and up to ten, twenty, thirty, or more cubic feet.

The main portion 150 may be coupled (e.g., rigidly mounted) to an interior wall or walls of the plurality of ducts 130. In some embodiments, the center of gravity of the device is located along the longitudinal axis of the wing 102. Advantageously, this may improve the stability of the aircraft 100 when traveling in the air. In some embodiments, the ducts 130 may extend through the main portion 150. The ducts 130 may extend through radially outward locations of the main portion 150. The ducts 130 may extend through a central location of the main portion 150, with the empty space of the main portion 150 surrounding upper portions of the plurality of ducts 130.

In some embodiments, with reference to FIG. 2, the plurality of ducts 130 may also have a flap 140 positioned along a bottom edge of the ducts 130. The flap 140 may be a hinged member, rudder, etc., that is moveable to reveal a slot or other opening in the duct 130. The flap 140 may allow a flow of air to exit the ducts 130 through an opening 141 before reaching the leading edge 104 of the wing. Therefore, the flap 140 may be configured to create a horizontal directional (e.g., forward/backward) thrust to move the aircraft 100. For example, when the aircraft 100 is traveling through the air, the flap 140 located on at least one of the ducts 130 may be configured to open to direct a flow of air out of the opening 141 in a desired direction to move the aircraft 100 horizontally forward. Additionally, the flap 140 may be configured to open during takeoff or landing to direct a flow of air downward which may achieve a desired amount of lift. For example, directing a desired flow of air downward from the flap 140 can directly generate lift which can supplement the lift generated by directing a flow of air across the wing(s), which may help stabilize the aircraft 100 during landing and/or may increase the net vertical lifting force during takeoff. The flap 140 may be on a vertical portion of the duct 130, on a horizontal portion of the duct 130, or as shown on an angled or curved portion of the duct 130.

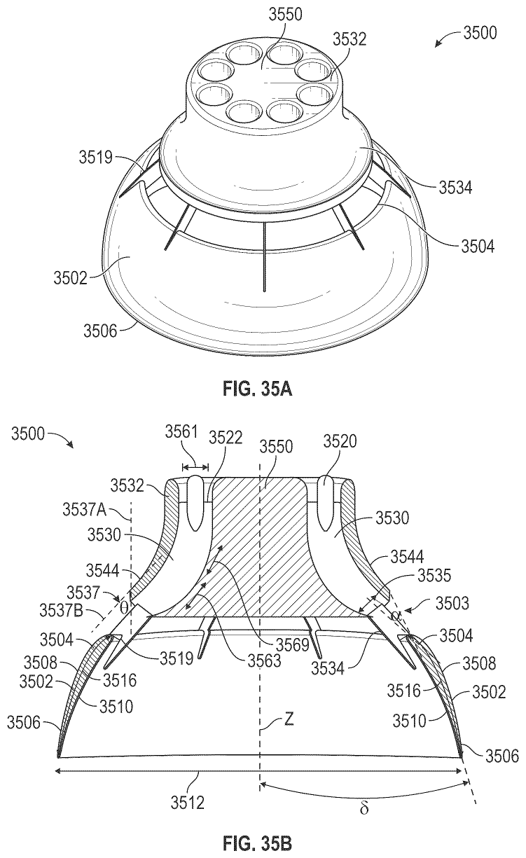

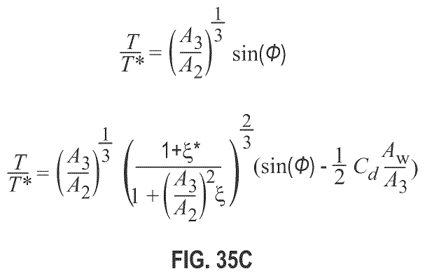

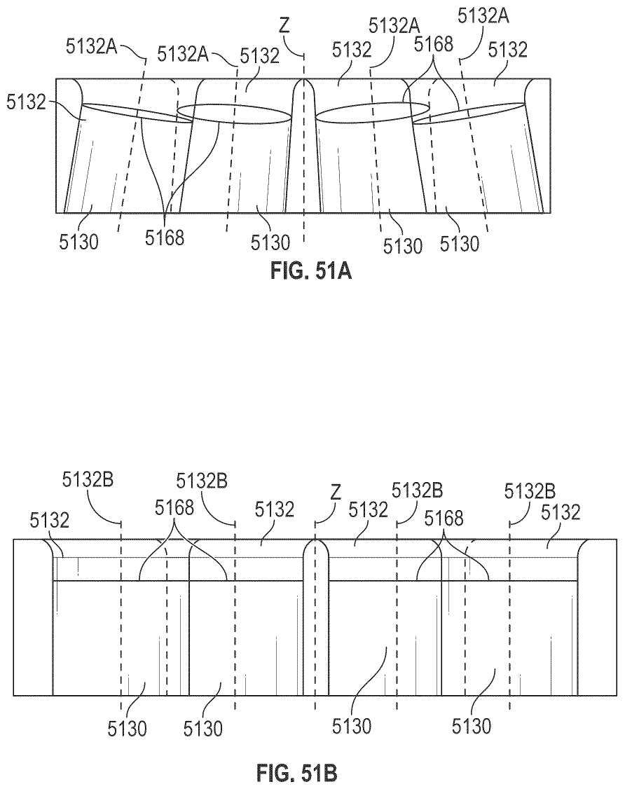

With reference to FIG. 2, the ducts 130 may turn or bend from the inlet end 132 to the outlet end 134. The turn may be measured by a “turn angle” as measured between a first longitudinal axis 3537A as defined by the duct channel at the inlet end 132 and a second longitudinal axis 3537B as defined by the duct channel at the outlet end 134 (see, for example, FIG. 35B). This turn angle may be from 10 degrees to 60 degrees, from 15 degrees to 55 degrees, from 20 degrees to 45 degrees, or from 30 degrees to 40 degrees. Further, the first longitudinal axis 3537A may be parallel to or slightly angled or “canted” with respect to a reference axis. The reference axis may be a central longitudinal axis of the vehicle, or an axis aligned with a gravity vector (a vector aligned with the direction of the force of gravity), or a vertical axis (see, for example, FIGS. 51A and 51B). A set of the propulsion units 120 may be mounted at the inlet ends 132 of the ducts 130. The propulsion units 120 may comprise a plurality of blades 122 extending from a central hub. In some embodiments, the blades in the propulsion units 120 may have a variable blade pitch to optimize energy consumption during flight. A motor within each propulsion unit may rotate the blades 122 via the hub. By configuring the plurality of propulsion units 120 to rotate the blades 122 at various, independently controlled speeds, the aircraft 100 may, as mentioned, change altitude, pitch, roll, and yaw to maneuver the aircraft 100 in a desired direction. Operating the different propulsion units 120 independently may also be used to stabilize flight, even in a stationary hover, such as to account for turbulence, wind, movement of payloads and/or passengers, and/or the like.

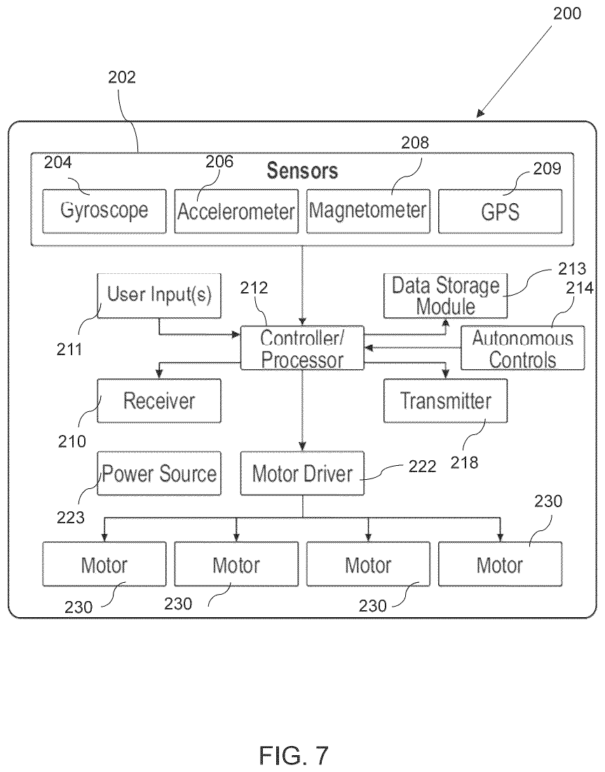

The plurality of propulsion units 120 may be operated by a controller 212 or processor system based on user inputs 211 and/or autonomous controller (e.g., self-operating mode) 214 and/or sensors 202 (see, for example, FIG. 7). The plurality of propulsion units 120 may be coupled to independently controlled motors 230 that are operated to fly the aircraft 100 through the air. The motors 230 may operate to spin the plurality of blades 122 to deliver air to the ducts 130. The plurality of blades 122 may be coupled to the hub and to the motor 230, which may be configured to rotate or swivel the hub and the plurality of blades 122. The plurality of blades 122 may have a fixed span (e.g., length). In some cases, the plurality of blades 122 may have a length and/or blade pitch that varies to deliver an optimized flow of air to the ducts 130. In some embodiments, rotating or swiveling the propulsion units 120 and therefore the plurality of blades 122, may vary the blade pitch. Additionally, in some embodiments, the blade pitch may be varied by oil pressure or centrifugal weights which may be attached directly to the plurality of blades 122. The plurality of blades 122 may be shrouded in a case which houses the motor 230, blades 122, and hub. Additionally, the plurality of propulsion units 120 may each deliver approximately fifty to two-hundred and fifty N of thrust (e.g., spin the blades 122 at a fast enough speed to generate the desired force). The plurality of propulsion units 120 may have a diameter of about 12 inches. However, in some cases the diameter of the propulsion units 120 (e.g., the diameter of the case or shroud) may range from six inches to sixteen inches, from sixteen inches to thirty-two inches, or from thirty-two inches to seventy-two inches.

The plurality of propulsion units 120 may be coupled to or include an electric motor (e.g., motors 230) or a piston engine (e.g., powered by fossil fuel). In some embodiments, the propulsion units 120 may be electric propulsion units capable of delivering up to 250 Newtons (N) of thrust at 15 kW of power to 1,000 N or more. In some embodiments, the propulsion units 120 may have a casing with an inside diameter of 195 mm. The casing may, in some embodiments, have an inside diameter from 100 mm to 300 mm, or from 100 mm to 600 mm, or from 300 mm to 550 mm, or from 500 mm to 550 mm, or from 520 mm to 530 mm. The total area of the rotating plurality of blades 122 may be approximately 215 cm² (e.g., thirty-three in²). The amount of input power may range between four kW and 25 kW. Additionally, the static thrust range may be from 50 to 350 N, or from 500 to 700 N. The RPM range of the propulsion units 120 may be 10,000-18,000 RPM (e.g., the plurality of blades 122 spin at 10,000-18,000 RPM), or from 2,000-20,000 RPM. The total weight of each propulsion unit 120 may be from 1000 grams (g) to 3400 g (e.g., about 7.5 lbs.), or from 1000 g to 20,000 g. In some embodiments, the propulsion units 120 may weigh between four lbs, and 40 lbs. The propulsion units 120 may generate a flow of air at speeds from 64 to 128 meters per second (m/s) (e.g., 143 mph to 286 mph), or from 40 to 60 m/s. The total area of the rotating plurality of blades 122 may be from approximately 20 to 50 square inches (in²). The battery (e.g., power source 223) may be a 12-14S 20000 mAH LiPo battery. The efficiency of the propulsion units 120 may be approximately 78%. Additionally, in some embodiments, the efficiency of the propulsion units 120 may be from 68% to 85%. The propulsion units 120 may be, in some cases, a DS-215-DIA HST electric fan or an eP05-21 electric motor manufactured by Schubeler (Bad Lippspringe, Germany). In some embodiments, the propulsion units 120 may be powered by a hybrid power source that includes two different power sources, such as electric and fossil fuel, etc. It should be noted that, while the above description provides examples of certain specifically configured propulsion units that can be used with at least some embodiments of aircraft disclosed herein, the concepts disclosed herein are not limited to such propulsion units, and any propulsion units capable of performing the functions disclosed herein may be utilized.

Additionally, the air may travel through the opening at the flap 140 to cause the aircraft 100 to tilt and or move forward. Assuming a constant airflow output from a propulsion unit 120, the amount of air that reaches the corresponding leading edge 104 will be reduced when air exits through the flap 140. When air exits the flap 140 the pressure differential on the section of the wing the duct 130 is providing the flow of air to may change relative to the other sections. Therefore, the change in pressure differential on the section of the wing 102 may cause the aircraft 100 to ascend, descend, hover, tilt, rotate, or translate. In some cases, the aircraft may compensate for such change by, for example, increasing the air flow from the propulsion unit 120. The flap 140 coupled to the duct 130 may be angled. By angling the flaps 140, directing air out of the flaps 140 may cause the aircraft 100 to move in a desired direction (e.g., forward/backwards).

In some embodiments, the plurality of ducts 130 may be grooved or include a plurality of grooves on an inner wall of the ducts 130. The grooves may extend from the inlet 132 to the outlet 134 of the ducts 130 and may reduce turbulent flow of air. Advantageously, this may allow for streamlining of airflow (e.g., laminar flow) and better control of the speed of the flow of air as it reaches the leading edge 104 of the device. In some embodiments, the plurality of ducts 130 may taper, (e.g., decrease in cross-sectional area, from the inlet end 132 to the outlet end 134), which may increase the air pressure from the inlet end 132 to the outlet end 134 and increase the speed of the air at the leading edge 104. Advantageously, tapering the ducts 130 may allow the propulsion units 120 to operate at slower speeds to deliver a desired amount of air to the leading edge 104.

The wing 102 may be mounted to the outlet 134 of the ducts 130 via a series of supports 148 (e.g., high strength tie rods, axles, cables, and the like). The supports 148 may also connect to an area adjacent to the leading edge 104 of the wing 102. By using the supports 148, the angle of the annular wing 102 relative to the direction of incoming air from the duct 130 may be varied. As described in further detail below, the supports 148 may be configured to adjust the angle (e.g., angle of attack) of the wing 102 to achieve a desired lift and/or operational profile. The supports 148 may also extend or retract the wing 102 further into or outside of duct 130. Advantageously, using supports 148 to couple the wing 102 to the plurality of ducts 130 may lead to significant weight reduction in the aircraft 100. Additionally, in some embodiments, the supports 148 may further connect the wing 102 to the main portion 150 of the aircraft 100.

FIGS. 3A and 3B illustrate the wing 102 in isolation from the aircraft 100. The wing 102 may be generally symmetrical and extend annularly about the longitudinal axis Z. The wing 102 may have an outer diameter 112 and an inner diameter 114. The ratio of the outer diameter 112 to the inner diameter 114 may be 2:1 or greater, 3;1 or greater, 4:1 or greater, about 3:1, or about 4:1. The outer diameter 112 of the wing 102 may be approximately thirty feet and the inner diameter may be about ten feet. Additionally, in some embodiments, the outer diameter 112 of the wing 102 may be between twenty feet to sixty feet. In smaller versions (e.g., handheld versions) of the aircraft 100, the inner diameter 114 may be from one to ten inches, and the outer diameter 112 may be from three to fifty inches. The main portion 150 may be disposed within the inner diameter 114 of the wing 102. The wing 102 may be made of carbon fiber, aluminum alloy, fabric, wood, magnesium alloy, or any other suitable material.

The wing 102 may also be partitioned (e.g., sectioned) into separately and independently moveable sections. The wing 102 may be broken up into discrete sections (e.g., 102A, 102B, 102C, 102D) with open spaces or slots in between each section instead of being a continuous disc/annular shape. Each of the sections may be independently mounted to the aircraft 100 and the plurality of ducts 130 via the supports 148. The number of wing sections may correspond to the number of ducts 130 (e.g., 1:1 ratio of sectioned wings to ducts 130). Therefore, in some cases, the number of wing sections may also correspond to the number of propulsion units 120 (e.g., 1:1:1 ratio of wing sections to ducts 130 to propulsion units 120).

The individual wing sections (e.g., 102A, 102B, 102C, 102D) may be independently rotatable or actuatable. The individual wing sections (e.g., 102A, 102B, 102C, 102D) may be operated by a controller 212 which can actuate supports 148 to move the wing sections. The supports 148 may be configured to move the leading edge 104 of the wing upwards or downwards (e.g., longitudinally) and/or translate the individual wing section from side to side (e.g., laterally). The individual wing sections (e.g., 102A, 102B, 102C, 102D) may each have a variable mounting angle. The supports 148 may be configured to adjust the angle of each section of the wing 102 independently to achieve a desired lift and/or operational profile. In some embodiments, the individual wing sections can independently rotate from side to side (e.g., horizontally) within the ducts 130. Therefore, the majority of the wing 102 area (e.g., the total surface area of the individual wing sections 102A, 102B, 102C, 102D) could shift from a front side of the aircraft 100 to a rear side of the aircraft 100.

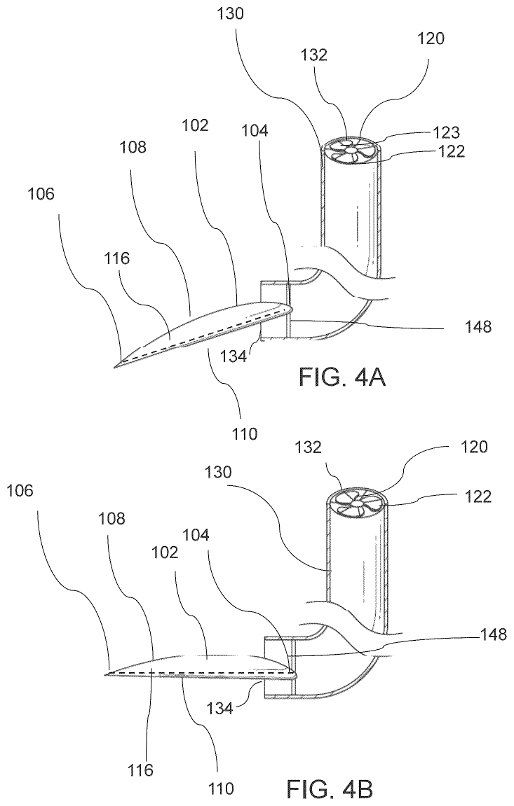

FIGS. 4A-4B illustrate an example cross section of one of the ducts 130 coupled to the wing 102 of the aircraft 100, with the wing 102 shown in different angular orientations. The wing 102 may have a first mounting angle proving a first angle of attack (e.g., 0 degrees, 5 degrees) which may be used, for example, to assist in the vertical lift of the aircraft 100. The angle of attack is the angle at which air exiting the duct 130 meets the airfoil. The angle is formed between the chord 116 of the airfoil and the direction of the relative air. The first mounting angle as shown in FIG. 4A may provide a first angle of attack that provides a first amount of lift and allows the plurality of propulsion units 120 to operate at an optimal speed to vertically lift the aircraft 100. The wing section may then be rotated to a second mounting angle as shown in FIG. 4B to provide a second angle of attack that is less than the first angle of attack and which may provide a relatively smaller lifting force as compared to the first angle of attack.

Furthermore, by changing the mounting angle (e.g., from 0 degrees to ten degrees) of the wing 102, and thus the angle of attack, the aircraft 100 may move in a forward direction. For example, after vertically lifting the aircraft 100 at a desired first mounting angle, the mounting angle of one or more sections of the wing 102 may change to tilt (e.g., move) to alter its angle of attack and the associated lifting force. Due to the uneven lifting forces, the wing 102 now tilts in a forward direction (e.g., a leading edge of the wing 102 is relatively lower than in the first position) and the aircraft 100 may move in a forward direction as the plurality of propulsion units 120 delivers a flow of air to the leading edges 104 of the various sections of the wing 102. As described in more detail below, the supports 148 may be connected to a controller or processor which may be configured to change the mounting angle of the one or more sections of the wing 102.

### Additional Duct Examples

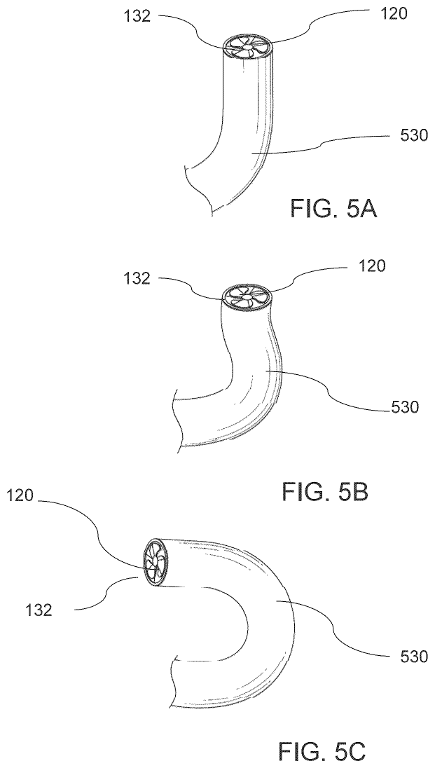

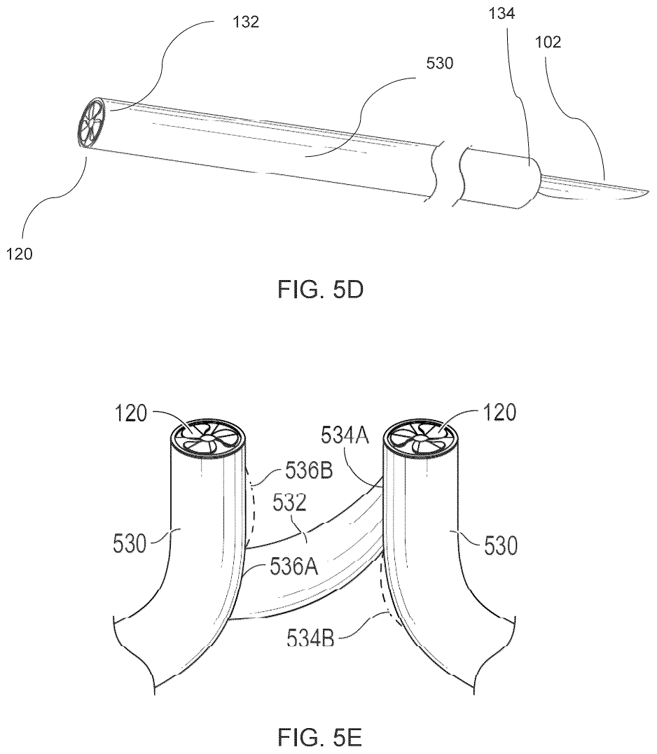

FIGS. 5A-5E illustrate examples of different shapes that the ducts 530 may utilize. The ducts 530 may operate similarly to the ducts 130 of aircraft 100, discussed above, and may be used with any aircraft described herein, including aircraft 100. The ducts 530 may be J-shaped (see, for example, FIG. 5B), C-shaped (see, for example, FIG. 5C), L-shaped (see, for example, FIG. 5A) or any other orientation which may effectively deliver a flow of air to a wing (such as to wing 102 discussed above) for optimal angle of attack to cause optimal lift while optimizing energy usage. The L-shape may be an angled L-shape where the angle of the turn from inlet to outlet is from thirty to forty-five degrees, or from thirty-five to forty degrees, for example, thirty-one, thirty-two, thirty-three, thirty-four, thirty-five, thirty-six, thirty-seven, thirty-eight, thirty-nine, forty, forty-one, forty-two, forty-three, forty-four, or forty-five degrees. This angle may be between an inlet longitudinal axis and an outlet longitudinal axis. In some embodiments, the inlet end 132 of the ducts 530 may be configured to extend in a horizontal direction, and the propulsion unit 120 mounted to the aircraft may be horizontal. The airflow may be directed to the wing along the curved path (e.g., L-, J-, or C-shape) of the duct to deliver the desired amount of lift.

Any ducts described herein, including ducts 130 and 530, may be made of a metal frame or another suitable frame to optimize the flow of air to the wing 102 and the weight of the aircraft 100 (e.g., carbon fiber, aluminum alloy, etc.). In some embodiments, the ducts may have a smooth exterior surface to reduce the amount of drag exerted on the aircraft 100 and the duct. Although not shown, the ducts may be configured to move (e.g., change angle relative to main portion 150 of aircraft 100) to deliver a desired amount of airflow to the wing 102 or receive an optimal amount of air through the propulsion units 120. Additionally, each of the propulsion units 120 may be mounted on a swivel and configured to be rotated along multiple axis when mounted to plurality of ducts 130.

The ducts 130, 530 in some cases may extend across the span of the wing 102. At least one of the plurality of ducts 130 may extend from the inlet end 132 at a first side of the wing 102, past the main body, and to the outlet end 134 located at the leading edge 104 of the wing 102 (see, for example, FIG. 5D).

FIG. 5E is a partial perspective view of two ducts 530 having a connecting duct 532 that may selectively connect the airflow paths of the two ducts 530 together. The connecting duct 532 may fluidly couple the two ducts 530 by selectively opening covers 536A and 534A. The respective covers may move to opened positions 536B and 534B. In this manner, airflow from one of the propulsion units 120 may feed air into two ducts, for example if one of the propulsion units 120 fails. This is merely one example. In some embodiments, the plurality of ducts may be created in a larger channel (e.g., walled structure) 144 with collapsible sides. Therefore, if one of the propulsion units 120 mounted at the inlet 132 of the ducts 130 fails (e.g., stops spinning), the sides of the ducts 130 configured for the failed propulsion unit 120 may be collapsed and permit airflow to be delivered to another region of the wing 102 (causing one propulsion unit to feed two ducts). Advantageously, this may assist in flight and landing in emergency situations (e.g. failure of a propulsion unit) so that the aircraft 100 may remain capable of flight. Stated another way, in some embodiments the aircraft may be configured to dynamically (e.g., during flight) “merge” multiple ducts. As an example, if a propulsion unit fails during flight, then as a safety mechanism, the aircraft may be configured to merge the duct being fed by the failed propulsion unit with another one (fed by an active propulsion unit).

### Example Landing Gear

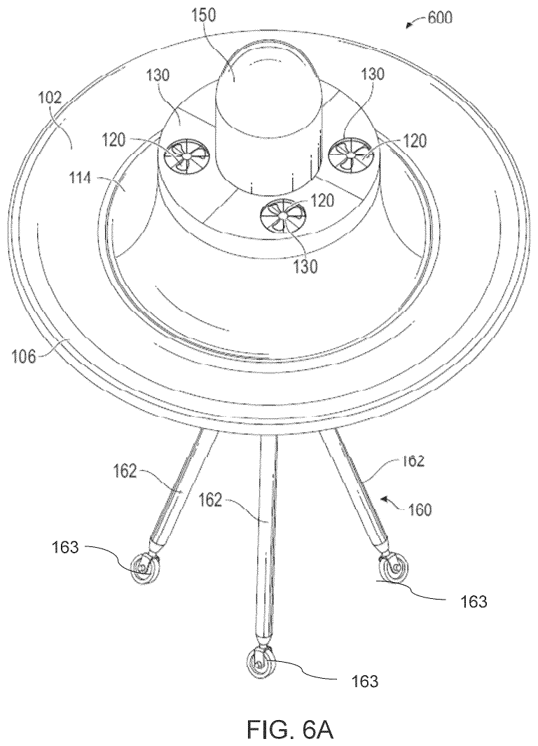

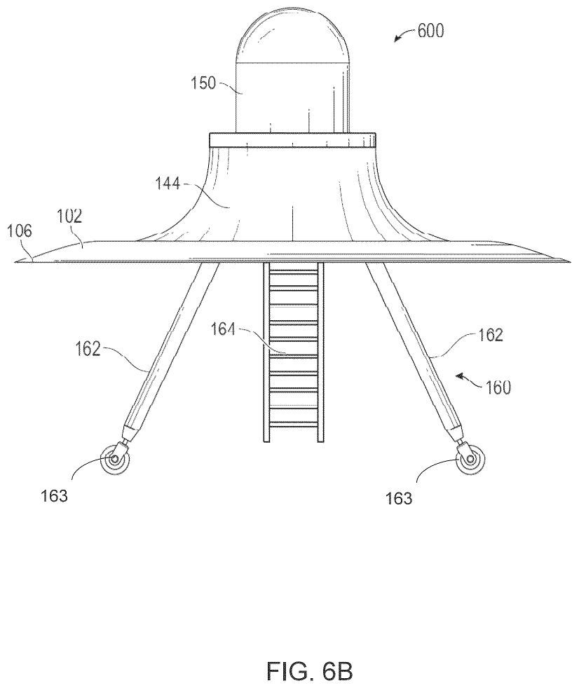

FIGS. 6A-6B illustrate another embodiment of an aircraft 600. The aircraft 600 may have many or all of the same or similar features as aircraft 100, and the same reference numbers are used to refer to the same features. The aircraft 600 includes landing gears and landing features 160. The landing features 160 may comprise a plurality of legs 162 (e.g., tripod) which may extend from a retracted position on the underside of the aircraft 600 or bottom portion 119 of the aircraft 600. The plurality of legs 162 may be configured to support the aircraft 600 upon landing. The plurality of legs 162 may also, in some embodiments, collapse, telescope, and/or pivot. Additionally, in some embodiments, a ladder 164 may extend from the main portion 150 of the aircraft 600 to reach a ground surface. This may be advantageous in embodiments where there is a passenger compartment and passengers need to enter and exit the aircraft 600. The landing features 160 and/or ladder 164 may be retractable such as, for example, by being telescopically and/or rotatably coupled to the body of the aircraft 600. The landing gears or landing features 160 may comprise tires or wheels 163. The tires or wheels 163 may be located at the bottom of the plurality of legs 162.

### Signal Receiving, Processing, And Executing

FIG. 7 illustrates an embodiment of a block diagram 200 for an aircraft as disclosed herein, including, for example, the aircraft 100, which may be used with the techniques disclosed herein. The aircraft 100 may have sensors 202, a receiver 210, a controller 212 or processor, a data storage module 213, a transmitter 218, a power source 223, motor driver(s) 222, and motors(s) 230. The sensors 202 in the aircraft 100 may include at least one of a gyroscope 204, accelerometer 206, magnetometer 208, GPS 209, and/or other sensors 202 (e.g., an optical sensor, thermometer, barometer, altimeter, camera, etc.).

The system may also allow for user input(s) 211 to control various aspects of the system. For example, in the main portion 150 of the aircraft 100 there may be one or more buttons or control panels which may be operated to fly the aircraft 100.

The controller 212 may also be used to perform certain functions while the device is flying. In some embodiments, the data storage module 213 may have programming instructions which may be used to dictate flight operations under certain conditions. For example, there may be programmed instructions to indicate to a user that the power source is low on energy and the aircraft 100 needs to land in a short amount of time.

The data storage module 213 may store information and data. The data storage module 213 may have read-only memory for the process to execute programmed functions. The data storage module 213 may also have writeable memory to store various programmed features. The data storage module 213 does not need to have both read-only memory and writeable memory.

The transmitter 218 may be used to receive data from the controller 212 or processor to send the signal to another location (e.g., computer, remote server for storage and/or analysis). For example, the transmitter 218 may be used to send data to an air traffic control center or to a central hub to review/analyze flight patterns and flight characteristics.

The motor driver 222 may be configured to receive instructions from the controller or processor 212 which may be used to adjust the speed or blade pitch or rotor axis of the various motors 230 coupled to the various propulsion units 120 of the aircraft 100. There may be more than one motor driver 222 controlling the motors 230 to assist in the independent operation of each of the propulsion units 120. The motors 230 are connected to the motor driver 222 and receive instructions from the controller 212 or processor to operate at various speeds to lift and fly the aircraft 100. Although not shown, a motor driver 222 may be connected to the supports 148 to move the supports 148 to different positions to adjust the mount angle of the wing 102.

The power source may also be included in the aircraft 100 to power each of the components and features of the aircraft 100. Although no line is drawn from the power source to each component, each component is either directly or indirectly coupled to the power source. The power source 223 may be based on fossil fuel or electric battery which may be recharged or live power. Solar energy may be used. Additionally, there may be alternative power sources 223 (e.g., solar) which may be used to power the aircraft 100.

### Methods of Aircraft Operation

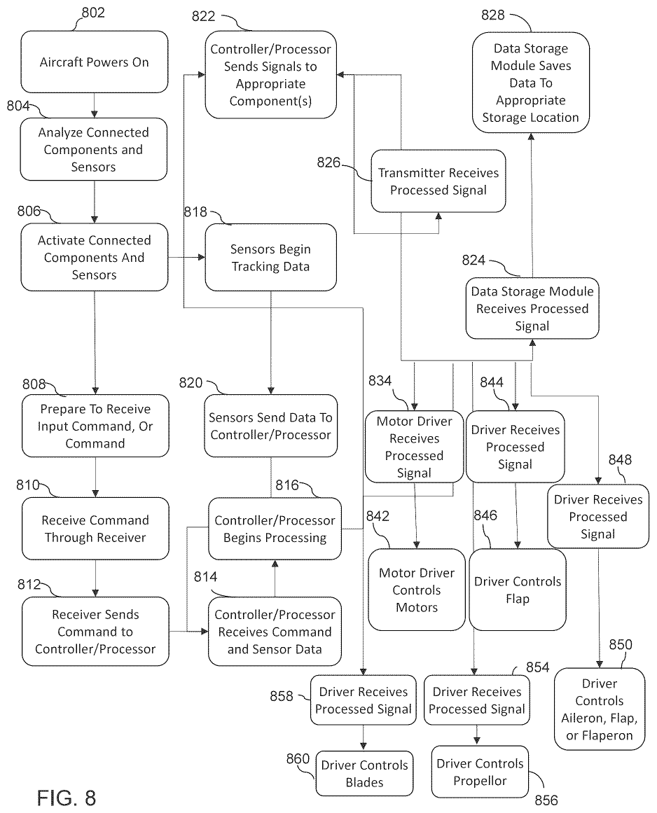

In some embodiments described herein a method for flying an aircraft 100 is disclosed herein. FIG. 8 illustrates a flow chart diagram for one embodiment of a process for the aircraft 100 disclosed herein. Blocks 802 through 808, and 818 and 820 relate to a general start up procedure of the aircraft. To start-up the aircraft 100 at block 802, the aircraft 100 may be powered on, either by a key control, button control, switch, or any other similar feature. After starting the aircraft 100, at block 804, the controller 212 or processor may determine whether there is sufficient power to fly the aircraft 100, if the sensors 202 are all connected, and if the motor driver(s) 222 and motors 230 are operational. At block 806, the aircraft may activate the components and sensors 202.

At block 818, the aircraft 100 may then determine the requirements for flying based on readings from the sensors 202 (e.g., weather, windspeed, aircraft 100 weight). At block 820, after determining what is necessary for flying based on the sensors 202, data may be sent to the controller 212 or processor. Additionally, the aircraft 100 may receive input data from a user to determine a flight path or flight instructions. Furthermore, at block 808, the user inputs 211 may include selecting (e.g., commanding) an autonomous flight path to fly the aircraft 100. Additionally, the controller may be connected to an autonomous control box 214 which may control (e.g., command) various aspects of the system-based readings from the sensors 202. For example, a user may select a flight destination to send to the controller 212 and the autonomous controls 214 may provide inputs on speed and flight controls and operations of the propellors to optimize the flight experience, which may be based on weather and traffic. Additionally, at block 810, the aircraft 100 may also determine next steps based on inputs (e.g., commands) to a receiver 210.

At blocks 812 and 814, the commands received by the controller 212 may be converted into a signal to operate the aircraft 100 or perform a flight sequence. In some embodiments, the flying device may convert the commands into an appropriate signal (e.g., electrical signal). At block 816, the controller 212 may process the commands and sensor data to send signals to the various components of the aircraft 100 (e.g., motors) to manipulate the components. After processing is complete, at block 822, the signals may be sent to the components to operate them. Additionally, not all of the components are necessarily driven at the same time. For example, operating the controller 212 may include directing a determined amount of power or energy based on the signals to one or more of the propulsion units 120 to direct a flow of air through the ducts 130 to lift the aircraft 100.

At block 824, the data storage module 213 may also receive a processed signal from the controller 212. Additionally, at block 826, the transmitter 218 may receive a signal from the controller 212. At block 828, the data storage module 213 may store information and signals to be later used during flight. For example, the flap 140 may be opened if the forward speed of the aircraft 100 is not met by a certain time threshold. The transmitter 218 may send the processed signal to another source (e.g., computer) for further analysis.

At block, 834, the motor 230 or motor driver 222 may receive a signal from the controller 212 to adjust the speed and/or power delivered to the propulsion unit 120. At block 842, the motor driver 222 may activate to signal to a specific motor 230 of a propulsion unit 120 for operational controls. For example, by adjusting the speed of a motor driver 222 based on the input signal, the speed of the flow of air from the propulsion unit 120 may tilt the aircraft 100 thrust the aircraft 100 forward. Additionally, by adjusting the speed of at least one of the motor drivers 222, the aircraft 100 may be configured to vertically takeoff or land safely (e.g., without excessive turbulence).

Additionally, the controller 212, although not shown, may be coupled to a driver which may adjust the orientation of the wing 102 (e.g., change the mounting angle). Therefore, based on the desired speed of the aircraft 100 the controller may deliver a signal to the cable driver which may extend or retract the supports 148 which may adjust the mount angle. For example, when the aircraft 100 is not moving at a desired speed by a predetermined period of time, the controller may send a signal to the cable driver to adjust the mount angle of the wing 102 to increase the speed of the aircraft 100 (e.g., from 5 MPH to 10 MPH).

At block 844, the controller 212 may be coupled to a driver. At block 846, the driver can operate to the flap 140 to open or close the flap 140 a desired amount. For example, when the aircraft 100 needs to increase its speed, the controller 212 may send a signal to the driver to open the flap 140 a desired amount to direct a flow of air from the ducts 130 to increase the speed of the aircraft 100.

At block 848, the controller 212 may be coupled to a driver. At block 850 the driver can operate an aileron, flap, or flaperon located at the trailing edge 106 of the wing 102, which can pivot, extend or retract the aileron. For example, when the additional lift is needed to operate the aircraft 100 the controller 212 may send a signal to the driver to extend a flap to increase the camber of the wing 102.

At block 854, the controller 212 may be coupled to a driver. At block 856, the driver may control one or more propellors or other types of propulsion units and/or thrusters located below the wing 102. The propellors may receive a signal from the controller 212 to adjust the speed and/or power delivered to the propellors. For example, adjusting the speed of the propellor based on the input signal from the controller 212 to the driver can thrust the aircraft 100 in a desired direction (e.g., forward).

At block 858, the controller 212 may be coupled to a driver. At block 860 the driver may be connected to a swivel connected to the plurality of blades 122. Therefore, the driver may adjust the angle of the plurality of blades when the driver receives a signal from the controller 212. The controller 212 may also be coupled to drivers connected to each of the individual wing sections (e.g., 102A, 102B, 102C, 102D). After receiving a signal from the controller 212, the driver may adjust the angle of the individual wing sections (e.g., 102A, 102B, 102C, 102D) to achieve desired operational characteristics (e.g., lift, tilt, thrust, etc.).

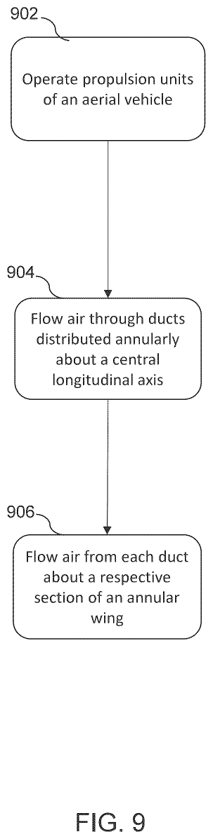

FIG. 9 illustrates a flow chart diagram for one embodiment of a process for the aircraft 100 disclosed herein. Blocks 902-906 generally relate to operating propulsion units of the aircraft 100. At block 902, the propulsion units 120 may be powered on so that they may generate a flow of air for vertical takeoff of short takeoff. At block 904, the flow of air generated from the propulsion units 120 may flow through the ducts 130. The ducts 130 may be distributed annularly about a central longitudinal axis of the aircraft 100. At block 906, the flow of air from each duct 130 may flow to the leading edge 104 of a respective region (e.g., section) of the wing 102 (e.g., sections 105A, 105B, 105C, 105C).

### Additional Aircraft Examples

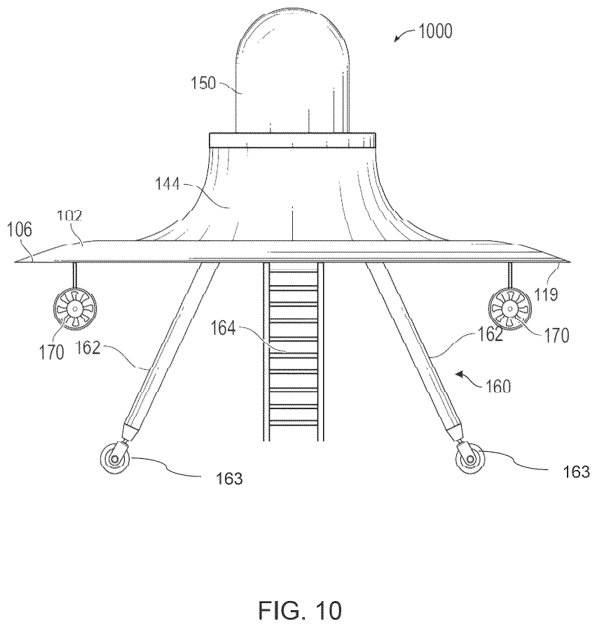

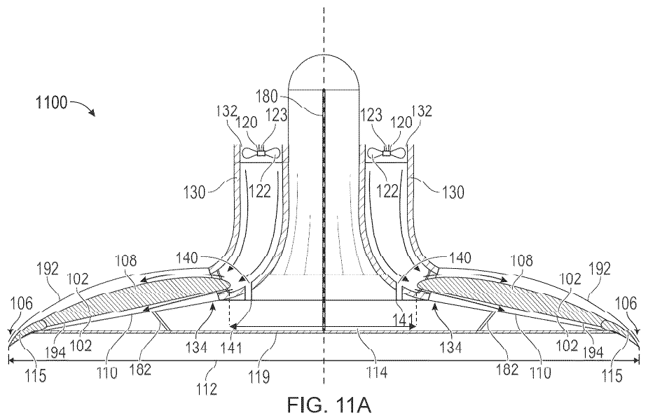

FIG. 10 illustrates another embodiment of an aircraft 1000. The aircraft 1000 may have many or all of the same or similar features as aircraft 100, and the same reference numbers are used to refer to the same features. The aircraft 1000 includes one or more propellors 170 (and/or propulsion units, thrusters, and/or the like) positioned on a bottom portion 119 of the aircraft 1000. The propellors 170 may be operated to thrust the aircraft 1000 in a desired direction. For example, when the aircraft 1000 is traveling, additional thrust may be desired to increase the airspeed of the aircraft. Therefore, the plurality of propellors 170 may be capable of delivering additional thrust for forward motion. Additionally, the one or more propellors 170 may be retractable to the bottom portion 119 of the aircraft 1000. When not in use, the propellers 170 may retract from an extended, operational position to a retracted position.

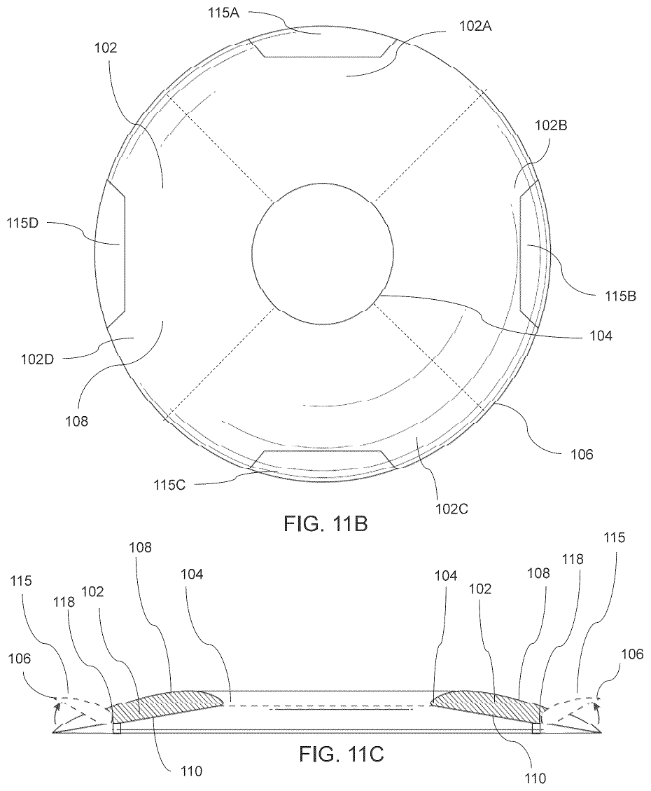

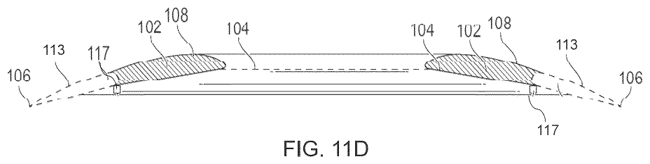

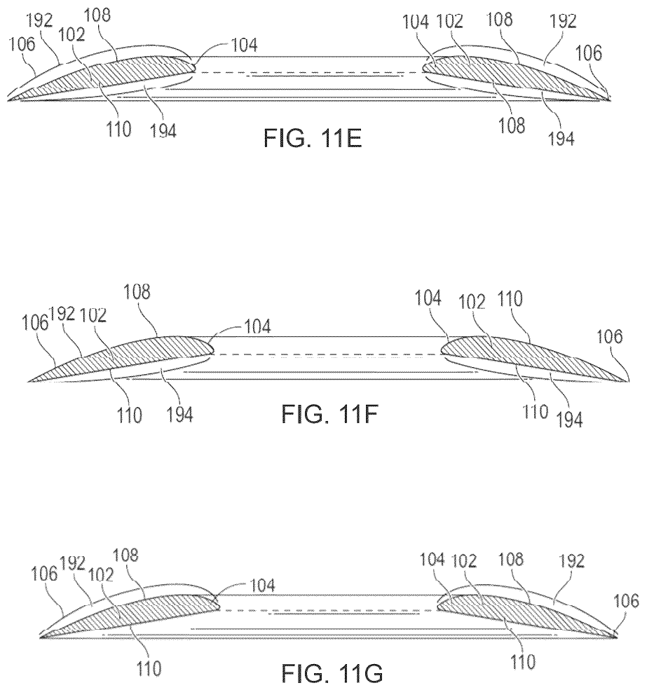

FIGS. 11A-11G show an additional embodiment of an aircraft 1100. The aircraft 1100 may have many or all of the same or similar features as aircraft 100, and the same reference numbers are used to refer to the same features. The wing 102 may be covered with one or more sleeves or thin sheets which may be one or more top sleeves 192 and/or one or more bottom sleeves 194 (see, for example, FIGS. 11A, 11E-11G). The wing 102 may have both one or more top sleeves 192 and one or more bottom sleeves 194 (see FIG. 11E). The wing 102 may solely have one or more bottom sleeves 194 (see FIG. 11F). The wing 102 may solely have one or more top sleeves 192 (see. FIG. 11G). The one or more sleeves (e.g., top sleeves 192 and bottom sleeves 194) may extend radially, either partially or entirely, over the top surface 108 and/or the bottom surface 110 of the wing 102. Advantageously, the flow of air traveling from the outlet end 134 of the ducts 130 will travel between a space between the one or more top sleeves 192 and/or the one or more bottom sleeves 194 from the leading edge 104 to the trailing edge 106.

The top sleeves 192 and the bottom sleeves 194 may enhance the ground effect (e.g., the positive influence of lift that occurs on an aircraft wing when it is close to the ground due to a reduction in the aerodynamic drag). The top sleeves 192 and the bottom sleeve 194 may be configured to further reduce the speed of air at the bottom surface 110 of the wing 102 to improve the lift characteristics by increasing the amount of pressure exerted on the bottom surface 110. In some embodiments, the wing fabric may be a cloth-like fabric. Advantageously, the top sleeves 192 and bottom sleeves 194 on the wing 102 may assist in reducing weather related turbulence by streamlining airflow on the top surface 108 and/or bottom surface 110 (e.g. by isolating external unstable atmosphere).

The plurality of blades 122 may be coupled to the hub and to the motor 230, which may be configured to rotate or change the angle of the plurality of blades 122 due to a swivel 123. The plurality of blades 122 may have a fixed span (e.g., length). In some cases, the plurality of blades 122 may have a length and/or blade pitch that varies to deliver an optimized flow of air to the ducts 130. In some embodiments, the swivel 123 may vary the blade pitch.

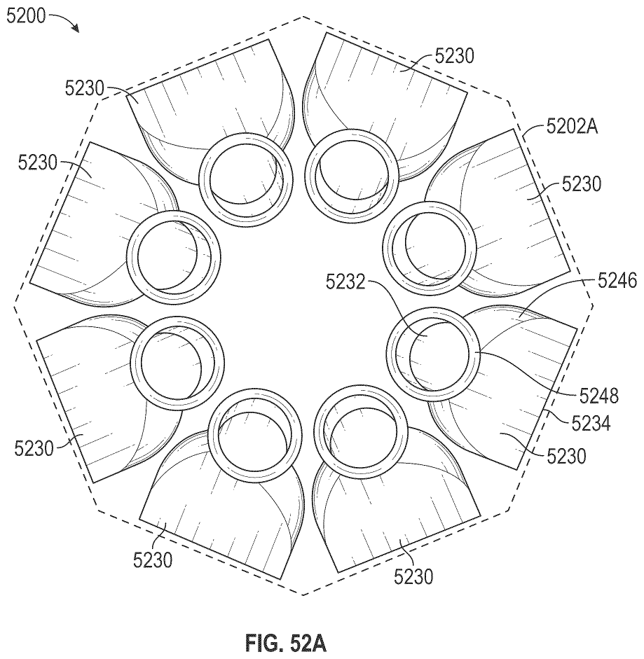

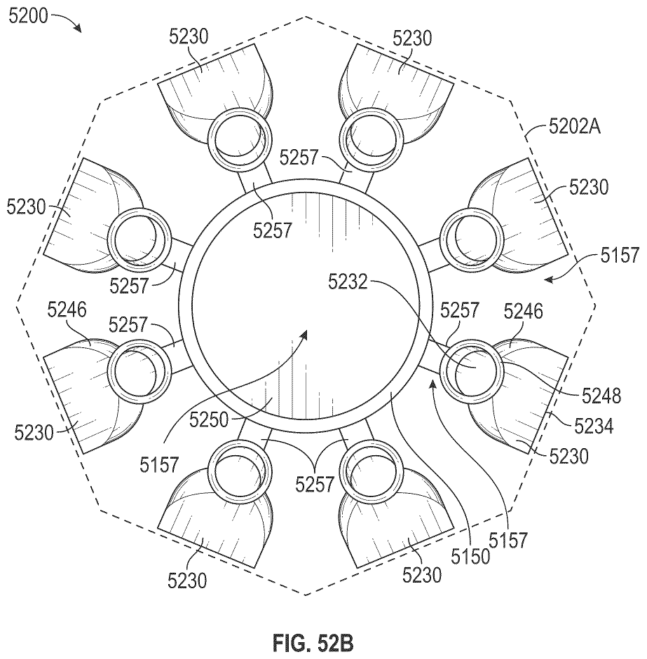

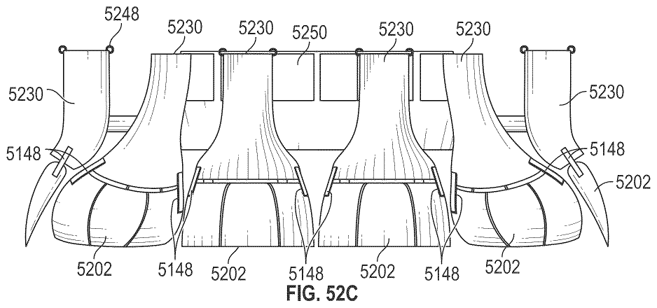

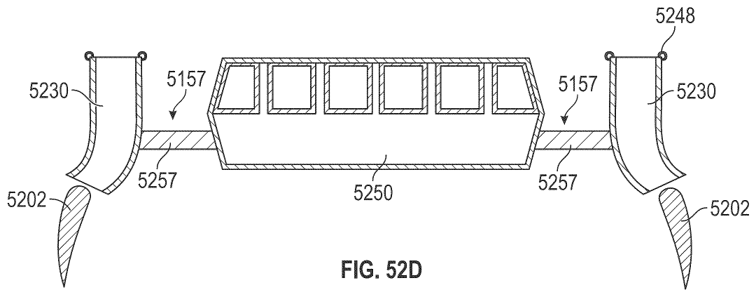

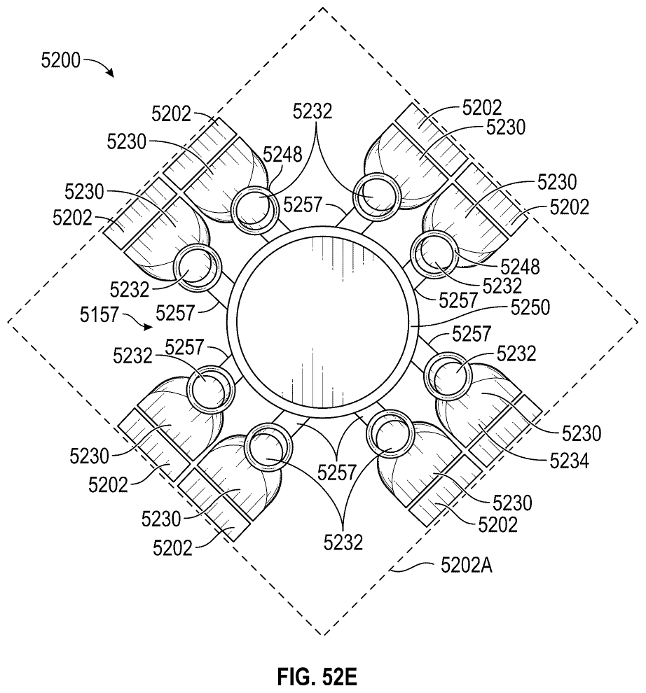

With reference to FIG. 11A, the main portion 150 may have one or more structural support members 180, such as a structural beam or beams or a structural framework, which may be used to support and couple the wing 102 to the aircraft 1100. The one or more structural support members 180 may be static or dynamic. The structural support members 180 may be deployable from a stowed configuration where the aerolift systems attached thereto are located closer to the main portion 150, to a deployed configuration where the aerolift systems are located radially farther away from the main portion 150, as described in further detail herein, for example with respect to FIGS. 52A-52D. The structural support members 180 may extend though the vertical centerline or true centerline or center point of the aircraft 100 (e.g., the centerline of the wing 102 or the main portion 150). Additionally, the aircraft 1100 may include additional structural support members 180 and/or a bottom portion 119 which may extend from one edge of the wing 102 on the bottom surface 110 to an opposite edge of the wing 102 on the bottom surface 110. Additionally, the structural support members 180 may have supporting members 182 which can extend to a middle area of the bottom surface 110 of the wing 102. Advantageously, the structural support members 180 can act as a foundation for the bottom surface 110 which may help to transfer lift force generated at the wing 102 to the aircraft 1100. An additional advantage of the bottom portion 119 may be that the bottom portion 119 makes the profile of the aircraft 1100 more aerodynamic during flight (e.g., forward motion). In some embodiments, the structural beams can be hydraulic. An advantage of hydraulic structural beams may be that the wing 102 can flex or move a desired amount due to the changing angle of attack at the leading edge and to effectively transfer lift force to the aircraft 100. Additionally, although not shown, the sleeves 192 and 194 may be made of or covered with fixed or retractable solar panels. One advantage of having solar panel on the one or more top sleeves 192 and/or the one or more bottom sleeves 194 may be their ability to generate power during storage or in flight. The solar panels may be used to recharge the aircraft (e.g., motor, components, batteries, etc.).

In some embodiments, the wing 102 may have a variable span (e.g., variable outer diameter). Depending on the conditions or desired operational characteristics, the wing 102 may expand in diameter or retract in diameter. Advantageously, this may help deliver a desired amount of lift, stability, or maneuverability to the aircraft 1100. In some embodiments, the wing 102 may include moveable (e.g., extendable or retractable) flaps 113 on the trailing edge that can increase or decrease the span (see FIG. 11D). The flaps 113 may also rotate from side to side (e.g., from a left position to a right position). The flaps 113 may deflect downward a desired amount (e.g., fifteen degrees) which may improve lift. The flaps 113 may also be coupled to an actuator 117 which controls the movement of the flaps. The flaps 113 may also deflect downwards to increase drag. For example, when the aircraft 1100 may be traveling at a high rate of speed, the flaps 113 may deflect downwards to increase drag to rapidly reduce the speed of the aircraft. Additionally, the changing profile of the flaps 113 can help produce more lift at takeoff and can allow for improved maneuverability during landing. The flaps 113 can be any type of flap (e.g., plain flap, split flap, slotted flap, etc.) that may provide stability and help to maneuver the aircraft 1100 to optimize the wing profile.

In some embodiments, the wing 102 may have ailerons 115 mounted on the top surface 108 near the trailing edge 106 (see FIG. 11C). The ailerons 115 may deflect upwards or downwards to change the shape, profile, or camber of the wing 102. The ailerons 115 may also be coupled to an actuator 118 which controls the deflection of the ailerons 115. Advantageously, by changing the profile of the section of the wing 102 (e.g., increasing the wing area, increasing the camber or curvature of the wing 102) by actuating the ailerons 115 in an upward direction, the aircraft 1100 may receive more sectional lift at desired speeds, which may assist in turning or specific directional movements. In some embodiments, the ailerons 115 may be differential ailerons (e.g., one aileron 115 goes up more than another aileron goes down 115). For example, when the aircraft 1100 makes a left roll, the leftmost ailerons 115 may deflect upwards, and the rightmost ailerons 115 may deflect downwards more than the leftmost aileron 115. For a right roll, the rightmost ailerons 115 may deflect upwards and the leftmost ailerons 115 may deflect downwards more than the rightmost aileron 115. In some embodiments, the ailerons 115 are connected to a controller 212 which can send a signal to the ailerons 115 to adjust their orientation. The ailerons 115 can be coupled (e.g., hinge) to the outermost edge of the wing 102 and can form the original shape of the airfoil profile when not actuated. The ailerons 115 can be located on each of the individual wing sections (e.g., 102A, 102B, 102C, 102D) and can be multiple ailerons (e.g., aileron 115A, aileron 115B, aileron 115C, aileron 115D).

### Alternative Wing Shapes

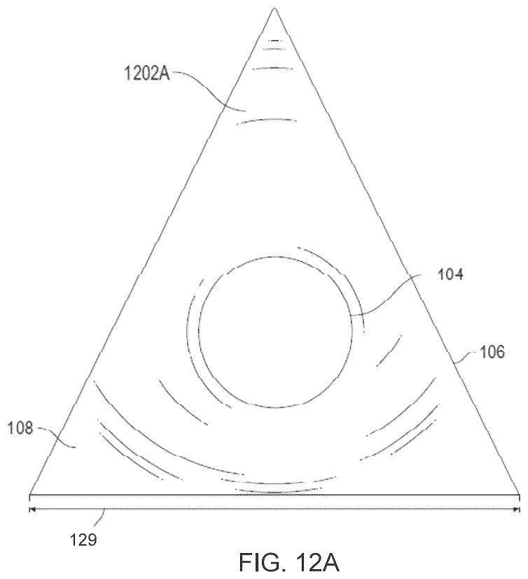

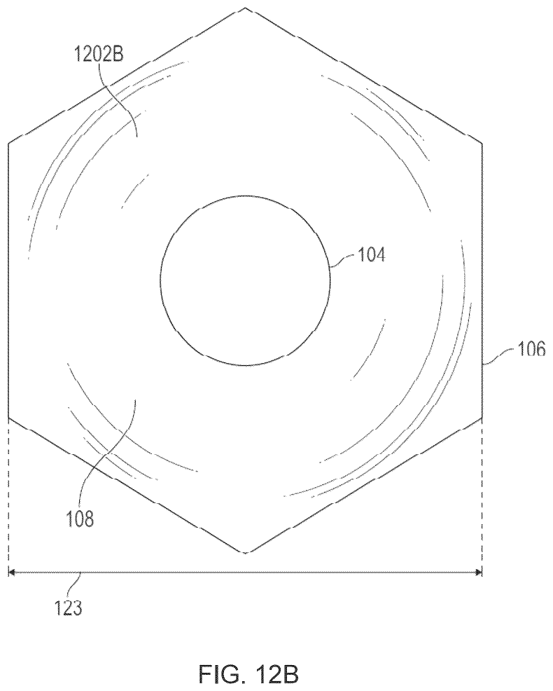

Various embodiments of aircraft disclosed herein may position one or more wings or wing segments about or around a central compartment in configurations that generally form an annular shape, a doughnut shape, a toroid shape, a triangular shape, a square shape, a rectangular shape, a hexagonal shape, a polygonal shape, a round shape, and/or the like. FIGS. 12A and 12B illustrate two specific example embodiments of such wings. Specifically, FIGS. 12A and 12B are top views of wings 1202a and 1202b, respectively. Wings 1202a and 1202b may be similar to the wing 102 described above, and the same reference numbers are used to refer to the same components. In some embodiments, as shown in FIG. 12A, the wing 1202a may be triangularly shaped. In some embodiments, as shown in FIG. 12B, the wing 1202b can comprise a polygonal or hexagonal shape. An advantage of multiple different wing shapes may allow the aircraft 1100 to achieve desired flight characteristics. The wing 102 can have a span 129 that extends along the trailing edge 106 or outer edge of the wing 102.

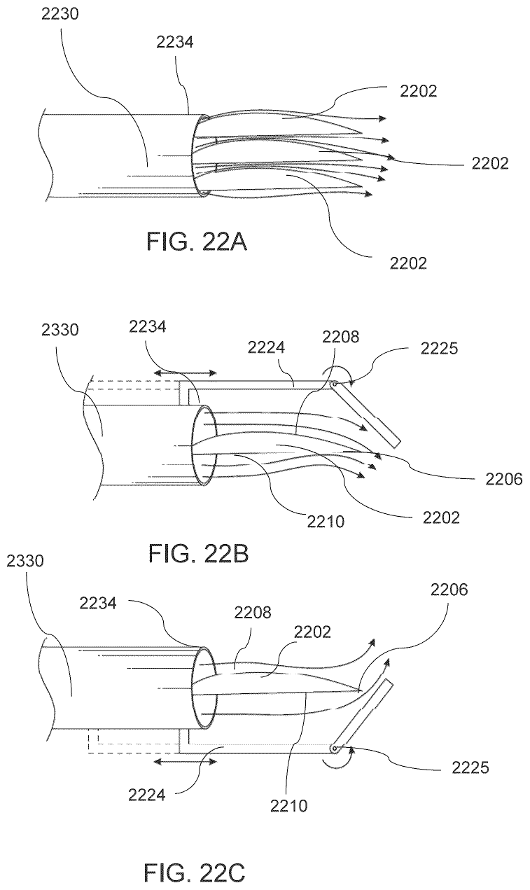

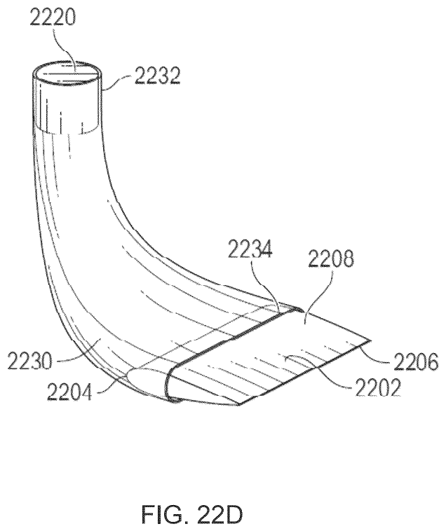

The wing 102 may be a plurality of wings 102 stacked on top of each other (see, for example, FIG. 22A). Therefore, the plurality of wings 102 may be mounted to the ducts 130 and may receive a flow of air at the leading edge 104. The plurality of wings 102 may each have a different span (outer diameter) to improve the lift and maneuverability characteristics of the aircraft 1100.

Additionally, although not shown, the wing 102 may have one or more solar panels attached (e.g., fixed) to a portion (e.g., top surface 108 and/or bottom surface 110) of the wing 102 for solar energy generation. In some embodiments, the wing 102 may be made of one or more solar panels. The solar panels may be retractable (e.g., return into a space within the wing 102) when not required for energy generation. One advantage of the one or more solar panels is that they may store and generate energy during flight and/or when in storage. The energy from the one or more solar panels can be used to power the aircraft components, motor, and/or controls.

Example Aircraft with Central Rotor and Non-Distributed Airflow Duct

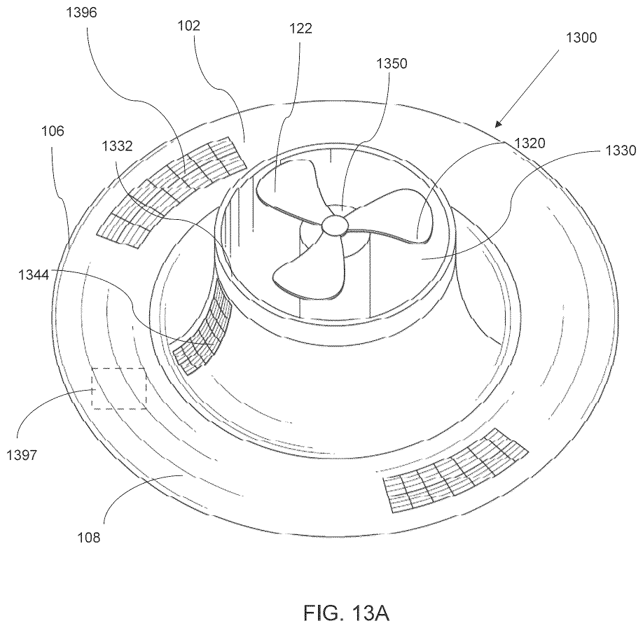

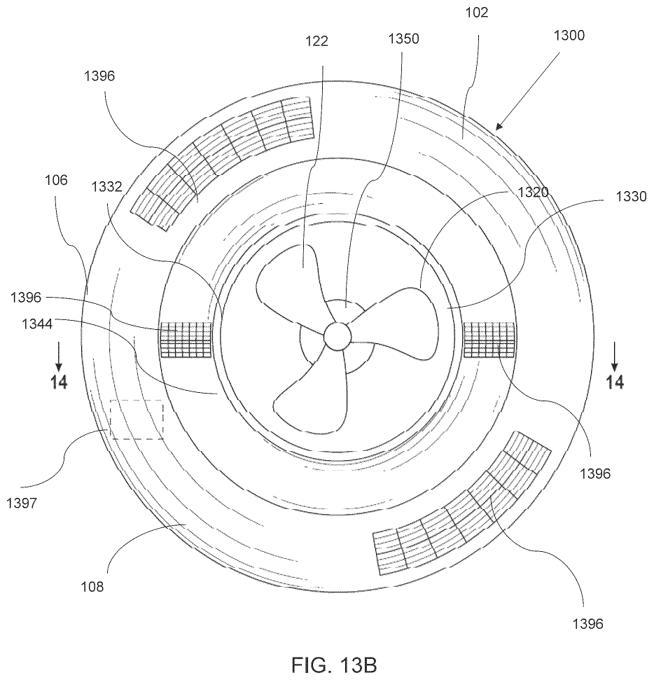

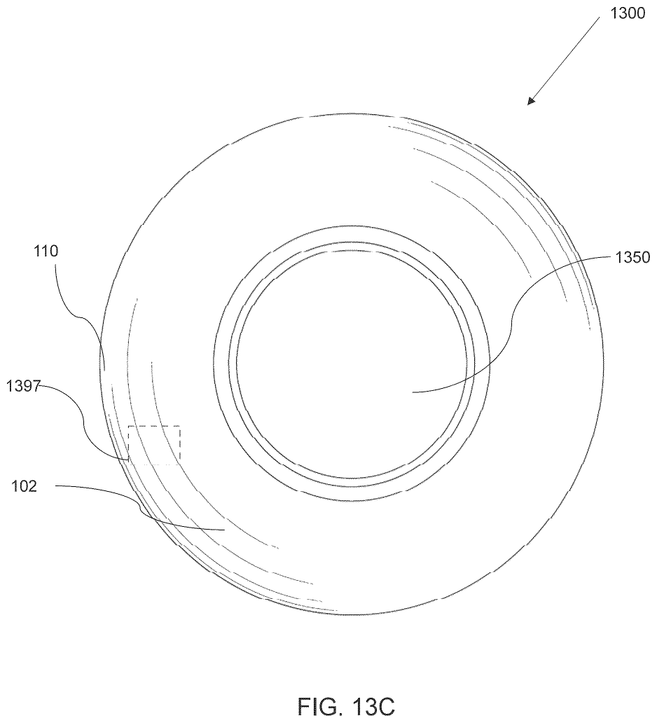

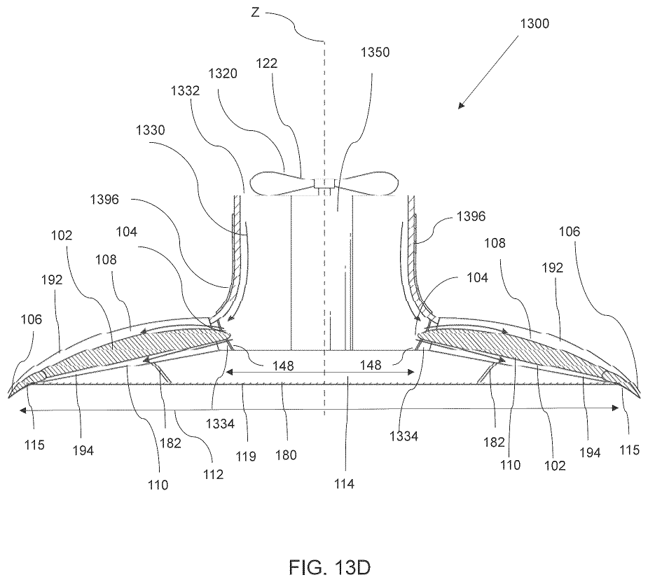

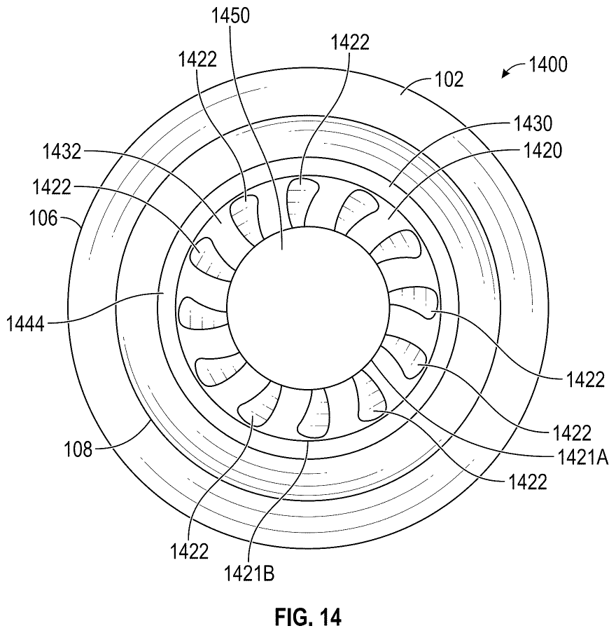

FIGS. 13A-13D illustrate another embodiment of an aircraft 1300. The aircraft 1300 may have many or all of the same or similar features as aircraft 100, or any other aircraft disclosed herein, and the same reference numbers are used to refer to the same features. The aircraft 1300 includes one propulsion unit 1320 mounted along the longitudinal centerline Z of the aircraft 1300 and one duct 1330 configured to receive air from the one propulsion unit 1320. Additionally, the one propulsion unit 1320 may be located central to and/or above the main portion 1350. The one propulsion unit 1320 may be configured to draw a flow of air (such as from above the aircraft) and deliver the flow of air to the inlet end 1332 of the one duct 1330. Additionally, the one propulsion unit 1320 may be mounted in a vertical and/or downward facing direction to deliver the flow of air to the one duct 1330. The flow of air (e.g., flow of environmental air) may be delivered to the leading edge 104 of the wing 102 from the outlet end 1334 of the duct 1330. The flow of air may first be delivered to the leading edge of 104 of the wing 102 and travel over the top surface 108 and the bottom surface bottom surface 110, in order to generate lift, similar to as described in more detail above with reference to aircraft 100. In this embodiment, the outlet end 1334 of the duct 1330 may be generally annularly shaped, in order to provide a flow of air to the generally annularly shaped leading edge 104 of wing 102 (e.g., the outlet end 1334 allows air to flow radially outwards in all directions or in 360-degrees). The flow of air can travel from the inlet end 1332 to the outlet end 1334 along a conical path (e.g., a conical or frustoconical flow path), or a curved conical path like a trumpet or flared shape. Other embodiments may shape the duct outlet and/or wing differently.

With continued reference to FIGS. 13A-13D, in some embodiments, one or more solar panels 1396 may be placed on the wing 102. The one or more solar panels 1396 may be placed along the top surface 108 of the wing 102 and spaced circumferentially along the wing 102. The one or more solar panels 1396 may also or alternatively be placed along the outside of the duct 1330 or along the outside of the larger channel (e.g., walled structure) 1344, or may be placed anywhere else on the aircraft that may be exposed to sunlight. In some embodiments, the solar panels may be fixed, and in some embodiments, the solar panels may be retractable. Further, some embodiments may include deployable solar panels, which can be stored when not needed, and can be deployed when needed (such as, for example, by deploying in a fashion that wraps the solar panels around a portion of the aircraft, and/or by deploying in a fashion that pops open an array of solar panels that are supported away from the main body of the aircraft). An advantage of one or more solar panels 1396 may be that it provides additional power to a battery. Additionally, the one or more solar panels 1396 may be an additional power source 223 to power the aircraft 1300. Another advantage of including one or more solar panels is that the aircraft may be able to reach more remote areas (such as for search and rescue or air ambulance missions) where there is no power source and not get stuck. As an example, the aircraft could be flown into the middle of the Arizona desert, be left in the sun for a few hours or days, and then fly back to a nearby power source. The addition of solar panels is not limited to the embodiment of FIGS. 13A-13D, and solar panels may also be included with any other aircraft embodiments disclosed herein.

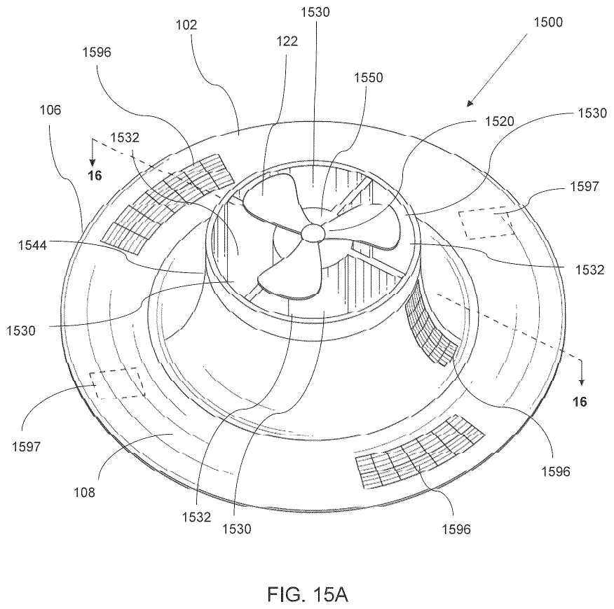

The aircraft 1300 may also have one or more proximity sensors 1397 positioned on the top surface 108, and/or the bottom surface 110 of the aircraft 1300, and/or elsewhere. The proximity sensor 1397 may be configured to determine the location of the aircraft 1300 in space and/or the proximity of the aircraft 1300 to an obstacle. For example, the proximity sensor 1397 may be configured to determine the distance the proximity sensor 1397 is located from a ground surface. Furthermore, the proximity sensor 1397 may be configured to determine the distance the aircraft 1300 is from other objects (e.g., objects, other aircrafts, buildings, etc.). The proximity sensor(s) may utilize any suitable technology, such as radar, ultrasonic, infrared, machine vision, laser, and/or the like. The addition of proximity sensors is not limited to the embodiment of FIGS. 13A-13C and 14, and proximity sensors may also be included with any other aircraft embodiments disclosed herein.

FIG. 14 illustrates another embodiment of an aircraft 1400 having a propulsion unit 1420 with radially outer blades 1422. The aircraft 1400 may have any or all of the same or similar features as aircraft 100, or any other aircraft disclosed herein, and vice versa. The aircraft 1400 includes the propulsion unit 1420 that feeds airflow to one or more ducts 1430. The propulsion unit 1420 may be an annular propulsion unit which can deliver a flow of air to the propulsion unit 1420 while reducing stress on the plurality of blades 1422. Multiple blades 1422 may extend from a central ring 1421A, which may reduce the length of the blades. The plurality of blades 1422 can be positioned around the radially inner ring 1421A of the propulsion unit 1420. The blades 1422 may extend radially outward from the radially inner ring 1421A. The radially inner ring 1421A of the propulsion unit 1420 can rotate the plurality of blades 1422 in order to generate a flow of air to deliver to the inlet end 1432 of the duct 1430. The duct 1430 can be one duct configured to receive air from the propulsion unit 1420, such as a conical or flared trumpet shape duct, or a single tubular duct. Additionally, the propulsion unit 1420 may deliver a flow of air to multiple, discrete ducts, such as the separate, tubular ducts described herein.

The propulsion unit 1420 may be coupled to or include an electric motor configured to rotate the radially inner ring 1421A to rotate the blades 1422. The propulsion unit 1420 may also be able to rotate the plurality of blades 1422 about the radially inner ring 1421A via electromagnets. The plurality of blades 1422 can extend from the radially inner ring 1421A to a radially outer ring 1421B. The radially inner ring 1421A may be radially spaced from the radially outer ring 1421B based on a desired length of the plurality of blades 1422. The plurality of blades 1422 may include one, two, three, four, five, six, seven, eight, nine, ten, from two to ten, from two to twenty, or at least two, at least four, or at least six blades 1422. The plurality of blades 1422 may have a set of blades that rotate in a first direction and a second set of blades that rotate in an opposite direction to provide counter torque to reduce stress on the propulsion unit 1420 (e.g., on the plurality of blades 1422 and the radially inner ring 1421A). There may be a gap between the radially outer ends of the plurality of blades 1422 and a radially inner surface of the radially outer ring 1421B. The radially outer ring 1421A may correspond to an outer wall of the inlet end 1432 of the duct 1430. The flow of air delivered by the propulsion unit 1420 can travel from the inlet end 1432 to the outlet end 1434 of the duct 1430 and to a wing 102. The propulsion unit 1420 may define a central opening 1450 therethrough. The central opening 1450 may be empty and define a channel extending through the propulsion unit 1420. The central opening 1450 may form part of a channel that extends through the entire aircraft vertically from top to bottom. In some embodiments, the central opening 1450 may be a hollow, central void of the radially inner ring 1421A. In some embodiments, the central opening 1450 may include or lead to one or more inlets of a duct or ducts into which air is flowing. In some embodiments, the central opening 1450 may contain a compartment, for example for cargo or passengers.

Example Aircraft with Central Rotor and Distributed Airflow Ducts

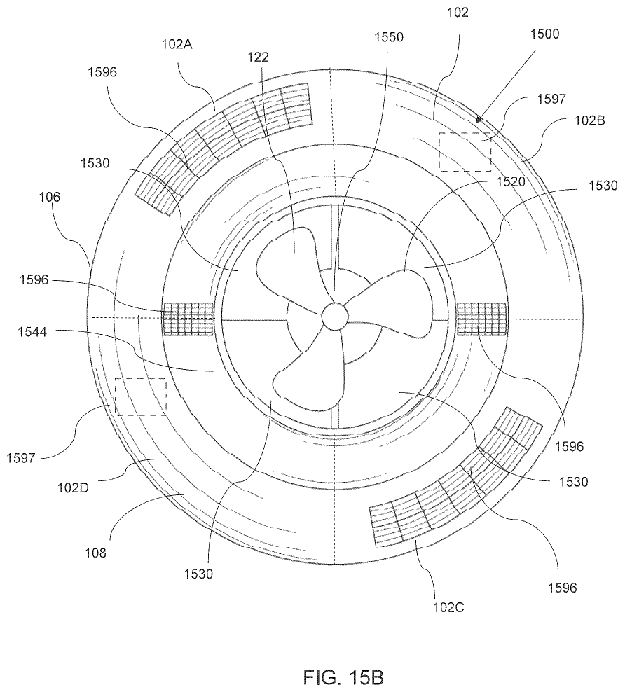

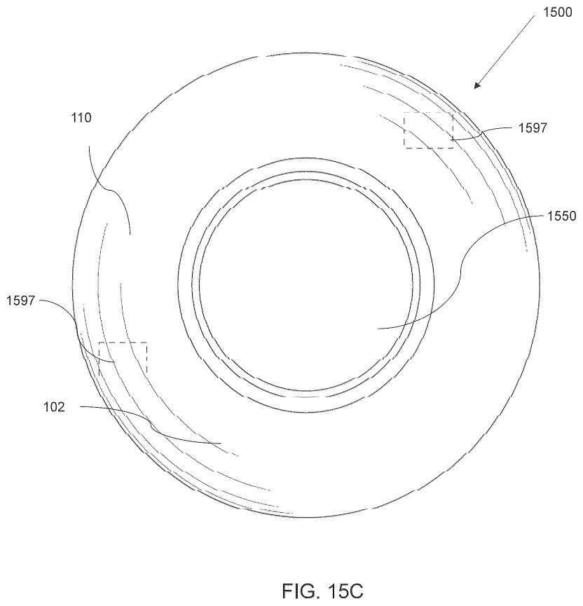

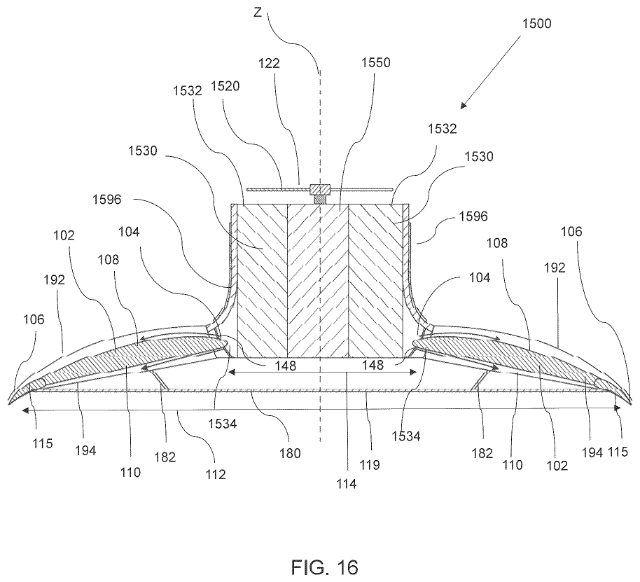

FIGS. 15A-15C and 16 illustrate another embodiment of an aircraft 1500. The aircraft 1500 may have many or all of the same or similar features as aircraft 1300, or any other aircraft disclosed herein, and the same reference numbers are used to refer to the same features. The aircraft 1500 includes a single propulsion unit 1520 that feeds airflow to a plurality of ducts 1530, instead of a single propulsion unit that feeds airflow to a single duct. The single propulsion unit 1520 may be positioned centrally on the aircraft 1500. Additionally, the one propulsion unit 1520 may be positioned central to and/or above the main portion 1550. The plurality of ducts 1530 may be tubular ducts which may extend from the inlet ends 1532 to the outlet end 1534. The plurality of ducts 1530 may each have inlet ends 1532 with a closed profile and a outlet end 1534 with a closed profile (e.g., closed rectangular profile). The single propulsion unit 1520 may be configured to draw a flow of air and deliver said flow of air to the inlet ends 1532 of the plurality of ducts 1530. Additionally, the single propulsion unit 1520 may be mounted in a vertical and/or downward facing direction to deliver the flow of air to the plurality of ducts 1530. The flow of air (e.g., flow of environmental air) may delivered to the leading edge 104 of the wing 102 from the outlet end 1534 of the plurality of duct 1530. The flow of air may first be delivered to the leading edge of 104 and travel over the top surface 108 and the bottom surface bottom surface 110.

In some embodiments, the plurality of ducts 1530 may be configured to deliver a flow of air to a particular region of the wing 102. For example, when the single propulsion unit 1520 delivers the flow of air to the plurality of ducts 1530 (e.g., four ducts in this embodiment, but could be a different number in other embodiments) the flow of air can reach a particular section (e.g., one or more of sections 102A, 102B, 102C, 102D) of the wing 102. Additionally, the wing 102 may have ailerons 115 mounted on the top surface 108 near the trailing edge 106. The ailerons 115 may deflect upwards or downwards to change the shape, profile, or camber of the wing 102. The ailerons 115 may also be coupled to an actuator 118 which controls the deflection of the ailerons 115. By changing the profile of the section of the wing 102 (e.g., increasing the wing area, increasing the camber or curvature of the wing 102) by actuating the ailerons 115 in an upward direction, the aircraft 1500 may receive more sectional lift at desired speeds, which may assist in turning or specific directional movements. Advantageously, this may allow for increased control and maneuverability of the aircraft 1500 when it has a single propulsion unit 1520.

Similar to as discussed above with reference to aircraft 1300, in some embodiments, one or more solar panels 1596 may be placed on the wing 102. The one or more solar panels 1596 may be placed along the top surface 108 of the wing 102 and spaced circumferentially along the wing 102. The one or more solar panels 1596 may also be placed along the outside of the duct 1530 or along the outside of the larger channel (e.g., walled structure) 144. An advantage of the one or more solar panels 1596 may be that the one or more solar panels 1596 provide additional power to a battery. Additionally, the one or more solar panels 1596 may be an additional power source 223 to power the aircraft 1500.

Similar to above, with reference to aircraft 1300, the aircraft 1500 may also have one or more proximity sensors 1597 positioned on the top surface 108 and the bottom surface 110 of the aircraft 1500. The one or more proximity sensors 1597 may be configured to determine the location of the aircraft 1500 in space. For example, the one or more proximity sensors 1597 may be configured to determine the distance the proximity sensor 1597 is located from a ground surface. Furthermore, the one or more proximity sensors 1597 may be configured to determine the distance the aircraft 1300 is from other objects (e.g., objects, other aircrafts, buildings, etc.).

Example Aircraft with Parachute

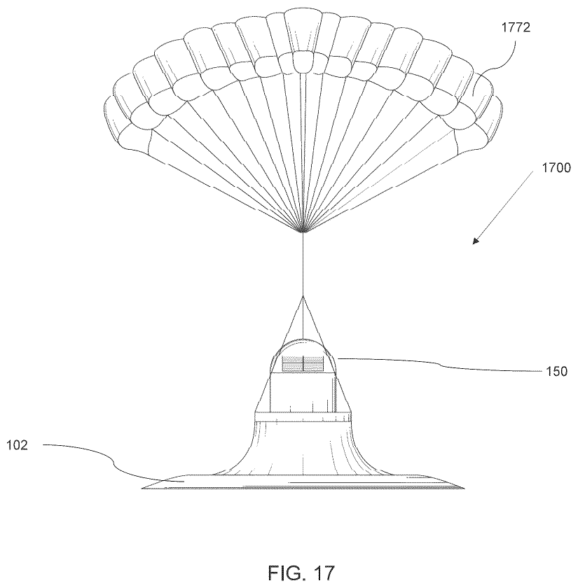

FIG. 17 illustrates another embodiment of an aircraft 1700. The aircraft 1700 may have many or all of the same or similar features as aircraft 100, or any other aircraft disclosed herein, and the same reference numbers are used to refer to the same features. A parachute may be released from aircraft 1700 to assist with landing (and/or to enable a safe landing in an emergency, such as when power is lost). In some cases, the parachute 1772 may be positioned on or within the main portion 150 before being deployed. When deployed, the parachute 1772 may release and expand from the top of the main portion 150. Advantageously, the parachute 1772 may release when the aircraft 1700 is making a rapid decent or when one or more of the propulsion units 120 fail and the aircraft rapidly loses elevation. Some embodiments may include a plurality of parachutes instead of a single parachute. In some embodiments, the parachute 1772 may be attached to another portion of the aircraft using one or more tethers, cables, ropes, and/or the like. The parachute 1772 may deploy when the aircraft is descending (e.g., descending rapidly) at an altitude of at least 200 feet, of at least 400 feet, of at least 600 feet, of at least 800 feet, or of at least 1,000 feet.

Example Aircraft with Inflatable Landing Gear

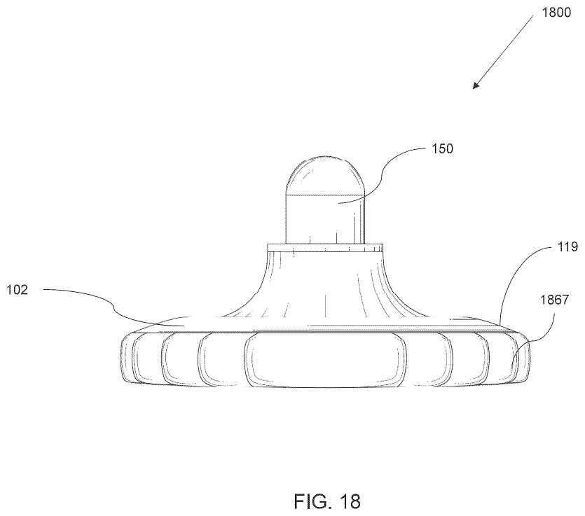

FIG. 18 illustrates another embodiment of an aircraft 1800. The aircraft 1800 may have many or all of the same or similar features as aircraft 100, or any other aircraft disclosed herein, and the same reference numbers are used to refer to the same features. An inflatable landing gear 1867 may be located at or near a bottom surface of the aircraft 1800. The inflatable landing gear 1867 may expand and inflate from within a bottom area of the aircraft 1800. Additionally, the inflatable landing gear 1867 may be coupled to a pump or another inflation device which may provide a flow of air required to fill the inflatable landing gear 1867. Advantageously, by placing the inflatable landing gear 1867 on the bottom portion bottom portion 119 of the aircraft 1800, the aircraft 1800 may be able to safely land in water when the inflatable landing gear 1867 deploys.

Example Aircraft with Elongated Body and Longitudinal Wings

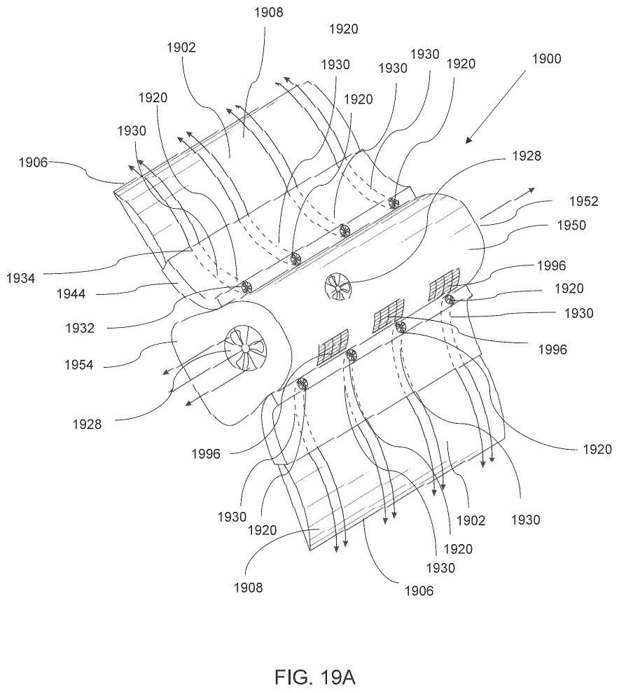

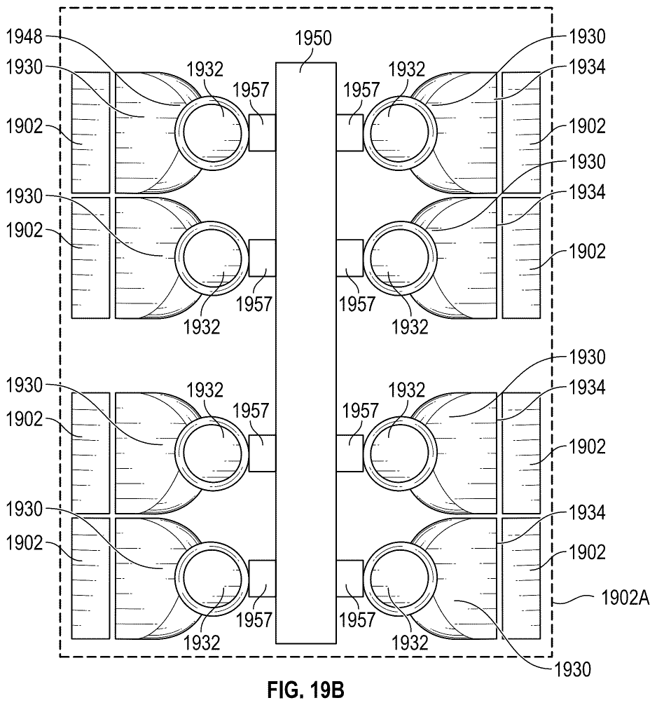

FIGS. 19A-19B illustrate another embodiment of an aircraft 1900. The aircraft 1900 may have many or all of the same or similar features as aircraft 100, or any other aircraft disclosed herein, and the same reference numbers are used to refer to the same features. The aircraft 1900 comprises two lifting bodies depicted as wings 1902 extending longitudinally along the sides of the aircraft 1900, instead of a wing extending circumferentially around the aircraft. The aircraft 1900 may have a plurality of propulsion units 1920, a plurality of ducts 1930, and a main portion 1950 which may be empty, or which may contain a payload compartment, passenger area, cockpit, and/or the like.

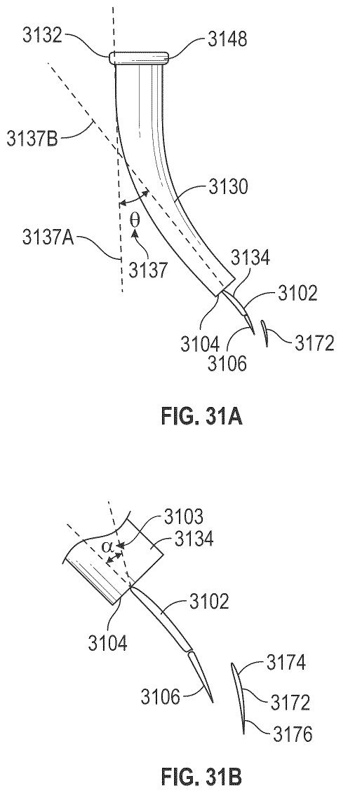

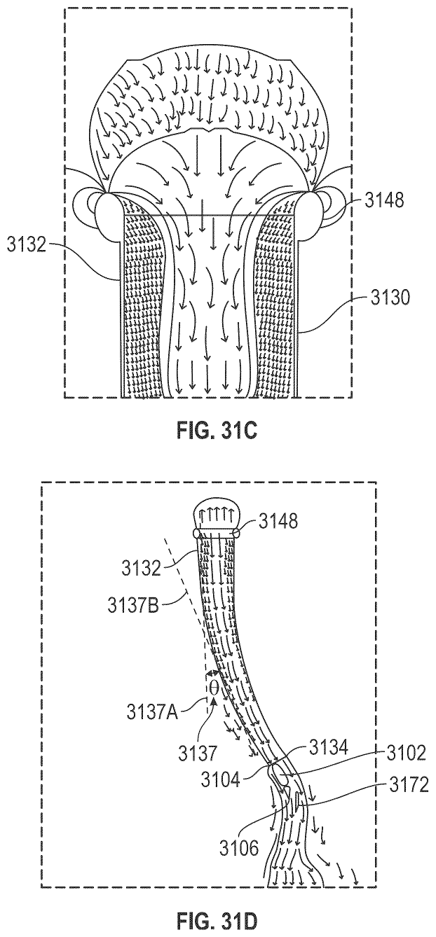

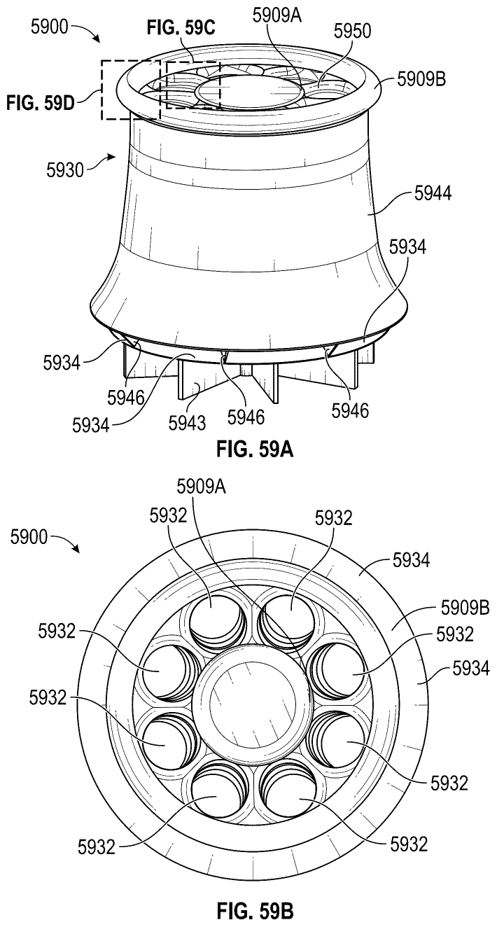

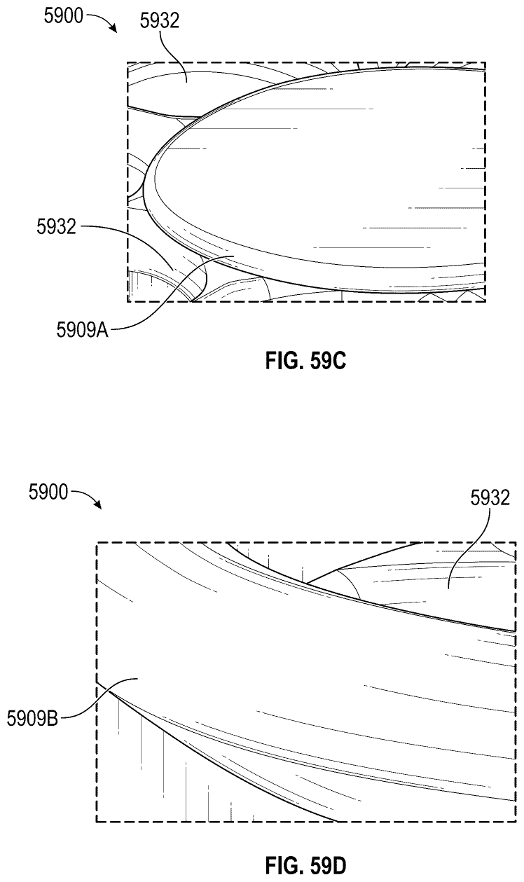

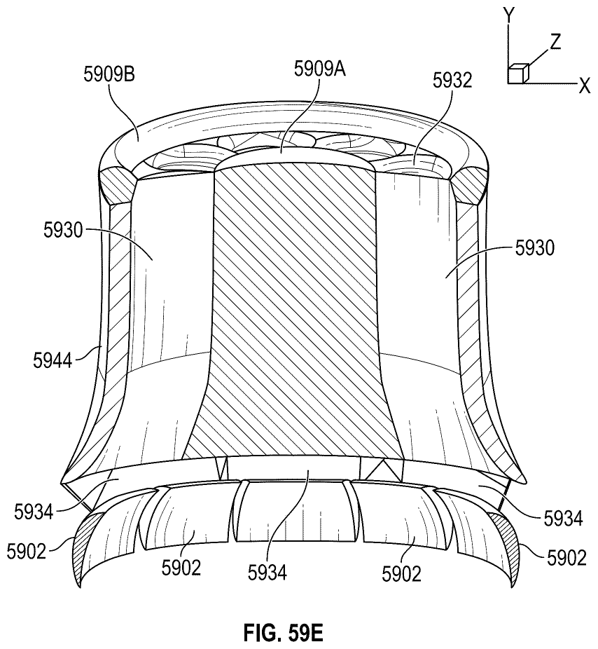

FIG. 19B shows a top view of an embodiment of the aircraft 1900 with the plurality of ducts 1930 (e.g., eight ducts) positioned around the main portion 1950 to form a four-sided profile 1902A embodied as a rectangular profile. The plurality of ducts 1930 may be connected to the main portion 1950 and supported outwardly away from the main portion 1950 by one or more supports 1957. Further, the plurality of ducts 1930 (as viewed from a top side as shown in FIG. 19B) may have sets of two ducts 1930 positioned adjacent to each other (e.g., next to each other and not angled relative to one another). For example, as shown in FIG. 19B, a set of two adjacent ducts 1930 may be parallel to each other and rotated approximately 180 degrees relative to another set of two parallel, laterally opposite ducts 1930, or at other angles. Another set of the two of the ducts 1930 may also be laterally spaced away from another set of two parallel ducts 1930 (e.g., the first set of ducts 1930 is parallel to the second set of ducts 1930). The angles may be defined with reference to the outlet axes, which may be geometric central axes at the duct outlets. The pairs of ducts 1930 with corresponding wings 1902 (e.g. lifting bodies) may form the rectangular profile 1902A. There may be one, two, three, four or more than four ducts 1930 (and one, two, three, four or more than four corresponding wings 1902) on each side of the four-sided profile 1902A. The inlet end 1932 may have an inlet lip 1948. The inlet lip 1948 may be a curved lip (as described in further detail herein, for example with reference to FIGS. 31C and 59A-59D).

In some embodiments, the main portion 1950 may be tubular or cylindrical or shaped otherwise, and may extend along the longitudinal axis of the aircraft 1900. The main portion 1950 may have a front portion 1952 and rear portion. The front portion 1952 and the rear portion 1954 and/or a top portion of the aircraft may have one or more rotors 1928 (and/or one or more inlets or outlets of ducts coupled to a rotor). The one or more rotors 1928 may deliver a flow of air from the front portion 1952 to the rear portion 1954, such as through a duct that passes therebetween, to move the aircraft 1900 in a forward direction. Alternatively, the one or more rotors 1928 may deliver a flow of air from a top portion of the aircraft to the rear portion 1954, such as through a duct that passes therebetween, to move the aircraft 1900 in a forward direction. Additionally, the main portion 1950 may contain a passenger portion therein. The aircraft 1900 may also have one or more solar panels 1996 positioned on the main portion 1950 or elsewhere.

In some embodiments, the ducts 1930 are coupled to the main portion 1950. The ducts 1930 extend from a sidewall of the main portion 1950. The plurality of ducts 1930 may extend from an inlet end 1932 to an outlet end 1934. Additionally, in some embodiments, the length or shape of the plurality of ducts 1930 can be configured to provide a desired flow of air to the wings 1902 coupled to the outlet end 1934. The plurality of ducts 1930 can have a propulsion unit 1920 coupled to the inlet end 1932 of the plurality of ducts 1930. The propulsion units 1920 may deliver a flow of air through the plurality of ducts 1930 and to the leading edge of the wings 1902. The flow of air may travel over a top portion 1908 of the wings 1902 and to a trailing edge 1906. The plurality of ducts 1930 may be contained within one or more walled channels 1944. The walled channels 1944 may be positioned along the sidewalls of the main portion 1950. The one or more walled channels 1944 may be L-shaped or J-shaped, or shaped otherwise, and may extend the entire length of the tubular main body 1950, or may not extend the entire length.

In some embodiments, one or more solar panels 1996 may be placed on the body 1950. An advantage of one or more solar panels 1996 may be that it provides additional power to a battery. Additionally, the one or more solar panels 1996 may be an additional power source 223 to power the aircraft 1900.

Example Aircraft with Crescent Wings

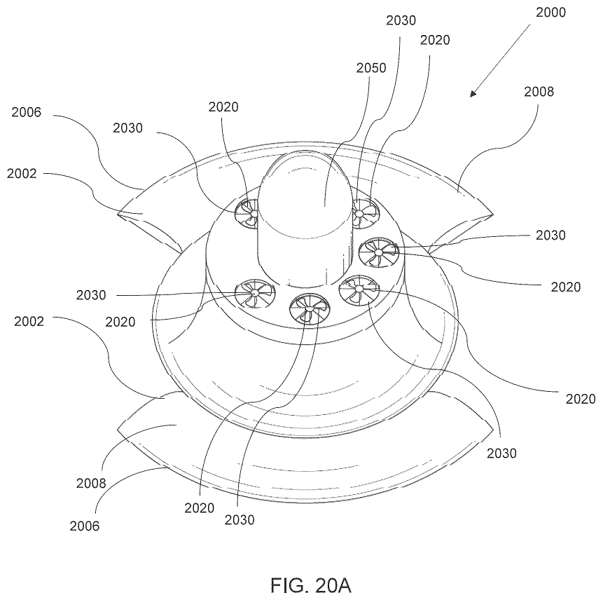

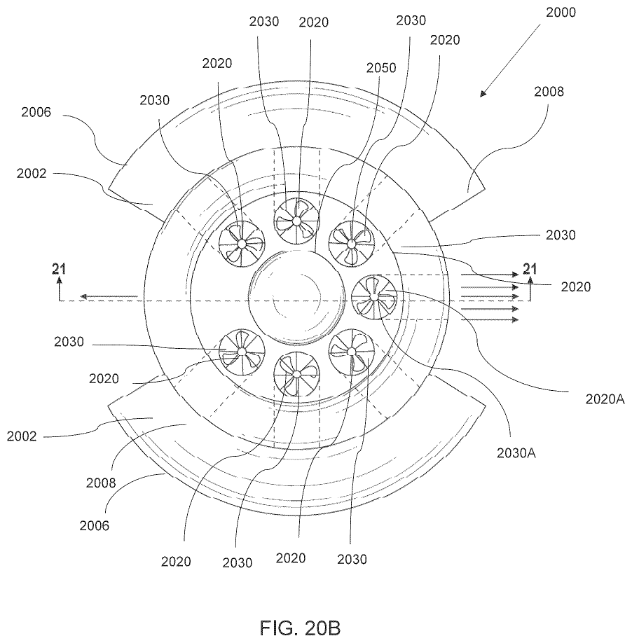

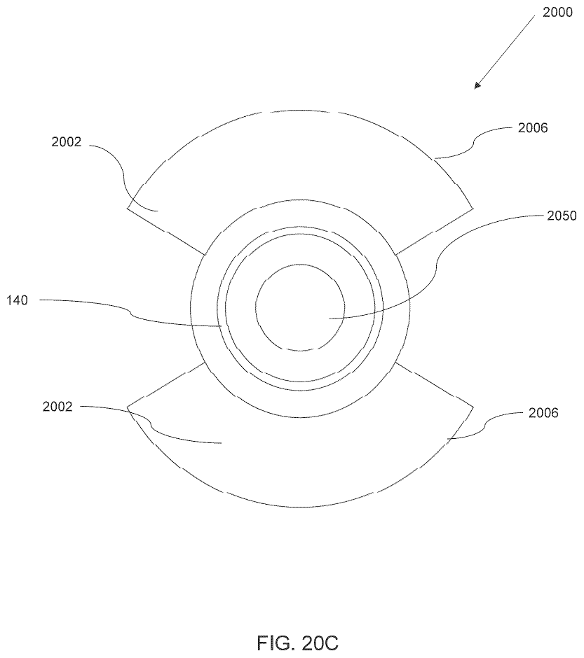

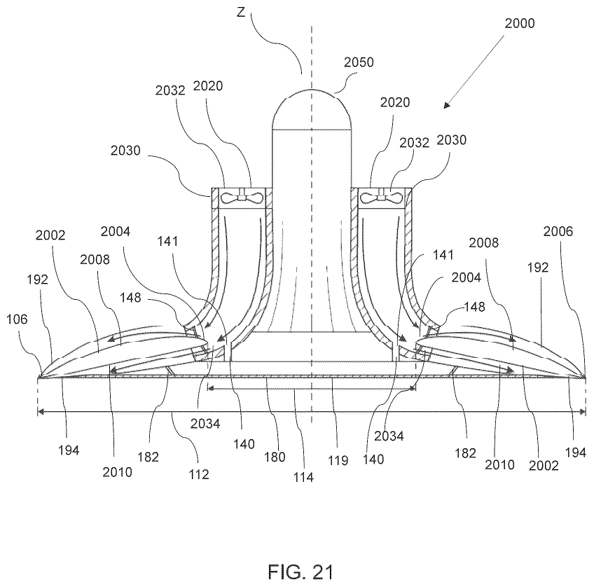

FIGS. 20A-20C and 21 illustrate another embodiment of an aircraft 2000. The aircraft 2000 may have many or all of the same or similar features as aircraft 100, or any other aircraft disclosed herein, and the same reference numbers are used to refer to the same features. The aircraft 2000 has two crescent shaped lifting bodies depicted as wings 2002. In other words, the aircraft 2000 may include some portions of the wing 102 of aircraft 100, with some portions of the wing 102 of aircraft 100 removed. The two crescent shaped wings 2002 can be positioned on opposite sides of the aircraft 2000. In this embodiment, each of the wings 2002 may span approximately 90 degrees of the circular outer profile of the aircraft 2000. In other embodiments, each of the one or more wings 2002 may span between 45 to 150 degrees of the circular outer profile of the aircraft 2000. The two crescent shaped wings 2002 may have a trailing edge 2006, a top portion 2008, and a bottom portion 2010. The two crescent shaped wings 2002 may also have a main portion 2050.

The aircraft 2000 may also have one or more ducts 2030 (e.g., four, five, six, seven, etc.). One of the propulsion units 2020 (e.g., 2020A) and ducts 2030 (e.g., 2030A) may be placed on a rear portion of the aircraft 2000 (and/or be configured such that airflow is directed rearward). The duct 2030A at the rear portion of the aircraft 2000 may be coupled to a propulsion unit 2020A which may deliver a flow of air through the duct 2030 from the inlet end 2032 to the outlet end 2034. The flow of air that exits the outlet end 2034 at the rear portion of the aircraft 2000 may thrust the aircraft 2000 forward. Advantageously, the other one or more ducts 2030 may receive a flow of air from other propulsion units 2020. The other propulsion units 2020 can deliver the flow of air from the inlet end 2032 to the outlet end 2034 and to the leading edge 2004 of the one or more wings 2002. The other propulsion units 2020 and other one or more ducts 2030 may be configured to change altitude, pitch, roll, and yaw to maneuver the aircraft 2000 in a desired direction, similarly as described above with reference to other embodiments. Additionally, each of the propulsion units 2020 may also be operated independently. By operating the rear propulsion unit 2020A independently, the aircraft 2000 can thrust forward while the other propulsion units 2020 may be used to stabilize flight to account for turbulence, wind, movement of payloads and/or passengers, and/or the like.

### Example Wing Configurations and Flow Diverters

FIGS. 22A-22D illustrate examples of different configurations of lifting bodies depicted as wings 2202 and ducts 2230. The wings 2202 and ducts 2230 may operate similar to the wings 102 and ducts 130 of aircraft 100, discussed above, and may be used with any aircraft described herein, including aircraft 100. In some embodiments, the ducts 2230 may be coupled to one or more wings 2202 (see FIG. 22A). The wings 2202 may be spaced apart vertically or stacked within or next to the duct 2230. Therefore, each of the stacked wings 2202 may receive a flow of air from the outlet end 2234 of the ducts 2230 at the leading edge 2204 of the wings 2202. Such a stacked configuration may, for example, increase the efficiency of the aircraft.

The wings 2202 may be coupled to (or be positioned next to) a flow diverter 2224 near a top portion 2208 of the wing 2202 (see FIG. 22B) and/or near a bottom portion 2210 of the wing (see FIG. 22C). The flow diverter 2224 may be configured to divert a flow of air at the trailing edge 2206 upwards or downwards. Advantageously, the flow diverter 2224 may be configured to prevent air from being directed radially outwards when landing, such as to prevent blowing the flow of air onto objects around the aircraft when landing. For example, when the flow diverter 2224 is positioned above the top portion 2208 of the wings 2202, the flow diverter 2224 may rotate downwards to direct a flow of air in a downward direction at the trailing edge 2206. In embodiments where the flow diverter 2224 is located at a bottom portion 2210 of the wings 2202, the flow diverter 2224 can rotate upwards to direct a flow of air in an upwards direction at the trailing edge 2206. Additionally, the flow diverter 2224 may be connected to a pivot actuator 2225 which may control the flow diverter 2224 and rotate a segment of the flow diverter 2224 upwards or downwards.

The flow diverter 2224 may be designed to prevent the flow of air delivered to the trailing edge 2206 along the top portion 2208 and/or bottom portion 2210 from being obstructed. For example, when the aircraft (e.g., aircraft 100) is traveling in a forward direction, the flow diverter 2224 can block an incoming flow of environmental air at the trailing edge 2206 of the wings 2202. Advantageously, having the flow diverter 2224 block an incoming flow of air at the trailing edge 2206 may improve maneuverability and stability when the aircraft (e.g., aircraft 100) is moving in a desired direction (e.g., forward direction).

The flow diverter 2224 may also translate in a forward and backward (or outward and inward) direction along the ducts 2230. The flow diverter 2224 may be coupled to an exterior portion of the ducts 2230 near the outlet end 2234. Advantageously, the flow diverter 2224 may translate forward and backwards to divert the flow of air closer or further from the trailing edge 2206 of wings 2202. In some embodiments, the flow diverter 2224 may translate along the ducts 2230 along a track coupled to the ducts 2230.

With reference to FIG. 22D, in some embodiments, the ducts 2230 may have a larger (e.g., wider) outlet end 2234 than inlet end 2232. Additionally, the wings 2202 may be completely contained or mounted within the outlet end 2234 (or a leading edge of the wing maybe be completely contained or mounted within the outlet end 2234). The propulsion unit 2220 can direct a flow of air from the inlet end 2232 to the outlet end 2234 through the widening profile (e.g., tapering profiled) of the ducts 2230 to allow the flow of air to reach the leading edge 2204 of the wing 2202. The cross-sectional area of the outlet end 2234 may be greater than the cross-sectional area of the inlet end 2232. The cross-sectional area of the inner channel defined by the duct 2230 may increase, along at least a section of the duct 2230 or along the entire length of the duct 2230, in the direction from the inlet end 2232 to the outlet end 2234 along the inner channel. The ducts 2230 can be J-shaped, C-shaped, L-shaped, or any other orientation which may effectively deliver a flow of air to the wing 2202 for optimal angle of attack to cause optimal lift while optimizing energy usage. In some embodiments, the opening area of the outlet end 2234 may be at least twice as large as the opening area of the inlet end 2232. Alternatively, the outlet end 2234 may be at least one and a half times as large as the inlet end 2232. The outlet end 2234 may be between one and a quarter times and three times as large as the inlet end 2232. Therefore, the ducts 2230 can deliver a flow of air over wings with larger surface areas. The wing 2202 may be located partially outside the outlet end 2234. In some embodiments, the wing 2202 may be located entirely outside the outlet end 2234.

Example Aircraft with Stacked Wings

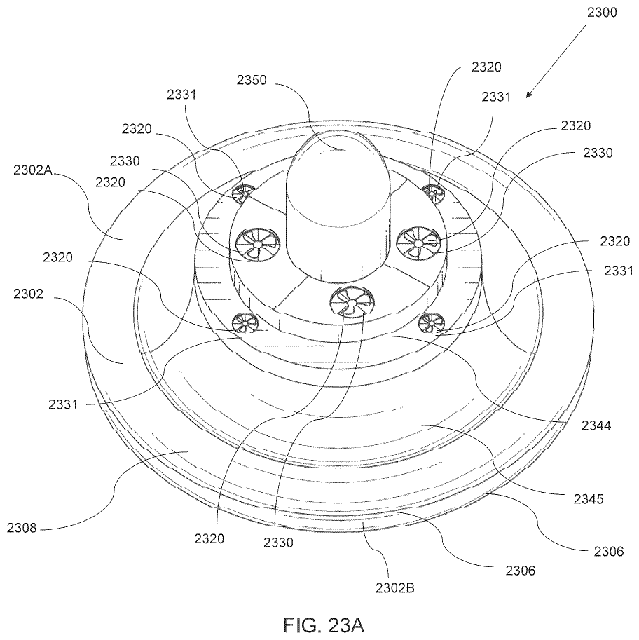

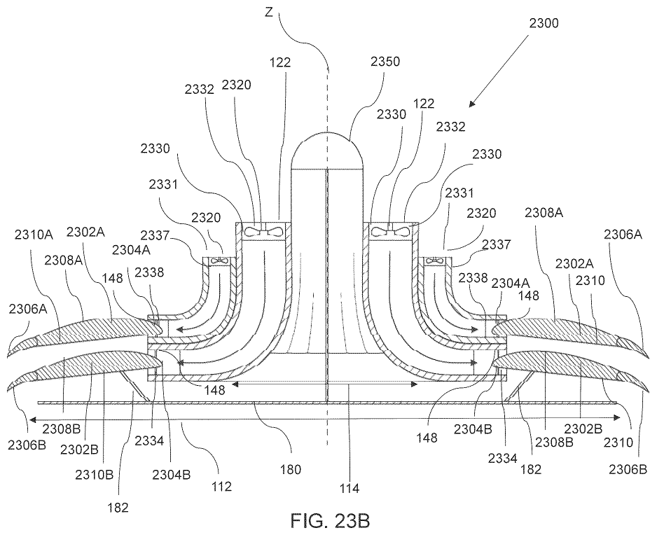

FIGS. 23A-23B illustrate another embodiment of an aircraft 2300. The aircraft 2300 may have many or all of the same or similar features as aircraft 100, or any other aircraft disclosed herein, and the same reference numbers are used to refer to the same features. The aircraft 2300 has multiple distinct annular arrangements of ducts 2330, 2331 and propulsion units 2320. In other words, the aircraft 2300 may have a first section of ducts 2330 and propulsion units 2320 which may provide a flow of air to a first lifting body depicted a first wing 2302B (e.g., bottom wing) and a second section of ducts 2331 and propulsion units 2320 which may provide a flow of air to a second lifting body depicted as a second wing 2302A (e.g., top wing). The wings 2302A and the wings 2302B may have a leading edge 2304A, 2304B and a trailing edge 2306A, 2306B. The first section of ducts 2330 may be positioned radially outward of the main body 2350 along a first annular path. The second section of ducts 2331 may be positioned radially outward of the first section of ducts 2330 along a second annular path. In this embodiment, there are two wings 2302A, 2302B which may be positioned in a stacked orientation where 2302A is positioned above 2302B. Other embodiments may utilize other arrangements of ducts intended to feed different wings (including, but not limited to, arrangements that position ducts intended to feed different wings within the same general annular space, instead of positioning one set of ducts radially outside of another set of ducts). For example, there may be one, two, three, four, five, six, seven, eight, nine, ten, eleven, twelve, or more of each of the ducts 2330 and the ducts 2331. There may be two, three, four, five, or more of the sections of ducts. As further example, there may be one, two, three, four, five, six, seven, eight, nine, ten, or more of the wings 2302. The ducts 2330 in the first section may be angularly offset about a central longitudinal axis from the ducts 2331 of the second section, as shown. In some embodiments, the ducts 2330 may be angularly aligned with some or all of the ducts 2331.

The first section of ducts 2330 may have a longer duct length than the second section of ducts 2331. Therefore, in some embodiments, the first section of ducts 2330 may have an inlet end 2332 positioned higher than an inlet end 2337 of the second section of ducts 2331. Additionally, the first section of ducts 2330 may have an outlet end 2334 positioned below outlet end 2338 of the second section of ducts 2331. The shorter length of the second section of ducts 2330 may increase the flow rate of air that exits the outlet end 2338 since there may be less friction and turbulence experienced by the air in the ducts 2331. Additionally, by positioning the inlet end 2337 of the second section of ducts 2331 below the inlet end 2332 of first section of ducts 2330, the air intake at the inlet end 2337 may increase (e.g., as compared to an orientation where the inlet end 2332 of the ducts 2330 and the inlet end 2337 of the ducts 2331 are level). In some embodiments, the inlet ends 2332 may be positioned above or at the same height as the inlet ends 2337. In some embodiments, the outlet ends 2334 may be positioned above or at the same height as the outlet ends 2338. The inlet end 2337 and outlet end 2338 of the second section of ducts 2331 may have a smaller diameter than the diameter inlet end 2332 and outlet end 2334 of the first section of ducts 2330. The first section of ducts 2330 may be created in a larger channel (e.g., walled structure) 2344. In some embodiments, the second section of ducts 2331 may be created in a second larger channel (e.g., second walled structure) 2345.

The plurality of propulsion units 2320 are configured to deliver a flow of air from the inlet end 2332 of the ducts 2330 and the inlet end 2337 of the ducts 2331 to deliver a flow of air to the leading edge 2304A, 2304B of the wings 2302A, 2302B. The flow of air generated by the propulsion units 2320 to travel through the first section of ducts 2330 and the second section of ducts 2331 may be delivered to the leading edges 2304A, 2304B and travel over the top surfaces 2308A, 2308B and the bottom surfaces 2310A, 2310B. The flow of air traveling from the leading edges 2304A, 2304B to the trailing edges 2306A, 2306B along the top surfaces 2308A, 2308B may flow at a relatively greater speed, compared to air flowing along the bottom surfaces 2308A, 2308B, due to the curved profile of the top surface 2308, resulting in a relatively lower air pressure exerted on the upper portion of the wing as compared to the pressure on the bottom surface 2310. Furthermore, the flow of air traveling over the leading edge 2304A and top surface 2308A of wing 2302A may be greater than the flow of air traveling over the leading edge 2304B and top surface of 2308B of wing 2302B. Advantageously, by having a stacked wing orientation (e.g., 2302A above 2302B), the total lift capability of aircraft 2300 may increase and may permit the aircraft 2300 to lift heavier payloads without increasing the span of the wings 2302A, 2302B.

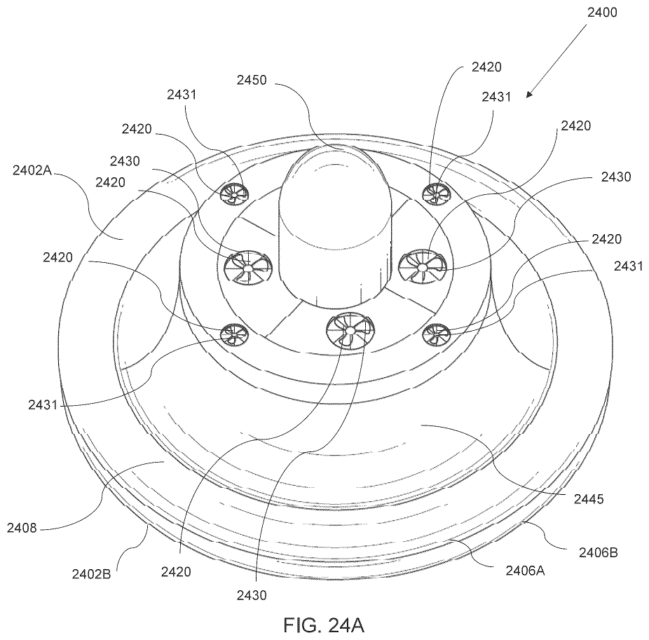

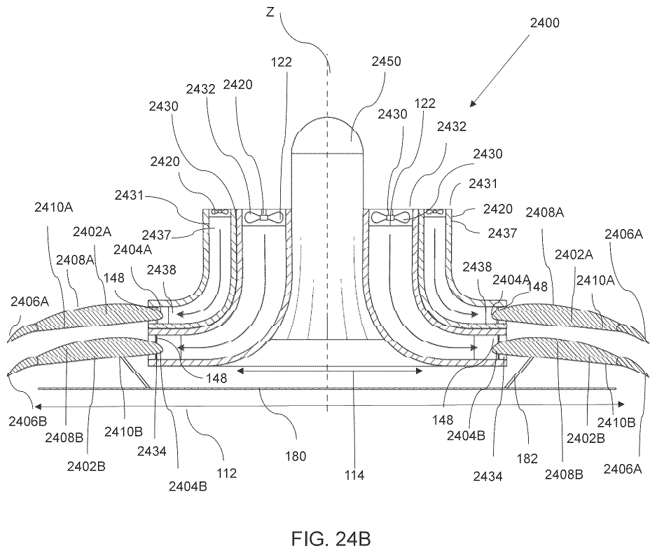

FIGS. 24A-24B illustrate another embodiment of an aircraft 2400. The aircraft 2400 may have many or all of the same or similar features as aircraft 100, 2300, or any other aircraft disclosed herein, and the same reference numbers are used to refer to the same features. The aircraft 2400 has multiple distinct annular arrangements of ducts 2430, 2431 and propulsion units 2420 (similar in concept the arrangements of ducts of aircraft 2300 discussed above). In other words, the aircraft 2400 may have a first section of ducts 2430 and propulsion units 2420 which may provide a flow of air to a first lifting body depicted as a first wing 2402B (e.g., bottom wing) and a second section of ducts 2431 and propulsion units 2420 which may provide a flow of air to a second lifting body depicted as a second wing 2402A (e.g., top wing). The first section of ducts 2430 may be positioned radially outward of the main body 2450. The second section of ducts 2431 may be positioned radially outward of the first section of ducts 2430. In this embodiment, there are two wings 2402A, 2402B which may be positioned in a stacked orientation where 2402A is positioned above 2402B. As with aircraft 2300 discussed above, other embodiments may utilize other arrangements of ducts intended to feed different wings (including, but not limited to, arrangements that position ducts intended to feed different wings within the same general annular space, instead of positioning one set of ducts radially outside of another set of ducts).

In the aircraft 2400, the first section of ducts 2430 may be level (e.g., positioned at a same height in the Z-direction) as the second section of ducts 2431. The first section of ducts 2430 may have a longer length than the second section of ducts 2431. Therefore, the first section of ducts 2430 may have an outlet end 2434 positioned below outlet end 2438 of the second section of ducts 2431. The shorter length of the second section of ducts 2430 may increase the flow rate of air that exits the outlet end 2438 since there may be less friction and turbulence experienced by the air in the ducts 2431. The inlet end 2437 and outlet end 2438 of second section of ducts 2431 may have a smaller diameter than the diameter of the inlet end 2432 and outlet end 2434 of the first section of ducts 2430. The first section of ducts 2430 may be created in a larger channel (e.g., walled structure) 2444. In some embodiments, the second section of ducts 2431 may be created in a second larger channel (e.g., second walled structure) 2445.

The plurality of propulsion units 2420 are designed to deliver a flow of air from an inlet end 2432 of the ducts 2430. The inlet end 2437 of the ducts 2431 are designed to deliver a flow of air to the leading edge 2404A, 2404B of the wings 2402A, 2402B. The flow of air generated by the propulsion units 2420 to travel through the first section of ducts 2430 and the second section of ducts 2431 may be delivered to the leading edges 2404A, 2404B and travel over the top surfaces 2408A, 2408B and the bottom surfaces 2410A, 2410B. The flow of air traveling from the leading edges 2404A, 2404B to the trailing edges 2406A, 2406B along the top surfaces 2408A, 2408B may flow at a relatively greater speed, compared to air flowing along the bottom surfaces 2408A, 2408B, due to the curved profile of the top surface 2408A, 2408B, resulting in a relatively lower air pressure exerted on the upper portion of the wing as compared to the pressure on the bottom surface 2410A, 2410B. Furthermore, the flow of air traveling over the leading edge 2404A and top surface 2408A of wing 2402A may be greater than the flow of air traveling over the leading edge 2404B and top surface of 2408B of wing 2402B. Advantageously, by having a stacked wing orientation (e.g., 2402A above 2402B), the total lift capability of aircraft 2300 may increase and may permit the aircraft 2300 to lift heavier payloads without increasing the span of the wings 2302A, 2302B.

Example Aircraft with Alternative Wing Tip Shape and Flow Diverters

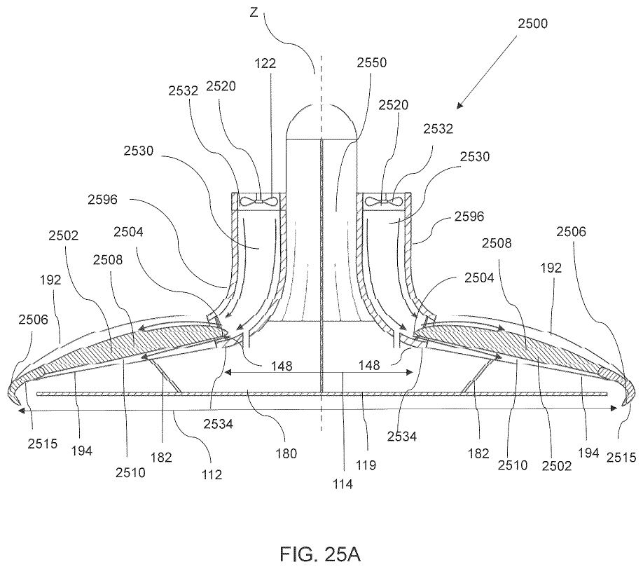

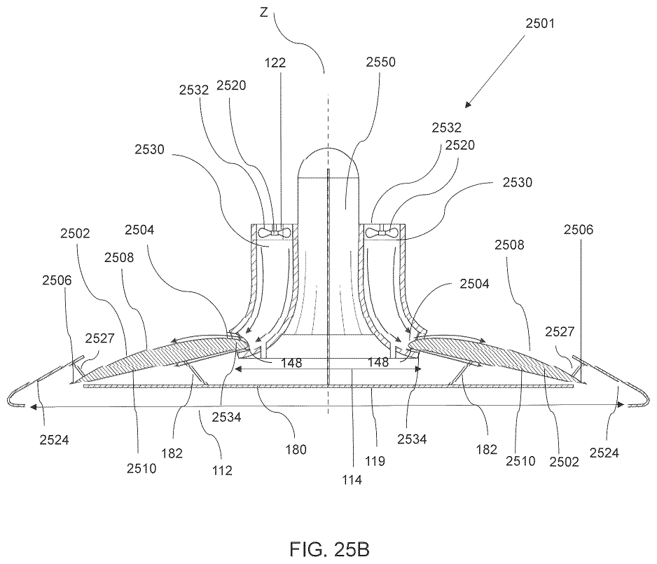

FIGS. 25A-25B illustrate additional embodiments of aircraft 2500 and 2501, respectively. The aircraft 2500, 2501 may have many or all of the same or similar features as aircraft 100, or any other aircraft disclosed herein, and the same reference numbers are used to refer to the same features. For example, one or more solar panels 2596 may be placed along the outside of the duct 2530 or along the outside of the larger channel. Additionally, the aircraft 2500 may have a main body 2550. In the aircraft 2500, 2501, the flow of air at the trailing edge 2506 of the lifting body depicted as wing 2502 is configured to flow and/or be diverted inwardly towards the longitudinal centerline Z of the aircraft 2500, 2501.

The plurality of propulsion units 2520 are configured to deliver a flow of air from the inlet end 2532 to the outlet end 2534 and to a leading edge 2504 of the wing 2502. The flow of air may travel along the top surface 2508 and the bottom surface 2510 of the wing 2502. The ailerons 2515 (see FIG. 25A) may have a curved shape (e.g., C-shape) and may be configured to allow a flow of air to flow over the top surface 2508 of the wing and may direct a flow of air at the bottom surface 2510 downward and towards the longitudinal centerline of the aircraft 2500. The tip of the ailerons 2515 (or trailing edge 2506) may be curved towards the centerline of the aircraft 2500.

The wings 2502 may be coupled to (or be positioned next to) a flow diverter 2524 near a top surface 2508 of the wing 2502 (see FIG. 25B). The flow diverter 2524 may be coupled to the wings 2502 via a coupling member 2527. The flow diverter 2524 may be configured to divert a flow of air at the trailing edge 2506 downwards. Advantageously, the flow diverter 2524 may be configured to prevent air from being directed radially outwards when landing, such as to prevent blowing the flow of air onto objects around the aircraft when landing. For example, when the flow diverter 2524 is positioned above the top surface 2508 of the wings 2502, the flow diverter 2524 may rotate downwards to direct a flow of air in a downward direction at the trailing edge 2506.

The flow diverter 2524 may be configured to prevent the flow of air delivered to the trailing edge 2506 along the top surface 2508 and the bottom surface 2510 from being obstructed. For example, when the flow diverter 2524 is traveling in a forward direction, the flow diverter flow diverter 2524 may block an incoming flow of environmental air at the trailing edge 2506 of the wing 2502. Advantageously, having the flow diverter 2524 block an incoming flow of air at the trailing edge 2506 may improve maneuverability and stability when the aircraft 2500 is moving in a desired direction (e.g., forward direction).

Example Aircraft with Multi-Component Wing

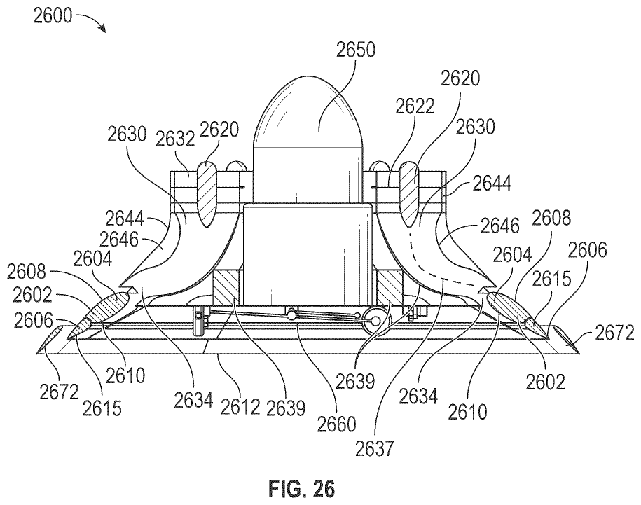

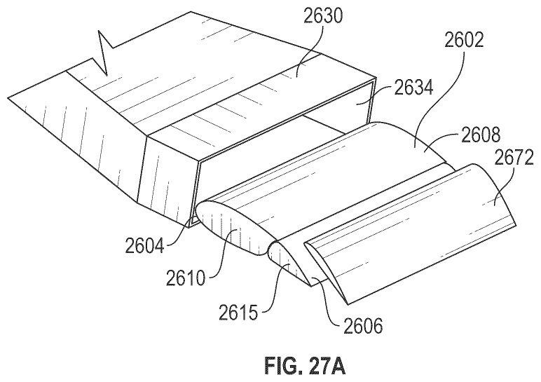

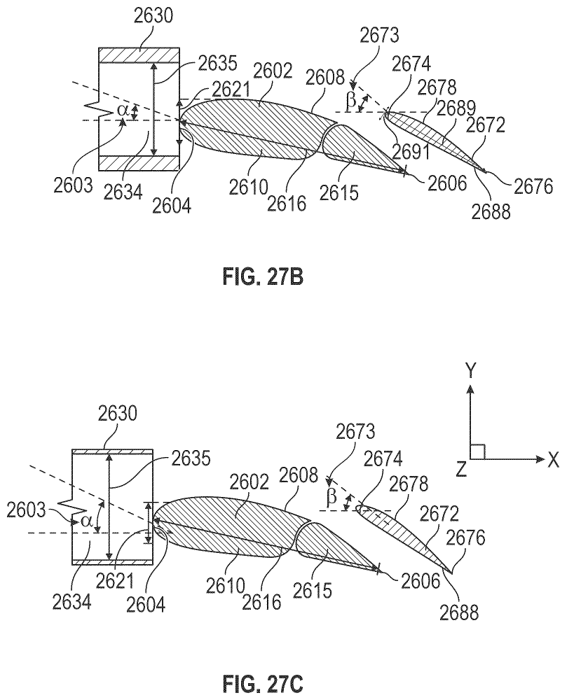

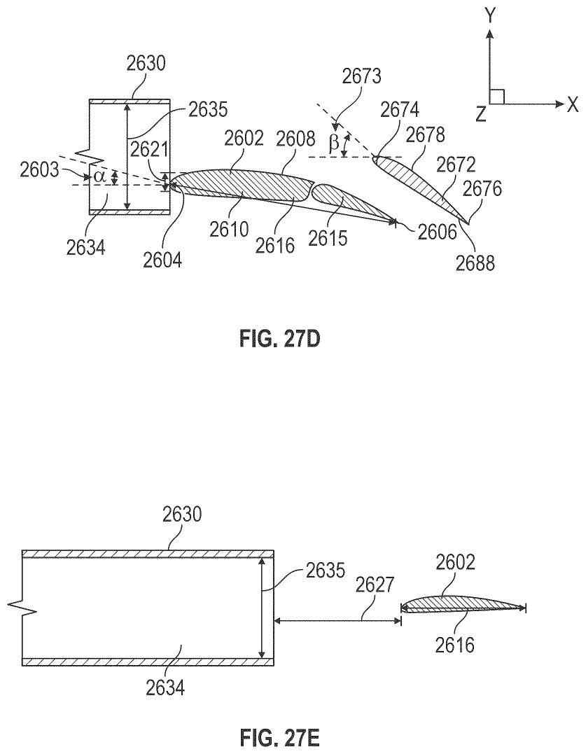

FIGS. 26-27E illustrate additional embodiments of an aircraft 2600 and components thereof. The aircraft 2600 may have many or all of the same or similar features as aircraft 100, or any other aircraft disclosed herein, or vice versa, and the same reference numbers are used to refer to the same features. In the aircraft 2600, a multi-component lifting body (e.g. airfoil or wing, etc.) is utilized, where an additional lifting body depicted as an additional wing 2672 is spaced away from the main or first wing 2602. Further, the wings may be angled more toward a vertical orientation, as further described. The wing 2602 or the additional wing 2672 may have an annular shape having an overall outer diameter 2612 from five to 25 feet, from 10 to 20 feet, from 10 to 15 feet, about 13.5 feet, or 13.5 feet.

The plurality of propulsion units 2620 are configured to deliver a flow of air from the inlet end 2632 to the outlet end 2634 of the plurality of ducts 2630 and to a leading edge 2604 of the wing 2602. The plurality of propulsion units 2620 may, for example, be from ten inches to thirty inches or from fifteen inches to twenty five inches or a twenty inch diameter, ducted fan (although any other suitable propulsion unit sizes may also be used for a given application). The plurality of propulsion units 2620 may be designed to generate thrust at the inlet end 2632 of the plurality of ducts 2630 to deliver a flow of air to the wing 2602. The plurality of ducts 2630 may be placed within a larger channel 2644. The plurality of propulsion units 2620 may be canted (e.g., have tilt at the outside edge of the plurality of propulsion units 2620), which may improve the flow of air delivered to the plurality of ducts 2630.

The plurality of ducts 2630 may also have an outer wall 2646. The outer wall 2646 may define an outer boundary for the flow of air through the duct 2630. The outer wall 2646 may be located inwardly of a wall of the larger channel 2644. The outer wall 2646 may define a profile. The profile may be configured to maintain or optimize the airflow velocity at the outlet end 2634 (e.g., reduce the amount of airflow, thrust, and/or power lost due to the plurality of ducts 2630 turning between the inlet end 2632 and the outlet end 2634). For example, the outer wall 2646 may have a curved profile which may be designed to reduce frictional forces exerted on the flow of air (e.g., which may reduce the airflow velocity at the outlet end 2634 and which may deliver a slower flow of air to the wing 2602). The outer wall 2646 may cause a middle area of the plurality of ducts 2630 to have a smaller width or area than the inlet end 2632 and/or the outlet end 2634.

The flow of air may travel along the top portion 2608 and the bottom surface 2610 of the wing 2602. The ailerons 2615 may be configured to allow a flow of air to flow over the top portion 2608 of the wing and may direct a flow of air at the bottom surface 2610 downward and relatively more inwardly, e.g. more towards the longitudinal centerline of the aircraft 2600. The ailerons 2615 may deflect (for example, rotate and/or translate) upwards and/or downwards to change the shape, profile, or camber of the wing 2602. The ailerons 2615 may have any of the same or similar features or functions as those described with respect to other ailerons herein, such as the ailerons 115, and vice versa.

The additional wing 2672 may be coupled to or positioned adjacent to a top portion 2608 of the wing 2602. The additional wing 2672 may be spaced upwards and laterally away (e.g., radially outward) from the wing 2602 (e.g., upwards and away from the top portion 2608). A portion of the additional wing 2672 may be positioned above the ailerons 2615 of wing 2602. As seen in FIG. 27B, the leading edge 2674 may be radially inward of the trailing edge 2606. Alternatively, the entire additional wing 2672 may be positioned upwards and away (e.g., farther away along the longitudinal axis) from the aircraft 2600 such that the leading edge 2674 of the additional wing 2672 is located radially outward of the trailing edge 2606.

The additional wing 2672 may have a top surface 2678, where the top surface 2678 may have a curved profile. The additional wing 2672 may have a bottom surface 2688, where the bottom surface 2688 may have a flatter surface relative to the top surface 2678. Therefore, when viewing the cross-sectional profile of the additional wing 2672, the additional wing 2672 may have the profile of an airfoil. The additional wing 2672 may be configured to generate additional lift from the flow of air at the trailing edge 2606. For example, when the flow of air exits the outlet end 2634 and flows over the top portion 2608 the flow of air can travel to the additional wing 2672. In some embodiments, it may be advantageous to have a thicker wing 2602, where the wing 2602 may have a thickness to chord ratio (e.g., t/c ratio) of approximately 0.24, of approximately 0.12, or from 0.1 to 0.25 or from 0.15 to 0.3, or from 0.2 to 0.28. The wing 2602 may have a thickness to chord ratio of approximately 0.20 or less (e.g., 0.19, 0.18, 0.17, 0.16, 0.15, 0.14, 0.13), or 0.10 or less (e.g., 0.09, 0.08, 0.07, 0.06).

In some embodiments, the flow of air traveling over the top portion 2608 of the wing 2602 can be delivered to a leading edge 2674 of the additional wing 2672. The flow of air may first be delivered to the leading edge 2674 and may travel over the top surface 2678 and the bottom surface 2688. The leading edge 2674 may be located above approximately 10% to 50% of the top portion 2608 of the wing 2602 (e.g., 10% to 50% of a distance measured from a middle point of the top portion 2608 to the trailing edge 2606 of the wing 2602). Therefore, air can flow from the top portion 2608 to the leading edge 2674 of the additional wing 2672.

The additional wing 2672 may have a trailing edge 2676 positioned on the same horizontal axis as the trailing edge 2606. The trailing edge 2676 may be positioned radially outward of the trailing edge 2606.

The leading edge 2674 of the additional wing 2672 may be radially outward of the leading edge 2604 of the wing 2602. In at least some embodiments, the leading edge 2674 of the additional wing 2672 is radially inward of the trailing edge 2606 of the wing 2602. The additional wing 2672 may be thinner than the wing 2602, where the additional wing 2672 is 20%-70% thinner than the wing 2602 (e.g., relative to thickness 2621). “Thinner” as used here may refer to a relation between the maximum thicknesses of the two wings.

The flow of air traveling from the leading edge 2674 to the trailing edge 2676 along the top surface 2678 may flow at a relatively greater speed than that of the air flowing along the bottom surface 2688. The flow of air from the leading edge 2674 to the trailing edge 2676 along the bottom surface 2688 may flow at a relatively lower speed due to the flatter profile (e.g., compared to the top surface 2678) of the bottom surface 2688. The pressure differential between the bottom surface 2688 and the top surface 2678 causes an additional lifting force which may be transferred to the aircraft 2600. Advantageously, positioning the additional wing 2672 above and away from the wing 2602 can improve the amount of lift generated (e.g., a 12%, or 10% or greater, or 8% or greater, improvement) over an embodiment of the aircraft 2600 without the additional wing 2672. In some embodiments, positioning the additional wing 2672 above and away from the wing 2602 may improve the performance of the aircraft 2600 by 5%-7% relative to aircrafts without the additional wing 2672. Therefore, the performance of the wing 2602 may be improved by adding the additional wing 2672, which may in turn increase the amount of lift generated by the aircraft 2600. In some embodiments, the positioning of the additional wing 2672 above and away from the wing 2602 may improve the amount of lift generated by 5%-20% when compared to an embodiment of the aircraft 2600 without the additional wing 2672.

In some embodiments, by placing the additional wing 2672 above and away from the wing 2602, the thickness of the wing 2602 may be reduced. For example, adding the additional wing 2672 can allow the wing 2602 to be relatively thin, where the wing 2602 can have a thickness to chord ratio (e.g., t/c ratio) of 0.12 or less (e.g., 0.10, 0.09, 0.08, 0.07, 0.06, 0.05, etc.) and produce enough force to lift the aircraft 2600 upwards. Furthermore, by reducing the thickness to chord ratio of the wing 2602, the wing 2602 can occupy less space at the opening of the duct (e.g., the thickness of the wing 2602 is much smaller). Reducing the thickness to chord ratio may thus reduce the amount of back pressure generated at the outlet end 2634 of the plurality of ducts 2630 due to the thinner wing 2602. In some embodiments, by reducing the thickness to chord ratio, the amount of thrust generated per propulsion unit 2620 can be increased by approximately 12%, or 10% or more, or 8% or more, when compared to aircraft embodiments with larger thickness to chord ratios (e.g., 0.24) and without an additional wing 2672.

The additional wing 2672 may have any of the same or similar features or functions as those described with respect to other additional wings or flow surfaces as described herein, such as the wings 2202 (e.g., see FIG. 22A) or the flow diverter 2224 (e.g., see FIG. 22B), and vice versa.

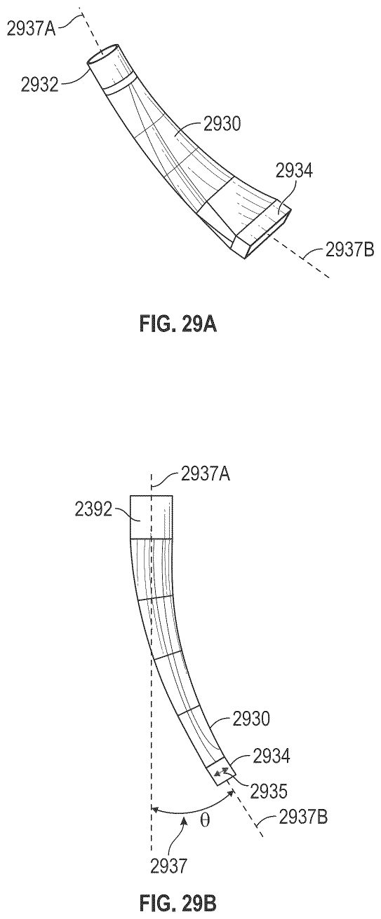

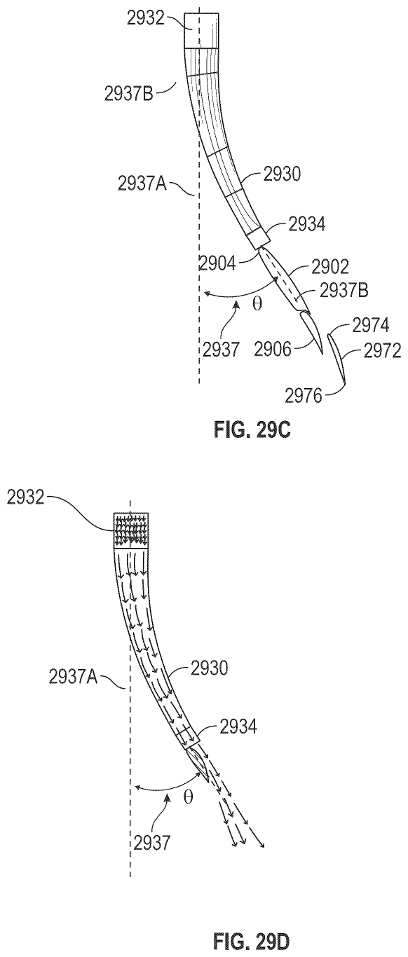

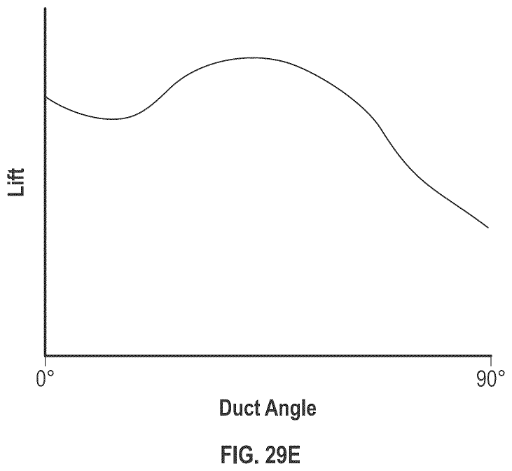

In some embodiments, the outer wall 2646 geometry or configuration may improve the amount of lift generated by the wing 2602. The plurality of ducts 2630 can each have a turn angle 2637, also called a bend angle or duct angle. The turn angle 2637 may improve the maximum amount of lift which can be generated by the plurality of propulsion units 2620 (e.g., the turn angle 2637 can optimize the delivery of airflow to the wing 2602 in order to generate lift). The turn angle 2637 can refer to the angular difference between the direction in which a propulsion unit directs thrust into the inlet end 2632 of the plurality of ducts 2630 (e.g., line 2937A in FIG. 29B) and the direction in which the outlet end 2634 of the plurality of ducts 2630 directs the flow of air (e.g., line 2937B in FIG. 29B). The turn angle 2637 may therefore be indicative of the angle through which a flow of air from the plurality of propulsion units 2620 is bent (e.g., turned) while traveling through the ducts 2630 from the inlet end 2632 to the outlet end 2634. For example, if the plurality of propulsion units 2620 directs a flow of air vertically downward (e.g., parallel to a longitudinal axis of the aircraft 2600), and the plurality of ducts 2630 expels the flow of air vertically downward (e.g., at the outlet end 2634) then the turn angle 2637 would be zero degrees. In another example, if the plurality of ducts 2630 directs a flow of air vertically downward through the inlet end 2632 and the plurality of ducts 2630 expels the flow of air horizontally at the outlet end 2634, then the turn angle 2637 would be ninety degrees.

In some embodiments, the turn angle 2637 can range from 32 degrees to 45 degrees. Additionally, the turn angle can be zero degrees, five degrees or more, ten degrees or more, 15 degrees or more, 20 degrees or more, 25 degrees or more, 30 degrees or more, 35 degrees or more, fifty degrees or less, fifty five degrees or less, sixty degrees or less, sixty five degrees or less, seventy degrees or less, seventy five degrees or less, eighty degrees or less, eighty five degrees or less, or ninety degrees or less. The turn angle 2637 can correspond to improvements in the amount of lifting force generated by the plurality of propulsion units 2620 by 50-60%.

In general, testing of the concepts disclosed herein has shown that, when considering turn angles (which may alternatively be referred to as “duct angles”) between 0 degrees and 90 degrees, there can be a range of angles within which the total vertical lift generated by the combination of the thrust from the propulsion unit(s) and the lift created by the airfoil(s) is greater than the lift that would be generated by the propulsion units alone. An example of this effect can be seen in the graph of FIG. 29E. This graph shows that, as the turn angle increases from 0, there may be a slight loss of efficiency; but then as the turn angle increases further, the total lift increases over the lift of the propulsion units alone (i.e. over the lift at angle 0). Once the turn angle is increased further, however, the efficiency begins dropping, eventually resulting in a total lift that is less than the lift would be with the propulsion units alone (i.e. the lift at angle 0). Testing has found that the area within which the total lift is greater than the lift would be with the propulsion units alone can be around approximately 32 degrees to 45 degrees. This is not always the case, however, and variations in designs and configurations may cause the upper and lower bounds of that range to be different depending on the application.

As further shown in FIG. 26, the aircraft 2600 may also have a landing gear assembly 2660. The landing gear assembly 2660 may have a plurality of legs which extend downwards and which may allow the aircraft to roll or rest on ground surface. The landing assembly gear assembly 2660 may also include one or more wheels which may allow the aircraft 2600 to travel along the ground. The aircraft 2600 may also include one or more battery packs 2639. The one or more battery packs 2639 may be capable of delivering power to the operations systems of the aircraft 2600 and to the plurality of propulsion units 2620. The battery pack(s) 2639 may extend annularly about a central portion 2650 of the aircraft 2600.

FIGS. 27A-27E show different configurations of wings 2602 coupled to or placed adjacent to one of the plurality of ducts 2630 at the outlet end 2634. The outlet end 2634 may have a diameter or opening or height 2635 which may assist in providing a desired amount of airflow to the leading edge 2604. The wing 2602 may have a variety of parameters which factor into the lift characteristics of the aircraft 2600. For example, the wing 2602 may have a chord 2616 or chord length which represents the distance from the leading edge 2604 to the trailing edge 2606. In some embodiments, the chord 2616 is angled no more than 45 degrees relative to a reference axis of the system, such as a vertical axis or an axis aligned with a gravity vector. The reference axis may be the central axis Z of the vehicle or system (for example, see FIG. 2). In some embodiments, the chord 2616 may be angled no more than 40 degrees, no more than 35 degrees, no more than 30 degrees, no more than 25 degrees, no more than 20 degrees, no more than 15 degrees, no more than 10 degrees, or no more than 5 degrees, relative to the reference axis. Additionally, the wing 2602 may have a maximum thickness 2621 as shown.

The wing 2602 may have an angle of attack 2603 which corresponds to the angle between the chord 2616 and the direction of flow of air exiting the outlet end 2634. The additional wing 2672 may also have a thickness (e.g., thickness 2691), chord (e.g., chord 2689), and angle of attack (e.g., angle of attack 2673), as discussed further below.

In some embodiments, the thickness 2621 of the wing 2602 relative to its chord 2616 (e.g., length) may have a ratio from 0.08 to 0.16, from 0.09 to 0.15, from 0.10 to 0.14, from 0.11 to 0.13, or 0.12 (e.g., a t/c ratio of 0.12). The distance the wing 2602 is spaced from the outlet end 2634 can also vary (e.g., see FIG. 27E and associated description). Additionally, the sizing of the wing 2602 can be determined based on a variety of non-dimensional parameters, which can include, for example, the ratio between height 2635 of plurality of ducts 2630 at the outlet end 2634 to the chord 2616 (e.g., H/c), and/or the ratio between the distance 2627 (See FIG. 27E) the airfoil (e.g., wing 2602) is offset from the outlet end 2634 to the chord 2616 (e.g., D/c). The ratio between i) the distance the additional wing 2672 is positioned from the wing 2602 and ii) the chord 2689 of the additional wing 2672 may be approximately 2:1, 3:2, 1:1, 2:3, 1:2, 2:5, 1:4, or 1:5.

The horizontal distance between the additional wing 2672 and the wing 2602 may be measured from the leading edge 2604 or the trailing edge 2606 to the leading edge 2674 or trailing edge 2676, respectively. This horizontal distance may be at least 50%, at least 60%, at least 70%, at least 80%, or at least 90% of the length of the chord 2616 of the radially inward wing 2602 that is closer to the duct outlet.

In some embodiments, the propulsion units 2620 may be electric propulsion units capable of delivering at least six-hundred N of thrust, or up to six-hundred and sixty N of thrust, and/or at least thirty kW of power or at thirty-six kW of power. In some embodiments, the propulsion units 2620 may have a casing with a radius of ten inches. The casing may, in some embodiments, have a radius between eight inches to twenty inches. The plurality of blades 2622 of the propulsion units 2620 may have a rotational speed range or RPM (revolutions per minute) range between four thousand five hundred to six thousand five hundred RPM (e.g., the plurality of blades 2622 spin at four thousand five hundred to six thousand five hundred RPM). The plurality of blades 2622 may include eleven blades having a 0.25″ radius center body. The blade chord of the plurality of blades 2622 is approximately two inches. Additionally, the blade chord of the plurality of blades 2622 may be between one inch and five inches. The plurality of blades 2622 may also have a linear twist at the end or root. The plurality of blades 2622 may have a linear twist extending along the chord of the plurality of blades 2622. Additionally, the plurality of blades 2622 may have a linear twist at the tip of the plurality of blades 2622. For example, the plurality of blades 2622 may have a twist of seventy-five degrees at the root (e.g. base of the plurality of blades 2622). The plurality of blades 2622 may have a twist of thirty-five degrees at the tip. Additionally, the plurality of propulsion units 2620 when rotating at approximately five thousand five hundred RPM may generate at 12.5 kg/s mass flux, a vertical force of approximately six-hundred sixty N, and a power of approximately thirty-six KW.

In FIGS. 27A-27C, the thickness 2621 to chord 2616 ratio (e.g., t/c) of the wing 2602 may be such that the height or thickness of the wing 2602 may occupy approximately half of the opening height 2635 at the duct outlet end 2634. Alternatively, the thickness to chord ratio of the wing 2602 may be smaller than that of FIGS. 27A-27C (see, for example, FIG. 27D). The wing 2602 may only have a height or thickness that occupies approximately one quarter of the opening or height 2635 of the outlet end 2634. The wing 2602 may only have a height or thickness that occupies approximately one fifth of the opening or height 2635 of outlet end 2634. The wing 2602 may be positioned at a lower end of the outlet end 2634. The leading edge 2604 may be located a particular distance from the bottom of the duct exit, such as five percent or less, ten percent or less, fifteen percent or less, twenty percent or less, twenty five percent or less, thirty percent or less, thirty five percent or less, forty percent or less, or fifty percent or less, of the height of the opening 2635 as measured from the bottom of duct exit. The relatively lower positioning of the wing may allow for a majority (e.g., eighty percent or more, ninety percent or more, or ninety five percent or more) of the flow of air exiting the outlet end 2634 to flow over the top portion 2608 of the wing.

In some embodiments, the wing 2602 may be placed near or at the vertical middle of the outlet end 2634 which can allow for more uniform distribution (e.g., relative to when the wing 2602 is placed at a lower portion of the outlet end 2634) of air flowing from the outlet end 2634 to flow over both the top portion 2608 and bottom surface 2610 of the wing 2602. Additionally, the thickness to chord ratios (e.g., t/c) for the additional wing 2672 may be similar (e.g., 0.12, 0.06, etc.) to those for the wing 2602 (e.g., thickness 2691 to chord 2689). The thickness to chord ratios (e.g., t/c) for the additional wing 2672 may be smaller than those for the wing 2602.

In some embodiments, the additional wing 2672 may have a smaller height or thickness 2691 than the wing 2602. The ratio between the thickness 2691 of the additional wing 2672 and the thickness 2621 of wing 2602 can be approximately 2:3 or less, 1:2 or less, 2:5 or less, 1:3 or less, 2:7 or less, or 1:4 or less. The additional wing 2672 may have a smaller height or thickness 2691 than wing 2602. The additional wing 2672 may have a smaller chord 2689 than the chord 2616 of wing 2602. The ratio between the chord 2689 of the additional wing 2672 and the chord 2616 of wing 2602 can be approximately 2:3 or less, 1:2 or less, 2:5 or less, 1:3 or less, 2:7 or less, or 1:4 or less. Alternatively, the additional wing 2672 can have the same chord 2689 as the chord 2616 of wing 2602.

The chord 2689 of the additional wing 2672 may be angled relative to the chord 2616 of the wing 2602, where the relative angle between the two chords (i.e., chord 2689 and chord 2616) is approximately ten degrees. In some embodiments, the relative angle between the two chords may be 5 degrees or less, fifteen degrees or less, twenty degrees or less, twenty five degrees or less, thirty degrees or less, or forty degrees or less. The relative angle between the two chords may be between 5 degrees and fifty degrees.

The additional wing 2672 may have an angle of attack (β) 2673 which differs from the angle of attack (α) 2603 of the wing 2602. For example, the angle of attack 2603 of the wing 2602 may be smaller than the angle of attack 2673 of the additional wing 2672. In some embodiments, the angle of attack 2603 may be equal to the angle of attack 2673. The angle of attack 2673 of the additional wing 2672 may be optimized to generate a desired amount of lift from the flow of air travelling the top portion 2608 of the wing 2602. In some embodiments, the difference between the angle of attack 2673 of the additional wing 2672 and the angle of attack 2603 of the wing 2602 may be approximately 1 degree or less, 5 degrees or less, fifteen degrees or less, twenty degrees or less, twenty five degrees or less, thirty degrees or less, or forty degrees or less. In some embodiments, one or both of the angles of attack (e.g., angle of attack 2673 and angle of attack 2603) may be adjustable. One or both of wing 2602 and additional wing 2672 may rotate to adjust the angle of attack (e.g., angle of attack 2603 and angle of attack 2673), for example via actuation of an actuator.

As shown in FIG. 27E, the leading edge 2604 of the wing 2602 may be spaced or offset horizontally from the outlet end 2634 a distance 2627. The distance 2627 may be determined to reduce back pressure at the outlet end 2634, which may improve lift characteristics. The distance 2627 may be optimized given other parameters of the system to improve lift characteristics. For example, the ratio of i) the D=distance 2627 between the leading edge 2604 and the outlet end 2634 relative to ii) the chord 2616 (e.g., “D/c ratio”) may be at least 1, or at least 1.5. In some embodiments, the D/c ratio may be from 0 to 1, less than 0.5, less than 0.75, less than 1, or less than 2. The particular D/c ratio may depend on the size and scale of the application of the aerolift system.

The positioning of the wing 2602 may be optimized with a desired D/c ratio (e.g., distance 2627 over chord 2616) and “H/c” ratio (e.g., H=height 2635 over the c=chord 2616). As the H/c ratio is reduced, the amount of lift for the aircraft 2600 may be reduced. In some cases, reducing the H/c ratio from 0.8 to 0.4 or 0.25 will reduce the amount of lift generated by the aircraft 2600. In some embodiments, adjusting D/c ratio (e.g., increasing/decreasing) may not significantly affect the amount of lift generated by the aircraft 2600. The amount of drag generated by the wing 2602 may be affected by the D/c ratio. In some examples, a lower H/c ratio (e.g., 0.2) can increase the amount of drag experienced by the aircraft 2600.

In some embodiments, the combined considerations of the wing 2602 profile (e.g., chord, airfoil profile, turn angle, distance, etc.), the outer wall 2646 of the plurality of ducts 2630 profile, and the pressure generated at the leading edge 2604 are responsible for determining the optimal characteristics of the aircraft 2600.

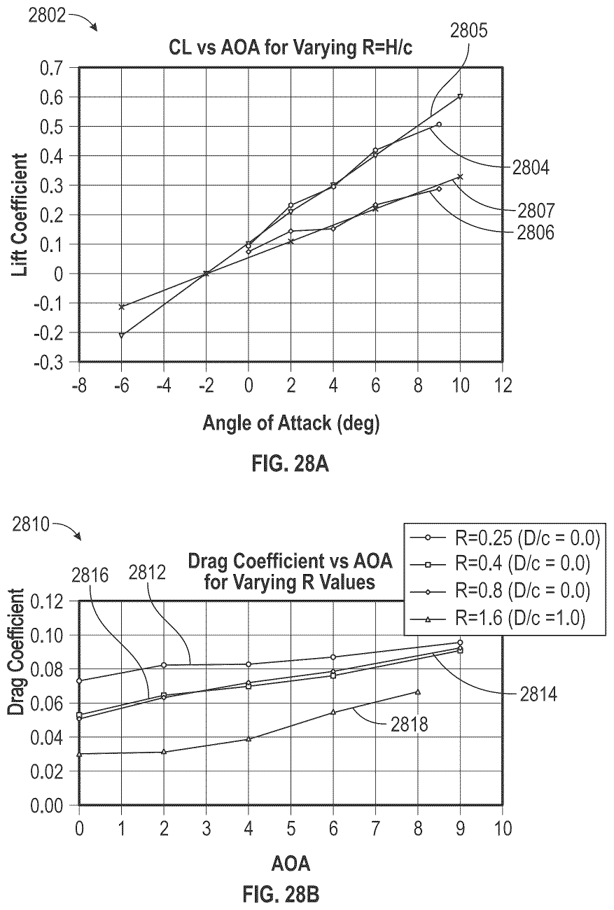

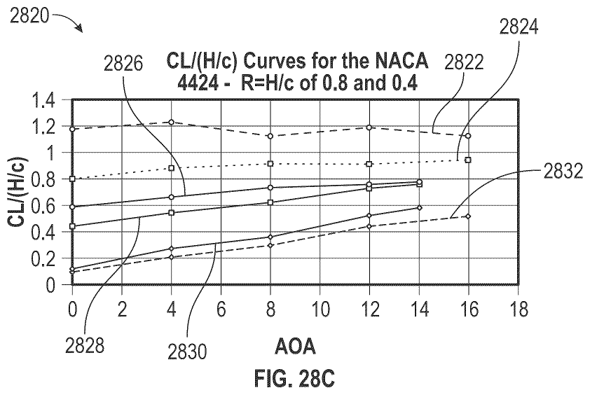

FIGS. 28A-28C are graphical representations of theoretical and model-based data based on selected parameters (e.g., t/c ratio, H/c ratio, D/c ratio) of the aircraft 2600. FIG. 28A shows a data plot 2802 with a comparison of the predicted lift coefficient (CL) versus the angle of attack (AOA) of the wing 2602 for varying H/c ratios as produced by analysis using the relevant equations and as produced by a computer model using computational fluid dynamics (CFD). Lines 2804 and 2805 show the data for an H/c ratio of 1.6 for the model-based data and the theoretical data, respectively. Lines 2806 and 2807 are for an H/c ratio of 0.8 for the model-based data and the theoretical data, respectively. As shown, the theoretical and model-based data tightly correspond to each other. For example, for an H/c ratio of 1.6, the line 2805 and the line 2804 correspond to one another (e.g., follow a similar trend/slope). Additionally, for an H/C ratio of 0.8, the line 2807 and the line 2806 correspond to one another.

FIG. 28B shows trends 2810 for the predicted drag coefficient for the wing 2602 versus angle of attack (AOA) based on different combinations of H/c and D/c ratios. For example, line 2812 shows the expected drag based on the angle of attack of the wing 2602 when the H/c ratio is 0.25 and the D/c ratio is 0. Line 2814 shows the expected drag based on the angle of attack of the wing 2602 when the H/c ratio is 0.4 and the D/c ratio is 0. Line 2816 shows the expected drag based on the angle of attack of the wing 2602 when the H/c ratio is 0.8 and the D/c ratio is 0. Line 2818 shows the expected drag based on the angle of attack of the wing 2602 when the H/c ratio is 0.1.6 and the D/c ratio is 1.

FIG. 28C shows a graphical representation 2820 of the lift coefficient to H/c ratio versus angle of attack of the wing and for varying combinations of H/c. As shown in FIG. 28C, the maximum value of the lift coefficient relative to H/c ratio is relatively insensitive (e.g., does not change) with respect to the angle of attack of the wing 2602. Therefore, it may be advantageous to maintain a lower angle of attack for the wing 2602 to have a high lift to drag ratio. For example, line 2822 shows lift coefficient relative to H/c ratio when the H/c ratio is 0.8 and the D/c ratio is 0. Line 2824 shows lift coefficient relative to H/c ratio when the H/c ratio is 0.8 and the D/c ratio is 0.2. Line 2826 shows lift coefficient relative to H/c ratio when the H/c ratio is 0.8 and the D/c ratio is 0.3. Line 2828 shows lift coefficient relative to H/c ratio when the H/c ratio is 0.4 and the D/c ratio is 0. Line 2830 shows lift coefficient relative to H/c ratio when the H/c ratio is 0.8 and the D/c ratio is 0.1. Line 2832 shows lift coefficient relative to H/c ratio when the H/c ratio is 0.4 and the D/c ratio is 0.15.

### Additional Duct Examples

FIGS. 29A-29D illustrate additional embodiments of one or more ducts 2930, and FIG. 29E illustrates a graph showing how lift can be influenced by a turn angle of the duct (also called a turn angle or duct angle). The ducts 2930 may have many or all of the same or similar features as ducts 130, or any other ducts disclosed herein, and vice versa, and the same reference numbers are used to refer to the same features. The ducts 2930 may have a different shape or profile (e.g., turn angle) to deliver an optimal amount of airflow to an airfoil (e.g., airfoil 2902), and/or to optimize the amount of lift generated.

FIGS. 29A-29D show one or more ducts 2930 having a turn angle 2937. In some embodiments, the ducts 2930 may have various turn angles 2937. The turn angle 2937 is an angle between line 2937A and line 2937B. The line 2937A represents a direction parallel with and defined by the channel of the duct at the inlet end 2932, which may be approximately the same as the direction of the flow of air into the inlet end 2932 delivered by the propulsion units, e.g., propulsion units 2620. The line 2937B represents a direction parallel with and defined by the channel of the duct at the outlet end 2934, which may be approximately the same as the direction of the flow of air out of the outlet end 2934. The turn angle 2937 is measured as viewed from a side view of the duct, as shown in FIG. 29B. FIGS. 29C and 29D also show the lines 2937A and 2937B but offset from the duct channel for clarity. In some embodiments, the turn angle 2937 may be from twenty-five to forty degrees, from twenty eight to thirty eight degrees, from thirty to thirty five degrees, thirty two degrees, or about thirty two degrees. In other embodiments, the turn angle 2937 may be ninety degrees or less. Additionally, the turn angle 2937 may be between thirty-two degrees and ninety degrees. For example, the turn angle can be forty-five degrees or less, fifty degrees or less, fifty-five degrees or less, sixty degrees or less, or sixty five degrees or less. One advantage of optimizing the turn angle 2937 is to improve the resultant vertical force that may be obtained for the aircraft system (e.g., aircraft 2600) and to reduce turbulent airflow (e.g., deliver laminar airflow at the outlet end 2934).

The inlet end 2932 of the ducts 2930 can have an opening or diameter which can correspond to the diameter of the fan or propulsion unit (e.g., propulsion units 2620). For example, the inlet end 2932 may be sized and shaped to contain propulsion units (e.g., propulsion units 2620) having a twenty inch diameter. The outlet end 2934 of the ducts 2930 may have a vertical (relative to the orientation of the opening) height 2935 from six to twenty two inches, from eight to twelve inches from nine to eleven inches, of ten inches, 10.5 inches, or approximately 10.5 inches. The height 2935 is the vertical distance of the opening at the outlet end 2934 measured vertically and perpendicularly to the line 2937B at the cross-sectional opening of the outlet end 2934. Furthermore, the height 2935 of the outlet end 2934 may be designed or optimized for a particular airfoil 2902 design. For example, the airfoil 2902 may have a chord of approximately two feet. The leading edge 2904 may be positioned at or adjacent to the outlet end 2934.

The additional wing 2972 may be coupled to or positioned adjacent to the airfoil 2902. The additional wing 2972 may be spaced upwards and laterally away (e.g., radially outward) from the airfoil 2902 (e.g., upwards and away from the airfoil 2902). The leading edge 2974 may be radially inward of the trailing edge 2906. Alternatively, the entire additional wing 2972 (e.g., the leading edge 2974 and the trailing edge 2976) may be positioned upwards and away (e.g., farther away along the longitudinal axis) from an aircraft such that the leading edge 2974 of the additional wing 2972 is located radially outward of the trailing edge 2906.

As described above, FIG. 29E shows a graph of the amount of combined lift generated by the propulsion unit and the airfoil based on the duct's turn angle 2937. For example, as the turn angle 2937 changes from 0 to 90 degrees, the amount of combined lift generated can vary. In some embodiments, a turn angle 2937 around or near 32 to 45 degrees may generate the greatest amount of combined lift. Additionally, a turn angle 2937 of zero degrees may generate a large amount of lift relative to other turn angles 2937 close to zero. As the turn angle 2937 increases beyond zero degrees, the contribution to the lift from the airfoil causes the combined lift to be greater than other possible with only a propulsion unit. As the turn angle 2937 increases beyond 32 or 45 degrees, or beyond some amount therebetween, the amount of combined lift generated by the airfoil 2902 and propulsion unit may then decrease.

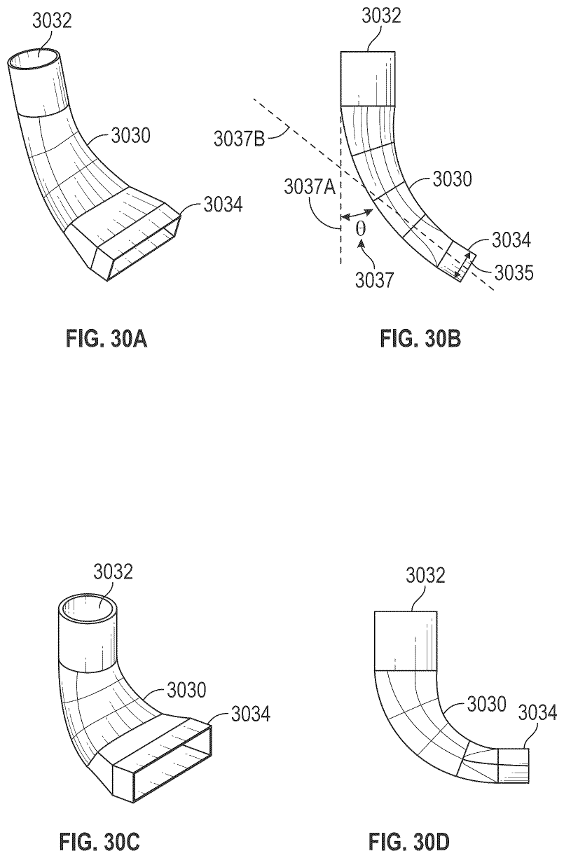

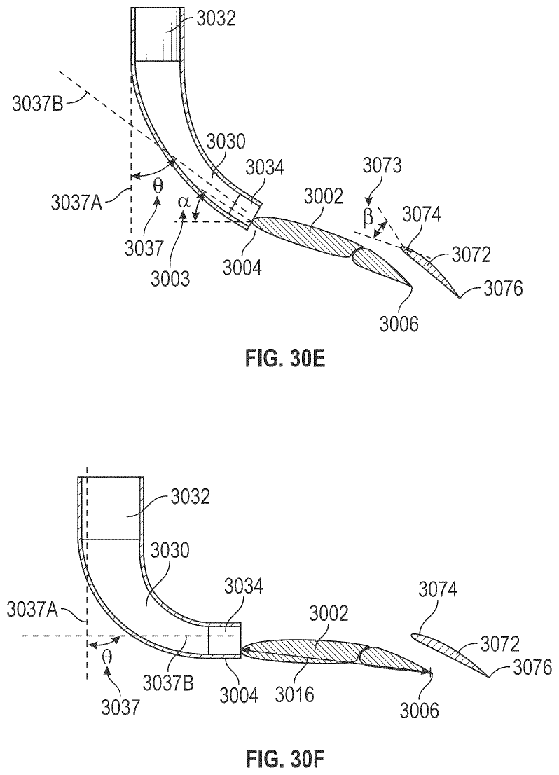

FIGS. 30A-30F illustrate additional embodiments of one or more ducts 3030. The ducts 3030 may have many or all of the same or similar features as ducts 130, or any other ducts disclosed herein, and vice versa, and the same reference numbers are used to refer to the same features. The ducts 3030 may have a different shape or profile (e.g., turn angle 3037) to deliver an optimal amount of airflow to an airfoil (e.g., airfoil 3002). The turn angle 3037 is an angle between line 3037A (which represents the direction of the flow of air into the inlet end 3032) and line 3037B (which represents the direction of the flow of air out of the outlet end 3034).

FIGS. 30A-30B show a duct 3030 with a turn angle 3037. The duct 3030 may have the same or similar features as the duct 2930 and vice versa, except as otherwise described. FIG. 30E shows a cross-sectional view of the ducts 3030 with a turn angle of approximately 45 degrees. The outlet end 3034 may have a height 3035 of approximately 10.5 inches. In some embodiments, the outlet end 3034 may have a height 3035 between 6 inches to 22 inches. Furthermore, the height 3035 of the outlet end 3034 may be designed or optimized for a particular airfoil 3002 design. For example, the airfoil 3002 may have a chord of approximately two feet. The airfoil 3002 may have an outer diameter (e.g., the diameter measured from trailing edge 3006 of the airfoil 3002 that passes through a center point or axial centerline of the airfoil 3002) of 13.5 feet.

FIGS. 30C and 30D show the duct 3030 with a turn angle 3037 of approximately 90 degrees. FIG. 30F shows a cross-sectional view of the ducts 3030 with a turn angle 3037 of approximately 45 degrees. The outlet end 3034 may have a height 3035 of approximately 10.5 inches. In some embodiments, the outlet end 3034 may have a height 3035 between 6 inches to 22 inches. Furthermore, the height 3035 of the outlet end 3034 may be designed or optimized for a particular airfoil 3002 design. For example, the airfoil 3002 may have a chord 3016 of approximately two feet. The airfoil 3002 may have an outer diameter (e.g., the diameter measured from trailing edge 3006 of the airfoil 3002 that passes through a center point or axial centerline of the airfoil 3002) of 13.5 feet.

The duct 3030 may further have an outlet end 3034 with a cross-sectional area that is larger than that of the inlet end 3032. The ratio of an area of the outlet end 3034 to an area of the inlet end 3032 may be 1.25:1 or less, 1.5:1 or less, 1.75:1 or less, 2:1 or less, 2.25:1 or less, 2.5:1 or less, 3:1 or less, 5:1 or less. The inlet end 3032 may be circular or other rounded shapes. The outlet end 3034 may be rectangular, square, or other segmented shapes. The outlet end 3034 may have a shape corresponding to that of the airfoil 3002.

FIG. 30E shows the additional wing 3072 which may be coupled to or positioned adjacent to the airfoil 3002. The additional wing 3072 may be spaced upwards and laterally away (e.g., radially outward) from the airfoil 3002 (e.g., upwards and away from the airfoil 3002 and away from the leading edge 3004). The leading edge 3074 may be radially inward of the trailing edge 3006. Alternatively, the entire additional wing 3072 (e.g., the leading edge 3074 and the trailing edge 3076) may be positioned upwards and away (e.g., farther away along the longitudinal axis) from an aircraft such that the leading edge 3074 of the additional wing 3072 is located radially outward of the trailing edge 3006.

The additional wing 3072 may have a curved profile. The additional wing 3072 may be configured to generate additional lift from the flow of air at or adjacent to the trailing edge 3006. The additional wing 3072 may be configured to generate additional lift from the flow of air at or adjacent to a middle portion of the airfoil 3002. For example, when the flow of air exits the outlet end 2634 and flows over the airfoil 3002 the flow of air can travel to the additional wing 3072. The airfoil 3002 may have an angle of attack 3003 which corresponds to the angle between the chord 3016 and the direction of flow of air exiting the outlet end 3034. The angle of attack may be positive. The angle of attack may be from zero to 75 degrees, from zero to 50 degrees, from zero to 30 degrees, from 10 to 75 degrees, from 10 to 50 degrees, from ten to 30 degrees, or from ten to 20 degrees. The angle of attack may be adjustable during flight as the lifting body rotates (or parts thereof, such as flaps etc.) relative to the “freestream” direction of air exiting the duct outlet. Further, the chord 3016 may be angled with respect to a reference axis of the system or vehicle, for example as described with respect to the chord 2616 and FIGS. 27A-27E. Likewise, this angle between the chord 3016 and the reference axis may change as the lifting body rotates, etc.

FIGS. 31A-31D show one or more ducts 3130 with an inlet lip 3148. FIG. 31A shows a side view of the one or more ducts 3130 with an inlet lip 3148. FIG. 31B shows a detailed view of the outlet end 3134 of the one or more ducts 3130. The airfoil 3102 may have a leading edge 3104 and a trailing edge 3106. The airfoil 3102 may have an angle of attack 3103 which corresponds to the angle between the chord and the direction of flow of air exiting the outlet end 3134. The inlet lip 3148 may provide a smooth transition surface for air to flow into the inlet end 3132. The inlet lip 3148 may be an elliptic lip, which may provide for improved airflow from the inlet end 3132 to the outlet end 3134. The horizontal width of the inlet lip 3148 may be greater than the vertical height of the lip. Furthermore, the inlet lip 3148 may be designed to provide for a better conditioned or more laminar flow of air into the one or more propulsion units. A flow of air from the inlet lip 3148 through the inlet end 3132, the one or more ducts 3130, and the outlet end 3134 can have improved lift characteristics relative to ducts 3130 without an inlet lip 3148. For example, the inlet lip 3148 can provide increased performance of a propulsion unit (e.g., propulsion units 120) compared to one or more ducts 3130 without an inlet lip 3148. In some embodiments, the performance of a propulsion unit coupled to one or more ducts 3130 with an inlet lip 3148 can be approximately 20%-40% greater than those without an inlet lip 3148. In some embodiments, the inlet lip 3148 may be canted, which may improve airflow from the inlet end 3132 to the outlet end 3134 (e.g., less turbulent airflow). An additional wing 3172 having a leading edge 3174 and a trailing edge 3176 may also be positioned radially outward of the airfoil 3102.

FIGS. 31C-31D depict improved airflow characteristics of the one or more ducts 3130. The one or more ducts 3130 may have a smoother airflow velocity field at the inlet end 3132 due to the inlet lip 3148. Additionally, such airflow traveling through the one or more ducts 3130 may result in a greater induced lift due to the inlet lip 3148. The flow of air from the inlet end 3132 may be more laminar (e.g., smoother) and faster at positions nearer the centerline of the one or more ducts 3130, as opposed to the boundary or outer inside diameter of the one or more ducts 3130 (e.g., the flow of air may be slower at the outer inside diameter of the one or more ducts 3130). Incorporating the inlet lip 3148 with the turn angle 3137 can further improve the amount of lift that can be generated by reducing the risk of turbulent or separated flow inside the duct. For example, having one or more ducts 3130 with a turn angle 3137 of approximately 32 degrees and an inlet lip 3148 may result in an approximately 8.5% improvement in vertical thrust to power ratio. Additionally, including a turn angle 3137 of approximately 32 degrees may provide about a 12% improvement over the baseline fan in vertical thrust to power ratio when the airfoil 3102 is poisoned adjacent to (e.g., approximately 0 inches away from) the outlet end 3134. The turn angle 3137 is an angle between line 3137A (which represents the direction of the flow of air into the inlet end 3132) and line 3137B (which represents the direction of the flow of air out of the outlet end 3134).

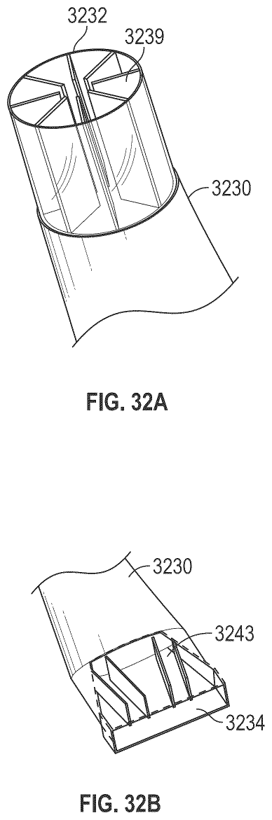

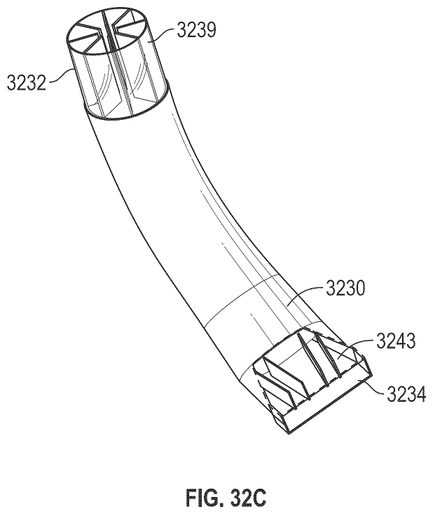

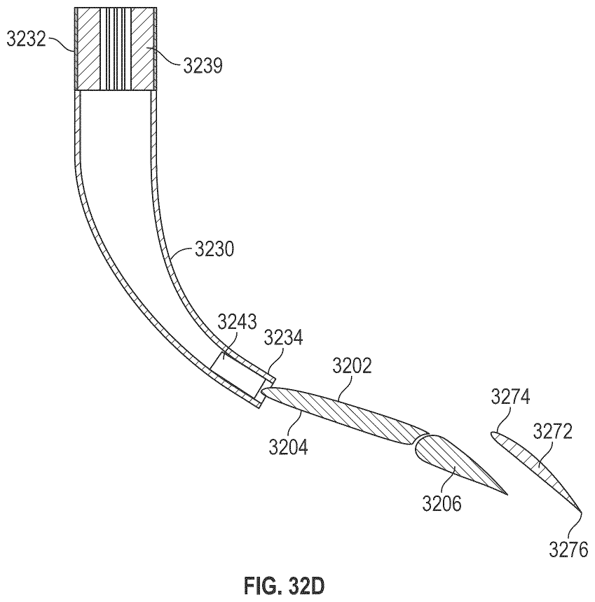

FIGS. 32A-32D illustrate additional embodiments of one or more ducts 3230. The ducts 3230 may have many or all of the same or similar features as ducts 130, or any other ducts disclosed herein, and vice versa, and the same reference numbers are used to refer to the same features. The ducts 3230 may have one or more vanes which may improve airflow at the inlet end 3232 or outlet end 3234 of the one or more ducts 3230.

FIGS. 32A-32D show one or more ducts 3230 which designed to generate more uniform airflow at the inlet end 3232 and the outlet end 3234. Portions of the ducts 3230 are shown transparently in order to more clearly see structures therein. FIG. 32A shows the one or more ducts 3230 may include one or more vanes 3239 (e.g., steering vanes 3239) positioned within and at the inlet end 3232. The one or more vanes 3239 may be capable of removing air swirl entering the duct 3230. The one or more vanes 3239 may be positioned adjacent to the inlet end 3232. The one or more vanes 3239 may include eight vanes extending radially and angularly spaced within the inlet end 3232. The one or more vanes 3239 may be positioned underneath (e.g., below) one or more of the plurality of propulsion units in order to create a smooth transition of air (e.g., laminar air flow) from the inlet end 3232 to the outlet end 3234. The one or more vanes 3239 may also be rectangularly shaped and extend from an outside wall of the one or more ducts 3230 towards an axial centerline of the one or more ducts 3230.

FIG. 32B shows the outlet end 3234 of the duct 3230 having one or more additional vanes or deswirling vanes 3243 positioned therein. FIGS. 32C and 32D show the duct 3230 which may include both deswirling vanes 3243 at the outlet end 2334 and vanes 3239 at the inlet end 3232. An additional wing 3272 having a leading edge 3274 and a trailing edge 3276 may also be positioned radially outward of the airfoil 3202 (e.g., the leading edge 3204 and/or the trailing edge 3206). The deswirling vanes 3243 may extend from a position within the one or more ducts 3230 and towards (e.g., adjacent to the) the outermost edge or opening of the outlet end 3234. The deswirling vanes 3243 may be angled relative to walls of the one or more ducts 3230 such that the flow of air generated by the plurality of propulsion units and flowing through the one or more ducts 3230 is more laminar and has a more uniform velocity at the outlet end 3234. The deswirling vanes 3243 positioned at the outlet end 3234 may include a plurality of deswirling vanes 3243 (e.g., 2, 3, 4, 6, 8, 10, etc.) designed to deliver a more uniform flow to the airfoil 3202. The deswirling vanes 3243 may be one or more rectangular plates which may extend from a bottom-most portion of the outlet end 3234 of the one or more ducts 3230. Additionally, the deswirling vanes 3243 may be positioned around (e.g., radially around) the outlet end 3234 in order to deliver a more uniform airflow to an airfoil 3202. In some embodiments, by including deswirling vanes 3243, the pressure buildup that may occur at the outlet end 3234 due to the positioning of the airfoil 3202 near or adjacent to the outlet end 3234 may be reduced, which can improve the lift of an aircraft.

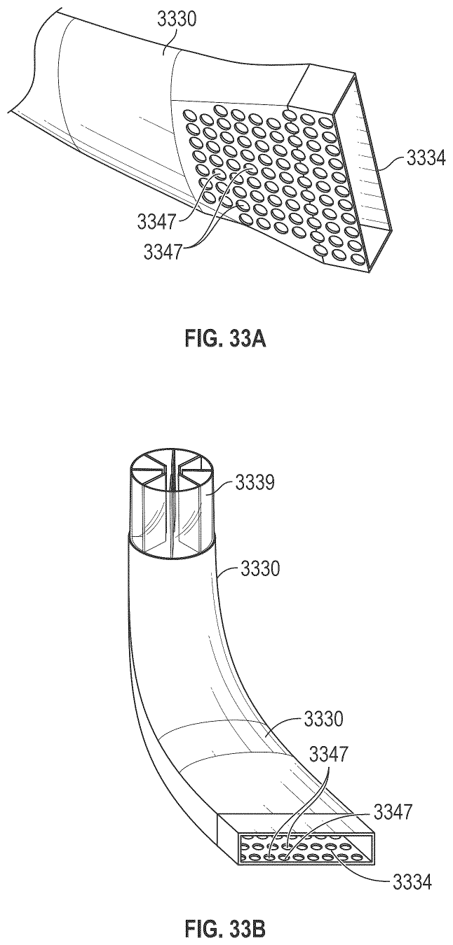

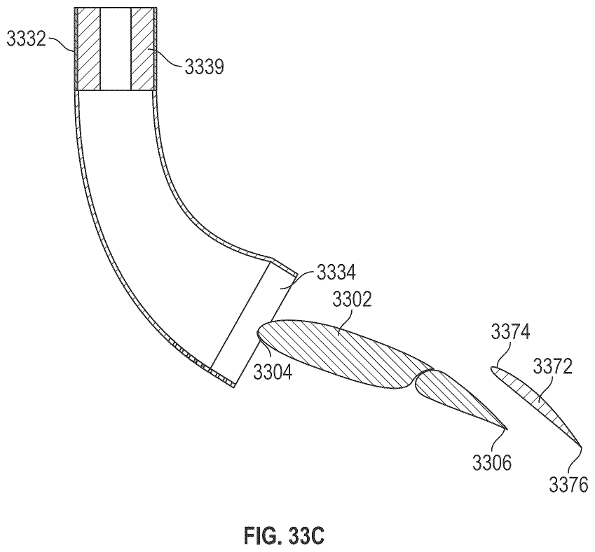

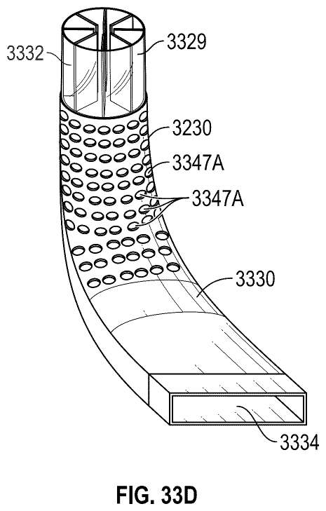

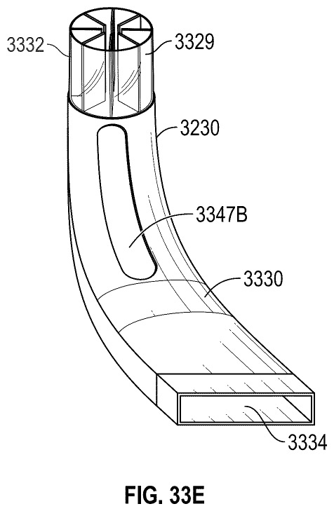

FIGS. 33A-33E illustrate additional embodiments of the one or more ducts 3330 with openings 3347. The ducts 3330 may have many or all of the same or similar features as ducts 130, or any other ducts disclosed herein, and vice versa, and the same reference numbers are used to refer to the same features. The ducts 3330 may have one or more openings 3347 at the outlet end 3334 which may improve airflow to the airfoil 3302.

FIGS. 33A-33C show the outlet end 3334 of the one or more ducts 3330 which can include the one or more openings 3347, shown as a plurality of holes (for clarity only some of the openings 3347 are labelled in FIGS. 33A and 33B). FIG. 33A shows the outlet end 3334 with the one or more openings 3347. FIG. 33B shows a perspective view of the one or more ducts 3330. FIG. 33C shows a cross-sectional view of one or more ducts 3330. The one or more ducts 3330 may include one or more vanes 3339 (e.g., steering vanes 3339) positioned within and at the inlet end 3332. An additional wing 3372 having a leading edge 3374 and a trailing edge 3376 may also be positioned radially outward of the airfoil 3302 (e.g., at the leading edge 3304 or trailing edge 3306). The one or more openings 3347 may be positioned along a bottom-most portion or lower portion of the outlet end 3234, such as a lower sidewall. The one or more openings 3347 may be arranged evenly in a grid like pattern at the outlet end 3334. Additionally, the one or more openings 3347 may be arranged in rows starting from the outermost edge of the outlet end 3334 to a medial or middle area of the outlet end 3334, where the density of openings 3347 in each row may decrease farther away from the outermost edge of the outlet end 3334. In some embodiments, the one or more openings 3347 may reduce the amount of backpressure generated by the airfoil 3302 on the duct exit and can increase the amount of lift that may be generated. The openings 3347 may be circular as shown or other shapes, such as elongated, etc.

FIG. 33D shows a perspective view of the one or more ducts 3330 which can have one or more openings 3347A positioned along the duct between the inlet end 3332 and the outlet end 3334. FIG. 33E shows a perspective view of the one or more ducts 3330 which can have an elongated opening 3347B (e.g., elliptical, rounded) extending between the inlet end 3332 and the outlet end 3334. The one or more openings 3347A may allow the one or more ducts 3330 to draw in air (e.g., in addition to air drawn in at the inlet end 3332) to be delivered to the outlet end 3334 to the airfoil 3302. The additional amount of air delivered to the airfoil 3302 via the one or more openings 3347A may improve the lift of an aircraft. The elongated opening 3347B can allow for a flow of air to be delivered to the one or more ducts 3330 at a region between the inlet end 3332 and the outlet end 3334. In some embodiments, the elongated opening 3347B may allow an additional flow of air (e.g., in addition to air drawn in the at the inlet end 3332) to be delivered to the outlet end 3334 and to the airfoil 3302. The additional amount of air delivered to the airfoil 3302 via the elongated opening 3347B may improve the lift of an aircraft. The one or more openings 3347A and/or the one or more elongated openings 3347B may be located closer to the inlet, or along a middle portion, or closer to the outlet, or any combination of these locations, of the duct 3330. The one or more openings 3347A and/or the one or more elongated openings 3347B may be located on one or more sides or angular positions of the duct wall, e.g. on the top surface of the duct wall, a bottom surface of the duct, and/or one or both lateral sides of the duct wall. The duct 3330 may include one or both of the one or more openings 3347A and the one or more elongated openings 3347B. One or more of the ducts 3330 (for example, one, some, or all of the ducts 3330) may include the one or more openings 3347A and/or the one or more elongated openings 3347B.

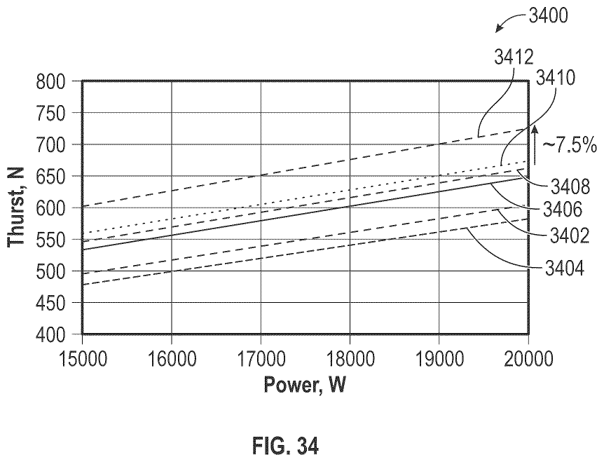

FIG. 34 is a graphical representation 3400 of the amount of thrust (N, newtons) generated versus fan power (W, watts) for varying duct turn angles. A baseline representation 3402 of the one or more ducts (e.g., duct 2930) is included where the duct does not have a turn angle (e.g., turn angle of zero) and is therefore a straight pipe). Line 3404 shows the amount thrust versus power generated when the duct has a turn angle of 32 degrees without an airfoil. Line 3406 shows the thrust versus power generated when the duct has a turn angle of 32 degrees and the airfoil has a t/c ratio of 0.12. Line 3408 shows the thrust versus power generated when the duct has a turn angle of forty five degrees and the airfoil has a t/c ratio of 0.06. Line 3410 shows the thrust versus power generated when the duct has a turn angle of thirty two degrees and the airfoil has a t/c ratio of 0.06. Line 3412 shows the thrust versus power generated when the duct is using an alternative fan, where the alternative fan is expected to provide improved thrust of approximately 7.5% compared to line 3410.

Example Aircraft with Substantially Vertically-Oriented Airfoils

FIGS. 35A-35B illustrate additional embodiments of an aircraft 3500. The aircraft 3500 may have many or all of the same or similar features as aircraft 100, or any other aircraft disclosed herein, and vice versa, and the same reference numbers are used to refer to the same features. In the aircraft 3500, the wing (e.g., airfoil) 3502 is oriented close to vertically, as further described.

The plurality of ducts 3530 may receive a flow of air delivered by a plurality of propulsion units 3520. The plurality of propulsion units 3520 may have a plurality of blades 3522. The flow of air may travel from the inlet end 3532 to the outlet end 3534 of the plurality of ducts 3530 and to a leading edge 3504 of the wing 3502. The flow of air may be delivered by a propulsion unit 3520 which may be a 20″ diameter ducted fan. Thrust may be generated at the inlet end 3532 of the plurality of ducts 3530 to deliver a flow of air to the wing 3502. The plurality of ducts 3530 may be placed within a larger channel 3544. The plurality of ducts 3530 may also be shaped to optimize the airflow velocity at the outlet end 3534 (e.g., reduce the amount of airflow lost due to the plurality of ducts 3530 turning between the inlet end 3532 and the outlet end 3534). The flow of air may travel along the top surface 3508 and the bottom surface 3510 of the wing 3502. The wing 3502 may be couped to the outlet end 3534 with one or more coupling units 3519. The one or more coupling units 3519 may extend radially around the aircraft 3500 and be positioned adjacent to the outlet end 3534.

In some embodiments, the wing 3502 may be oriented substantially vertical or at small angles with respect to a reference axis such as the longitudinal axis Z of the aircraft 3500. The reference axis may be a vertical axis, or an axis aligned with the gravity vector. An angle δ may be defined between the chord 3516 of the wing 3502 and the longitudinal axis Z of the aircraft 3500. The angle δ may be no more than 45 degrees, no more than 40 degrees, no more than 35 degrees, no more than 30 degrees, no more than 25 degrees, or no more than 20 degrees. In some embodiments, the angle δ may be from 25 to 35 degrees, or approximately 30 degrees. The angle δ may change as the wing rotates (or rotates portions thereof, such as flaps, etc.) and changes its angle of attack (a). The angle δ may have any of the values, and the chord and reference axis may have any of the features, described herein with respect to the angle between a reference axis and the chord 2616 (see FIGS. 27A-27E) or the chord 3016 (see FIGS. 30A-30F), and vice versa.

As shown, the duct 3530 may have a turn angle 3537. The turn angle 3537 is the angle between axis 3537A, which is parallel with the direction of the inlet end 3532 of the duct 3530 (the axis 3537A is shown offset from the inlet end 3532 so that the angle is clear), and axis 3537B, which is parallel with the direction of the outlet end 3534 of the duct 3530. The turn angle 3537 may be any of the amounts as described herein, such as from 32 to 45 degrees, etc. The turn angle 3537 may be the acute angle as measured between the axis 3537B and a portion of the axis 3537A that extends below the vehicle.

The aircraft 3500 may include eight or more propulsion units 3520 (e.g., fans) which may generate approximately 1,200 pounds of thrust. The amount of thrust generated by the plurality of propulsion units 3520 can range between 1,000 pounds and 1,400 pounds when eight propulsion units 3520 are incorporated. Additionally, the aircraft 3500 can include more than eight propulsion units 3520 (e.g., ten fans, twelve fans, fourteen fans, sixteen fans). The plurality of ducts 3530 can have an expansion ratio from the inlet end 3532 to the outlet end 3534. The expansion ratio from the inlet to the outlet may be approximately 1:1 (e.g., where the width 3561 or area at the inlet end 3532 is equal to the height 3535 or area at the at the outlet end 3534). Additionally. The expansion ratio may be between 0.5 (e.g., the width 3561 or area at the inlet end 3532 is half as large as the height 3535 or area at the outlet end 3534) and three (e.g., the width 3561 or area at the inlet end 3532 is three times smaller than the height 3535 or area at the outlet end 3534). Other ratios as described herein may be incorporated. In some embodiments, the height 3535 at the outlet end 3534 can be approximately eleven inches. Additionally, the height 3535 at the outlet end 3534 can be between 9 inches and fifteen inches.

The aircraft 3500 may have an outer radius 3512 of about 6.6 ft. The aircraft 3500 may also have an outer radius 3512 between four feet and ten feet. The aircraft 3500 may have a duct turn length 3569 which is the length along a curved centerline of the duct 3530, e.g. as measured from where the duct 3530 begins to bend to where the duct 3530 stops bending (see FIG. 35B). The aircraft 3500 may have a duct turn length 3569 of ten inches. In some embodiments, the duct turn length 3569 may be between 6 inches and fifteen inches. The aircraft 3500 may have a duct length after the turn 3563 of about 4.9 feet. The aircraft 3500 may also have a duct length after the turn 3563 between three feet and six feet. The total duct length may be 2095 mm. Additionally, the total duct length may be between 1400 mm and 3000 mm. The total duct length may be 1499 mm, 1629 mm, 1842 mm, 2018 mm, 2019 mm, 2219 mm, 2301 mm, 2600 mm.

The aircraft 3500 may be capable of holding a passenger and cargo, where the passenger and cargo may weigh approximately 250 lbs. The aircraft 3500 may also weigh approximately 1,000 lbs. In some embodiments, the aircraft 3500 may be capable of carrying a passenger and cargo weighing up to or approximately 1,000 lbs. The aircraft 3500 may weigh approximately 1,800 lbs. The passenger and cargo may be stored in the main portion 3550.

The aircraft 3500 with combined propulsion unit and wing may be able to generate a greater amount of thrust (“T”) than the thrust (“T*”) of a system having only a propulsion unit operating with the same amount of power (i.e. the “thrust ratio” of T/T* as shown in the equations of FIG. 35C). The aircraft 3500 may have a thrust ratio which is dependent on the expansion ratio (i.e., A3/A2) from the inlet end 3532 (e.g., inlet end area A2) to the outlet end 3534 (i.e., outlet end area A3) and the duct deflection angle 3537. For example, see the equations in FIG. 35C. The angle φ represents an angle between a horizontal line (e.g., perpendicular to the longitudinal axis Z) and the direction of the flow of air out of the outlet end 3534. The drag coefficient is represented by C_{d}. The average pressure loss coefficient is represented by ξ. Additionally, the expansion ratio (A3/A2) may be represented by A_{w}. The aircraft 3500 may be capable of generating a thrust ratio between 1.1 and 1.2. Additionally, based on the selected parameters, the thrust ratio may be approximately 1.169, 1.17, 1.185, or 1.173. A list of tables (e.g., Tables 1-3) are reproduced for reference which disclose the thrust ratio based on selected parameters previously disclosed.

TABLE 1

| Parameter | Value |
|---|---|
| Max Thrust Ratio | 1.185 |
| Fan Number | 8 |
| Outer Radius | 6.6 |
| Length of Turn | 12 |
| Length After Turn | 4.5 |
| Duct Deflection | 15 deg (from |
| Angle | vertical) |
| Expansion Ratio | 2.5 |
| Exit Thickness | 11 |

TABLE 2

| Parameter | Value | |
|---|---|---|
| Max Thrust Ratio | 1.173 | |
| Fan Number | 14 | |
| Outer Radius | 9.93 | ft |
| Length of Turn | 11.5 | in |
| Length After Turn | 5 | ft |
| Duct Deflection | 15 deg (from | |
| Angle | Vertical) | |
| Expansion Ratio | 2.74 | |
| Exit Thickness | 13.1 | in |

TABLE 3

| Parameter | Value | |
|---|---|---|
| Max Thrust Ratio | 1.169 | |
| Fan Number | 8 | |
| Outer Radius | 6.6 | ft |
| Length of Turn | 10 | in |
| Length After Turn | 4.9 | ft |

| Duct Deflection | 15 deg (from |
|---|---|
| Angle | Vertical) |
| Expansion Ratio | 2.34 |
| Exit Thickness | 11.2 |

### Example Aerolift System

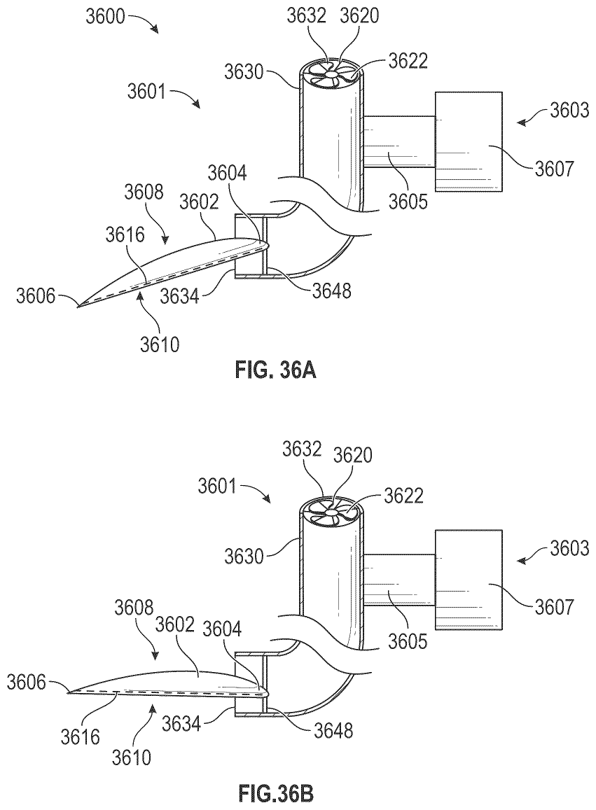

FIGS. 36A and 36B are cross-section views illustrating an example of a system 3600 for generating movement via aerodynamic lifting forces. The system 3600 may have many or all of the same or similar features as aircraft 100, or any other aircrafts or systems disclosed herein, and vice versa, and the same reference numbers are used to refer to the same features. Thus the aerolift system may incorporate any or all of the vertically-oriented wings, the multi-component wings such as a wing with one or more additional wings, and the duct with a particular turn angle, as described above with respect to the particular embodiment of an aircraft. Other applications may use the same basic propulsive design. Various such “aerolift” systems are described herein with respect to FIGS. 36A-45.

As shown in FIGS. 36A and 36B, the system 3600 includes a machine structure 3603 having a supporting structure 3607 and moveable component 3605, each shown schematically. Attached to the moveable component 3605 is an aerolift system 3601. The aerolift system 3601 includes a propulsion unit 3620, a duct 3630, and a lifting body 3602. The propulsion unit 3620 moves air through the duct 3630 and over the lifting body 3602. In this way, the aerolift system 3601 produces movement via aerodynamic lifting forces to cause the moveable component 3605 to move relative to the supporting structure 3607.

The system 3600 may be an elevator, construction vehicle, skycrane, electric vertical take-off and landing (eVTOL) vehicle, helicopter, hovercraft, lift (e.g., ski-lift, utility lift, electric ladder), drill, hover drone, other flying vehicle, weather drone, or other system. The system 3600 may be used with, or include any features shown in, the aircrafts and related systems shown in the Appendix filed herewith. The machine structure 3603 may include a moveable elevator passenger or cargo compartment as the moveable component 3605 and the supporting structure 3607 as a supporting shaft. The machine structure 3603 may include a lifting arm as the moveable component 3605 and the supporting structure 3607 as a construction vehicle body. The machine structure 3603 may also include a helicopter body, a drone body, a satellite body, a weather drone body. Additionally, the supporting structure may also include an external wall, a pole, a ground surface, a ledge, a crane, a bridge, etc. The moveable component may also include containment area, cargo, a rigid pole, a coupling member, a drone body, a grabbing mechanism, etc.

The aerolift system 3601 includes the duct 3630 coupled to the lifting body 3602. FIG. 36A is a cross-sectional view of the system 3600 with the lifting body 3602 at a first orientation (e.g., 30-degree orientation) with one duct 3630 shown. In some embodiments, there can be multiple ducts 3630 positioned on or within the aerolift system 3601. FIG. 36B is a cross-sectional view of the system 3600 with the lifting body 3602 at a second orientation (e.g., 0-degree orientation). The lifting body 3602 may have a leading edge 3604 and a trailing edge 3606. The leading edge 3604 may be located near or within the lower or outlet end 3634 of the ducts 3630. The ducts 3630 may be coupled to one or more propulsion units 3620. The lifting body 3602 may have a top surface 3608, where the top surface 3608 may have a curved profile. The lifting body 3602 may have a bottom surface 3610, where the bottom surface 3610 has a flatter surface relative to the top surface 3608. Therefore, when viewing a cross-sectional profile of the lifting body 3602, the lifting body 3602 may have the profile of an airfoil. Furthermore, the lifting body 3602 may be symmetrical about a longitudinal axis.

In some embodiments, the lifting body 3602 may be generally symmetrical about a longitudinal axis. Additionally, the lifting body 3602 may be shapes that are generally circumferential including but not limited to circular, elliptical, triangular, square, rectangular, pentagonal, hexagonal, heptagonal, octagonal, other polygonal or segmented shapes, or combinations thereof. The lifting body 3602 may have a cross-sectional shape of an airfoil. The cross-sectional profile of the airfoil may be configured so that the top (e.g., upper) side of the airfoil is more curved than a bottom (e.g., lower) side of the airfoil. The airfoil configuration may be useful since it may be capable of generating lift in the system 3600 to move the moveable component 3605. Advantageously, by having an airfoil profile, a flow of air may increase speed upon reaching a leading edge 3604 of the lifting body 3602 and travel over the top, curved portion of the lifting body 3602. The upper curved shape creates a lower pressure zone relative to the high-pressure zone created by slower moving air flowing around the flat contour of the bottom surface 3610 of the lifting body 3602. In some embodiments, having a singular, annular lifting body 3602 may further increase the amount of pressure underneath the lifting body and may improve the lift/drag coefficient to lift the moveable component 3605 more efficiently.

The lifting body 3602 may be mounted at the outlet end 3634 at a variable angle of attack (e.g., 0 degrees, 5 degrees) which may be used, for example, to assist in vertical lift of the aerolift system 3601 to move the moveable component 3605. The angle of attack may be based on the angle which air exiting the duct 3630 meets the leading edge 3604 of the lifting body 3602. The angle may be formed between the chord 3616 of the airfoil and the direction of the relative air flow from the outlet end 3634. The first mounting angle as shown in FIG. 36A may provide a first angle of attack that provides the desired amount of lift and allows a plurality of propulsion units 3620 to operate at an optimal speed to provide vertical lift. The lifting body 3602 may then rotate to a second mounting angle as shown in FIG. 36B to provide a second angle of attack which may provide a relatively smaller lifting force as compared to the first angle of attack.

In some embodiments, a flow of air (e.g., flow of environmental air) is delivered to the leading edge 3604 of the lifting body 3602 from the outlet end 3634 of each of the ducts 3630. The flow of air may first be delivered to the leading edge 3604 and travel over the top surface 3608 and the bottom surface 3610. The flow of air traveling from the leading edge 3604 to the trailing edge 3606 along the top surface 3608 may flow at a relatively greater speed, compared to air flowing along the bottom surface 3610, due to the curved profile of the top surface 3608, resulting in a relatively lower air pressure exerted on the upper portion of the lifting body 3602 as compared to the pressure on the bottom surface 3610. The flow of air from the leading edge 3604 to the trailing edge 3606 along the bottom surface 3610 may flow at a relatively lower speed, compared to air flowing along the top surface 3608, due to the flatter profile (e.g., compared to the top surface 3608) of the bottom surface 3610, resulting in a relatively greater air pressure exerted on the bottom surface 3610 of the lifting body 3602 as compared to the pressure on the top surface 3608. The pressure differential between the bottom surface 3610 and the top surface 3608 causes a lifting force applied upward to the lifting body 3602, which may be transferred to the aerolift system 3601 and/or the machine structure 3603 (e.g., the moveable component 3605 and supporting structure 3607).

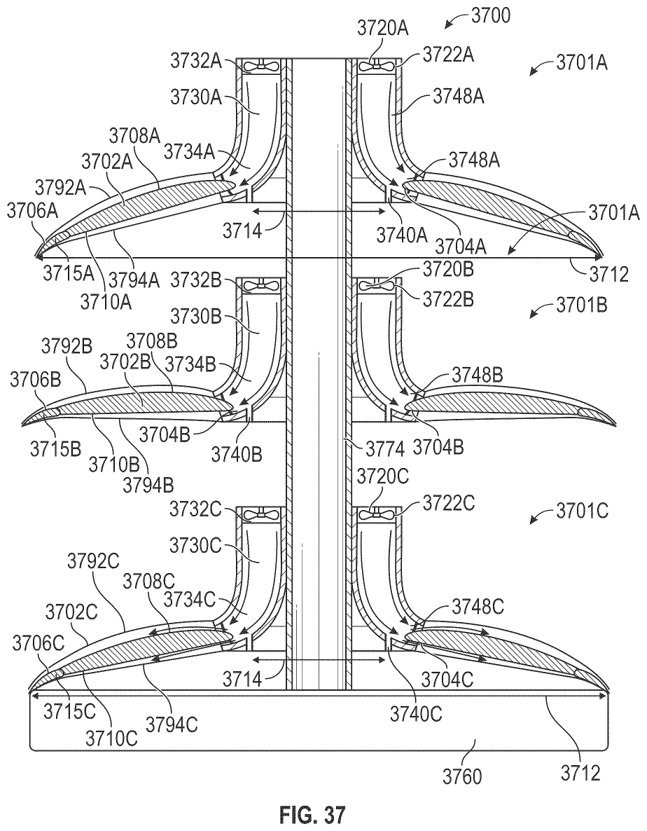

The plurality of ducts 3630 may be coupled to the lifting body 3602. Additionally, or alternatively, the system may be coupled to a compartment 3760, such as a passenger or other compartment (see, for example, FIG. 37). The plurality of ducts 3630 may extend from an inlet end 3632 to an outlet end 3634. In some examples, the length or shape of the ducts 3630 may be configured to provide a desired speed and direction of airflow to provide streamlined airflow and a desired amount of lift necessary for the operational requirements of the aerolift system 3601 to move the moveable component 3605. The length of the ducts 3630 may determine how long of a path the flow of air has to travel from the inlet end 3632 to the outlet end 3634. The longer the length of the ducts 3630, the lower the flow rate of the air is at the outlet end 3634 due to friction and turbulence experienced by the air in the ducts 3630. Therefore, in some embodiments, the length of the ducts 3630 may be configured to be as short as possible to increase the flow rate of air at the outlet end 3634. In some embodiments, the extended length of the ducts 3630 may be two feet. Additionally, the extended length of the ducts 3630 may be ten feet. In some embodiments, the extended length of the ducts 3630 may be between one foot and twelve feet. Furthermore, the ratio of length of the ducts 3630 to a diameter of a blade 3622 may be 2:1 (e.g., length of the ducts is two times longer than the diameter of the blades 3622 of the propulsion units 3620). Additionally, in some embodiments, the ratio between the length of the ducts 3630 and the diameter of a blade 3622 may be between 1:1 to 4:1. The duct 3630 can define a channel that “turns” from the inlet to the outlet. There may be various turn angles. The duct 3630 may have an inlet oriented vertically or generally vertically. A longitudinal axis of the inlet may be parallel with a vertical longitudinal axis of the system. The axis of the inlet may be within two, five, ten, twenty or thirty degrees of a vertical axis. The outlet of the duct 3630 may be angled with respect to the inlet. A longitudinal axis of the outlet may be at an angle from ten to sixty degrees, from twenty to fifty degrees, or from thirty to forty degrees, relative to a longitudinal axis of the inlet. The axes may be at other relative angles, such as about ninety degrees as shown in the figures. Further, the lifting body 3602 may be outside or inside or partially inside the duct 3630. The lifting body 3602 may be positioned a distance away from the exit of the duct 3630. The lifting body 3602 may be positioned vertically relative to the outlet opening of the duct 3630. A chord line of the lifting body 3602 may be positioned aligned with, or unaligned with (located vertically upward or downward relative to), a central longitudinal axis of the outlet of the duct 3630 exit.

The inlet end 3632 and the outlet end 3634 may be circular or generally circular (e.g., ovular). The inlet end 3632 and outlet end 3634 may be shaped to permit a desired flow of air to enter the propulsion units 3620. The inlet end 3632 and outlet end 3634 of the ducts 3630 may have a diameter configured to provide a desired amount of airflow to the leading edge 3604 of the lifting body 3602. In some examples, the diameter of inlet end 3632 may be approximately two feet. Additionally, in some examples, the diameter of the inlet end 3632 may range from eight inches to sixteen inches, from sixteen inches to thirty-two inches, or from thirty-two inches to seventy-two inches. In some embodiments, the diameter of the inlet end 3632 of the ducts 3630 corresponds to the diameter of the propulsion units 3620. In some examples, the diameter of the outlet end 3634 may be approximately two feet. Additionally, in some examples, the diameter of the outlet end 3634 may range from eight inches to sixteen inches, from sixteen inches to thirty-two inches, or from thirty-two inches to seventy-two inches. The ratio of diameter between the inlet end 3632 and the outlet end 3634 may be between 1:1 to 4:1. Therefore, the ducts 3630 may taper from the inlet end 3632 to the outlet end 3634.

In some embodiments, the plurality of ducts 3630 may be grooved or include a plurality of grooves (e.g., vanes) on an inner wall of the ducts 3630. The grooves may extend from the inlet end 3632 to the outlet end 3634 of the ducts 3630 and may reduce turbulent flow of air. Grooves may allow for streamlining airflow (e.g., laminar flow) and better control the airflow velocity as it reaches the leading edge 3604 of the device. For each embodiment the wall thickness of the ducts 3630 is sufficient to maintain shape under nominal and operational environmental stresses from pressure and temperature changes. In some embodiments, the plurality of ducts 3630 may taper, (e.g., decrease in cross-sectional area, from the inlet end 3632 to the outlet end 3634), which may increase the air pressure from the inlet end 3632 to the outlet end 3634 and increase the speed of the air at the leading edge 3604. Tapering the duct 3630 may allow the propulsion unit 3620 to operate at increased or slower speeds, depending on geometry, to deliver a desired amount of air to the leading edge 3604.

In some embodiments, the plurality of ducts 3630 may also have a flap or bypass valve 3740 positioned along a bottom edge of the ducts 3630 (shown, at least, in FIG. 37). The bypass valve 3740 may be a hinged member, rudder, etc., that is moveable to reveal a slot or other opening in the duct 3630. The bypass valve 3740 may allow a flow of air to exit the ducts 3630 through an opening 3741 before reaching the leading edge 3604 of the lifting body. Therefore, the bypass valve 3740 may be designed to create additional vertical lift when the flow of air exiting the ducts through opening 3741 is directed downwards. For example, directing a desired flow of air downward from the bypass valve 3740 can directly generate lift which can supplement the lift generated by directing a flow of air across the lifting body 3602, which may increase the net vertical lifting force during the rising phase of the elevator system. The bypass valve 3740 may be on a vertical portion of the duct 3630, on a horizontal portion of the duct 3630, or as shown on an angled or curved portion of the duct 3630.

In some embodiments, a set of propulsion units 3620 (e.g., rotors, propellers, ducted fans, turbofans, and/or the like) may be mounted at the inlet end 3632 of the ducts 3630. The propulsion units 3620 may comprise a plurality of blades 3622 extending from a central hub. In some embodiments, the blades in the propulsion units 3620 may have a variable blade pitch to optimize energy consumption during flight. A motor within each propulsion unit may rotate the blades 3622 via the hub. In some embodiments, each of the propulsion units 3620 may be independently controlled (e.g., different pitch, spin/rotate to generate a flow of air independently of each other, such that each propulsion unit 3620 may generate a different flow level than the others). Independently controlling the propulsion units 3620 may allow each propulsion unit 3620 to rotate at a particular speed or deliver a different amount of air to a section of the leading edge of the lifting body 3602. By configuring the plurality of propulsion units 3620 to rotate the blades 3622 at various, independently controlled speeds, the aerolift system 3601 may, adequately lift and lower the machine structure 3603 and/or moveable component 3605 based on the operating conditions experienced by the aerolift system 3601. Operating the different propulsion units 3620 independently may also be used to stabilize flight, even in a stationary hover, such as to account for turbulence, wind, movement of payloads and/or passengers, and/or the like.

In some embodiments, the one or more propulsion units 3620 may be oriented in a vertical and/or downward facing direction to provide lift to the aerolift system 3601. Other embodiments may orient the propulsion units 3620 angled, vertical, or other orientations. It should be noted that, although various embodiments described herein depict the propulsion units 3620 at the inlet end 3632 of the ducts 3630, other embodiments may position the propulsion units 3620 differently. For example, the propulsion units 3620 may be positioned within the ducts 3630, such as at an intermediate point between the inlet end 3632 and outlet end 3634. The propulsion units 3620 may be equidistantly distributed along a circular path around a central portion and/or lifting body 3602 or may be spaced differently. The series of ducts 3630 may be coupled to each of the propulsion units 3620 and equidistantly spaced or spaced differently. The propulsion units 3620 may be configured, such that a flow of air being drawn into the channels reaches a particular area (e.g., segment) of the lifting body 3602. Therefore, the system 3600 may have the optimal amount of airflow drawn to the entire lifting body (and/or to a substantial portion of the lifting body 3602) to lift/lower the moveable component 3605.

The plurality of propulsion units 3620 may be operated by a controller 212, such as one or more processors, based on user inputs 211 and/or autonomous controller 214 and/or sensors 202 (see, for example, FIG. 10). The plurality of propulsion units 3620 may be coupled to independently controlled motors 230 that are operated to lift the system 3600 upwards or lower the system 3600 downwards (e.g., on or within a building). The motors 230 may operate to spin the plurality of blades 3622 to deliver air to the ducts 3630. The plurality of blades 3622 may be coupled to the hub and to the motor 230, which may be configured to rotate or swivel the hub and the plurality of blades 3622. The plurality of blades 3622 may have a fixed span (e.g., length). In some cases, the plurality of blades 3622 may have a length and/or blade pitch that varies to deliver an optimized flow of air to the ducts 3630. In some embodiments, rotating or swiveling the propulsion units 3620 and therefore the plurality of blades 3622, may vary the blade pitch. Additionally, in some embodiments, the blade pitch may be varied by oil pressure or centrifugal weights which may be attached directly to the plurality of blades 3622. The plurality of blades 3622 may be shrouded in a case which houses the motor 230, blades 3622, and hub. Additionally, the plurality of propulsion units 3620 may each deliver approximately fifty to two-hundred and fifty N of thrust (e.g., spin the blades 3622 at a fast enough speed to generate the desired force). The plurality of propulsion units 3620 may have a diameter of about 12 inches. However, in some cases the diameter of the propulsion units 3620 (e.g., the diameter of the case or shroud) may range from six inches to sixteen inches, from sixteen inches to thirty-two inches, or from thirty-two inches to seventy-two inches.

The plurality of propulsion units 3620 may be coupled to an electric motor (e.g., motors 230) or a piston engine (e.g., powered by fossil fuel). In some embodiments, the propulsion units 3620 may be electric propulsion units capable of delivering up to two-hundred and fifty newtons of thrust at fifteen kW of power. In some embodiments, the propulsion units 3620 may have a casing with an inside diameter of one hundred and ninety-five mm. The casing may, in some embodiments, have an inside diameter between one hundred mm and 300 mm. The total area of the rotating plurality of blades 3622 may be approximately two hundred and fifteen cm² (e.g., thirty-three in²). The amount of input power may range between four kW and twenty-five kW. Additionally, the static thrust range may be between fifty and three hundred and fifty N. The RPM range of the propulsion units 3620 may be 10,000-18,000 RPM (e.g., the plurality of blades 3622 spin at 10,000-18,000 RPM). The total weight of each propulsion unit 3620 may be between 36000 g to 3400 g (e.g., about 7.5 lbs.).

The lifting body 3602 may be mounted to the outlet 3634 of the ducts 3630 via a series of supports 3648 (e.g., high strength tie rods, axles, cables, and the like). The supports 3648 may also connect to an area adjacent to the leading edge 3604 of the lifting body 3602. By using the supports 3648, the angle of the lifting body 3602 relative to the direction of incoming air from the duct 3630 may be varied. The supports 3648 may be configured to adjust the angle (e.g., angle of attack) of the lifting body 3602 to achieve an amount of lifting force. The supports 3648 may also extend or retract the lifting body 3602 further into or outside of duct 3630. Advantageously, using supports 3648 to couple the lifting body 3602 to the plurality of ducts 3630 may lead to significant weight reduction in the aerolift system 3601. Additionally, in some embodiments, the supports 3648 may further connect the lifting body 3602 to other portions of the aerolift system 3601.

Various embodiments disclosed herein may be configured for a system 3600 which may have a cargo area or moveable component 3605 disposed beneath or within the aerolift system 3601 (see, for example, FIG. 37). However, the disclosures herein may be used for a system 3600 which may be designed to lift persons, items, packages, other payloads, and/or the like within the cargo area (which may also be referred to as a payload compartment, passenger compartment, and the like) at the machine structure 3603. In some embodiments, the system 3600 may be designed to lift 50 lbs., to transport packages from one floor of a building to another floor (e.g., higher or lower floor). Furthermore, the aerolift system 3601 may be designed and sized to hold 2500 lbs. at the machine structure 3603 (e.g., moveable component 3605), which may include a number of individuals and their personal items. In some embodiments, the aerolift system 3601 may be designed lift 25 lbs., 3600 lbs., 500 lbs., 36000 lbs., 2000 lbs., 3000 lbs., 4000 lbs. 5000 lbs, and/or 6000 lbs. located at the moveable component 3605 and/or at the machine structure 3603. Additionally, in some embodiments, the machine structure 3603 can be a freight elevator and can be designed to hold 40,000 lbs. In some embodiments, the freight elevator may be designed to hold 10,000, lbs., 20,000 lbs., 30,000 lbs., 40,000 lbs., 50,0000 lbs., and/or 60,000 lbs.

The system 3600 can be operated according to block diagram 200 (see, FIG. 7). The system 3600 may be used in or with the various other systems described herein, such as aircraft 100, and used with the techniques disclosed herein. The system 3600 may have sensors 202, a receiver 210, the controller 212, a data storage module 213, a transmitter 218, a power source 223, motor driver(s) 222, and motors(s) 230. The sensors 202 in the system 3600 may include at least one of a gyroscope 204, accelerometer 206, magnetometer 208, and/or other sensors 202 (e.g., an optical sensor, thermometer, barometer, altimeter, camera, etc.).

The system may also allow for user input(s) 211 to control various aspect of the system. For example, in the passenger compartment 3660 there may be one or more buttons or control panels which may be operated to lift and/or lower the system 3600.

The controller 212 may also be used to perform certain functions while the device operational. In some embodiments, the data storage module 213 may have programming instructions which may be used to the amount of lift generated by the one or more propulsion units 3620. For example, there may be programmed instructions to indicate to a user that the power source is low on energy and the system 400 need to be shut down for a period of time.

The data storage module 213 may store information and data. The data storage module 213 may have read-only memory for the process to execute programmed functions. The data storage module 213 may also have writeable memory to store various programmed features. The data storage module 213 does not need to have both read-only memory or writeable memory.

The transmitter 218 may be used to receive data from the controller 212 to send the signal to another location (e.g., computer, remote server for storage and/or analysis). For example, the transmitter 218 may be used to send data to a or to a central hub to review/analyze maintenance conditions.

The motor driver 222 may be configured to receive instructions from the controller 212 which may be used to adjust the speed or blade pitch or rotor axis of the various motors 230 coupled to the various propulsion units 3620 of the system 3600. There may be more than one motor driver 222 controlling the motors 230 to assist in the independent operation of each of the propulsion units 3620. The motors 230 are connected to the motor driver 222 and receive instructions from the controller 212 to operate at various speeds to lift the system 3600. Although not shown, a motor driver 222 may be connected to the supports 3648 to move the supports 3648 to different positions to adjust the mount angle of the lifting body 3602.

The power source may also be included in the system 3600 to power each of the components and features of the system 3700. Although no line is drawn from the power source to each component, each component is either directly or indirectly coupled to the power source. The power source 223 may be a direct power connector (e.g. plug with chord) or based on fossil fuel, or electric battery which may be recharged, or live power such as based on solar energy. Additionally, there may be alternative power sources 223 (e.g., solar) which may be used to power the system 3600.

### Example Machine System-Elevator

FIG. 37 illustrates an embodiment of a system 3700 for generating movement via aerodynamic lifting forces shown as an elevator system. The system 3700 may cause a passenger compartment 3760 or cab to travel upwards and/or downwards along a central spine 3774. The system 3700 includes components from many of the systems disclosed herein to permit the aerolift system to travel up a central spine 3774. The system 3700 may include one or more aerolift systems 3701A, 3701B, 3701C, such as three as shown, or one, two, four, five, six, seven, eight, nine, ten, or more, and which may include or incorporate many or all of all of the features described in system 200 and aerolift system 3601, or any other system disclosed herein.

The supporting structure is shown as a supporting spine 3774, such as an elevator shaft. The aerolift systems 3701A, 3701B, 3701C are coupled to the central spine 3774. The central spine 3774 may be located inward of the plurality of ducts 3730 and is parallel to a longitudinal centerline of the aerolift systems 3701A, 3701B, 3701C. The aerolift systems 3701A, 3701B, and 3701C may all be coupled to each other and may be configured to travel vertically or translate along the central spine 3774. The bottom system (e.g., aerolift system 3701C) may be directly connected to an elevator cab or payload area or passenger compartment 3760. The passenger compartment 3760 may be capable of containing persons, cargo, and/or other materials. Advantageously, having the multiple aerolift systems 3701A, 3701B, 3701C connected may increase the amount of lift generated and can allow for the system 3700 to operate in smaller spaces. For example, in buildings with smaller elevator shafts, the aerolift systems 3701A, 3701B, 3701C can have a smaller diameter (e.g., outer diameter 3712) and still generate enough lift to travel between floors of a building.

The aerolift systems 3701A, 3701B, 3701C may have a plurality of ducts 3730 (ducts 3730A, ducts 3730B, ducts 3730C). The plurality of ducts 3730 may be spaced annularly around the central spine 3774. An inner wall of the plurality of ducts 3730 may be attached to an outer surface of the central spine 3774. The inner wall of the plurality of ducts 3730 may be slidably or otherwise coupled to reduce the amount of friction between the central spine 3774 and the plurality of ducts 3730 (e.g., pulley, trolley, slide, gears, groove, etc.) The plurality of propulsion units 3720 (e.g., 3720A, 3720B, 3720C) may be positioned near the inlet end 3732 (e.g., 3732A, 3732B, 3732C) of the plurality of ducts 3730. The plurality of propulsion units 3720 may be designed to provide a flow of air which can be used to create a vertical force (e.g., parallel to the longitudinal axis) to lift all of the coupled aerolift systems 3701A, 3701B, 3701C.

The flow of air generated by the plurality of propulsion units 3720 can be delivered to the leading edge (e.g., leading edge 3704A, 3704B, 3704C) of the lifting bodies (e.g., lifting bodies 3702A, 3702B, 3702C) at the exit end (e.g., exit end 3734A, 3734B, 3734C) of the plurality of ducts 3730. The flow of air can travel along the top surface (e.g., top surface 3708A, 3708B, 3708C) and the bottom surface (e.g., bottom surface 3710A, 3710B, 3710C) of the lifting bodies 3702A, 3702B, 3702C. The flow of air traveling along the top surface 3708 from the leading edge 3704A, 3704B, 3704C to the trailing edge 3706A, 3706B, 3706C may flow at a relatively greater speed compared to the air flowing along the bottom surface 3710A, 3710B, 3710C, due to the curved profile of the top surface 3708A, 3708B, 3708C. By having air flowing at a faster speed over the top surface 3708A, 3708B, 3708C relative to the bottom surface 3710A, 3710B, 3710C, the lifting body 3702A, 3702B, 3702C may have lower pressure over the top surface 3708A, 3708B, 3708C relative to the bottom surface 3710A, 3710B, 3710C. Therefore, a pressure differential (e.g., the lower pressure on the top surface 3708A, 3708B, 3708C relative to the higher pressure on the bottom surface 3710A, 3710B, 3710C) may cause a lifting or vertical force to be applied to the lifting body 3702A, 3702B, 3702C to allow the aerolift systems 3701A, 3701B, 3701C to travel upwards along the central spine 3774.

The plurality of propulsion units 3720 may also be configured to stop running or operate at a speed which allows the aerolift systems 3701A, 3701B, 3701C to drop or descend. The plurality of propulsion units 3720 may be configured to create a vertical force which does not exceed the gravitational force of the aerolift systems 3701A, 3701B, 3701C and the aerodynamic forces exerted on the system. The plurality of propulsion units 3720 may have plurality of blades 3722A, 3722B, 3722C which rotate slower when the aerolift systems 3701A, 3701B, 3701C are descending than when the aerolift systems 3701A, 3701B, 3701C are traveling upwards (e.g., rising, lifting).

In some embodiments, the system 3700 may include three aerolift systems each coupled together (e.g., aerolift system 3701A, aerolift system 3701B, aerolift system 3701C). However, in some embodiments, the system 3700 may contain anywhere from one to six aerolift systems (or more in some embodiments). The lifting body 3702 (e.g., 3702A, 3702B, 3702C) may have an outer diameter 3712 and an inner diameter 3712. The ratio of the outer diameter 112 to the inner diameter 3714 may be 2:1 or greater, 3:1 or greater, 4:1 or greater, about 3:1, or about 4:1. The outer diameter 3712 of the lifting body 3702 may be approximately thirty feet and the inner diameter may be about ten feet. Additionally, in some embodiments, the outer diameter 3712 of the lifting body 3702 may be between twenty feet to sixty feet. In smaller versions of the system 3700, the inner diameter 3714 may be from one to ten inches, and the outer diameter 112 may be from three to fifty inches. Additionally, each of aerolift systems 3701A, 3701B, 3701C may be sized differently (e.g., have different lifting body diameters). Advantageously, by having a variety of lifting body diameters (e.g., outer diameter 3712) the amount of energy required to operate the system 3700 may be reduced.

The lifting bodies (e.g., lifting body 3702A) may be independently rotatable or actuatable. The angle of each lifting body (e.g., lifting body 3702A) in the system 3700 may be able to change independently of another lifting body (e.g., lifting body 3702B) to achieve a desired lifting or vertical force to move the systems up the central spine 3774. In some embodiments, the systems 3701A, 3701B, and 3701C may be coupled to a set of rollers positioned on an outside surface of the central spine 3774 which may allow the aerolift systems 3701A, 3701B, 3701C to freely slide along the central spine 3774.

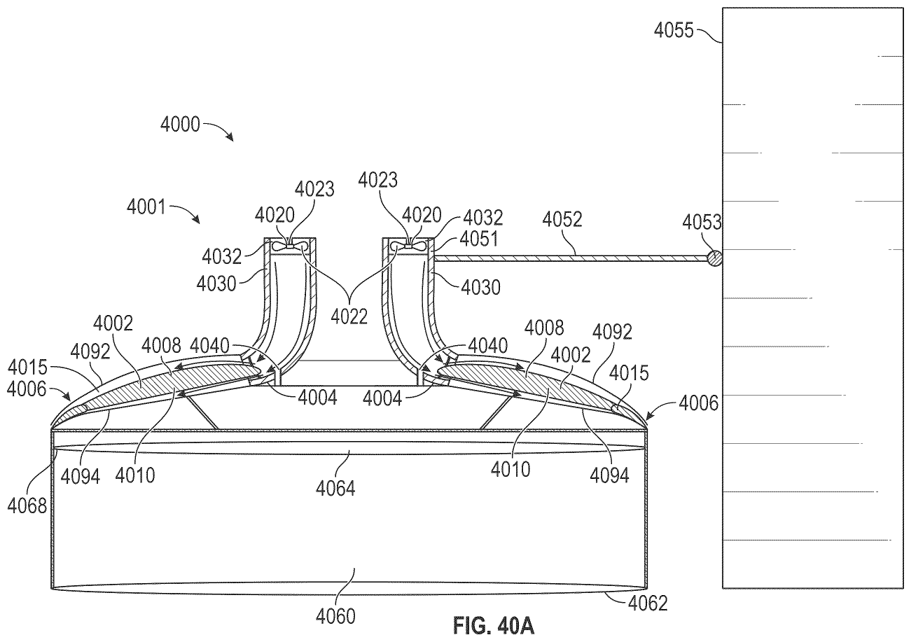

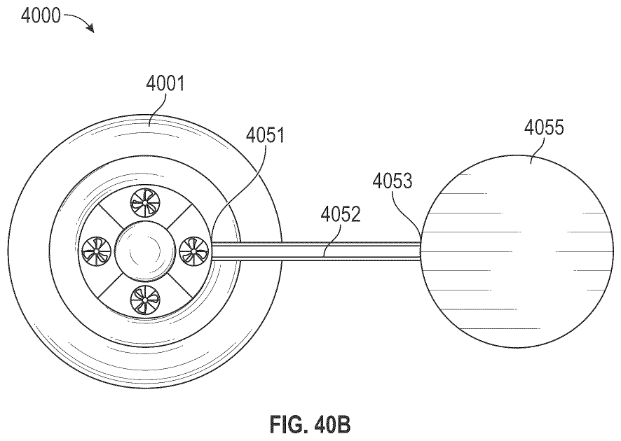

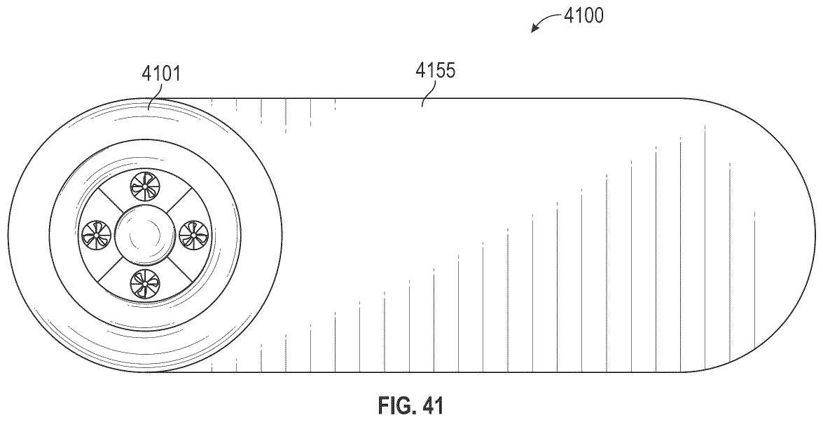

Advantageously, the aerolift systems 3701A, 3701B, 3701C may not require a machine room to travel up and down a building (when compared to current cable or hydraulic based elevator systems). Since the plurality of propulsion units 3720 are positioned within the aerolift systems 3701A, 3701B, 3701C and may be configured to lift and lower the system 3700, a machine room may be unnecessary. Additionally, by using the aerolift systems 3701A, 3701B, 3701C, no oils and/or pistons may be necessary to lift and lower the aerolift systems 3701A, 3701B, 3701C and or passenger compartment 3760 up the central spine 3774. Advantageously, this can reduce maintenance costs due to replacement parts, routine upkeep, or staffing. Additionally, the aerolift systems 3701A, 3701B, 3701C can be attached externally to buildings (see, for example, FIG. 40A). Having aerolift systems 3701A, 3701B, 3701C positioned externally may allow for the floorplan of a building to include more offices, apartments, rooms, etc. Additionally, for other external structures, like construction sites, system 3700 can be attached to the side of beams to translate the passenger compartment 3760 (e.g., or other item, device, car, construction item, etc.) up and down the beams. In some embodiments, the wing 102 may have ailerons 115 mounted on the top surface 108 near the trailing edge 106

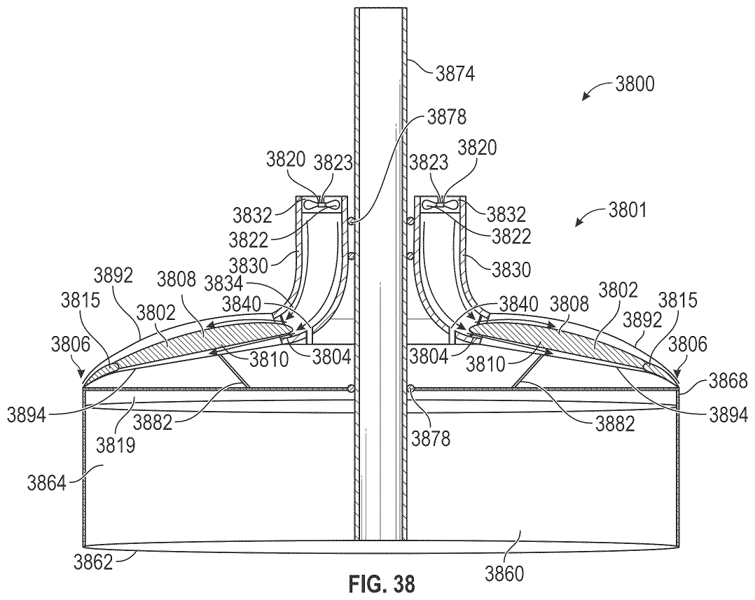

FIG. 38 illustrates an additional embodiment of a system 3800 for generating movement via aerodynamic lifting forces shown as an elevator system. The system 3800 may have many or all of the same or similar features as system 3700, or any other system disclosed herein, and the same reference numbers are used to refer to the same features. The system 3800 may include a plurality of gears 3878 configured to lift and lower the passenger compartment 3860 along the central spine 3874. The plurality of gears 3878 may be coupled to an internal portion of the aerolift system 3801 and may be positioned internally to the ducts 3830. Advantageously, having the plurality of gears 3878 coupled to the system 3800 can efficiently lift and lower the system along the central spine 3874.

The aerolift system 3801 may have a plurality of ducts 3830. The plurality of ducts 3830 may be spaced annularly around the central spine 3874. An inner wall of the plurality of ducts 3830 may be attached to an outer surface of the central spine 3874. The plurality of propulsion units 3820 may be positioned near the inlet end 3832 of the plurality of ducts 3830. The plurality of propulsion units 3820 may be designed to provide a flow of air which can be used to create a vertical force (e.g., parallel to the longitudinal axis) to lift the aerolift system 3801.

The flow of air generated by the plurality of propulsion units 3820 can be delivered to the leading edge 3804 of the lifting bodies 3802 at the exit end 3834 of the plurality of ducts 3830. The flow of air can travel along the top surface 3808 and the bottom surface 3710 of the lifting bodies 3802. The flow of air traveling along the top surface 3808 from the leading edge 3804 to the trailing edge 3806 may flow at a relatively greater speed compared to the air flowing along the bottom surface 3810, due to the curved profile of the top surface 3808. By having air flowing at a faster speed over the top surface 3808 relative to the bottom surface 3810, the lifting body 3802 may have lower pressure over the top surface 3808 relative to the bottom surface 3810. Therefore, a pressure differential (e.g., the lower pressure on the top surface 3808 relative to the higher pressure on the bottom surface 3810) may cause a lifting or vertical force to be applied to the lifting body 3802 to allow the aerolift system 3801 and passenger compartment 3860 to travel upwards along the central spine 3874.

The plurality of propulsion units 3820 may also be configured to stop running or operate at a speed which allows the aerolift system 3801 to drop or descend. The plurality of propulsion units 3820 may be configured to create a vertical force which does not exceed the gravitational force of the aerolift system 3801 and the aerodynamic forces exerted on the system. The plurality of propulsion units 3820 may have plurality of blades 3822 which rotate slower when the aerolift system 3801 is traveling upwards (e.g., rising, lifting).

The plurality of gears 3878 may be configured to guide the system 3800 along the central spine 3874. For example, the plurality of gears 3878 may allow the system 3800 to travel upwards when a flow of air is delivered to the aerolift system 3801 by the plurality of propulsion units 3820. When a lifting force is applied to the lifting body 3802 via the plurality of propulsion units 3820, the plurality of gears 3878 can engage the central spine 3874 to translate the aerolift system 3801 upwards. In some embodiments, the plurality of gears 3878 can engage the central spine 3874 to prevent the aerolift system 3801 from traveling upwards or downwards when a desired height and or floor of a building is reached. The plurality of gears 3878 may allow the aerolift system 3801 to travel downwards when a flow of air is not delivered to or reduced to the plurality of ducts 3830.

In some embodiments, the aerolift system 3801 may contain anywhere from one lifting body and duct system to six lifting bodies and duct systems (or more in some embodiments). The lifting body 3802 may have an outer diameter 3812 and an inner diameter 3812. The ratio of the outer diameter 3812 to the inner diameter 3814 may be 2:1 or greater, 3:1 or greater, 4:1 or greater, about 3:1, or about 4:1. The outer diameter 3812 of the lifting body 3802 may be approximately thirty feet and the inner diameter may be about ten feet. Additionally, in some embodiments, the outer diameter 3812 of the lifting body 3802 may be between twenty feet to sixty feet. In smaller versions of the aerolift system 3801, the inner diameter 3814 may be from one to ten inches, and the outer diameter 3812 may be from three to fifty inches.

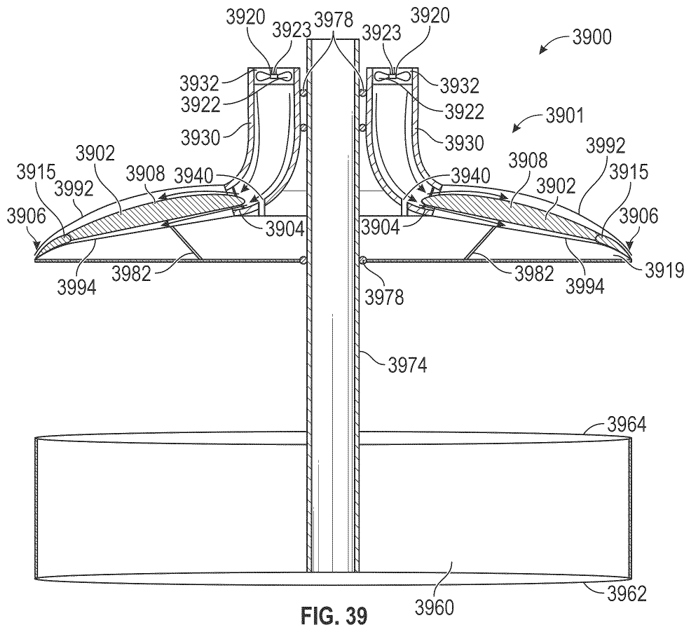

FIG. 39 illustrates an additional embodiment of a system 3900 for generating movement via aerodynamic lifting forces shown as an elevator system. The lift system 3900 may have many or all of the same or similar features as system 3700 or 3800, or any other system disclosed herein, and the same reference numbers are used to refer to the same features. The system 3900 may include a passenger compartment 660 detached from the system 3900. In some embodiments, the aerolift system 3601 can be configured to translate the passenger compartment 3960 along a belt 3974 coupled to a plurality of gears 3978. The belt 3974 can be attached to a top portion 3964 of the passenger compartment 3960.

The aerolift system 3901 may have a plurality of ducts 3930. The plurality of ducts 3930 may be spaced annularly around the belt 3974 and plurality of gears 3978. The plurality of propulsion units 3920 may be designed to provide a flow of air which can be used to create a vertical force (e.g., parallel to the longitudinal axis) to lift the aerolift system 3901. When the aerolift system 3901 begins to lift, the plurality of gears 3978 attached to the aerolift system 3901 may drive the belt 3974 upwards and correspondingly lift the passenger compartment 3960. When the aerolift system 3901 begins to descend, the plurality of gears 3978 attached to system 3900 may drive the belt 3974 downwards and lower the passenger compartment.

FIGS. 40A-40B illustrate an additional embodiment of a system 4000 for generating movement via aerodynamic lifting forces shown as an elevator system. The lift system 4000 may have many or all of the same or similar features as system 3700, or any other system disclosed herein, and the same reference numbers are used to refer to the same features. The aerolift system 4001 may be externally coupled to a building. Additionally, the passenger compartment 4060 may be directly coupled to the system 4000.

The aerolift system 4001 may have a plurality of ducts 4030 and a plurality of propulsion units 4020. The plurality of propulsion units 4020 may be positioned near the inlet end 4032 of the plurality of ducts 4030. The plurality of propulsion units 4020 may be designed to provide a flow of air which can be used to create a vertical force (e.g., parallel to the longitudinal axis) to lift the aerolift system 4001 and passenger compartment 4060. An outer wall of the plurality of ducts 4030 may be attached (e.g., fixed) at a first position 4051 to a connector 4052 which can couple the aerolift system 4001 to the building 4055. The connector 4052 may couple to the wall or building 4055 via a trolley 4053 or other suitable method (e.g., railing, slot, etc.) for translating the aerolift system 4001 and passenger compartment 4060 upwards and downwards. Advantageously, this can allow the aerolift system 4001 to easily connect to already built structures to permit vertical lift. Additionally, the building 4055 can be any suitable structure which requires a vertical lifting system (e.g., building, beam structure, skyscraper, etc.).

FIG. 41 illustrates an additional embodiment of a system 4100 for generating movement via aerodynamic lifting forces shown as an elevator system. The lift system 4100 may have many or all of the same or similar features as system 3700, or any other system disclosed herein, and the same reference numbers are used to refer to the same features. The aerolift system 4101 may be internally coupled to a leftmost side or a rightmost side of a building 4155. Advantageously, positioning the aerolift system 4101 at a side of the building 4155 may allow the building 4155 to have more available space in a middle or medial area.

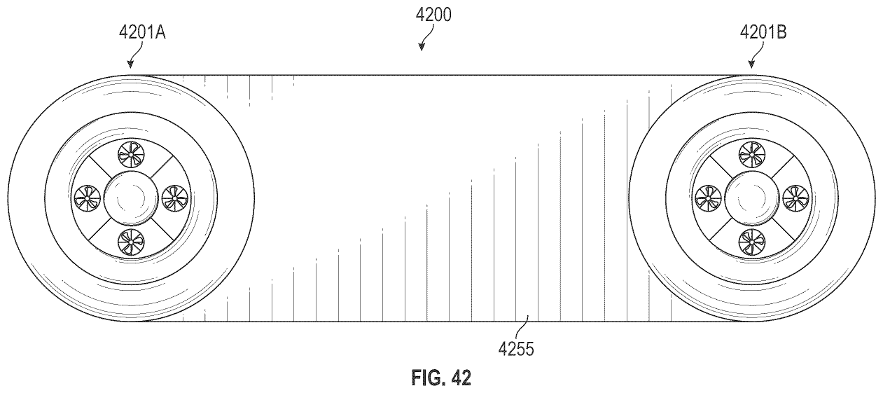

FIG. 42 illustrates an additional embodiment of a system 4200 for generating movement via aerodynamic lifting forces shown as an elevator system. The system 4200 may have many or all of the same or similar features as system 3700, or any other system disclosed herein, and the same reference numbers are used to refer to the same features. Multiple aerolift systems (e.g., 4201A and 4201B) may be internally coupled to a building 4255. The aerolift systems 4201A and 4201B may be coupled at the leftmost and rightmost portions of the building 4255. Advantageously, positioning aerolift systems 4201A and 4201B and the leftmost and rightmost portions can allow the building 4255 to have more available space in a middle or medial area.

### Methods of Operation

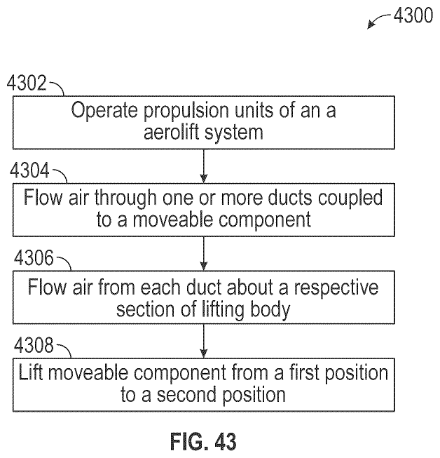

FIG. 43 illustrates a flow chart diagram 4300 for one embodiment of a process for the system 3600 disclosed herein. The lift system 3600 may have many or all of the same or similar features as any other system disclosed herein, and the same reference numbers are used to refer to the same features. Blocks 4302-4306 generally relate to operating propulsion units 3620 of the system 3600. At block 4302, the propulsion units 3620 may be powered on so that they may generate a flow of air for vertical lift or for vertical descent. At block 4304, the flow of air generated from the propulsion units 3620 may flow through the ducts 3630. The ducts 3630 may be distributed annularly about a central longitudinal axis of the system 3700. At block 4306, the flow of air from each duct 3630 may flow to the leading edge 3604 of a respective region (e.g., section) of the lifting body. At block 4308, the system 3600 may move from a first position to a second position. The first position may be higher than the second position. Alternatively, the first position may be lower than the second position.

### Additional Lifting Body Examples

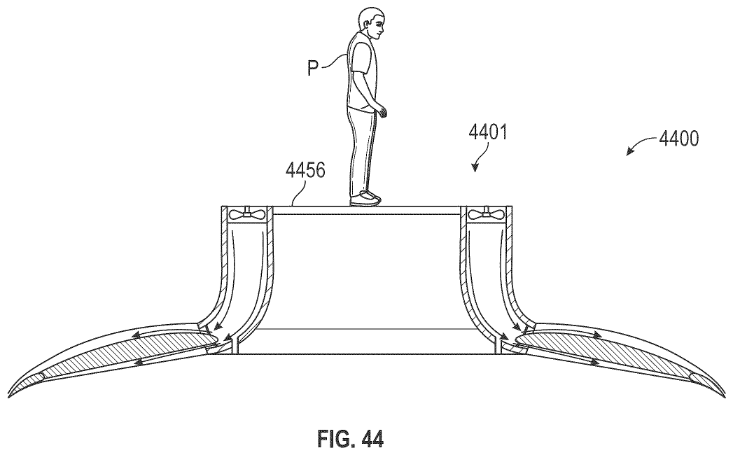

FIG. 44 illustrates an additional embodiment of a system 4400 for generating movement via aerodynamic lifting forces shown as an elevator system. The lift system 4400 may have many or all of the same or similar features as system 3700, or any other system disclosed herein, and the same reference numbers are used to refer to the same features. The aerolift system 4401 may be coupled to a lift platform 4456. Advantageously, coupling the aerolift system 4401 to a lift platform 4456 may allow a user or person P to travel vertically without a supporting structure. For example, a user may stand on the lift platform 4456 and be transferred from a first location to a second location, where the second location can be a higher location than the first location. Additionally, the system 4400 may be capable of transferring a user from the second, higher location to a lower location while the user is on the lift platform 4456.

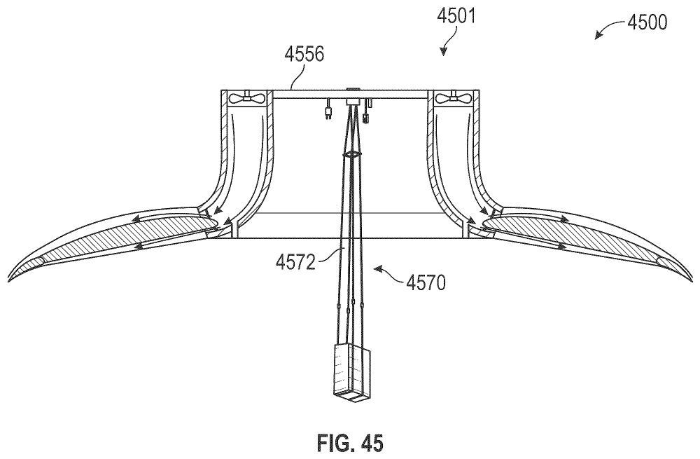

FIG. 45 illustrates an additional embodiment of a system 4500 for generating movement via aerodynamic lifting forces shown as an elevator system. The system 4500 may have many or all of the same or similar features as system 3700, or any other system disclosed herein, and the same reference numbers are used to refer to the same features. The system 4500 is coupled to a lift and carry system 4570. The lift and carry system 4570 may include one or more cables 4572 which are coupled to a platform 4556 of the lift and carry system 4570. In some examples, the lift and carry system 4570 may be a grabber (e.g., an arm which has one or more parts capable of opening and closing) capable of picking up and dropping off a package or equipment (e.g., construction equipment). Advantageously, the lift and carry system 4570 may support a package (e.g., cargo, payload, materials, etc.) to transfer the package to a desired location. For example, the system 4500 may be capable of delivering a package to a higher floor of a building or structure. Additionally, the lift and carry system 4570 may be capable of holding packages weighing 50 lbs. The lift and carry system 4570 may also be designed to lift 25 lbs., 100 lbs., 500 lbs., 1000 lbs., 2000 lbs., 3000 lbs., 4000 lbs., 5000 lbs., 6000 lbs, or more.

### Additional Example Aerolift Features and Aircraft Embodiments

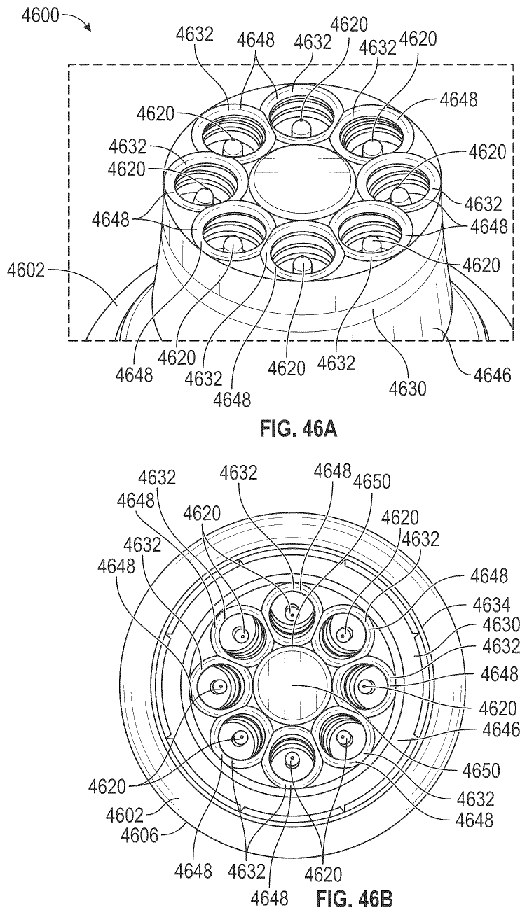

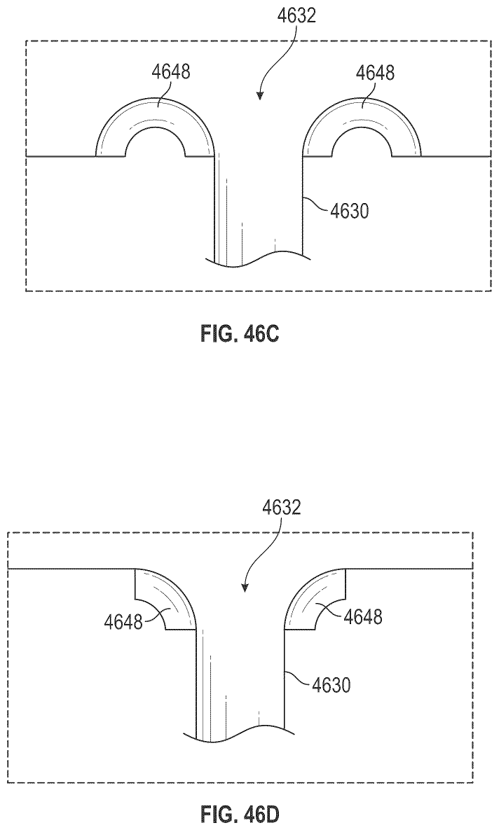

FIGS. 46A-46B illustrate perspective and top views respectively of additional embodiments of an aircraft 4600 and components thereof that includes the aerolift system. The aircraft 4600 may have many or all of the same or similar features as aircraft 100, or any other aircraft disclosed herein, or vice versa, and the same reference numbers are used to refer to the same features. The aircraft 4600 may utilize entry lips 4648 which may provide a smooth transition surface for air to flow into the inlet end 4632 of the ducts 4630, among other features as described herein.

The plurality of propulsion units 4620 are configured to deliver a flow of air from the inlet end 4632 to the outlet end 4634 of the plurality of ducts 4630 and to a lifting body shown as an airfoil 4602. The plurality of propulsion units 4620 may, for example, be from ten inches to 30 inches or from 15 inches to 25 inches or a 20 inch (in) diameter, ducted fan (although any other suitable propulsion unit sizes may also be used for a given application). The plurality of propulsion units 4620 may be designed to generate thrust at the inlet end 4632 of the plurality of ducts 4630 to deliver a flow of air to the airfoil 4602 and to the trailing edge 4606. The propulsion units 4620 may be aligned with the opening or axis of the inlet end. In some embodiments, the propulsion unit 4620 may be angled or canted with respect to the opening or axis of the inlet end, as described in further detail herein, for example with respect to FIGS. 51A and 51B.

The plurality of ducts 4630 may also have an outer wall 4646. The outer wall 4646 may define an outer boundary for the flow of air through the duct 4630. The outer wall 4646 may define a profile. The profile may be configured to maintain or optimize the airflow velocity at the outlet end 4634 (e.g., reduce the amount of airflow, thrust, and/or power lost due to the plurality of ducts 4630 turning between the inlet end 4632 and the outlet end 4634). For example, the outer wall 4646 may have a curved profile which may be designed to reduce frictional forces exerted on the flow of air (e.g., which may reduce the airflow velocity at the outlet end 4634 and which may deliver a slower flow of air to the airfoil 4602). The outer wall 4646 may be contoured so that a middle area of the plurality of ducts 4630 have a larger cross-sectional area than the inlet end 4632 and a smaller cross-sectional area than the outlet end 4634.

The aircraft 4600 may be capable of holding a passenger and/or cargo, where the passenger and cargo may weigh approximately 250 lbs total. The aircraft 4600 may also weigh approximately 1,000 lbs. The aircraft 4600 may weigh between 850 lbs, and 1500 lbs. In some embodiments, the aircraft 4600 may be capable of carrying a passenger and cargo weighing up to or approximately 1,000 lbs total. The passenger and cargo may be stored in the central body 4650.

FIGS. 46C and 46D show close up partial views of embodiments of the inlet end 4632 of the duct 4630 having inlet lips 4648. The inlet lip 4648 in FIG. 46C protrudes above the inlet end 4632, while the inlet lip 4648 of FIG. 46D is even with the inlet end 4632. The inlet lips 4648 may provide a smooth transition surface for air to flow into the inlet ends 4632. The inlet lip 4648 may be an inwardly curving lip, which may provide for improved airflow from the inlet end 4632 to the middle area of the duct and to the outlet end 4634. The inlet lip 4648 can be curved inwardly (e.g., curved in the direction of the flow of air into the duct 4630) to simplify manufacturing of the duct 4630. As shown in FIG. 46D, the topmost portion of the inlet lip 4648 may be level (e.g., an equivalent vertical height) with the topmost portion of inlet end 4632 of the plurality of ducts 4630 before curving into the inlet end 4632. As shown in FIG. 46C, in some embodiments, the inlet lip 4648 may protrude upwardly above the inlet end 4632 to create a “bump” at the inlet. In either case, the inlet lip 4648 may be designed to provide for a better conditioned or more laminar flow of air into the duct 4630. A flow of air from the inlet lip 4648 through the inlet end 4632, through the one or more ducts 4630, and through the outlet end 4634 can have improved lift characteristics relative to ducts 4630 without an inlet lip 4648. For example, the inlet lip 4648 can provide increased performance of a propulsion unit (e.g., propulsion units 4620) compared to one or more ducts 4630 without an inlet lip 4648. In some embodiments, the performance of a propulsion unit coupled to one or more ducts 4630 with an inlet lip 4648 can be approximately 20%-40% greater than those without an inlet lip 4648. The inlet lip 4648 may have an elliptical cross-section extruded about the opening of the inlet end. In some embodiments, the inlet lip 4648 may be circular, rounded, airfoil-shaped, other smooth rounded shapes or contours, or combinations thereof. In some embodiments, the inlet lip 4648 may be on a canted inlet end of the duct, or the inlet lip 4648 may be horizontal but with a canted propulsion unit therein, as further described herein for example with respect to FIG. 51A, which may improve airflow from the inlet end 4632 to the outlet end 4634 (e.g., less turbulent airflow).

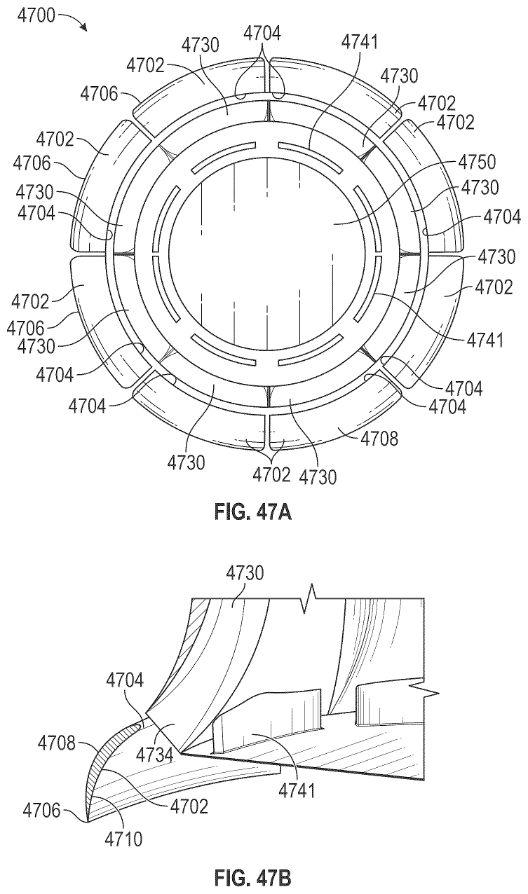

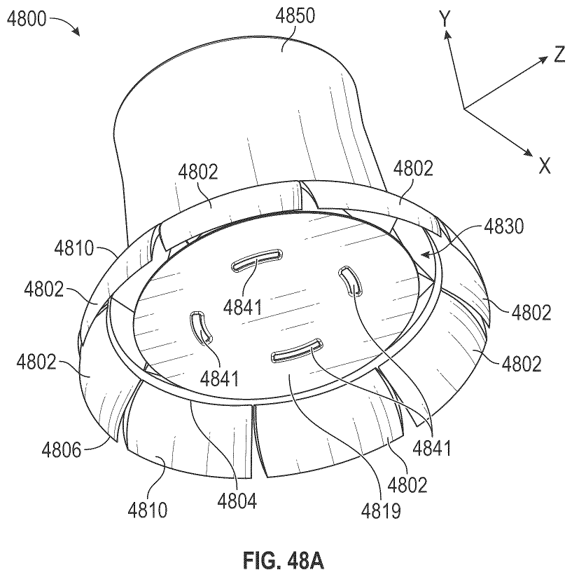

FIGS. 47A-47B illustrate bottom and partial cross-sectional view respectively of an additional embodiment of an aircraft 4700 and components thereof having the aerolift system. The aircraft 4700 may have many or all of the same or similar features as aircraft 100, or any other aircraft disclosed herein, and the same or similar reference numbers are used refer to the same or similar features. The aircraft 4700 may have a plurality of ducts 4730 and a central body such as a payload 4750 as shown, which may contain a payload compartment, passenger area, cockpit, and/or the like. In the aircraft 4700 one or more openings or bypass vents 4741 may be able to direct a flow of air, which entered the ducts 4730 through the inlet end 4732, to an area outside of the ducts 4730 before the flow of air would have reached the outlet end 4734 of the ducts 4730. There may be eight vents 4741 as shown (for clarity, only one of the vents 4741 is labelled). The vents 4741 may be rounded, elongated slits in the bottom or radially inward surfaces of one or more of the ducts 4730. In some embodiments, the vents 4741 may be in the top or radially outward surfaces of the one or more ducts 4730. The vents 4741 may be in lateral portions of the duct located in between radially inward and outward surfaces. The vents 4741 may be within one, some or all of these locations.

A flow of air (e.g., flow of environmental air) may be delivered to the leading edge 4704 of the wing 4702 from the outlet end 4734 of each of the ducts 4730. The flow of air may first be delivered to the leading edge 4704 and travel over the top surface 4708 and the bottom surface 4710. The flow of air traveling from the leading edge 4704 to the trailing edge 4706 along the top surface 4708 may flow at a relatively greater speed, compared to air flowing along the bottom surface 4710. The flow of air from the leading edge 4704 to the trailing edge 4706 along the bottom surface 4710 may flow at a relatively lower speed, compared to air flowing along the top surface 4708. The pressure differential between the bottom surface 4710 and the top surface 4708 may cause a lifting force to be applied upward to the wing 4702, which is transferred to the aircraft 4700.

The opening or bypass vent 4741 may provide a flow channel from an interior of the duct to an external region of the ducts 4730. The ducts 4730 may have a bypass vent 4741 which may extend from a lower portion of the ducts 4730 (e.g., adjacent to the outlet end 4734). The bypass vents 4741 may be positioned on the ducts 4730 in order to direct a flow of air downward and outside of the ducts 4730 before reaching the outlet end 4734 and the leading edge 4704 of the wing 4702. The bypass vents 4741 may prevent pressure buildup which may occur at the outlet end 4734. Additionally, the bypass vents 4741 may prevent the flow of air leaving the outlet end 4734 from circling around (e.g., recirculation) at the outlet end 4734 which may also lead to increased pressure at the outlet end 4734. Advantageously, positioning bypass vents 4741 along the ducts 4730 can improve the lift characteristics of the aircraft 4700. The downward flow of air through the vents 4741 may provide additional lift to the system.

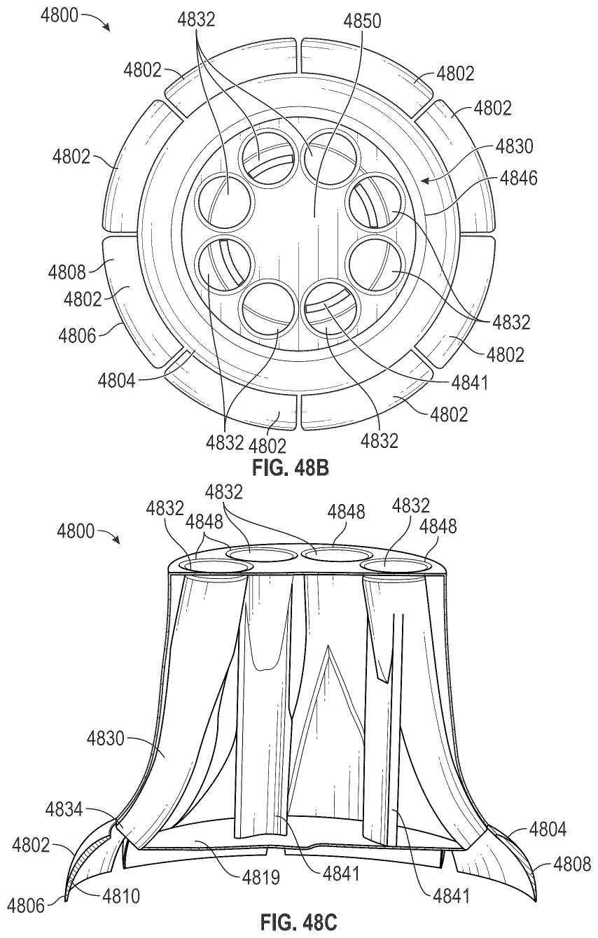

FIGS. 48A-48C illustrate bottom perspective, top end, and side cross-sectional views respectively, of an additional embodiment of an aircraft 4800 and components thereof having the aerolift system. The aircraft 4800 may have many or all of the same or similar features as aircraft 100, or any other aircraft disclosed herein, and the same or similar reference numbers are used refer to the same or similar features. The aircraft 4800 may have a plurality of ducts 4830 and a central body shown as a payload 4850 which may be empty, or which may contain a payload compartment, passenger area, cockpit, and/or the like. In the aircraft 4800 one or more openings or bypass vents 4841 may be connected (e.g., extending from) the ducts 4830 which may be able to direct a flow of air outside of the ducts 4730 before the flow of air reaches the outlet end 4734 of the ducts 4730.

A flow of air (e.g., flow of environmental air) may be delivered to the leading edge 4804 of the lifting body shown as the wing 4802 from the outlet end 4834 of each of the ducts 4830. The flow of air may first be delivered to the leading edge 4804 and travel over the top surface 4808 and the bottom surface 4810. The flow of air traveling from the leading edge 4804 to the trailing edge 4806 along the top surface 4808 may flow at a relatively greater speed, compared to air flowing along the bottom surface 4810. The flow of air from the leading edge 4804 to the trailing edge 4806 along the bottom surface 4810 may flow at a relatively lower speed, compared to air flowing along the top surface 4808. The pressure differential between the bottom surface 4810 and the top surface 4808 may cause a lifting force to be applied upward to the wing 4802, which is transferred to the aircraft 4800.

The ducts 4830 may have an opening or bypass vent 4841 which may extend from an upper portion of the ducts 4830 (e.g., adjacent to the inlet end 4832) and to an external region of the ducts 4830 (e.g., to or outside a bottom portion 4819 of the aircraft 4800). The bypass vents 4841 may be positioned on the ducts 4830 in order to direct a flow of air downward and outside of the ducts 4830 before reaching the outlet end 4834 and the leading edge 4804 of the wing 4802. The bypass vents 4841 may prevent pressure buildup which may occur at the outlet end 4834. Additionally, the bypass vents 4841 may prevent the flow of air leaving the outlet end 4834 from circling around (e.g., recirculation) at the outlet end 4834 which may also lead to increased pressure at the outlet end 4834. Advantageously, positioning bypass vents 4841 along the ducts 4830 can improve the lift characteristics of the aircraft 4800. These “upper” vents 4841 may be used in combination with, or alternatively to, the “lower” vents 4741 shown in FIGS. 47A and 47B. Further, the various vents 4841 and 4741 etc. may be valves that are independently or collectively controlled to adjust the openings of each vent and thus control the amount of air that can flow through the vents. The plurality of ducts 4830 may also have an outer wall. The inlet end 4832 of the ducts 4830 may also have an inlet lip 4848. The inlet lip 4848 may be rounded, for example elliptical or circular, as described above.

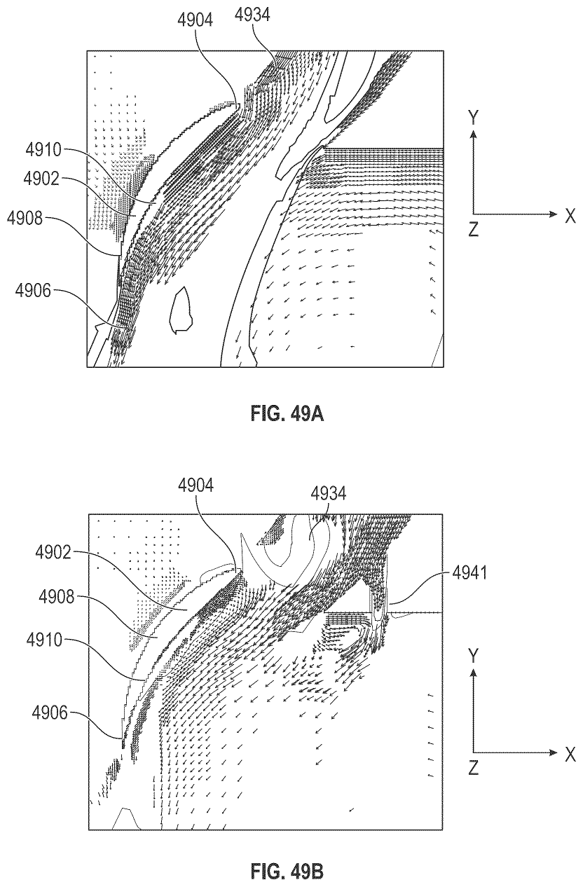

FIGS. 49A-49B show example analytical results for airflow characteristics of the one or more ducts 4930. The duct 4930 may have many or all of the same or similar features as ducts 130, or any other ducts disclosed herein, and the same or similar reference numbers are used refer to the same or similar features. FIG. 49A depicts airflow characteristics at the outlet end 4934 of the one or more ducts 4930, where there is no bypass vent. FIG. 49B depicts airflow characteristics at the outlet end 4934 of the one or more ducts 4930, where there is a bypass vent 4941.

A flow of air (e.g., flow of environmental air) may be delivered to the leading edge 4904 of a lifting body shown as the wing 4902 from the outlet end 4934 of each of the ducts 4930. The flow of air may first be delivered to the leading edge 4904 and travel over the top surface 4908 and the bottom surface 4910. The flow of air traveling from the leading edge 4904 to the trailing edge 4906 along the top surface 4908 may flow at a relatively greater speed, compared to air flowing along the bottom surface 4910. The flow of air from the leading edge 4904 to the trailing edge 4906 along the bottom surface 4910 may flow at a relatively lower speed, compared to air flowing along the top surface 4908. Advantageously, by positioning the bypass vent 4941 along the one or more ducts 4930, a pressure buildup may not occur at the outlet end 4934. Additionally, by not placing a bypass vent along the one or more ducts 4930, the flow of air may exit at the outlet end 4934 at a faster velocity, which may increase the amount of lift generated at the wing 4902 after the flow of air travels over the leading edge 4904. Further, by using the vent 4941 the pressure below the aircraft between the ducts may not be a dead zone or low pressure zone. The vents 4941 may thus increase the pressure in this area relative to systems without the vent 4941, thus increasing the lift of the system.

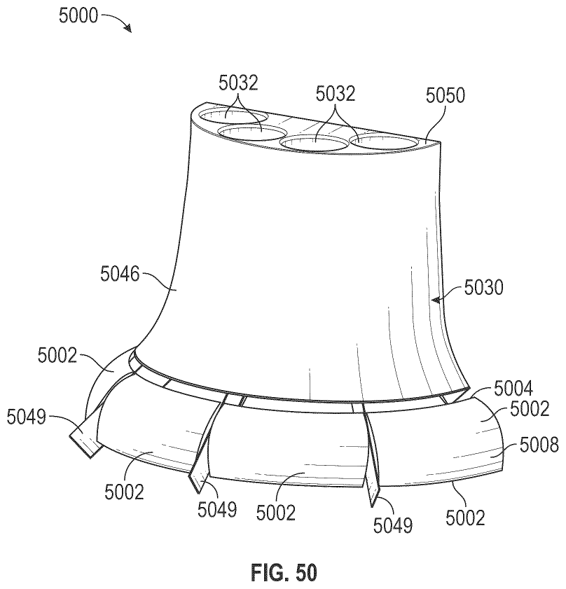

FIG. 50 illustrates an additional embodiment of an aircraft 5000 and components thereof having the aerolift system. The aircraft 5000 may have many or all of the same or similar features as aircraft 5000, or any other aircraft disclosed herein, and the same or similar reference numbers are used refer to the same or similar features. The aircraft 5000 may have a plurality of ducts 5030, a plurality of lifting bodies shown as airfoils 5002, and a payload 5050. In aircraft 5000, one or more dividers 5049 can be spaced around (e.g., annularly spaced, spaced about a central axis) the aircraft 5000 between adjacent duct outlets, as further described.

A flow of air may be delivered through the plurality of ducts 5030 from the inlet end 5032 and to the outlet end 5034. The flow of air may be delivered to the leading edge 5004 of the plurality of airfoils 5002 from the end 5034 of the plurality of ducts 5030. The flow of air may first be delivered to the leading edge 5004 and travel over the top surface 5008 and over the trailing edge 5006.

The plurality of ducts 5030 may also have an outer wall 5046. The outer wall 5046 may define an outer boundary for the flow of air through the duct 5030. The outer wall 5046 may define a profile. The profile may be configured to maintain or optimize the airflow velocity at the outlet end 5034 (e.g., reduce the amount of airflow, thrust, and/or power lost due to the plurality of ducts 5030 turning between the inlet end 5032 and the outlet end 5034). For example, the outer wall 5046 may have a curved profile which may be designed to reduce frictional forces exerted on the flow of air (e.g., which may reduce the airflow velocity at the outlet end 5034 and which may deliver a slower flow of air to the airfoil 5002). The outer wall 5046 may cause a middle area of the plurality of ducts 5030 to have a smaller width or area than the inlet end 5032 and/or the outlet end 5034.

One or more of the dividers 5049 may be spaced about the aircraft 5000. The one or more dividers 5049 may fence or contain a flow of air exiting an individual outlet end 5034 from leaving the area between two dividers 5049 positioned on opposing lateral sides of the outlet end 5034. The one or more dividers 5049 may be positioned adjacent to each of the plurality of airfoils 5002. The one or more dividers 5049 may extend from the outlet end 5034 and beyond the trailing edge 5006 of the plurality of airfoils 5002. Advantageously, the one or more dividers 5049 may prevent a flow of air which exits one of the plurality of ducts 5030 at the outlet end 5034 from interfering with another flow of air exiting another outlet end 5034 (e.g., adjacent outlet end 5034). The one or more dividers 5049 may provide a more controlled flow to the leading edge 5004 of the plurality of airfoils 5002 by blocking interfering flows of air. Since the one or more dividers 5049 may extend from the outlet end 5034 and beyond the trailing edge 5006 of the plurality of airfoils 5002, the flow of air from the leading edge 5004 to the trailing edge 5006 may be less turbulent. The dividers 5049 may be rigid planar members configured to withstand aerodynamic forces, such as structural walls or stiff sheets.

FIGS. 51A-51B illustrate inlet portions of multiple ducts 5130 that may be used in the various aerolift systems described herein. The one or more airflow ducts 5130 may have many or all of the same or similar features as ducts 130, or any other ducts disclosed herein, and the same or similar reference numbers are used refer to the same or similar features. In the one or more ducts 5130 (as shown in FIG. 51A) the inlet ends 5132 may extend along an axis 5132A that is “canted” or angled relative to a reference axis such as the central axis Z of the vehicle. The reference axis may be a vertical axis, or an axis parallel with a gravity vector, or the central axis Z. The axis 5132A may thus be angled relative to the central axis Z of an aircraft that the one or more ducts 5130 are connected to. Additionally, the canted openings 5168 located at the inlet end 5132 may each be angled towards (e.g., tilted towards) the central axis Z. The axes 5132A may be angled relative to the central axis Z no more than 30 degrees, no more than 25 degrees, no more than 20 degrees, no more than 15 degrees, no more than 10 degrees, no more than 5 degrees, or zero degrees (i.e. parallel). Advantageously, the canted openings 5168 (which are formed by angling the inlet end 5132 such that the inlet end 5132 extend about the axis 5132A) can reduce an amount of suction generated at the inlet end 5132 so that flow is more laminar and has less tendency to separate from the wall of the ducts and become turbulent. In some embodiments, the propulsion units may be canted with respect to the inlet axis. Thus the electric motor or fan or other propulsion unit may be angled with respect to the inlet end 5132. In some embodiments, both the inlet end 5132 and the propulsion unit may be canted. In some embodiments, only the inlet end 5132 or only the propulsion unit may be canted. The propulsion units may be configured to rotate between canted and uncanted configurations. FIG. 51B illustrates the one or more ducts 5130, where the one or more ducts 5130 may have straight or vertical openings 5168B, where the angle between the inlet end and the reference axis is zero degrees. The one or more ducts 5130 may extend along and define an axis 5132B which is parallel to the central axis Z. The propulsion unit may be straight, or may be canted in the vertical openings 5168B with respect to the axis 5132B. The “canted” orientation of the propulsion unit may be referring to an orientation of an axis of the propulsion unit, for example a central propulsion unit axis, which may be defined in some embodiments by rotating blades that rotate about the central propulsion unit axis. Thus the central propulsion unit axis may be canted with respect to the inlet axis, or with respect to the reference axis, etc., as described.

FIGS. 52A-52E illustrate additional embodiments of an aircraft 5200 having the aerolift system. FIG. 52A is a partial top view of the aircraft 5200 showing the ducts. FIG. 52B is a partial top view of the aircraft 5200 showing the ducts and a central body. FIG. 52C is a partial side view of the aircraft 5200 and FIG. 52D is a partial side cross-sectional view of the aircraft 5200. FIG. 52E is a top view of another embodiment of the aircraft 5200 showing the ducts in a four-sided outer profile. The aircraft 5200 may have many or all of the same or similar features as aircraft 100, or any other aircraft disclosed herein, and vice versa, and the same reference numbers are used to refer to the same features. In the aircraft 5200, the one or more ducts 5230 are arranged to form an outer profile 5202A which may be octagonal or square as shown, or other polygonal shapes, such as rectangular. The outer profile 5202A is a geometric reference only, to show the basic shape or outline. The aircraft 5200 can include the propulsion units, lifting bodies, etc. as described herein along with each duct to form a plurality of aerolift systems surrounding the center.

A flow of air may travel from the inlet end 5232 of the one or more ducts 5230 and to an outlet end 5234. The inlet end 5232 may have an inlet lip 5248. The inlet lip 5248 may be an elliptic lip (see FIG. 31C). Additionally, the inlet lip 5248 may be an inwardly curving lip (see FIG. 46A). The aircraft 5200 may include eight of the aerolift systems including eight ducts 5230. In some embodiments, there may be one, two, three, four, five, six, seven, nine, ten, eleven, twelve, thirteen, fourteen, fifteen, sixteen, or more of the aerolift systems. Each of the eight ducts may be spaced about the aircraft 5200. The inlet end of the eight ducts 5230 may each be rotated approximately forty-five degrees relative to each other as viewed from the top. The geometric reference outer profile 5202A of the aircraft 5200 may be polygonal, such as octagonal as shown since each of eight outlet ends 5234 is rotated forty-five degrees relative to one another. Thus, the angle between adjacent ducts may be forty-five degrees, as in the octagonal arrangement. In some embodiments, the angle formed between pairs of adjacent ducts may be less than forty-five degrees, less than forty degrees, less than thirty-five degrees, less than thirty degrees, less than twenty-five degrees, or less than twenty degrees. In some embodiments, the angle between two adjacent ducts may be zero degrees, where the adjacent ducts point in the same direction. For example, adjacent ducts may form a parallel pair, as in the four pairs of ducts shown in the square profile of FIG. 52E, as further described. The one or more ducts 5230 may also have an outer wall 5246 which may define an outer boundary for the flow of air through the duct 5230. The outlet end may have a rectangular shape or profile. Additionally, the spaces between adjacent ducts 5230 may be hollow or open (e.g., no payload compartment between the one or more ducts 5230) to allow airflow therebetween.

As shown in FIG. 52B, the one or more ducts 5230 may be connected to a central body 5250 which may be a cylindrical payload compartment as shown, or a cargo or passenger compartment, etc., as described herein for example with respect to the main portion 150. The central body 5250 may have the same or similar features as the main portion 150 except as otherwise described. As shown, each of the eight ducts 5230 may be supported radially outwardly away from the central body 5250. There may be one or more spaces 5157 between the central body 5250 and radially inwardly sides of the ducts 5230. There may be multiple spaces 5157 or a continuous space 5157 between each duct 5230 and a respective radially outer side of the central body 5250. There may also be a space 5157 within the central body 5250. The central body 5250 may therefore be hollow to allow airflow vertically therethrough. In some embodiments, there may be one or more fans located within the central body 5250 to blow air therethrough. There may be one continuous space 5157 extending annularly between the ducts 5230 and the central body 5250 except for supports 5257. There may be one or more spaces 5157 located circumferentially between adjacent ducts 5230. The space or spaces 5157 may allow for air to flow vertically through the space 5157 in between the central body 5250 and the ducts 5230 and/or between adjacent ducts 5230. This path for the airflow may prevent a region of low pressure from forming directly under the central body 5250 which could decrease total lift of the system. Further, the ducts 5230 (as viewed from a top side as shown in FIG. 52B) may be angled with respect to each other, for example the ducts 5230 may be angled approximately forty-five degrees relative to each other as shown, or at other angles.

The one or more ducts 5230 may be supported by one or more supports 5257. The supports 5257 may have the same or similar features as the supports 180, and vice versa. The supports 5257 may be elongated structural supports, such as cantilever beams or trusses or the like, that fixedly attach at an inward end to the central body 5250 and fixedly attach at an outward end to the respective duct 5230. In some embodiments, a single support 5257 may carry multiple ducts 5230. The radially inward ends of the supports 5257 may attach to an outer wall of the central body 5250. The supports 5257 may be deployable and stowable. The supports 5257 may stow radially inward to move the aerolift systems radially inward closer to a central reference axis of the system. The system may be transported or stored int eh stowed configuration. The supports 5257 may deploy radially outward to move the aerolift systems radially outward away from the central reference axis of the system. The system may deploy at the launch pad or other area of use. The supports 5257 may form a framework, which may be deployable and stowable.

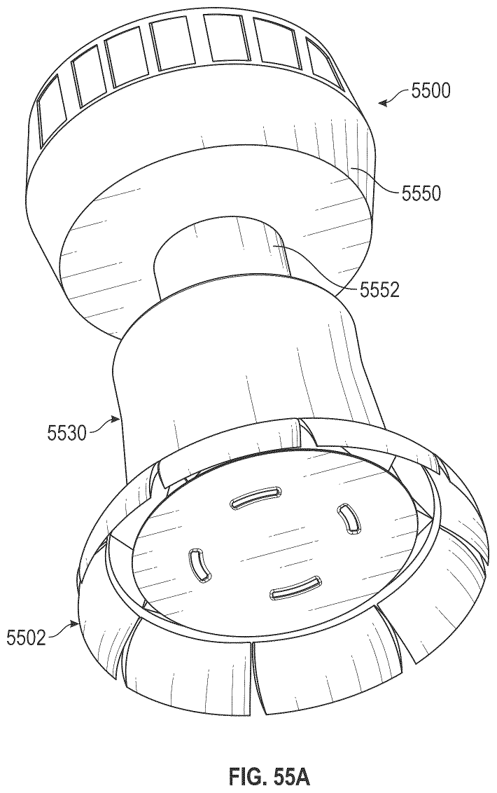

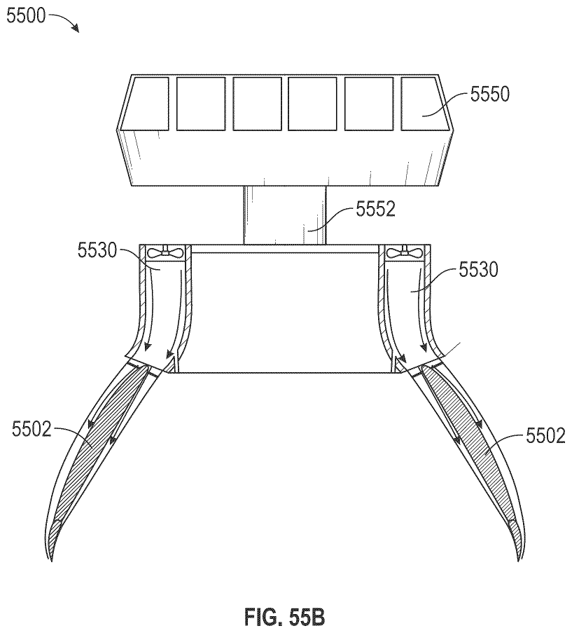

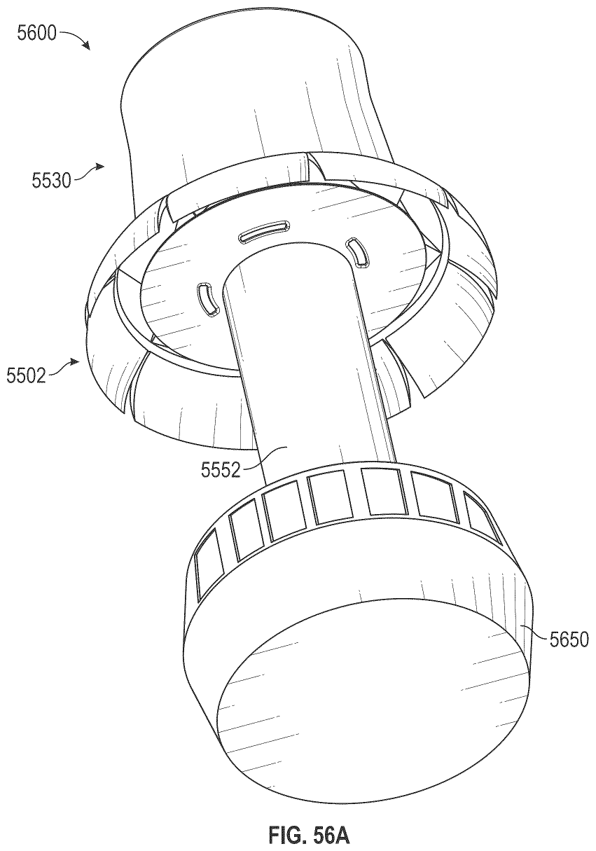

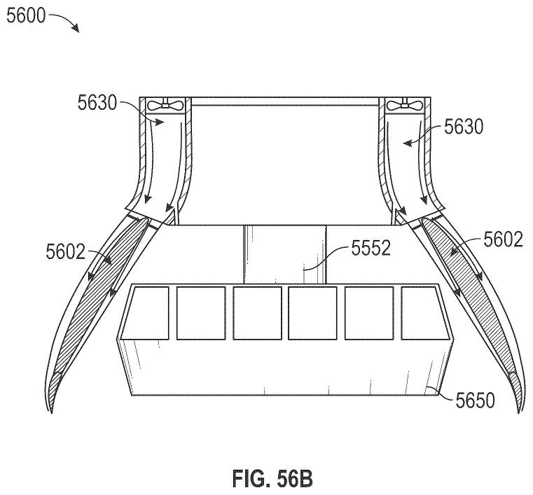

As shown in FIGS. 52C and 52D, one or more lifting bodies shown as wings 5202 (e.g., eight wings) may be located at the outlets of the one or more ducts 5230 (e.g., eight ducts), and the central body 5250 may be a passenger compartment which may have windows, etc. The central body 5250 may be located at least partially above or below the aerolift systems (see, e.g., FIGS. 55A-56B). The ducts 5230 and wings 5205 may have the same or similar features as any other ducts or lifting bodies described herein, respectively. In FIGS. 52C and 52D, for clarity, some of the features in the rear of the aircraft (as oriented) are not shown. The lifting bodies 5202 are attached to the ducts via supports 5148. The supports 5148 may be structural members that carry and locate the lifting bodies 5202. The supports 5148 may have the same or similar features as the support 148, as described herein for example with respect to FIG. 2. The supports 5148 may be metallic, composite, polymer, or combinations thereof.

The supports 5148 may attach to and extend from the duct 5230 to the lifting body 5202. The support 5148 may extend from a lateral or circumferential side of the lifting body 5202 to the lateral or circumferential side of the duct 5230. There may be two supports 5148 for each lifting body as shown, or there may be one, three, four or more supports 5148 for each lifting body. In some embodiments, a single support 5148 may support multiple lifting bodies 5202. In some embodiments, the supports 5148 may attach to the central body 5250. The lifting bodies 5202 may rotate about connections at radially outward ends of the supports 5148, for example to change the angle of attack, or to move a moveable portion such as a flap, etc.

As shown in FIG. 52E, another embodiment of the aircraft 5200 may have a four-sided profile 5202A, such as square as shown, or rectangular or other shapes. Other four-sided profiles may be implemented. The embodiment of the aircraft 5200 shown in FIG. 52E may have the same or similar features and/or functions as the aircraft 5200 of FIGS. 52A-52D, except as otherwise described. Thus, the one or more ducts 5230 may be connected to the central body 5250 and supported radially outwardly away from the central body 5250 by the one or more supports 5257, etc., as described with respect to FIGS. 52A-52D. Further, the ducts 5230 (as viewed from a top side as shown in FIG. 52E) may have sets of two ducts 5230 positioned adjacent to each other (e.g., next to each other and not angled relative to one another). For example, as shown in FIG. 52E, a set of two ducts 5230 may be parallel to each other and angled approximately ninety degrees relative to another set of two parallel ducts 5230, or at other angles. The angles may be defined with reference to the outlet axes, which may be geometric central axes at the duct outlets. The pairs of ducts 5230 with corresponding wings 5202 (e.g. lifting bodies) may form the four-sided profile 5202A. There may be one or more than two ducts 5230 (and one or more than two corresponding wings 5202) on each side of the four-sided profile 5202A.

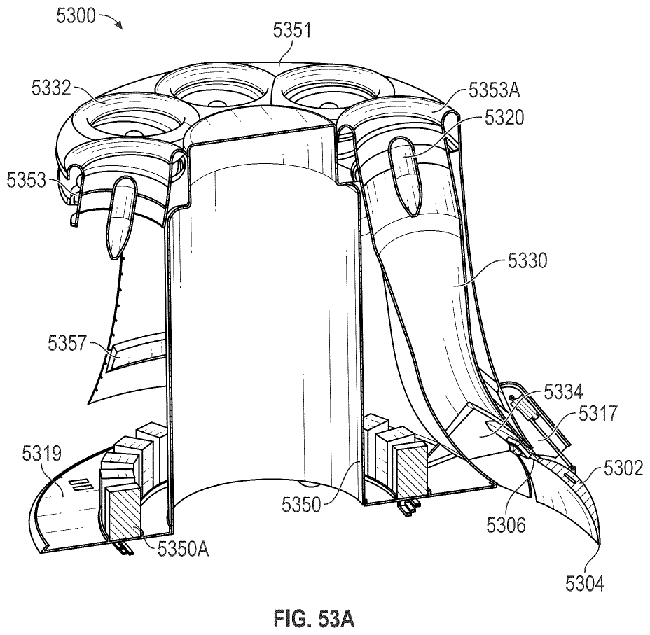

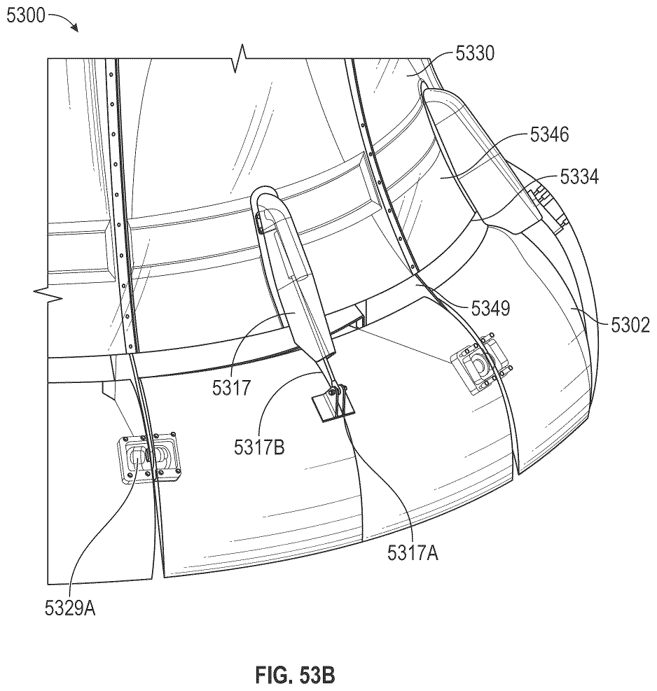

FIGS. 53A-53B illustrate a side cross-sectional view and a partial detail view respectively of additional embodiments of an aircraft 5300. The aircraft 5300 may have many or all of the same or similar features as aircraft 100, or any other aircraft disclosed herein, or vice versa, and the same reference numbers are used to refer to the same features. The aircraft 5300 includes an actuator 5317 positioned on an outside wall 5346 of the aircraft 5300, among other features as further described.

The plurality of propulsion units 5320 are configured to deliver a flow of air from the inlet end 5332 to the outlet end 5334 of the plurality of ducts 5330 and to a lifting body shown as an airfoil 5302. The plurality of propulsion units 5320 may, for example, be from ten inches to thirty inches or from fifteen inches to twenty five inches or a twenty inch diameter, ducted fan (although any other suitable propulsion unit sizes may also be used for a given application). The plurality of propulsion units 5320 may be designed to generate thrust at the inlet end 5332 of the plurality of ducts 5330 to deliver a flow of air to the airfoil 5302, where the flow of air travels to the leading edge 5304 and to the trailing edge 5306.

The aircraft 5300 may also include a composite upper cap 5351, a composite duct inlet bulkhead 5353, and/or a composite upper cap 5353A. The aircraft can include a stiffener 5357 which may be positioned along the outside wall 5346 and which may be coupled to and operate with the actuator 5317. Additionally, the aircraft 5300 can include a base portion 5319 and a batteries 5350A positioned annularly about and along the base portion 5319 and positioned outside of a payload section 5350.

The actuator 5317 may be connected to a hinge point 5317A. The hinge point 5317A may be positioned along the airfoil 5302. The hinge point 5317A may be located a distance equivalent to approximately one-third the length of the chord of the airfoil 5302 measure from the leading edge 5304. As the shaft 5317B extends outwards (e.g., the shaft 5317B extends out of the actuator 5317) the airfoil 5302 may rotate downwards such that the airfoil 5302 is oriented substantially vertically. As the shaft 5317B retracts (e.g., the shaft 5317B extends further into the actuator 5317), the airfoil may rotate upwards such that the airfoil 5302 can be more horizonal.

The aircraft 5300 may include one or more dividers 5349. The one or more dividers 5349 may support the airfoil 5302. The aircraft may also include a bearing 5329A which is positioned along the edges of the airfoils 5302 and coupled one of the dividers 5349. The bearing 5329A may allow the airfoil 5302 to rotate upwards and downwards relative to the one or more dividers 5349. The aircraft 5300 may further include any of the features of other aerolift systems or aircraft as described herein, such as those described with respect to FIGS. 52A-52D, etc.

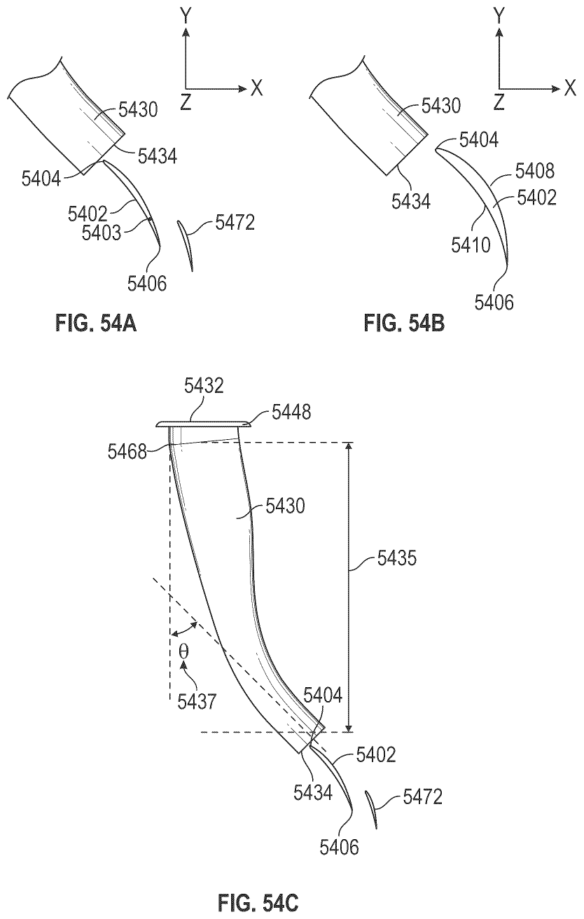

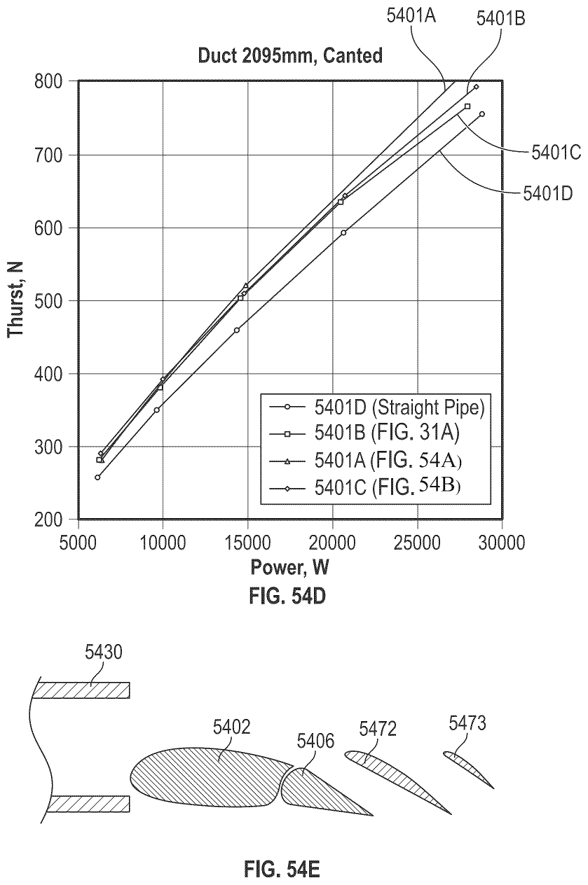

FIGS. 54A-54C illustrates partial side views of outlet ends of various aerolift systems, including ducts 5430 and lifting bodies. The one or more ducts 5430 may have many or all of the same or similar features as ducts 130, or any other ducts disclosed herein, and the same or similar reference numbers are used refer to the same or similar features. The systems may include the one or more ducts 5430 and a lifting body shown as a wing 5402, and in some embodiments one or more additional lifting bodies, positioned outside the outlet end 5434 of the duct 5439, as further described.

FIG. 54A illustrates the outlet end 5434 of the one or more ducts 5430. The leading edge 5404 of the wing 5402 may be positioned outside of the outlet end 5434. A flow of air can leave the one or more ducts 5430 at the outlet end 5434 and travel to the leading edge 5404 and to the trailing edge 5406. Additionally, a multi-component wing may be utilized, where one or more additional wings 5472 is spaced away from the wing 5402. The additional wing 5472 may be spaced upwards and laterally away (e.g., radially outward) from the wing 5402. The additional wing 5472 may be located in any of the various positions as described in further detail herein, for example with respect to FIGS. 27A-27E. In some embodiments, the wing 5402 may include one or more hinges 5403 or other mechanisms to allow the portion aft of the hinge 5403 that includes the trailing edge 5406 to rotate and/or translate about the hinge 5403 relative to the portion of the wing 5402 that is forward of the hinge 5403. The wing 5402 may thus include a moveable flap, aileron, etc.

FIG. 54B is another illustration of the outlet end 5434 of the one or more ducts 5430. The wing 5402 may be positioned away from the outlet end 5434 (e.g., the leading edge 5404 is located outside the outlet end 5434). The wing 5402 may not have an airfoil cross-sectional shape. The wing 5402 may be a regular surface designed to direct air flow downwards. The bottom surface 5410 of the wing 5402 may be curved in the direction of the top surface 5408 of the wing 5402. A majority of the flow of air exiting the outlet end 5434 may travel along the bottom surface 5410 in order to direct a larger amount of flow downwards (e.g., a greater amount of flow travels along the bottom surface 5410 than the top surface 5408). Advantageously, the curved bottom surface 5410 may generate additional lift. The wing 5402 may thus function as a flow diverter, for example as described herein with respect to FIGS. 22B and 22C. The air may mostly impinge upon and flow against, rather than flow over top and bottom sides, of the wing 5402.

FIG. 54C is another illustration the one or more ducts 5430. The one or more ducts 5430 can have an inlet end 5432 and an outlet end 5434. The inlet end 5432 can have a straight end portion that opens to a horizontal, non-canted opening as shown. In some embodiments, the straight end portion may be removed, such that the inlet end 5432 is canted or non-horizontal with respect to a reference axis, where the inlet end 5432 would be canted and have a canted opening 5468 (see also FIG. 51A). Additionally, the one or more ducts 5430, for either the canted or non-canted opening, can have an inlet lip 5448 located adjacent to the inlet end. The outlet end 5434 may include a straight portion. The two straight portions at the inlet and outlet ends may be constant diameter, linear sections of the interior channel of the ducts. Further, the duct can have a total duct length 5435. The total duct length 5435 may be the vertical linear distance from a bottom-most portion of the straight part of the inlet end 5432 to an upper-most portion of the straight part of the outlet end 5434. This total duct length 5435 can be from 2000 millimeters (mm) to 4000 mm, or about 2095 mm. In some embodiments, the total duct length 5435 can be from 500 mm to 5000 mm, from 750 mm to 3500 mm, from 1000 mm to 3000 mm, or from 1500 mm to 2500 mm. The one or more ducts 5430 may have a turn angle 5437 as described herein, for example from 20 to 45 degrees, of approximately 45 degrees, etc.

FIG. 54D is a graphical representation of analytical data of the expected amount of thrust (N, newtons) generated versus fan power (W, watts) for the duct and lifting body designs shown in FIGS. 31A, 54A and 54B. In FIG. 54D, the line 5401A represents the amount of thrust generated when the duct and lifting body (e.g., airfoil) is shaped similarly to the duct 5430, wing 5402, and additional wing 5472 of FIG. 54A (without the hinge 5403). Line 5401B illustrates the amount of thrust generated when the duct and lifting body (e.g., airfoil) is shaped similarly to the duct 3130, airfoil 3102, and additional wing 3172 of FIG. 31A (or FIG. 54A, but with the hinge). Line 5401C illustrates the amount of thrust generated when the duct and lifting body (e.g., airfoil) is shaped similarly to the duct 5430 and wing 5402 of FIG. 54B. Line 5401D illustrates the amount of thrust generated when the duct is a straight pipe or modified duct and without any lifting body, such as in fan systems that simply blow air straight downward to generate thrust. As shown in FIG. 54D, all three of the aerolift designs for FIGS. 31A, 54A (hinged and unhinged) and 54B generate more thrust than the straight pipe for a given fan power input. In some embodiments, the aerolift system with the duct and multicomponent airfoil of FIG. 54B generates the greatest amount of thrust for a given fan power input. Thus, the aerolift system, when designed properly as described herein with appropriate turn angle, lifting body placement, lifting body angular orientation, and overall duct angular orientation relative to gravity, produces more lift than merely blowing air downward to generate thrust.

FIG. 54E illustrates a side view of another embodiment of an airflow duct having the first lifting body 5402 positioned at the outlet end of the duct 5430, the second lifting body 5472 positioned radially outward (rearward) from the first lifting body 5402, and a third lifting body 5473 positioned radially outward from the second lifting body 5402. The first lifting body 5402 and the second lifting body may have any of the features as described herein, for example with respect to FIGS. 54A-54C. The third lifting body 5473 may have any of the same or similar features as the first and second lifting bodies. The third lifting body 5473 may be thinner and positioned relatively higher than the first lifting body 5402. The third lifting body 5473 may be positioned level or higher than the second lifting body 5472. The first lifting body 5402 may or may not include the moveable trailing edge 5406. Each of the three lifting bodies may be supported by one or more supports 5148 (see, e.g., FIG. 52C). In some embodiments the first lifting body 5402 may be attached to the duct 5430 via one or more of the supports 5148. The second lifting body 5472 may be attached to the first lifting body 5402 and/or to the duct 5430 (for example, to the outlet end) via one or more of the supports 5148. The third lifting body 5473 may be attached to the first lifting body 5402, to the second lifting body 5472, and/or to the duct 5430 via one or more of the supports 5148. The supports 5148 may rotatably support the one or more lifting bodies, such that the lifting bodies may rotate relative to the support 5148.

FIGS. 55A and 55B illustrate another embodiment of an aircraft 5500 having the aerolift system. The aircraft 5500 may have many or all of the same or similar features as aircraft 100, or any other aircraft disclosed herein, and vice versa, and the same reference numbers are used to refer to the same features. The aerolift systems may be located below or at least partially below the central body 5550. In the aircraft 5500, the one or more lifting bodies 5502 (e.g., airfoil or wing or wing segments, etc.) and one or more ducts 5530 are positioned below the central body 5550 (such as a payload, etc.) and attached by one or more structural supports 5552, shown as a cylindrical support. The structural support 5552 may be a truss, elongated beams, or other structures. The structural support 5552 may include a fan or it may be empty except for electronics, wiring, etc. In some embodiments, the space between the ducts 5530 may be empty to allow for vertical airflow therethrough. In some embodiments, the space between the ducts 5530 may include one or more fans to blow air therethrough.

FIGS. 56A and 56B illustrate another embodiment of an aircraft 5600. The aircraft 5600 may have many or all of the same or similar features as aircraft 100, or any other aircraft disclosed herein, and vice versa, and the same reference numbers are used to refer to the same features. The aerolift systems may be located above or at least partially above the central body 5650. In the aircraft 5600, the one or more lifting bodies 5602 (e.g., airfoil or wing or wing segments, etc.) and one or more ducts 5630 are positioned above the central body 5650. The structural support 5552 may include a fan or it may be empty except for electronics, wiring, etc. In some embodiments, the space between the ducts 5530 may be empty to allow for vertical airflow therethrough. In some embodiments, the space between the ducts 5530 may include one or more fans to blow air therethrough.

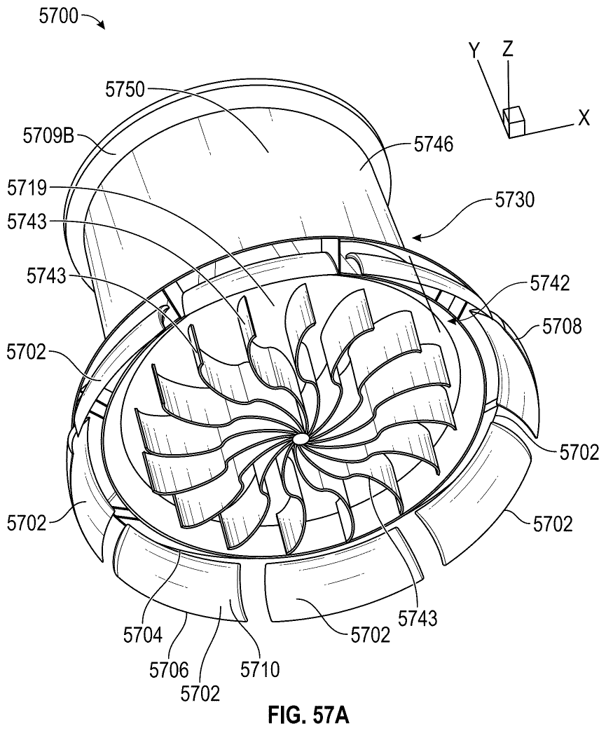

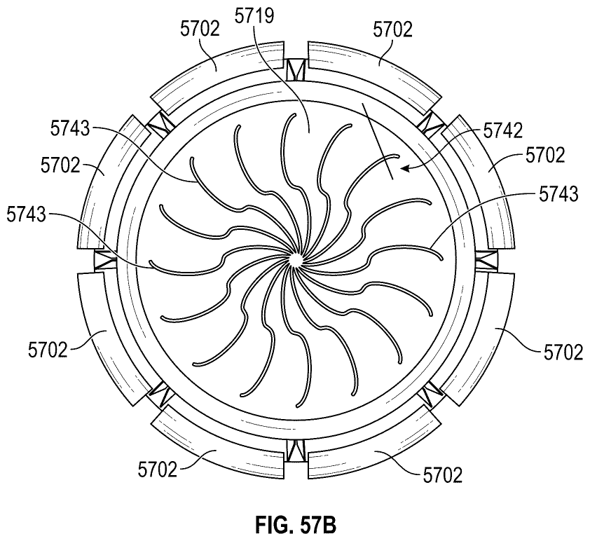

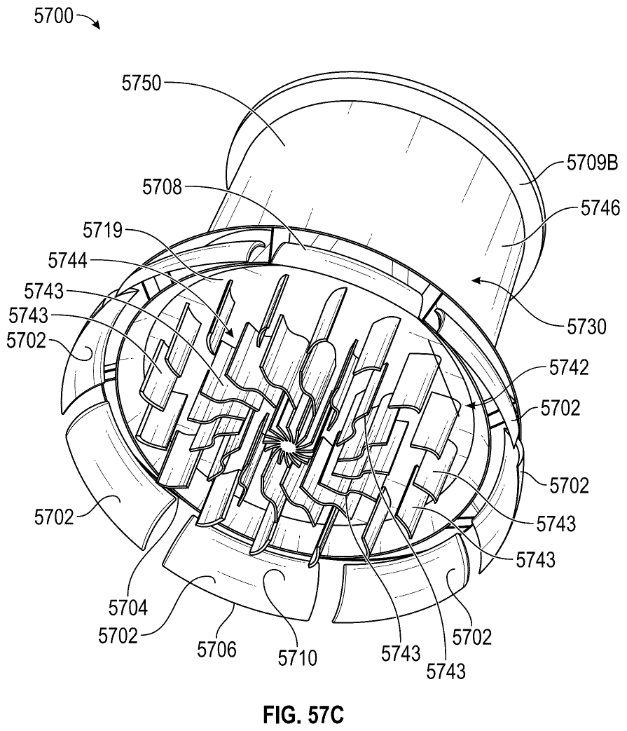

FIGS. 57A and 57B illustrate bottom perspective and bottom end views respectively of an additional embodiment of an aircraft 5700 and components thereof having the aerolift systems. The aircraft 5700 may have the same or similar features and/or functions as aircraft 100, or any other aircraft disclosed herein, and vice versa. The aircraft 5700 may thus have a plurality of ducts 5730 and a central body (shown as the payload 5750) which may be empty, or which may contain a payload compartment, passenger area, cockpit, and/or the like. The aircraft 5700 may further have a flow of air delivered to the leading edge 5704 of the lifting body shown as the wing 5702 from the outlet end 5734 of each of the ducts 5730 to cause a lifting force to be applied upward to the wing 5702, which is transferred to the aircraft 5700, as described herein.

The aircraft 5700 may additionally have a skirt 5742 comprising one or more baffles 5743 (only some of which are labelled in the figure, for clarity). The one or more baffles 5743 may be extending vertically downward from the bottom portion 5719. The one or more baffles 5743 may be fixedly or moveably connected with the bottom portion 5719. The one or more baffles 5743 may be configured to reduce an amount of suction (e.g., downward suction force) at the bottom portion 5719 of the aircraft 5700 produced by the radially outer flow from the duct outlets over the lifting bodies and resulting vortices under the aircraft. The aircraft 5700 may have an outer inlet lip 5709B (as discussed further below in FIGS. 59A-59E).

The bottom portion 5719 may have one or more or a plurality of the baffles 5743 which extend from the bottom portion 5719 and downwards along a vertical axis of the aircraft 5700 (e.g., along a Y-axis). The one or more baffles 5743 may extend (e.g., radially extend) around a central axis of the aircraft 5700. The one or more baffles 5743 may form an asymmetric pattern about the central axis of the aircraft 5700. The one or more baffles 5743 may have a wavy or curved shape (e.g., an S-shaped curve) as viewed from the bottom and which extends from a middle region of the bottom portion 5719 of the aircraft 5700 radially outward to or toward an outer region or outer edge of the bottom portion 5719.

As shown in FIG. 57C, there may be one or more gaps 5744 between one or more baffles 5743 (e.g., each gap may be an open space along the length of the one or more baffles 5743). Advantageously, positioning the one or more baffles 5743 along the bottom portion 5719 may further break up vortices and reduce a suction force generated underneath the aircraft 5700. The suction force at the bottom of the aircraft 5700 may then require additional power generated (e.g., lift) in order to lift the aircraft 5700 off of a ground surface. Having one or more baffles 5743 positioned on the bottom portion 5719 may break up the recirculating air flowing underneath the aircraft 5700 which may reduce losses which occur during takeoff and flight (e.g., vertical takeoff).

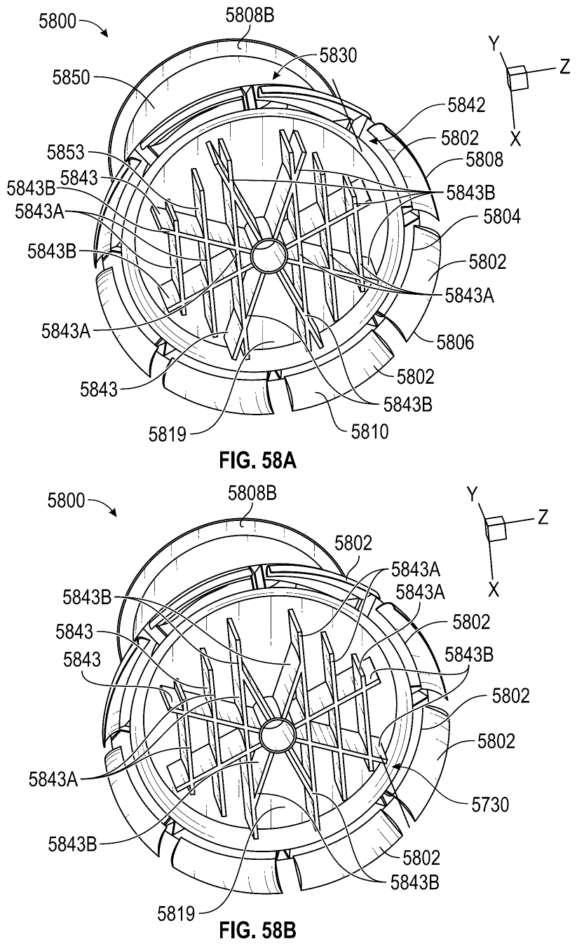

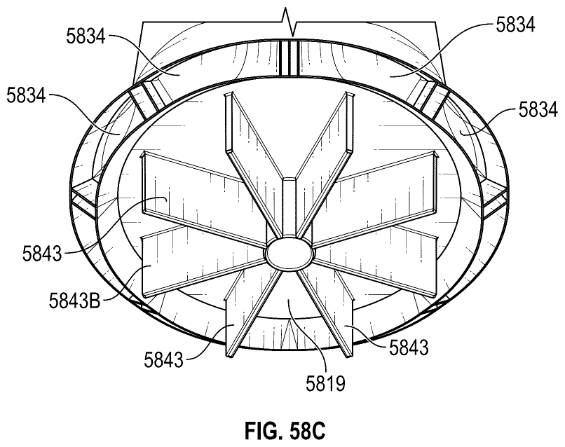

FIGS. 58A-58C illustrate bottom perspective and bottom end views of additional embodiments of an aircraft 5800 and components thereof having the aerolift system. The aircraft 5800 may have the same or similar features as the aircraft 100, or any other aircraft disclosed herein, and vice versa. The aircraft 5800 may therefore have the plurality of ducts 5830, a wing 5802, a central body shown as a payload 5850, etc., as described. The aircraft 5800 may additionally have a skirt 5842 comprising a plurality of baffles 5843.

FIG. 58A shows the bottom portion 5819 of the aircraft 5800 with the skirt 5842 having one or more or a plurality of the baffles 5843 which extend from the bottom portion 5819 and downwards along a vertical axis (e.g., Y-axis) of the aircraft 5800. The one or more baffles 5843 may be symmetrical about a central axis of the aircraft 5800. The one or more baffles 5843 may have a first set of baffles 5843A each extending in the same direction along the bottom portion 5719. For example, the first set of baffles 5843A may extend along an X-axis of the bottom portion 5819. The first set of baffles 5843A may be six baffles. The first set of baffles 5843A may be two, four, eight or ten baffles. Each baffle of the first set of baffles 5843A may be spaced laterally away from and be parallel to another baffle 5843A (e.g., each baffle 5843A extends along the X-axis and each baffle is parallel to another baffle 5843A along the Z-axis). The one or more baffles 5843 may have a second set of baffles 5843B which extend radially about a central axis of the bottom portion 5819 or payload 5850 (e.g., a central Y-axis). The second set of baffles 5843B may be eight baffles. The second set of baffles 5843B may include two baffles, four baffles, six baffles, ten baffles, or twelve baffles. Each of the second set of baffles 5843B may be angled relative to another one of the baffles 5843B. For example, each baffle 5843B may be angled forty-five degrees relative to another baffles 5843B. The second set of baffles 5843B may intersect the first set of baffles 5843A. Additionally, the second set of baffles 5843B may intersect and extend (e.g., radially extend) beyond the first set of baffles 5843A. Having one or more baffles 5843 symmetrically positioned on the bottom portion 5819 may recirculate the air flowing underneath the aircraft 5800 which may reduce losses which occur during takeoff (e.g., vertical takeoff).

FIG. 58B shows the bottom portion 5819 of aircraft 5800 with one or more or a plurality of baffles 5843 extending from the bottom portion 5819 and downwards along a vertical axis of the aircraft 5800 in a different orientation than FIG. 58A. In FIG. 58B, the second set of baffles 5843B may not each radially extend beyond the first set of baffles 5843A.

In FIG. 58C, the skirt 5842 may only include the second set of baffles 5843B (e.g., there may not be the first set of baffles 5843A). For clarity, the wings 5802 positioned around the outlet end 5834 are removed. Similarly to the baffles in second set of baffles 5843B, the baffles may extend radially about a central axis of the bottom portion 5819 or payload 5850. The second set of baffles 5843B can be eight baffles each angled forty-five degrees relative to an adjacent baffle of the second set of baffles 5843B. The one or more baffles 5843 may be two baffles, four baffles, six baffles, or ten baffles. The one or more baffles 5843 may be symmetrical about a central axis of the aircraft 5800.

FIGS. 59A and 59B illustrate perspective and top end views respectively of an additional embodiment of an aircraft 5900 and components thereof having the aerolift system. FIGS. 59C and 59D are detail views of portions of the aircraft 5900 as taken from and shown in FIG. 59A. The aircraft 5900 may have the same or similar features as the aircraft 100, or any other aircraft disclosed herein, and vice versa. Thus, the aircraft 5900 may have the plurality of ducts 5930 and a central body shown as a payload 5950, one or more skirts 5943, etc. Further, the aircraft 5900 may have an inner inlet lip 5909A and an outer inlet lip 5909B to deliver a flow of air to the inlet ends 5932.

A flow of air (e.g., flow of environmental air) may be delivered from the inlet ends 5932 to the outlet ends 5934 (e.g., a closed cross-sectional profile outlet end, such as the rectangularly shaped outlet end) of each of the ducts 5930 (e.g., see FIGS. 59A and 59B). The flow of air may be delivered to a lifting body or wing (not shown for clarity). The plurality of ducts 5930 may be placed within a larger channel 5944 (e.g., a walled structure forming an outer body of the aircraft 5900 containing and/or supporting the plurality of ducts 5930).

The plurality of ducts 5930 may be shaped to optimize the airflow velocity at the outlet ends 5934 (e.g., reduce the amount of airflow lost due to the plurality of ducts 5930 turning between the inlet end 5932 and the outlet end 5934). The plurality of ducts 5930 may also have an outer wall 5946. The outer wall 5946 may define a lateral outer boundary for the flow of air through the outlet end 5934 of the duct 5930. The outer wall 5946 may be located vertically inwardly (e.g. below) of a wall of the larger channel 5944. The outer wall 5946 may define a cross-sectional profile of the outlet end 5934. The cross-sectional profile may be a closed shape, such as a rectangle, oval, square, circle, other polygonal shapes, or polygonal shapes with rounded corners. The outer wall 5946 may be able to deliver an optimal flow of air over the entire top surface and bottom surface of a wing (not shown in FIG. 59A, for clarity).

FIGS. 59C and 59D are detail views of the inlet end 5932 of the duct 5930 having an inner inlet lip 5909A and an outer inlet lip 5909B. FIG. 59E is a partial cross-sectional view of the upper end of the aircraft showing the inner inlet lip 5909A and the outer inlet lip 5909B. The inner inlet lip 5909A and the outer inlet lip 5909B may provide a smooth transition surface for air to flow into the inlet ends 5932. The inner inlet lip 5909A and outer inlet lip 5909B can provide increased performance of a propulsion unit (e.g., the propulsion units 120 as described herein) compared to one or more ducts 5930 without the inner inlet lip 5909A and the outer inlet lip 5909B. The inner inlet lip 5909A may be positioned radially inward of the inlet ends 5932 of the plurality of ducts 5930. The outer inlet lip 5909B may be positioned radially outward of the inlet ends 5932. The inner inlet lip 5909A may protrude upwardly above the inlet end 5932 to create a “bump” at the inlet. The outer inlet lip 5909B may also protrude upwardly above the inlet ends 5932 to create a “bump” at the inlet. In some embodiments, the inner inlet lip 5909A may have a cross-sectional profile that is circular, elliptical, rounded, airfoil-shaped, other smooth rounded shapes or contours, or combinations thereof. In some embodiments, the inlet lip inner inlet lip 5909A may be on a canted inlet end of the duct. The inner inlet lip 5909A may be a round (e.g. semi-spherical) bump positioned in the middle region of the aircraft 5900 and above the payload 5950. The inner inlet lip 5909A may extend upwards above the inlet ends 5932 at least one inch, at least two inches, at least three inches, at least four inches, at least five inches, no more than six inches, no more than seven inches, no more than eight inches, no more than nine inches, no more than ten inches, or from one to ten inches. The inner inlet lip 5909A may provide for a smooth surface to guide flow in a more laminar manner into the adjacent inlet ends 5932. The inner inlet lip 5909A and the outer inlet lip 5909B may deliver improved airflow to the aircraft 5900 such the lift of the system (e.g., aircraft 5900) is significantly improved. For example, the inner inlet lip 5909A and the outer inlet lip 5909B may increase the lift of the system by approximately 7% over aircrafts without the inner inlet lip 5909A and the outer inlet lip 5909B. The inner inlet lip 5909A and the outer inlet lip 5909B may increase the lift of the system by approximately 4%, 5%, 6%, 8%, 9%, 10%, or 11% over aircrafts without the inner inlet lip 5909A and the outer inlet lip 5909B.

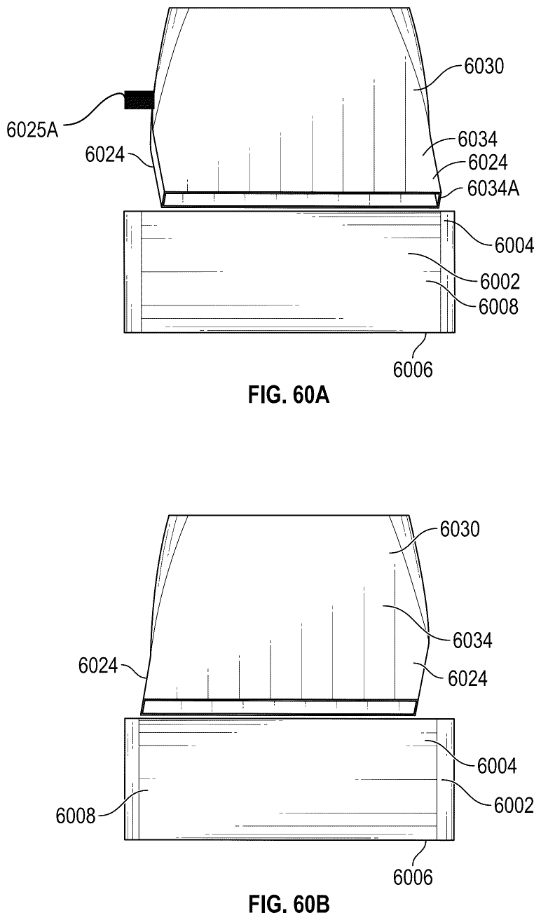

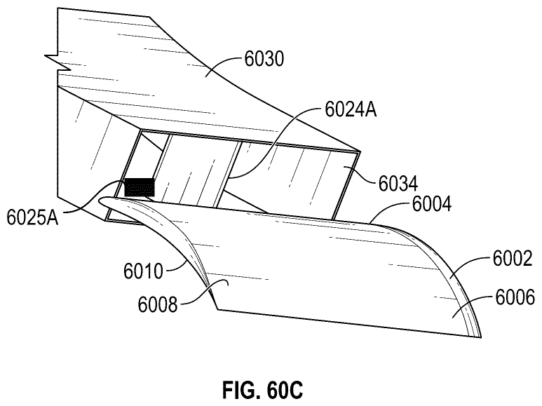

FIGS. 60A-60C illustrate additional embodiments of one or more ducts 6030. The ducts 6030 may have the same or similar features and/or functions as the ducts 130, or any other ducts disclosed herein, and vice versa. The ducts 6030 may be used in any of the aircraft described herein. The ducts 6030 may include propulsion units 120 or any other propulsion units disclosed herein. The ducts 6030 may have one or more movable wall portions 6024 which may direct a flow of air over an airfoil 6002 in order to control yaw (e.g., moving the one or more movable wall portions 6024 may control the twisting motion of the aircraft 6000 as described in relation to FIG. 1). Controlling the yaw of the aircraft 6000 with the one or more movable wall portions 6024 may assist in stabilization of the aircraft, even in a stationary hover, such as to account for turbulence, wind, movement of payloads and/or passengers, and/or the like. The one or more movable wall portions 6024 may be useful in controlling the aircraft 6000 when one or more rotors (e.g., propulsion units 120) fail (e.g., are no longer operational) and or if one or more ducts 6030 fail or become damaged. The one or more movable wall portions 6024 can move to counter any yaw rotation due to the failing or malfunctioning propulsion units (e.g., propulsion units 120) or ducts 6030. The one or more movable wall portions 6024 may be operated by an actuator 6025A.

The one or more movable wall portions 6024 may be positioned adjacent to outlet end 6034 of the ducts 6030. As shown in FIG. 60A, the one or more movable wall portions 6024 may move in a first direction (e.g., a rightward direction) in order to deflect a flow of air. The one or more movable wall portions 6024 at the outlet end 6034 may function as nozzles and may direct the flow of air from the outlet end to a desired direction. The one or more movable wall portions 6024 may provide yaw control of the aircraft 6000 in a first rotational direction about the aircraft's longitudinal axis. As shown in FIG. 60B, the one or more movable wall portions 6024 may move in a second direction (e.g., a leftward direction) in order to deflect a flow of air in an opposite direction to the first direction in order to control yaw of the aircraft 6000 in a second rotational direction about the aircraft's longitudinal axis opposite the first rotational direction. The one or more movable wall portions 6024 may be positioned on the outside edge or profile 6034A of the outlet end 6034. As the one or more movable wall portions 6024 deflect, the flow of air may exit the duct at an angle with respect to the outlet axis of the duct. The one or more movable wall portions 6024 may move to deflect air in a desired direction to control the device if one or more propulsion units of the aircraft 6000 fail or malfunction. The one or more movable wall portions 6024 may improve the safety and reliability of the aircraft 6000 since the one or more movable wall portions 6024 may move to direct flows of air in desired directions (e.g., towards the ducts 6030 having the failed propulsion unit) to safely land the aircraft 6000 due to the failing or malfunctioning propulsion unit. Additionally, the one or more movable wall portions 6024 may allow for additional control (e.g., counter yaw rotation due to imbalance caused by failing propulsion units) of the aircraft 6000 without having to increase the speed of the rotors. The one or more movable wall portions 6024 may be able to allow for additional control due to a failed propulsion unit without having to move/tilt the propulsion units to change the direction of airflow through the ducts 6030. The one or more movable wall portions 6024 may deliver an optimal flow of air to the airfoil 6002 if a propulsion unit fails (e.g., redirects the flow of air to an airfoil 6002 that stopped receiving a flow of air). The one or more movable wall portions 6024 may allow for simpler control (e.g., less complex programming instructions) of the propulsion units to deliver a flow of air to the airfoil 6002 (e.g., the speed of air delivered by the propulsion unit through the ducts 6030 does not need to be increased or slowed). The air may travel over the wing 6002 at such an angle as well.

As shown in FIG. 60C, the outlet end 6034 may include a deflectable movable plate 6024A which may be positioned in the middle of the outlet end 6034 and may move in a first or second direction (or a desired direction) in order to control the yaw of the aircraft 6000. Motion of the deflectable movable plate 6024A may be controlled by an actuator 6025A. For example, the deflectable movable plate 6024A may move in a first rotational direction (e.g., towards a wall of the profile 6034A and about a central axis of the aircraft 6000) to deliver a greater amount of flow to a section (e.g., a leftward section) of the airfoil 6002 in order to rotate, lift and/or tilt the aircraft 6000. The deflectable movable plate 6024A may move in a second rotational direction (e.g., towards an opposite wall of the profile 6034A and about a central axis of the aircraft 6000) to deliver a greater amount of flow to a section (e.g., a rightward section) of the airfoil 6002 in order to rotate, lift and/or tilt the aircraft 6000. Advantageously, controlling the deflectable movable plate 6024A can allow more control of the aircraft 6000 without increasing or decreasing an amount of airflow being delivered through the ducts 6030 and to the airfoil 6002. Additionally, controlling the deflectable movable plate 6024A may help deliver a desired amount of lift, stability, or maneuverability (e.g., robustness) to the aircraft 6000 if a propulsion unit loses power, stops rotating or fails (e.g., causing additional yaw on the aircraft 6000). The deflectable movable plate 6024A may assist in rebalancing the aircraft 6000 by directing a flow of air in a desired direction to counter yaw rotation from the failed rotor. The deflectable movable plate 6024A may allow for additional yaw control of the aircraft 6000 without having to increase the speed of a rotor (e.g., propulsion units 120). The deflectable movable plate 6024A may allow for simpler control (e.g., less complex programming instructions) of the propulsion units to deliver an optimal flow of air to the airfoil 6002. The outlet end 6034 may also include the one or more movable wall portions 6024 described in FIGS. 60A-60B.

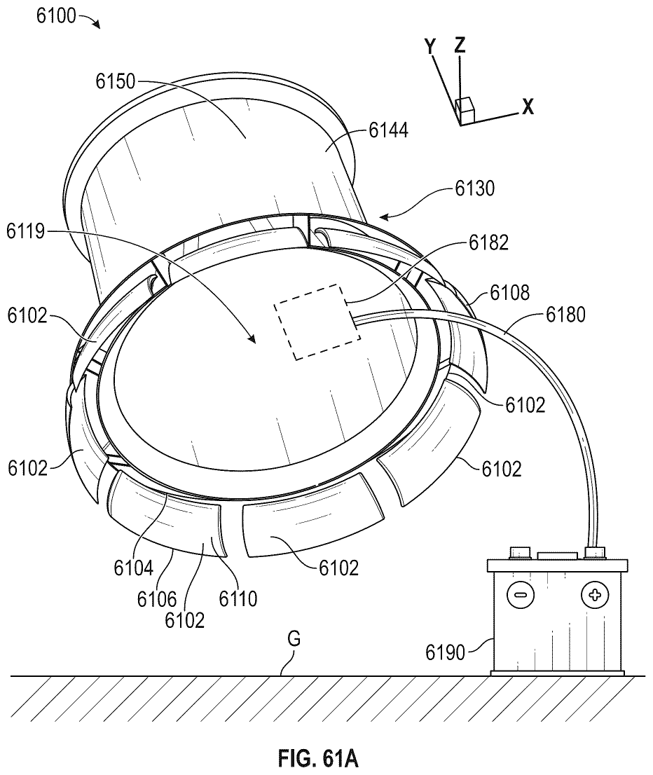

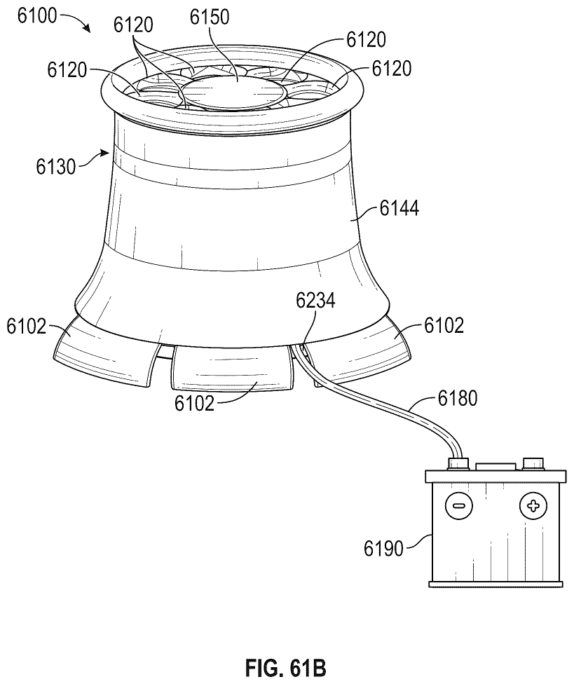

FIGS. 61A-61B illustrates bottom and top perspective views of an additional embodiment of an aircraft 6100 having components for use in aerolift systems. The aircraft 6100 may have the same or similar features and/or functions as aircraft 100, or any other aircraft disclosed herein, and vise versa. The aircraft 6100 may have wings 6102, a bottom portion 6119, a plurality of ducts 6130, and payload 6150. The wings 6102 may have a leading edge 6104, a trailing edge 6106, a top surface 6108, and a bottom surface 6110.

The aircraft 6100 may be coupled to a power source or power supply 6190. The power supply 6190 may be a battery or a generator. The power supply 6190 may be a hybrid electric engine and may be partly or entirely positioned on the ground or partly or entirely positioned within the aircraft 6100. The power supply 6190 may be a hybrid-electric powerplant. The power supply 6190 may be positioned on the ground or a ground surface G. The power supply 6190 may include a live power source and may be connected to a building. The power supply 6190 may include or be connected to an overhead power line, electric cables, utility poles, power cables, and/or the like. A tether 6180 may connect the aircraft 6100 with the ground (or building). The tether 6180 may include one or more electrical cables for transmitting electrical power from the ground to the aircraft 6100. Each cable may include a plurality of wires in a bundle. The tether 6180 may electrically connect the power supply 6190 to the aircraft 6100. The tether 6180 may also be a pantograph which may collect power through contact with an overhead power line.

The aircraft 6100 may have an electrical coupling region 6182. The tether 6180 may extend from the power supply 6190 and to the electrical coupling region 6182. The electrical coupling region 6182 may be disposed on a bottom portion 6119. In some examples, the electrical coupling region 6182 may be in other locations, for example on a sidewall (e.g., on the walled channel 6144) of the aircraft 6100.

The aircraft 6100 may not have any batteries or other power sources within the aircraft 6100. The power may only be supplied (e.g., via power supply 6190) from sources external to the aircraft 6100 and positioned on or adjacent to a ground surface G. The weight of the aircraft 6100 may therefore be drastically reduced without batteries onboard. The weight savings has cascading advantages for the overall system. For example, the lower weight reduces the output power levels and lifting forces required to be generated by the propulsion units, ducts, and lifting bodies.

The aircraft 6100 coupled to the power supply 6190 via the tether 6180 may be used for limited range missions. The tethered aircraft 6100 may be used for lifting objects to a higher altitude, such as on an upper floor of a skyscraper under construction, or to the roof of a building, etc. The tethered aircraft 6100 may be used for gaining a higher perspective or accessing higher components, such as inspecting or repairing a cell tower, radio tower, or other tall structure. Thus, the aircraft 6100 may be coupled to the power supply 6190 (e.g., via the tether 6180) during commercial use (e.g., when the aircraft 6100 is carrying passengers or cargo etc., as described). In some examples, the tethered aircraft 6100 may be used for research and development or testing of the aircraft 6100.

The tether 6180 may be used with any of the aerolift systems described herein. For example the tether 6180 may be used to power an individual aerolift system, such as aerolift systems 3601, 3701A, 3701B, 3701C, 3801, 3901, 4001, 4101, 4201A, 4201B. The tether 6180 may deliver power (e.g., via power source 6190) an elevator system, such as system 3700. The 6180 may power the system 3700 such that a cargo unit or a passenger compartment (e.g., passenger compartment 3760) may be lifted and lowered along a building. The tether may be used to power an aerolift system in order to move a machine structure (e.g., machine structure 3603). The machine structure may include an elevator, construction vehicle, skycrane, electric vertical take-off and landing (eVTOL) vehicle, helicopter, hovercraft, lift (e.g., ski-lift, utility lift, electric ladder), drill, hover drone, other flying vehicle, weather drone, or other system.

The tether 6180 may have a length configured for a particular mission. The tether 6180 may pay out from the ground supply 6190 or other deployment mechanism. The tether 6180 may therefore extend in length as the aircraft 6100 moves farther from the ground supply 6190. The tether 6180 may have various maximum lengths. In some examples, the tether 6180 may be at least 300 feet long. In some examples, the tether 6180 may be at least 50 feet, at least 100 feet, at least 150 feet, at least 200 feet, at least 250 feet, at least 350 feet, at least 400 feet, at least 450 feet, at least 500 feet, at least 600 feet, at least 700 feet, at least 800 feet, at least 900 feet, at least 1,000 feet, at least 1,500 feet, or longer. The tether 6180 and power supply 6190 can be used to power the aircraft 6100, where the aircraft may weigh at least 250 lbs., at least 300 lbs., at least 350 lbs., at least 400 lbs., at least 450 lbs., at least 550 lbs., at least 650 lbs., at least 700 lbs., or from 250 lbs. to 500 lbs. In some examples, the length of the tether may be fixed, and have any of the aforementioned lengths. In some examples, the tether 6180 may automatically retract into the ground station 6190 or other deployment mechanism such that there is little or no slack in the tether 6180 as the aircraft 6100 moves closer to the ground station 6190.

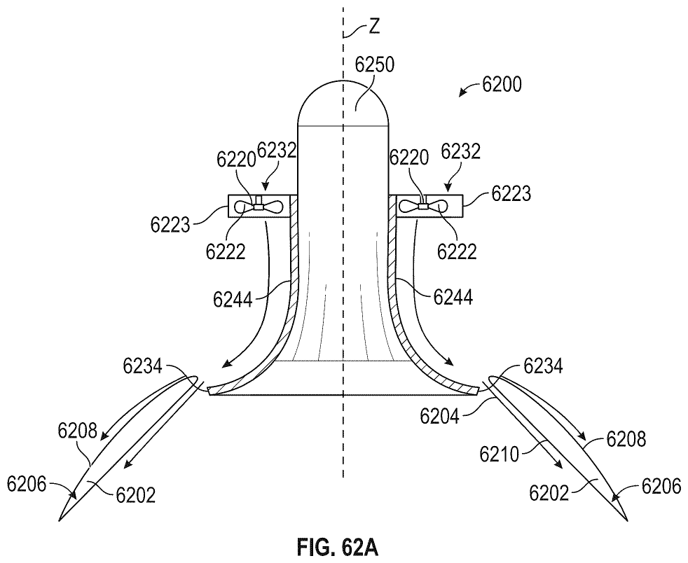

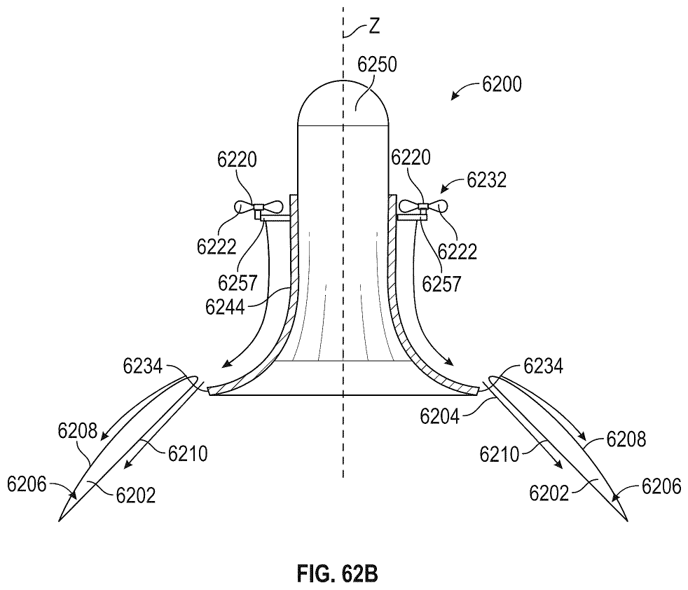

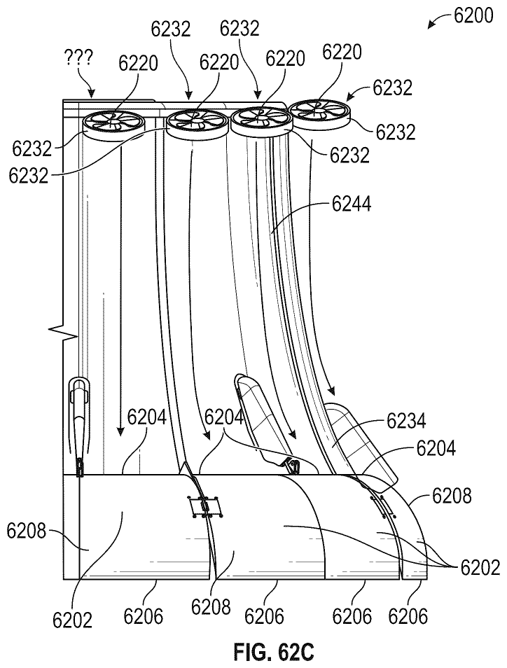

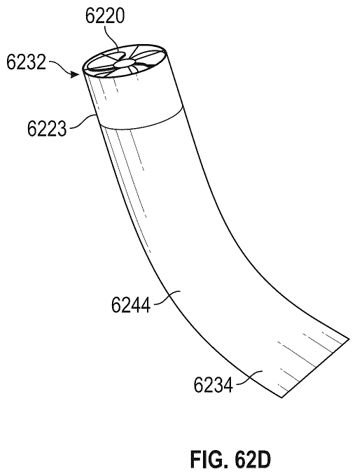

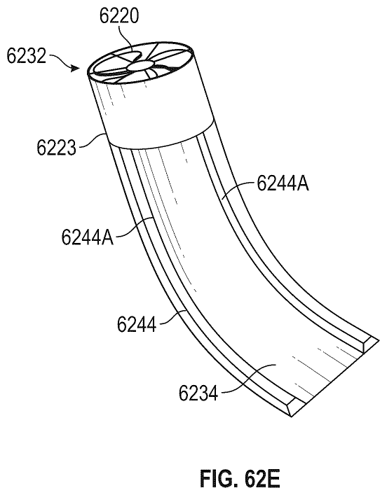

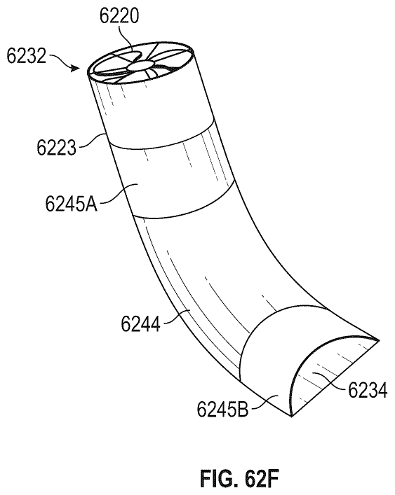

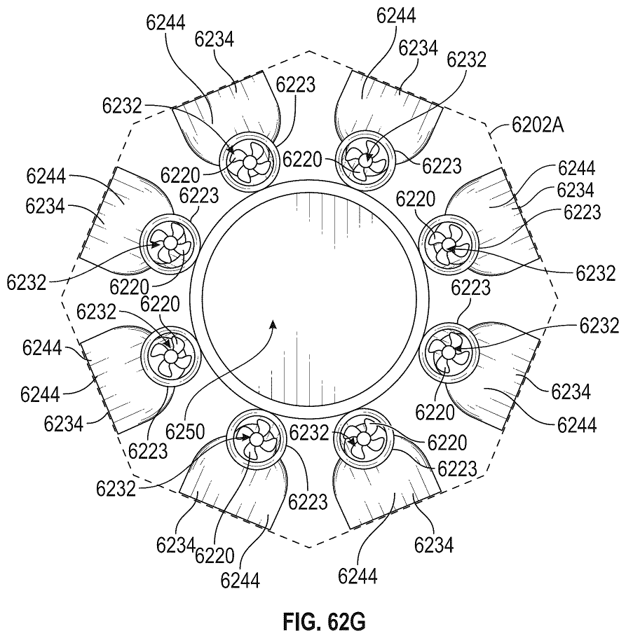

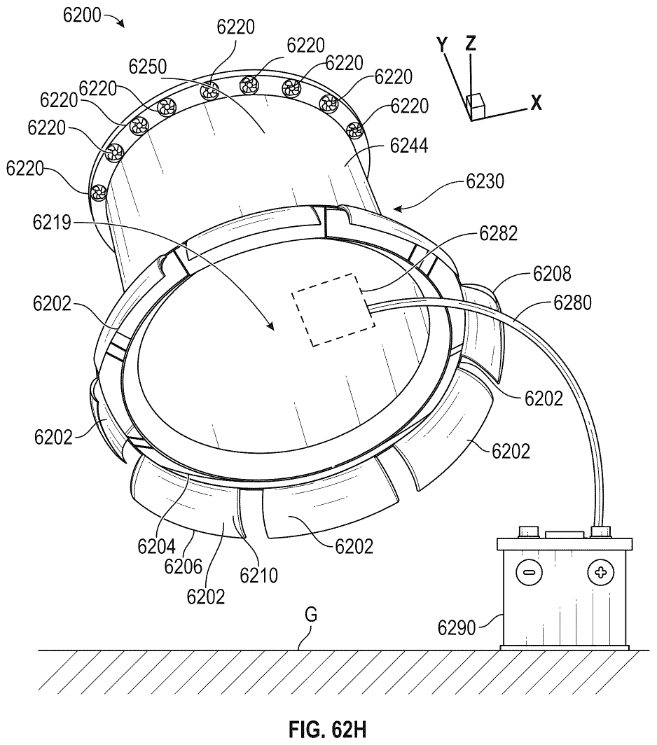

FIGS. 62A-62H illustrate various views of additional embodiments of an aircraft 6200 and aerolift system having an open duct. FIGS. 62A and 62B are cross-sectional views of the aircraft, FIG. 62C is a partial side view of the aircraft, FIGS. 62D-62F are perspective views of the aerolift system, FIG. 62G is a top view of the aircraft 6200, FIG. 62H is a bottom perspective view of the aircraft. The aircraft 6200 may have many or all of the same or similar features as aircraft 100, or any other aircraft disclosed herein, and vice versa, except as otherwise described. The same or similar reference numbers are used to refer to the same or similar features.

The aircraft 6200 may have a plurality of propulsion units 6220 spaced around a central body 6250. The propulsion units 6220 may have the same or similar features and/or functions as any other propulsion units described herein. The central body 6250 may be empty, or may contain a payload compartment, passenger area, cockpit, and/or the like. In the aircraft 6200, the plurality of propulsion units 6220 may be connected to (e.g., extend outward from) one or more open ducts 6244 of the central body 6250.

A flow of air may be moved by each propulsion unit 6220 from an inlet region 6232, along the one or more open ducts 6244, and to an end region 6234. The air may move from the end region 6234 to the lifting body 6202, such as a wing or an airfoil etc., as described herein. The lifting body 6202 may have a leading edge 6204, a trailing edge 6206, a top surface 6208, and a bottom surface 6210. The lifting body 6202 may have the same or similar features and/or functions as any other lifting bodies described herein. The one or more open ducts 6244 may be or form a sidewall, as further described.

FIG. 62A shows a cross-sectional view of the aircraft 6200 having the central body 6250 and one or more open ducts 6244. The central body 6250 can extend along and may be symmetric about a longitudinal centerline Z of the aircraft 6200. The aircraft 6200 may have a plurality of propulsion units 6220 positioned outward from the central body 6250. For example, the plurality of propulsion units 6220 may be positioned radially around the central body 6250 (e.g., when the central body is at least partially circular or partially cylindrical).

The central body 6250 may have a sidewall or sidewalls formed by the one or more open ducts 6244. The central body 6250 may be conical (e.g., a conical or frustoconical body) or have a curved outer body or shape (e.g., a trumpet or flared shape) relative to the longitudinal centerline Z of the aircraft 6200. The one or more open ducts 6244 may guide the flow of air moved by the propulsion units 6220 to the lifting bodies 6202.

The one or more open ducts 6244 may each have the same or similar features and/or functions as other open ducts described herein. For example, the aircraft 6200 may include the ducts 3330 having the elongated openings 3347B, as shown in and described with respect to FIG. 33E. As mentioned, the elongated openings 3347B may be located on the top (e.g. radially outward) surface of the duct wall and along both lateral (e.g. circumferential) sides of the duct wall. The resulting shape of the plurality of such ducts 3330 arranged together may be as shown in FIG. 62A. There may be a plurality of the ducts 3330 extending annularly around the aircraft 6200. The ducts 3330 may share a common sidewall. The one or more open ducts 6244 may form one continuous surface that is shared by each of the ducts 6244. The open duct 6244 may have an open cross-sectional profile, such as a trough or slide-like shape. The open duct 6244 may have a planar cross-sectional profile.

In some embodiments, the elongated opening 3347B (as shown in FIG. 33E) may only be located along a radially outer sidewall of the duct 3330. The elongate opening 3347B may extend over the entire radially outer sidewall. The duct 3330 may include lateral walls (see FIG. 62E showing lateral walls 6244A) extending along the length of the duct 3330 on circumferential sides of the air flow path from one of the propulsion units 6220, for example a trough, or a playground slide-like shape.

The plurality of propulsion units 6220 may have a plurality of blades 6222 which may rotate to direct a flow of air along the one or more open ducts 6244. The plurality of propulsion units 6220 may direct the flow of air downward (e.g., along the one or more open ducts 6244) towards a lifting body 6202. The plurality of propulsion units 6220 may be positioned at or adjacent to a top region of the central body 6250 or the open duct 6244 at an inlet region 6232. The inlet region 6232 may be where the flow of air directed by the plurality of propulsion units 6220 is delivered from and along the open duct 6244. The flow of air may travel along the open duct 6244 and to the end region 6234 before flowing around the lifting body 6202.

The aircraft 6200 may therefore not include a closed cross-sectional profile duct (e.g., the duct 130, or a “tunnel” shape) and the flow of air directed from the plurality of propulsion units 6220 may only be guided (e.g., directed) by the shape or profile of the sidewall formed by the open duct 6244.

In some examples, the one or more open ducts 6244 may include sections that have a closed cross-sectional profile. The open duct 6244 may have an open cross-sectional profile between the sections having the closed cross-sectional profile. For example, the propulsion units 6220 may be ducted fans having a shroud, as further described. As further example, the duct 6244 may include a closed cross-sectional profile extending partially along one or more sections of the open duct 6244. An upstream end of the open duct 6244, such as just below (downstream of) the propulsion unit 6220 and/or the inlet region 6232, may have a closed cross-sectional profile 6245A (see FIG. 62F). The closed cross-sectional profile 6245A may extend from an upstream end of the duct 6244 in a downstream direction no more than 5%, no more than 10%, no more than 15%, or no more than 20% along the length of the airflow path of the open duct 6244 between the inlet region 6232 and the end region 6234. A downstream end of the open duct 6244, such as just above (upstream of) the lifting body 6202 and/or the end region 6234, may have a closed cross-sectional profile 6245B (see FIG. 62F). The closed cross-sectional profile 6245B may extend from a downstream end of the duct 6244 in an upstream direction no more than 5%, no more than 10%, no more than 15%, or no more than 20% along the length of the airflow path of the open duct 6244 between the end region 6234 and the inlet region 6232. The open duct 6244 may include the closed cross-sectional profiles at both the upstream end and the downstream end.

Each of the propulsion units 6220 and the corresponding blades 6222 may be placed or contained within a shroud 6223. The shroud 62223 may be a circular, or rounded, tubular sidewall surrounding lateral sides of the propulsion unit 6220, such as surrounding the blade 6222. The shroud 6223 may be open at the top and bottom to allow air to flow into the top and out the bottom. The propulsion units 6220 may be ducted fans. The propulsion units 6220 may have the same or similar features and/or functions as other propulsion units described herein, such as the propulsions units 120 shown in and described with respect to FIG. 2. The plurality of propulsion units 6220 can spin the plurality of blades 6222 to generate a flow of air within the shroud 6223 that may be directed downward along the open duct 6244. The propulsion unit 6220 having the shroud 6223 may be used with any of the open duct examples described herein, such as completely open, or partially closed in one or more sections, as described.

FIG. 62B shows a cross-sectional view of the aircraft 6200 having the plurality of propulsion units 6220 extending from the central body 6250 from a support 6257. The plurality of propulsion units 6220 may be unshrouded. The blades 6222 may be uncovered along sides thereof. The blades 6222 may thus rotate freely within the ambient atmosphere. The propulsion unit 6220 without the shroud 6223 may be used with any of the open duct examples described herein, such as completely open, or partially closed in one or more sections, as described.

FIG. 62C shows a partial side view of the aircraft 6200 with a plurality of plurality of the propulsion units 6220 spaced along the inlet regions 6232. Each propulsion unit 6220 may deliver the flow of air from the respective inlet region 6232 along the open duct 6244 and towards the leading edge 6204 of the lifting body 6202. The propulsion units 6220 may have the shroud 6223 as shown, or the propulsion units 6220 may not have the shroud 6223. The one or more open ducts 6244 may include one or more closed cross-sectional sections, or lateral walls, etc., as described. The propulsion units 6220 whether shrouded or otherwise, may be fixed and not rotate or otherwise move, such that the air is always moved in the same direction relative to the inlet region 6232. In some examples, whether shrouded or otherwise, the propulsion units 6220 may gimbal, for example rotate. The propulsion units 6220 may rotate about one, two, or three axes. The propulsion units 6220 may gimbal to direct air at different angles relative to the vertical direction as defined by the aircraft longitudinal axis or a gravity vector.

FIGS. 62D-62F show perspective view of aerolift systems. One or more of the aerolift systems may be used with the aircraft 6200 or other applications, such as elevators, skycranes, industrial machines, etc., as described herein. The aerolift system may include the open duct 6244 and the propulsion unit 6220 at the inlet region 6232 configured to move air along the open duct 6224 toward the end region 6234. The open duct 6244 may have the open cross-sectional profile shape extending from the propulsion unit 6220 to the end region 6234 as shown. The open duct 6244 may have one or more lateral walls 6244A extending from the inlet region 6232 to the end region 6234. The open duct 6244 may also have a closed cross-sectional profile 6245A positioned at the inlet region 6232 and a closed cross-sectional profile 6245B positioned at the end region 6234.

FIG. 62G shows a top view of the aircraft 6200 having the plurality of propulsion units 6220 spaced radially outward from the central body 6250. The open ducts 6244 may be spaced away from the central body 6250. The propulsion units 6220 may be connected to (e.g., extend from) the central body 6250 (e.g., via the support 6257). The open duct 6244 may be separate from and radially spaced from the central body 6250. There may be eight open ducts 6244 as shown which may be supported radially outwardly away from the central body 6250. There may be any number of the open ducts 6244, as described herein, such as at least one, at least two, at least three, at least four, at least five, at least six, at least seven, at least eight, at least ten, at least twelve, or at least fourteen or more of the open ducts 6244. The open ducts 6244 (e.g., as defined by the end regions 6234) can form an eight-sided profile 6202A. In some examples, the open ducts 6244 (e.g., as defined by the end region 6234) may form other profiles or shapes (e.g., four-sided profile, six-sided profile, circular profile, elliptical profile, and the like). The open ducts 6244 may be arranged in an annular configuration as shown. In some examples, the open ducts 6244 may be arranged in other configurations, such as linear, etc., as described herein.

The open duct 6244 provides numerous advantages to the aerolift system and the applications in which the aerolift system is used, such as an aircraft. Directing the flow of air downwards along the open duct 6244 towards the lifting body 6202 (e.g., instead of directing the flow through a duct) may reduce the static pressure of the flowing air since there is no forces (e.g., due to the flowing air) acting on a closed cross-sectional duct profile (e.g., duct 130). Additionally, directing the flow of air downwards along the open duct 6244 from the plurality of propulsion units 6220 may reduce efficiency losses caused by the static pressure along a closed cross-sectional duct profile and may reduce efficiency losses caused by boundary layers of the airflow along the length of such duct. The flow of air from the plurality of propulsion units 6220 along the open duct 6244 and towards the leading edge 6204 of the lifting body 6202 may be optimized in order to improve lift of the lifting body 6202. The weight of the aircraft 6200 is also reduced because portions of the closed cross-sectional duct material are not included in the open duct 6244 (for example, at the elongated openings 3347B.

FIG. 62H shows the aircraft 6200 that may be coupled to a power source or power supply 6290. A tether 6280 may connect the aircraft 6200 with the ground. The tether 6280 may include one or more electrical cables for transmitting electrical power from the ground to the aircraft 6200. Each cable may include a plurality of wires in a bundle. The tether 6280 may electrically connect the power supply 6290 to the aircraft 6200. The tether 6280 may extend from the power supply 6290 and to the electrical coupling region 6282. The electrical coupling region 6282 may be disposed on a bottom portion 6219 of the aircraft 6200.

Example Aircraft with an Annular Airflow Duct

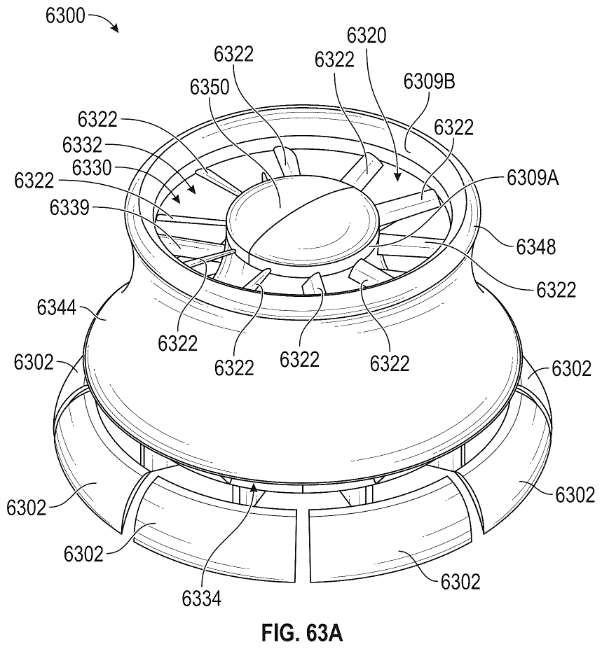

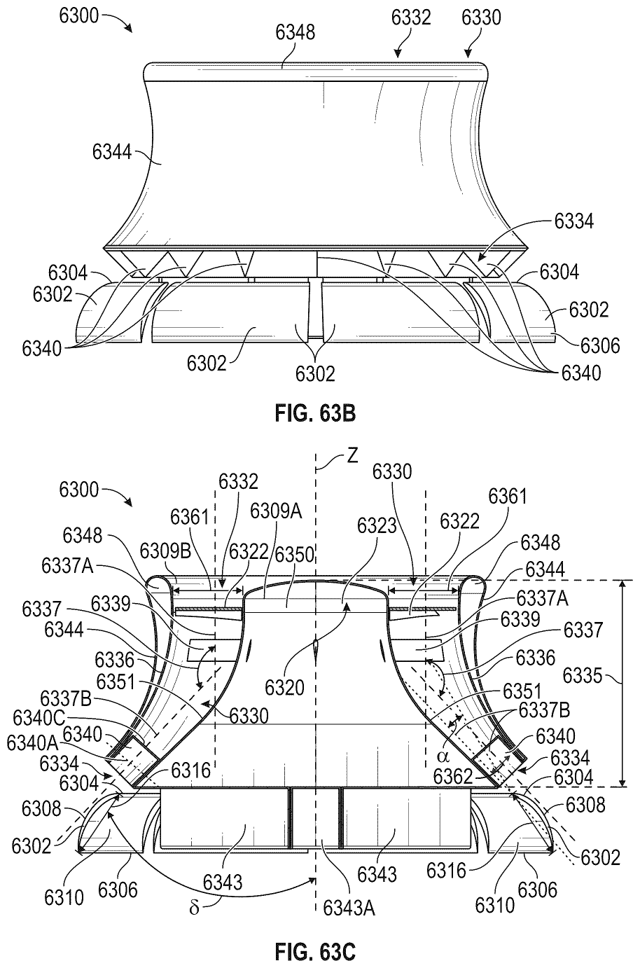

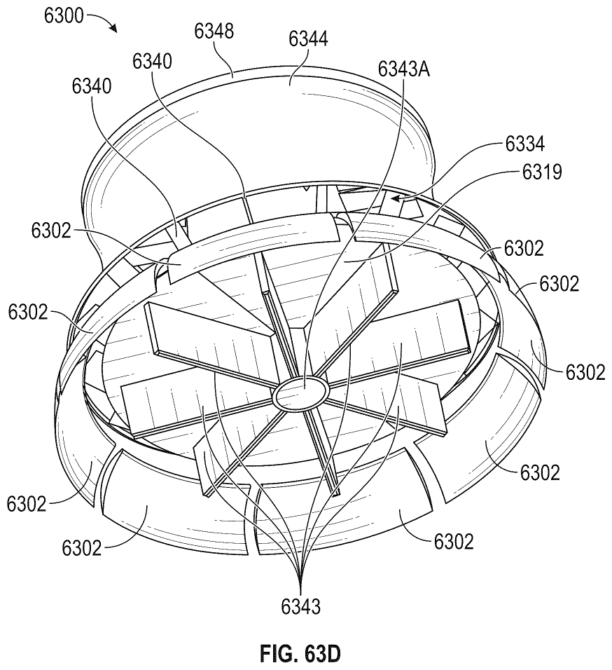

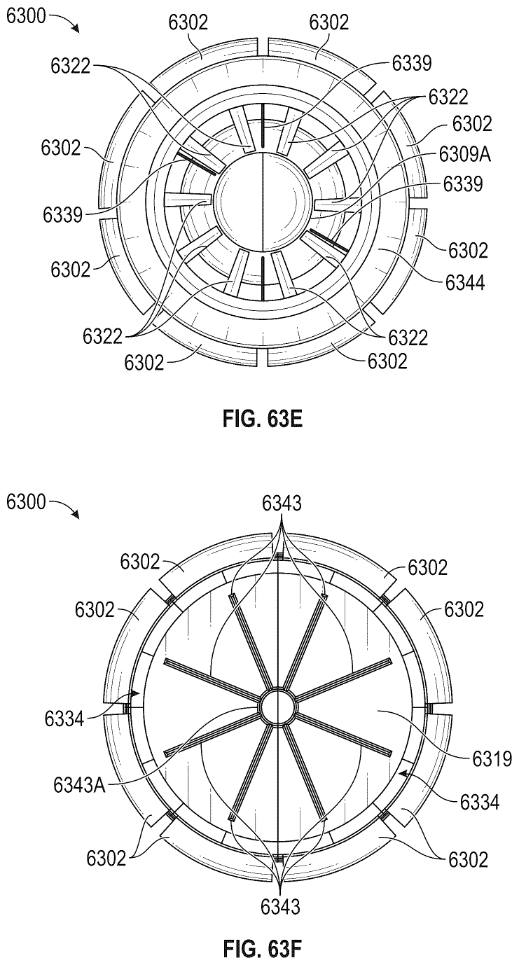

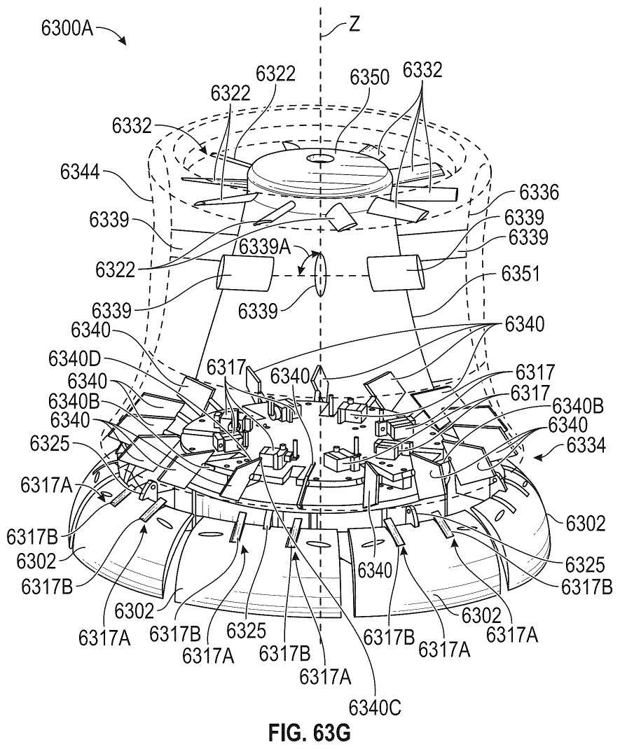

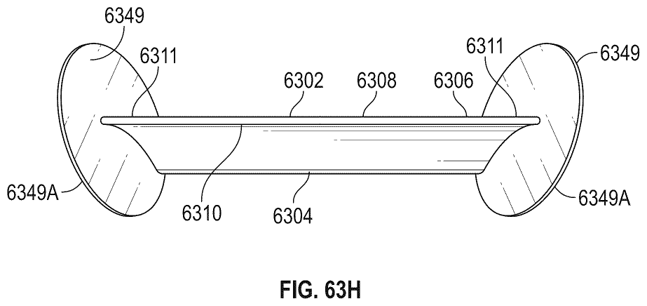

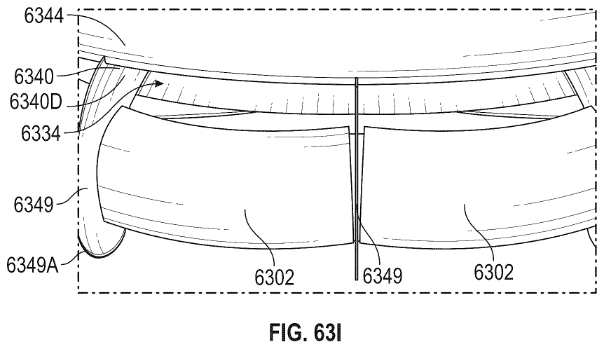

FIGS. 63A-63F illustrate various views of additional embodiments of an aircraft 6300 having an annular airflow duct. The aircraft 6300 may have any or all of the same or similar features as aircraft 100, aircraft 1300, aircraft 1400, aircraft 1500, or any other aircraft disclosed herein, and vice vera, except as otherwise described. The aircraft of FIGS. 63A-63F may include any of the features shown in or described with respect to FIGS. 13A-16, and vice versa, except as otherwise described. The same or similar reference numbers are used to refer to the same or similar features.

FIG. 63A is a top perspective view of the aircraft 6300. FIG. 63B is a front view of the aircraft 6300. FIG. 63C is a cross-sectional view of the aircraft 6300. FIG. 63D is a bottom perspective view of the aircraft 6300. FIG. 63E is a top view of the aircraft 6300. FIG. 63F is a bottom view of the aircraft 6300. The aircraft 6300 may be able to lift a payload weighing at least 100 pounds (lbs.), at least 200 lbs., at least 300 lbs., at least 400 lbs., at least 500 lbs., at least 600 lbs., at least 700 lbs., at least 800 lbs., at least 900 lbs., or at least 1,000 lbs. In some cases, the aircraft 6300 may be able to lift and transport a payload weighing from 200 lbs. to 400 lbs. The aircraft 6300 may have a maximum takeoff weight from 1,000 lbs. to 3,000 lbs., or from 1400 lbs. to 2000 lbs.

The aircraft 6300 has a single, annular airflow duct 6330. The annular airflow duct 6330 may have a conical shape, or a flared “trumpet bell” shape. The annular airflow duct 6330 may be symmetric about the longitudinal axis Z. The annular airflow duct 6330 may be positioned within an outer wall 6344 of the aircraft 6300 (and/or may be defined by a space between outer wall 6344 and central body 6350). The aircraft 6300 may not include multiple, distributed ducts (e.g., the duct 130, or a “tunnel” shape). As a geometric reference, the shape of the annular airflow duct 6330 may be visualized by rotating the cross-sectional profile of the flow path of the “tunnel” shaped duct 130 a full 360 degrees about the longitudinal axis Z of the aircraft 6300.

In some examples, the duct 6330 may be unobstructed or substantially unobstructed along the flow path of air in a central region between an annular inlet 6332 and an annular outlet 6334 (for example between any stators or vanes that may be located within the duct 6330, as further described). Such a central region may be unobstructed in a circumferential direction around the central body, for example for 360 degrees around the central body.

In some examples, a cross-section through the duct 6330 taken perpendicularly to the vertical axis, or taken perpendicular to the airflow direction at that point in the duct 6330, may be annular in shape (e.g., an inner circular or other closed shape nested within an outer circular or other closed shape, similar to aircraft 1300).

In some embodiments, walls or other dividers may be included (similar to as shown in FIGS. 15A-16) which divide the duct 6330 into multiple ducts each having a single closed cross-sectional profile, while still maintaining some or all of the other features of aircraft 6300.

The annular airflow duct 6330 defines a flow path for the air from the annular inlet 6332 to the annular outlet 6334. The annular inlet 6332 may be an upstream and/or upper portion at one end of the annular airflow duct 6330 configured to receive ambient airflow therein. The annular outlet 6334 may be a downstream and/or lower portion at another opposite end of the annular airflow duct 6330 configured to receive airflow from the annular airflow duct 6330 therethrough. The annular inlet 6332 may be open at a top portion of the aircraft 6300 and may span an entire 360 degree-profile of the aircraft 6300 relative to the longitudinal axis Z. The annular inlet 6332 may not be segmented. The air may flow into the annular inlet 6332, through the annular airflow duct 6330, and out the annular outlet 6334 toward one or more lifting bodies 6602. In some examples, the annular airflow duct 6330 may include one or more openings (e.g., one or more openings 3347A and/or elongated opening 3347B) as described herein with respect to FIGS. 33D and 33E. The annular airflow duct 6330 may have any or all of the features as the ducts 3330 discussed in FIGS. 33D and 33E, and vice versa. Such openings may be distributed annularly and/or longitudinally along the outer wall of the annular airflow duct 6330

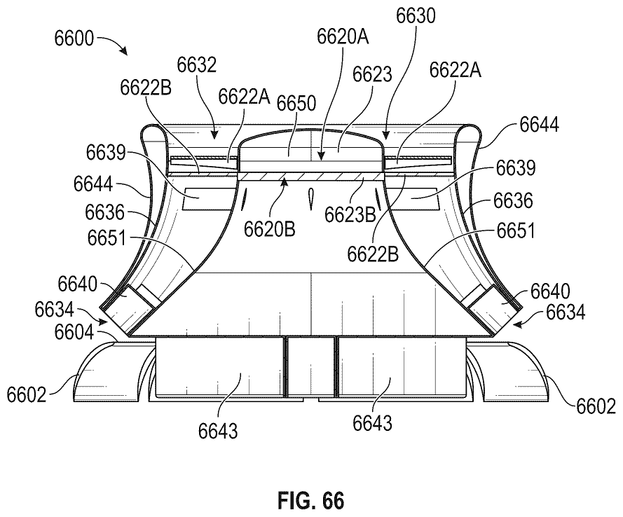

The annular inlet 6332 or upper portion thereof may extend along an inlet axis 6337A. The inlet axis 6337A is parallel to the longitudinal axis Z in this embodiment, but may not be parallel to the longitudinal axis Z in some embodiments. The inlet axis 6337A may be at least close to parallel to the longitudinal axis Z (such as within 5 degrees or within 10 degrees of parallel to the longitudinal axis Z). This is particularly beneficial in an aircraft like aircraft 6300, which has a single rotating fan (e.g., blades 6322 described below, and/or a version with two counter-rotating fans as shown schematically in FIG. 66) that rotates about the longitudinal axis Z and produces airflow for the entire annular inlet 6332 in a direction generally parallel to the longitudinal axis Z).

It should be noted that, when referring to an inlet axis (e.g., inlet axis 6337A) or an outlet axis (e.g., outlet axis 6337B) in the context of a single annular duct (e.g., duct 6330), the axes are defined by the direction of airflow in a plane into the inlet end of the duct and out of the outlet end of the duct. This is seen, for example, when the duct is viewed as a longitudinal cross-section through the longitudinal axis, as shown in FIG. 63C. These are just example axes, and the airflow flows along other similarly-oriented axes distributed annularly about the duct 6330. Thus, in the embodiment of the duct 6330, the airflow into the annular inlet 6332 of the duct 6330 flows along a generally annular (e.g. cylindrical) shape, which includes the two inlet axes 6337A being shown as parallel to the longitudinal axis Z in FIG. 63C. The airflow out of the annular outlet 6334 of the annular airflow duct 6330 flows along a generally conical or frustoconical shape, corresponding to the two outlet axes 6337B being shown at an angle to the longitudinal axis Z.

In an alternative embodiment that does not have the airflow into the inlet parallel to the longitudinal axis Z, the airflow into the inlet would—like the airflow out of the outlet—be a generally frustoconical shape, resulting in the two inlet axes 6337A being at an angle to the longitudinal axis Z. Such angled inlets may be angled outward away from the longitudinal axis Z or inward toward the longitudinal axis Z.

In some examples, the length or shape of the annular airflow duct 6330 may be configured to provide a desired speed and direction of airflow to provide streamlined airflow and a desired amount of lift necessary for the operational requirements of the aircraft 6300. The length 6335 of the annular airflow duct 6330 may be measured along the longitudinal axis Z (see FIG. 63C). The length 6335 may be no more than 80 inches, no more than 70 inches, no more than 60 inches, no more than 50 inches, from 35 to 75 inches, from 45 to 70 inches, or from 55 to 65 inches. The description regarding duct length with respect to FIG. 54C may also apply to aircraft 6300.

In general, it can be desirable to have a relatively short duct length for the aircraft 6300. This can reduce the weight of the duct itself as compared to a longer duct, and can also have a “cascading effect” on other components of the aircraft and thus the overall weight of the aircraft 6300 (e.g., by also reducing the weight of other components that have masses or shapes that are at least partially dictated by the duct shape). Accordingly, the aircraft can be more efficient, and/or can have a higher payload capacity for a given amount of lift being generated.

In the context of an aircraft having an annular duct (such as annular airflow duct 6330), the proportions of the duct 6330 can be considered by the following length to inlet width ratio: the vertical length of the duct (e.g., length 6335, measured parallel to the longitudinal axis Z) divided by the radial width of the inlet of the duct (e.g., dimension 6361, measured perpendicular to the longitudinal axis Z). In the aircraft 6300, the length to inlet width ratio may be from 2.5 to 3.0, from 2.25 to 3.25, or from 2.0 to 3.5. In some examples, the length to inlet ratio may be greater than 3.5. The same or similar ratios can also apply to aircraft that have multiple ducts instead of a single annular duct.

The annular airflow duct 6330 can have an expansion ratio from the annular inlet 6332 to the annular outlet 6334. The expansion ratio from the inlet to the outlet may be approximately 1:1 (e.g., where the dimension 6361 or area at the annular inlet 6332 is equal to respectively the dimension 6362 or area at the at the annular outlet 6334). The expansion ratio may be from 0.5 (e.g., the dimension 6361 or area at the annular inlet 6332 is half as large as respectively the dimension 6362 or area at the annular outlet 6334) to three (e.g., the dimension 6361 or area at the annular inlet 6332 is three times larger than respectively the dimension 6362 or area at the annular outlet 6334). Other ratios as described herein may be incorporated. In some embodiments, the dimension 6362 at the annular outlet 6334 can be approximately eleven inches. Additionally, the dimension 6362 at the annular outlet 6334 can be between 9 inches and fifteen inches. The same or similar ratios can also apply to any of the aircrafts having an annular duct disclosed herein. In some embodiments, the expansion ratio can be considered as a ratio between the surface area of the annular duct inlet (e.g., the difference between the diameter of the inner surface 6336 at the inlet minus the diameter of the outer surface 6351 at the inlet) and the surface area of the annular duct outlet (e.g., the area of the annular outlet 6334 spanning the diameter of the aircraft 6300). The expansion ratio may be the surface area of the annular duct inlet divided by the surface area of the annular duct outlet). In some embodiments, this ratio is approximately 1. In some embodiments, this ratio is greater than 1. In some embodiments, this ratio is less than 1. In some embodiments, this ratio is from 0.9 to 1.1, from 0.8 to 1.2, or from 0.75 to 1.25.

The aircraft 6300 may also have a propulsion system 6320. At least a portion of the propulsion system 6320, such as blades 6322 which may be fan blades, may be positioned within the annular airflow duct 6330. The propulsion system 6320 may be adjacent to the annular inlet 6332. The propulsion system 6320 may also be partially recessed within the annular inlet 6332. Positioning the propulsion system 6320 within the annular inlet 6332 can reduce the amount of vortices (e.g., swirling air) experienced by the plurality of blades 6322 at the tip (e.g., to reduce downwash). The propulsion system 6320 may rotate or swivel within the annular inlet 6332 as discussed herein with reference to FIG. 7. Thus the axis of rotation may rotate, swivel, wobble, etc. Such movement of the propulsion system 6320, and therefore the blades 6322, may vary the blade pitch of the blades 6332. The motor driver 222 (see FIG. 7) may receive instructions from the controller or processor 212 which may be used to adjust the speed and/or blade pitch and/or rotor axis of the motor 6323 coupled to the propulsion system 6320.

The propulsion system 6320 may have a plurality of the blades 6322 which extend within the annular airflow duct 6330 from the inner inlet lip (e.g., from a central hub or disc) 6309A and to (or adjacent to) the outer inlet lip 6309B or the outer lip 6348. The annular airflow duct 6330 may be positioned entirely within the outer lip 6348. In some examples, the propulsion system 6320 may include ten blades 6322. In some examples, the number of blades 6322 may be from six to twenty blades 6322. The blades 6322 may have a constant chord along a length thereof. The blades 6322 may twist at an angle from the inner inlet lip 6309A to the outer inlet lip 6309B. The blades 6322 may twist at approximately twenty degrees. The blades 6322 may twist from ten degrees to thirty degrees. The twist may refer to a changing angle of attack of the blades 6322 along their lengths. The twist of the blades 6322 may be varied dynamically, either via direct adjustment of the blades 6322 (by rotating or deforming the blades 6322 themselves), and/or by rotating or swiveling the propulsion system 6320 at the annular inlet 6332, as described herein.

The embodiment in FIG. 63C includes the propulsion system 6320 having a single (i.e., one) fan (e.g., the single fan comprising multiple blades 6322 configured to rotate essentially in a first plane about longitudinal axis Z in a first direction, such as a counterclockwise direction as viewed from above). Other embodiments of the propulsion system 6320 may include a second, counterrotating fan (e.g., comprising another plurality of blades 6322 configured to rotate, essentially in a second plane offset from the first plane, and about longitudinal axis Z in a counter counterclockwise direction, see FIG. 66). Two counter-rotating fans may zero-out or minimize the yaw induced on the aircraft due to the rotating blades 6322. Further, the first or second fan alone may be able to provide sufficient propulsion and deliver the flow of air through the annular airflow duct 6330 in emergency situations. For example, if the first fan (the propulsion system 6320) fails or stops operating, the second fan may be able to deliver the flow of air through the annular airflow duct 6330 and to the lifting bodies 6302 in order to assist with flight and landing of the aircraft 6300. A single fan may provide sufficient lift for increasing or maintaining altitude, and/or for descending at a safe speed. The two rotating fans may be aligned coaxially about the rotational axis.

The annular airflow duct 6330 may also have a plurality of vanes 6340 positioned at and/or near the annular outlet 6334. The vanes 6340 may be square, rectangular, trapezoidal, circular, oval-shaped, or curvilinear. The vanes 6340 may be plates that extend partially along the annular airflow duct 6330 from the annular outlet 6334 (e.g., from or near an outermost edge or opening of the annular outlet 6334), similar to the vanes 3243 as discussed above with reference to, for example, the duct of FIGS. 32A-32D. The vanes 6340 may have the same or similar features and/or functions as the vanes 3243, and vice versa. The vanes 6340 may also be one or more movable wall portions, nozzles, or plates, similar to the one or more movable wall portions 6024 and deflectable movable plate 6024A as discussed herein with reference to, for example, the ducts 6030 of FIGS. 60A-60C. The vanes 6340 may be curved. Further description of the vanes 6340 is provided herein.

The aircraft 6300 may include one or more lifting bodies 6302 (e.g., wings or wing sections, airfoils, or the like) at the annular outlet 6334. The lifting bodies 6302 may have the same or similar features and/or functions as any other lifting body described herein, such as the wing 102, wing 2502, wing 2602, wing 3502, wing 5402, and lifting body 6202, and vice versa, except as otherwise described. For example, the lifting bodies 6302 may include any of the features shown in or described with respect to FIGS. 1A-4B, 6A-6B, 13A-16, 25A-27E, 35A-35B, 54A-54C, and 62A. The aircraft 6300 may include eight lifting bodies 6302 as shown, but this is just one example. In some examples, the aircraft 6300 may include one, at least two, at least four, at least six, from one to twenty, or from four to twelve, or from six to ten lifting bodies 6302. The propulsion system 6320 may be designed to deliver a flow of air from the annular inlet 6332 through the annular airflow duct 6330, out the annular outlet 6334, and to the lifting bodies 6302.

The annular outlet 6334 may extend along an outlet axis 6337B. The outlet axis 6337B may be angled relative to the inlet axis 6337A. The angle measured between the inlet axis 6337A and the outlet axis 6337B may be a turn angle 6337 (similar to turn angle 3137, turn angle 3537, and/or turn angle 5437, as discussed above with respect to other aircrafts disclosed herein, and vice versa, except as otherwise described). The turn angle 6337 may correspond to end portions of the curvature along the annular airflow duct 6330 from the annular inlet 6332 to the annular outlet 6334. Thus the annular airflow duct 6330 may extend along a curve from the annular inlet 6332 to the annular outlet 6334. The inlet and outlet axes 6337A, 6337B may therefore be reference axes that are perpendicular to a cross-section of the annular inlet or outlet 6332, 6334 and/or that align with an average direction of airflow at the annular inlet or outlet 6332. More details about the turn angle 6337 are disclosed herein, and in particular, with reference to the features shown in or described with respect to FIGS. 31A, 35B, and 54C, and the value of the turn angle 6337 may include any of turn angle values discussed elsewhere herein.

The annular outlet 6334 may be angled downward (e.g., as defined by orientation of axis 6337B) relative to the longitudinal axis Z. The annular outlet 6334 may be angled downward to deliver the flow of air to the leading edge 6304 of the lifting body 6302 at a desired angle of attack. The lifting body 6302 may also be angled in a generally downward direction (e.g., when the lifting body 6302 is oriented at an angle from 10 degrees to 45 degrees with respect to the longitudinal axis Z). Such downward angles of the annular outlet 6334 and/or the lifting body 6302 may be the same or similar to the downward angles as discussed herein, for example with respect to FIGS. 29A-29D, 30B, 30E-31B, 35A-35B, and 54A-54C.

For instance, one or more of the lifting bodies 6302 may be angled downward, or in some examples oriented substantially vertically, as represented by the angle δ defined between the chord 6316 of each of the multiple lifting bodies 6302 and the longitudinal axis Z of the aircraft 6300. The angle δ may have any of the values shown or described herein with respect to any other example aircraft or systems disclosed herein. For example, the angle δ may be from 15 to 45 degrees. Further, one or more of the lifting bodies 6302 may have an angle of attack α, which may correspond to the angle between the chord 6316 and the direction of the flow of air exiting the annular outlet 6334 (which may be along the outlet axis 6337B, as indicated in FIG. 63C relative to a line parallel to the outlet axis 6337B, for clarity). The angle of attack a may have any of the values, and the chord and reference axis may have any of the features, described herein with respect to the angle between the exiting airflow or outlet axis and the chord 2616 (see FIGS. 27A-27E), the chord 3016 (see FIGS. 30A-30F), the chord 3516 (see FIG. 35A), and vice versa. For example, the angle of attack α may be from 10 to 20 degrees.

The annular outlet 6334 may be an entirely open outlet end. The annular outlet 6334 may be open radially (e.g., entirely along an outer radial edge spanning a 360-degree profile of the aircraft 6300). The vanes 6340 may be positioned within or near the annular outlet 6334 and may form regions to move the flow of air to or over a desired lifting body 6302.

As further depicted in FIG. 63C showing the cross-sectional view of the aircraft 6300, the propulsion system 6320 may include a motor 6323. The motor 6323 may be operable to rotate the blades 6322 within the annular airflow duct 6330 at the annular inlet 6332. The motor 6323 may be an electric motor. The motor 6323 may be a dual engine motor, a internal combustion engine, a turbofan engine, a turboshaft engine, a turboprop engine, a turbojet engine or the like. The motor 6323 may be able to power the aircraft 6300 for at least one hour, at least two hours, and/or at least four hours. There may be a plurality of the motors 6323 (e.g., two, three, four, or more motors) for a single rotor, such that the propulsion system 6320 may still be powered should one of the motors fail. Thus a single rotor may have multiple engines powering it (using gear box and transmission) for redundancy.

The propulsion system 6320 may be operated by a user, a pilot, a ground controller, or by an autonomous controller (see, for example, FIG. 7). The propulsion system 6320 may be operable to ensure (e.g., via the controller) to vertically lift the aircraft 6300 to a desired height before flying in a desired direction.

The plurality of blades 6322 may rotate about the central body 6350 of the aircraft 6300. The central body 6350 may have a dome-like shape and can extend from the annular inlet 6332 and to the annular outlet 6334 about a longitudinal axis Z of the aircraft 6300. The aircraft 6300 may be symmetrical about the longitudinal axis Z. The propulsion system 6320 may generate a flow of air from the rotation of the plurality of blades 6322 which may deliver a flow of air along the annular airflow duct 6330 between the outer surface 6351 of the central body 6350 and along an inner surface 6336 of the aircraft 6300 (e.g., an inner surface 6336 opposite to the outer wall 6344).

The aircraft 6300 may also have an outer lip 6348. The outer lip 6348 may provide a smooth transition surface for the flow of air pulled in by the propulsion system 6320 to flow in the annular inlet 6332. The outer lip 6348 may be a rounded lip. The outer lip 6348 may be designed to provide for a better conditioned or more laminar flow of air into the annular inlet 6332. The outer lip 6348 may include the outer inlet lip 6309B, which may be a radially inwardly rounded portion thereof. The central body 6350 may include the inner inlet lip 6309A, which may be a radially outwardly rounded portion thereof. The inner inlet lip 6309A and the outer inlet lip 6309B may form smooth transition surfaces for the flow of air into the duct 6330. The combination of the outer lip 6348, the outer inlet lip 6309B, and the inner inlet lip 6309A can improve the flow of air from the annular inlet 6332 to the annular outlet 6334 such that the flow of air is not turbulent.

The flow of air exiting the annular outlet 6334 may be able to flow smoothly over the lifting body 6302 from the leading edge 6304 and to the trailing edge 6306 and over and around the top surface 6308 and bottom surface 6310 to generate lift. The aircraft 6300 may be able to travel at speeds of at least 4 knots, at least 10 knots, at least 20 knots, at least 30 knots, at least 40 knots, or from 4 to 50 knots, when the propulsion system 6320 generates the flow of air through the annular airflow duct 6330. The aircraft 6300 may be able to ascend to altitudes up to at least 5,000 feet or at least 10,000 feet.

The annular airflow duct 6330 may include stators 6339 (also see FIG. 63G). The stators 6339 may be located vertically downward within the annular airflow duct 6330 at the annular inlet 6332 (e.g., positioned within or near the annular inlet 6332, but below the blades 6322). In some embodiments, the stators 6339 may be at least somewhat similar in structure and/or function to the vanes 3239 discussed above with reference to the embodiment of FIGS. 32A-32D.

The stators 6339 may extend from the outer surface 6351 and towards or to the inner surface 6336 (or vice versa). In some examples, the stators 6339 may extend from the inner surface 6336 and towards or to the outer surface 6351. The stators 6339 may be stationary and fixed relative to the outer surface 6351 and/or to the inner surface 6336 within the annular airflow duct 6330 The stators 6339 may not rotate and may be fixedly attached to the outer surface 6351 and/or to the inner surface 6336. In some examples, the stators 6339 may be actuatable and may move (e.g. rotate) within the annular airflow duct 6330.

The stators 6339 may provide a counter torque to the rotation of the plurality of blades 6322 and/or provide a deswirling effect to a rotating flow of air blown over the stators 6339 by the rotating blades 6322. For example, as the plurality of blades 6322 rotate to deliver the flow of air from the annular inlet 6332 and to the annular outlet 6334, the stators 6339 may provide at least some yaw control within the annular airflow duct 6330 to prevent (or limit) the entire aircraft 6300 from rotating in the opposite direction as the plurality of blades 6322 rotate without impacting lifting force. The annular airflow duct 6330 may include six stators 6339. In some examples, there may be from two to twenty, or from three to sixteen stators 6339.

One, some or all of the stators 6339 may provide structural support for the aircraft 6300. For example, the stators 6339 may attach the inner surface 6336 to the outer surface 6351. The stators 6339 may provide structural support for the annular airflow duct 6330. The stators 6339 may support the annular airflow duct 6330 such that the propulsion system 6320 can rotate within the annular inlet 6332. The stators 6339 may extend along the outer surface 6351 at or adjacent to the propulsion system 6320 in order to support the propulsion system 6320 within the aircraft 6300. The stators 6339 may support the hub or other blade apparatus. The stators 6339 may be flat, straight, or radial (e.g., have no twist or curve as the stators 6339 extend from the outer surface 6351 to the inner surface 6336). The stators 6339 may still provide at least some yaw control, as the flow of incoming air through the annular airflow duct 6330 and over the stators 6339 may create a counter torque. The stators 6339 may have a constant chord. In some examples, the stators 6339 may be angled or may have a taper (e.g., the stators 6339 may taper or twist from the outer surface 6351 and to the inner surface 6336, see FIG. 63G). The stators 6339 may twist or have an angle of at least ten degrees from the outer surface 6351 and to the inner surface 6336. In some embodiments, the stators 6339 comprise an airfoil shape. The stators 6339 may be shaped similarly to the lifting bodies 6302 (e.g., the stators 6339 may have a curved profile extending from the outer surface 6351 and to the inner surface 6336, and/or be airfoil-shaped). The stators 6339 may thus provide “lift” but in a yaw direction for the aircraft 6300A when shaped similarly to an airfoil. In some examples, the stators 6339 may extend radially outward relative to the longitudinal axis Z, as shown in FIG. 63E. In other examples, the stators 6339 may be angled with respect to respective radial directions from the longitudinal axis Z.

The vanes 6340 at the annular outlet 6334 may also provide a counter torque in response to the rotation of the plurality of blades 6322 (also see FIG. 63G). The vanes 6340 may be moveable at the annular outlet 6334, as described. In some examples, the vanes 6340 may be stationary (e.g., fixed) vanes, for example at an angle to the direction of flow of air. In some embodiments, one or more of the vanes 6340 may be stationary, and one or more of the vanes 6340 may be moveable. The vanes 6340 may be used to control the yaw of the aircraft 6300, to assist in the stabilization of the aircraft, even in a stationary hover, such as to account for turbulence, wind, movement of payloads, passengers, or the like, may be angled relative to a direction of flow of air through the duct 6330, such as a direction of flow at the annular outlet 6334, to induce the yaw forces, and/or may move in response to an increase in rotational speed of the plurality of blades 6322 (e.g., due to increased power being delivered to the motor 6323 to generate additional airflow/lift), as described herein.

One or more of the vanes 6340 may rotate in one or more rotational directions. The vanes 6340 may each rotate about a respective axis 6340A (see FIG. 63C). The vanes 6340 may rotate clockwise and/or counterclockwise about the axis 6340A. The axis 6340A may be angled relative to the longitudinal axis Z. The axis 6340A may be parallel with a rear or downstream edge 6340C of the vane 6340, and/or extend down the center of the vane 6340 as shown. The axis 6340A may extend along a plane that is perpendicular to the direction of airflow at vane 6340 and/or at the annular outlet 6334. In some examples, only a portion of the one or more vanes 6340 may rotate. Rotation of the vanes 6340 or portions thereof may alter the direction and/or amount of yaw forces induced due to the air hitting the vanes 6340. The vanes 6340 may extend from the outer surface 6351 and toward or to the inner surface 6336 at the annular outlet 6334. The vanes 6340 may extend from the inner surface 6336 and toward or to the outer surface 6351 at the annular outlet 6334. The vanes 6340 may extend from the outer surface 6351 and to the inner surface 6336 at the annular outlet 6334. The aircraft 6300 may include from two to twenty, from four to fourteen, from six to twelve, or form eight to ten vanes 6340.

At least some of the vanes 6340 may provide additional structural support (e.g., in addition to the stators 6339) in order to maintain the structural integrity of the aircraft 6300 (e.g., to ensure the aircraft 6300 can withstand the loads/forces experienced during takeoff, flight, and landing). One benefit of having the vanes 6340 positioned at or near the annular outlet 6334 of the annular airflow duct 6330 is that they are farther from the center of gravity of the aircraft 6300 than if they were positioned further inward. This increases the length of the moment arm of the vanes 6340 and increases effectiveness of the vanes 6340 at countering torque while reducing efficiency losses.

The aircraft 6300 may have baffles 6343 extending from the bottom 6319 of the aircraft 6300, as shown in FIGS. 63C, 63D, and 63F. The baffles 6343 may be fixed to the bottom 6319. The baffles 6343 may form a symmetric pattern about the longitudinal axis Z. The baffles 6343 may have a flat profile. The baffles 6343 may extend from a central support 6343A. The central support 6343A may be circular. The baffles 6343 may extend from a middle region of the bottom 6319 to an outer edge of the bottom 6319. The baffles 6343 may have any of the features or functions as any other baffles disclosed herein. For example, the baffles 6343 may have the same or similar features or functions as the one or more baffles 5743, one or more baffles 5843, the first set of baffles 5843A, and/or the second set of baffles 5843B as shown and described with reference to FIGS. 57A-58C, and vice-versa.

The central support 6343A and baffles 6343 may reduce the amount of suction (e.g., downward suction force) or pressure decrease at the bottom 6319 of the aircraft 6300. Such pressure decrease may be produced by the radially outer flow from the annular outlet 6334 and one or more lifting bodies 6302 that cause vortices under the aircraft 6300. Positioning the baffles 6343 along the bottom 6319 may break up these vortices and reduce a suction force generated underneath the aircraft 6300 by the low pressure. This prevents the need for the aircraft 6300 to have additional power (e.g., lift) to lift the aircraft 6300 off of a ground surface and/or to overcome the suction.

FIG. 63G shows a perspective view of an aircraft 6300A with an outer wall 6344 shown in dashed lines for illustrative purposes (e.g., to show features behind the outer wall). The aircraft 6300A may have any or all of the same or similar features as aircraft 6300, or any other aircraft disclosed herein, and vice versa. The aircraft 6300A may have the annular airflow duct 6330 with a shorter duct length. The aircraft 6300A may include one or more actuators 6317 designed to move one or more of the lifting bodies 6302. One or more of the lifting bodies 6302 may be movable to alter its angle of attack relative to the airflow and/or to adjust other lifting characteristics of the lifting bodies 6302. The angle of attack α may be formed between a chord 6316 of the lifting bodies 6302 and the direction of the flow of air from the annular outlet 6334 of the annular airflow duct 6330. For example, the available range of angles of attack α may be the same or similar as any other angles of attack as described herein, such as the angle of attack as shown in and described with respect to FIGS. 27A-27E and FIGS. 30A-30F.

The vanes 6340 at the annular outlet 6334 may rotate about the axis 6340A as described herein and may be moved by one or more actuators 6317. In some examples, the actuators 6317 may be physically or electrically coupled to the vanes 6340 in order to move the vanes 6340 rotationally about the axis 6340A. The actuators 6317 may move one or more shafts 6340B attached to the respective vanes 6340. The vanes 6340 may move about the axis 6340A relative to a neutral angle or position to an angle of at least five degrees, at least ten degrees, at least fifteen degrees, at least twenty degrees, at least thirty degrees, or at least forty-five degrees. Further, the vanes 6340 may have an angled rear edge 6340C, which may be an upstream edge of the vanes 6340. The rear edge 6340C may be angled in order to be approximately perpendicular to the direction of airflow at that region within the annular airflow duct 6330 having the turn angle, as described. The rear edge 6340C may be angled relative to an adjacent lower edge 6340D of the vanes 6340. The angled rear edge 6340C may form an angle with the lower edge 6340D of at least 45 degrees, at least 75 degrees, from 85 to 95 degrees, no more than 95 degrees, no more than 90 degrees, no more than 85 degrees, or no more than 75 degrees. The rear edge 6340C and/or the lower edge 6340D may be straight, linear, curved or arcuate. The movement of the vanes 6340 may assist in the stabilization of the aircraft and may also act to provide a countering torque and prevent swirl, as described.

One or more of the actuators 6317 may be used to control movement of one or more of the lifting bodies 6302. One or more of the actuators 6317 may be physically or electronically coupled to one or more of the lifting bodies 6302. The actuators 6317 may be a plurality of actuators, where each actuator 6317 is physically or electronically coupled to a respective one or more of the lifting bodies 6302.

The actuators 6317 may move or actuate a respective actuator rod 6325. The actuator rod 6325 may extend to and couple to one or more of the lifting bodies 6302, for example adjacent to the leading edge 6304. The actuator rod 6325 may be connected to a middle region of one or more of the lifting bodies 6302. The actuator rod 6325 may rotate to thereby cause the corresponding lifting body 6302 to rotate, for example to change the angle of attack of the lifting body 6302.

One or more of the lifting bodies 6302 may also have clearances 6317A, such as cutouts, that may receive and be connected to hinge bars 6317B. The hinge bars 6317B may allow the respective lifting body 6302 to move when controlled by the actuator 6317. The hinge bars 6317B may extend from the annular outlet 6334 and to the leading edge 6304 of the respective lifting body 6302. The clearances 6317A may be positioned at or along the leading edge 6304. The hinge bars 6317B may be freely connected to (e.g., a pin connection) to the respective lifting body 6302. The lifting bodies 6302 may rotate about the connection with the respective hinge bar 6317B. The lifting bodies 6302 may rotate in response to movement by the respective actuator rod 6325.

FIG. 63H illustrates an alternative embodiment of one of the lifting bodies 6302, which has endplates 6349 positioned along one or more outer edges 6311 of the lifting bodies 6302. Each lifting body 6302 may have an endplate 6349 at one or both of the outer edges 6311. The endplates 6349 may have an outer profile 6349A which is rounded. The outer profile 6349A may be elliptical, circular, ovoid, oblong, disc-shaped, or the like. The outer profile 6349A may extend beyond the leading edge 6304 and/or trailing edge 6306 (e.g., the length of the endplates 6349 is longer than a length/chord of the lifting bodies 6302). The outer profile 6349A may extend above and/or below, respectively, the upper and lower surfaces of the lifting body 6302. The endplates 6349 may be rigid planar members which can withstand aerodynamic forces. The endplates 6349 may be sheet metal. The endplates 6349 may be structural walls which block a flow of air (e.g., the air exiting the annular outlet 6334 and flowing towards the leading edge 6304) at the outer edge 6311. The endplates 6349 may be spaced apart from the annular outlet 6334. The endplates 6349 may be individual members which are couplable to the lifting bodies 6302 (e.g., via bolts, fasteners, or the like).

The endplates 6349 may reduce or eliminate “edge effects” when the flow of air travels over the top surface 6308 and bottom surface 6310 of the lifting bodies 6302. For example, the endplates 6349 may prevent the flow of air from spilling over or flowing from the bottom surface 6310 and to the top surface 6308 at the outer edge 6311. This can prevent vortices from forming and avoid associated aerodynamic losses to provide greater lift and less drag. The endplates 6349 may prevent an imbalance of pressure between the top surface 6308 and the bottom surface 6310 which can affect the lifting force applied to the lifting bodies 6302 by the flow of air. When the flow of air travels from the bottom surface 6310 and to the top surface 6308 at the 6311 (without the endplates 6349) the pressure on the bottom surface 6310 decreases and may cause the lifting force applied to the multiple lifting bodies 6302 to decrease.

The endplates 6349 may also prevent vortices from forming at the outer edge 6311 of the lifting body 6302, which can prevent downwash (e.g., a downward flow of air along the lifting body 6302). The endplates 6349 may prevent the profile of the airfoil (e.g., the angle of attack, curvature, chord) from changing due to the forces exerted on the outer edge 6311 due to vortices at the outer edge 6311. The endplates 6349 may also prevent excess drag from being induced on the lifting bodies 6302 by blocking the flow of air at the outer edge 6311, which can improve the efficiency of the aircraft 6300. One, some, or all of the lifting bodies 6302 may each include one or two of the endplates 6349.

FIG. 63I illustrates an alternative embodiment of the annular outlet 6334. The endplates 6349 may be joined to the vanes 6340 located at the annular outlet 6334. For example, the lower edge 6340D of the vanes 6340 may be joined (e.g., coupled, formed monolithically formed, unitary with) the outer profile 6349A of the endplates 6349. The joined endplates 6349 and vanes 6340 may move or rotate (e.g., about the axis 6340A as discussed in light of FIG. 63G).

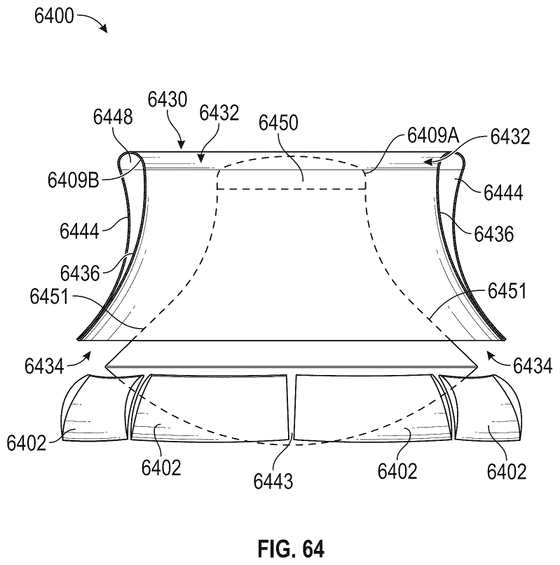

FIG. 64 illustrates an additional embodiment of an aircraft 6400. The aircraft 6400 may have any or all of the same or similar features as aircraft 100, 6300, 6300A, or any other aircraft disclosed herein, and vice vera, except as otherwise described. The same or similar reference numbers are used to refer to the same of similar features. For example, the aircraft 6400 may include the annular airflow duct 6430, the annular inlet 6432, the annular outlet 6434, the central body 6450, and the multiple airfoils 6402. A flow of air can flow from the annular inlet 6432 and to the annular outlet 6434 between the outer surface 6451 and the inner surface 6436. The annular airflow duct 6430 may be positioned within the outer wall 6444. The aircraft 6400 may include the outer lip 6448, the inner inlet lip 6409A, and the outer inlet lip 6409B, which may be able to deliver a more laminar flow of air from the annular inlet 6432 and to the annular outlet 6434.

Further, the aircraft 6400 may include a rounded baffle 6443. The rounded baffle 6443 may be located at or form the bottom 6419 of the aircraft 6300. The rounded baffle 6443 may be designed to break up vortices and reduce a suction force generated underneath the aircraft 6400. The rounded baffle 6443 may be essentially dome-shaped. The rounded baffle 6443 may have a lowest portion at or near the center of the rounded baffle 6443, which lowest portion may be below, even with, or above the trailing edges of the airfoils 6402. The rounded baffle 6443 may extend along a rounded and upward profile from the central region toward the outer edges.

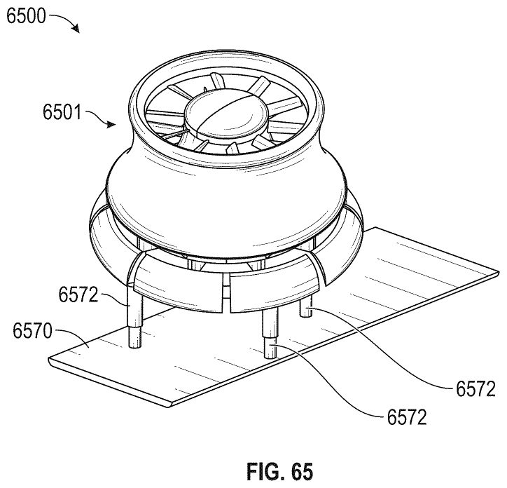

FIG. 65 illustrates a system 6500 including an aircraft 6501 positioned on transportation equipment 6570 (e.g., a trailer, a semi-trailer, box truck, or the like) and operable to transport or otherwise support the aircraft 6501 via the transportation equipment 6570 for movement to other locations. The aircraft 6501 may have any or all of the same or similar features as aircraft 100, 6300, 6300A, or any other aircraft disclosed herein, and vice vera, except as otherwise described.

The aircraft 6501 may be coupled to the transportation equipment 6570 via one or more coupling portions 6572. The one or more coupling portions 6572 may be legs that can extend from the aircraft 6501 and can attach to the transportation equipment 6570. The transportation equipment 6570, such as a platform thereof, may lift or elevate in order to position the aircraft 6501 at a desired height or position for take-off/landing. The one or more coupling portions 6572 may be telescopic legs. The one or more coupling portions 6572 may be able to retract within and extend outside of the aircraft 6501 in order to couple to transportation equipment 6570. The one or more coupling portions 6572 may be able to support the aircraft 6501 as the transportation equipment 6570 moves the aircraft 6501 to a desired location. For example, the transportation equipment 6570 may be a trailer. The transportation equipment 6570 may support the aircraft 6501 having a max height of between 5 feet and 12 feet and a max diameter (e.g., outer diameter 112) between 6 feet and 15 feet. The max diameter (e.g., outer diameter 112) can be from 10 to 12 feet. The aircraft 6501 may have a total weight between approximately 1200 lbs, and 2200 lbs.

FIG. 66 illustrates a cross-sectional profile of an additional embodiment of an aircraft 6600. The aircraft 6600 may have any or all of the same or similar features as aircraft 100, 6300, 6300A, 6500, or any other aircraft disclosed herein, and vice versa, except as otherwise described. For example, the aircraft 6600 may include the annular airflow duct 6630, the annular inlet 6632, the annular outlet 6634, the central body 6650, and the lifting bodies 6602. A flow of air can flow from the annular inlet 6632 and to the annular outlet 6634 along the outer surface 6651 and the inner surface 6636. The annular airflow duct 6630 may be positioned within the outer wall 6644. The aircraft 6600 may also include the stators 6639 within the annular airflow duct 6630. Vanes 6640 may be positioned at or adjacent to the annular outlet 6634. The aircraft 6600 may include a first propulsion system 6620A configured to rotate a first plurality of blades 6622A.

Further, the aircraft 6600 may also include a second propulsion system 6620B. The second propulsion system 6620B may be positioned below (or above) the propulsion system 6620 coaxially with the longitudinal axis Z and may have similar features and functions as the propulsion system 6620 (or propulsion system 6320 as shown in FIG. 63C).

The second propulsion system 6620B may include a second motor 6623B positioned at least partially within the central body 6650. The second propulsion system 6620B may include a second plurality of blades 6622B within the annular airflow duct 6630 and extending from the outer surface 6651 to or toward inner surface 6636. The second motor 6623B may rotate the second plurality of blades 6622B. The second propulsion system 6620B may comprise a counterrotating rotor. For example, as the first plurality of blades 6622A of the first propulsion system 6620A rotate in a first rotational direction, the second plurality of blades 6622B may rotate in a second rotational direction opposite the first rotational direction. The second propulsion system 6620B may prevent or minimize the aircraft 6600 from spinning or rotating about the longitudinal axis Z (e.g. yaw) due to rotation of the first plurality of blades 6622A. The rotational axes of the first propulsion system 6620A and the second propulsion system 6620B may be coaxial with each other.

In some embodiments, the second propulsion system's 6620B counterrotating blades are powered by a separate motor or engine (e.g., separate from the motor or engine of the first propulsion system 6620A). In some embodiments, the same motor or engine rotates both sets of blades 6622A, 6622B, but causes them to counterrotate via the use of a gearbox, transmission system, and/or the like. In some embodiments, a single motor with counter-rotating shafts may be used to rotate both propulsion systems 6620A, 6620B in opposite directions.

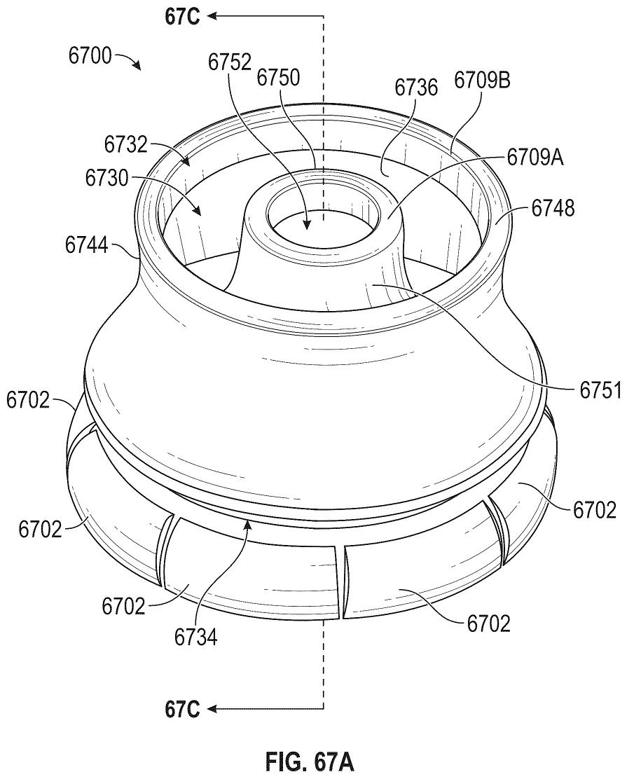

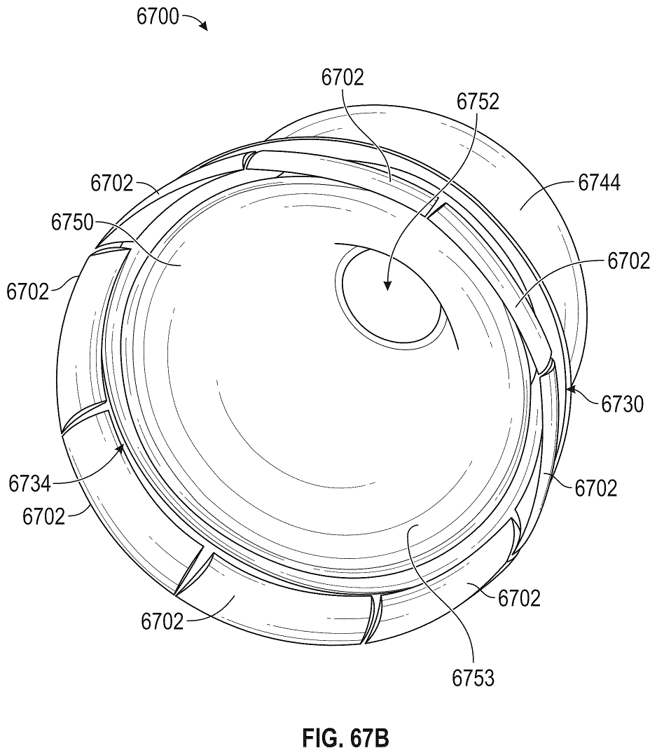

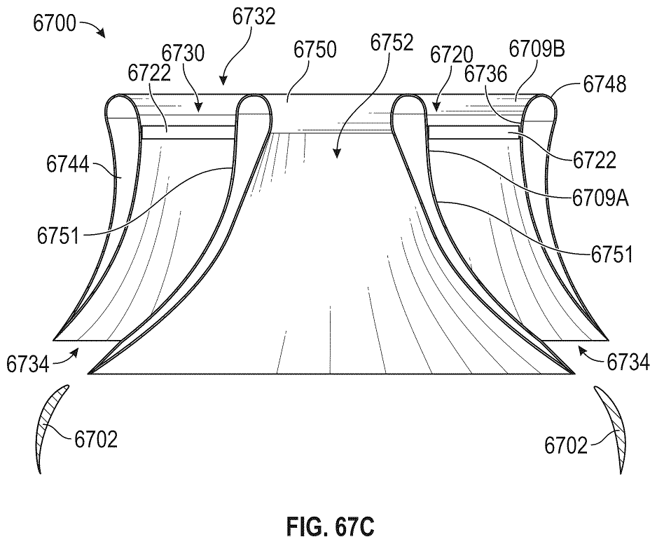

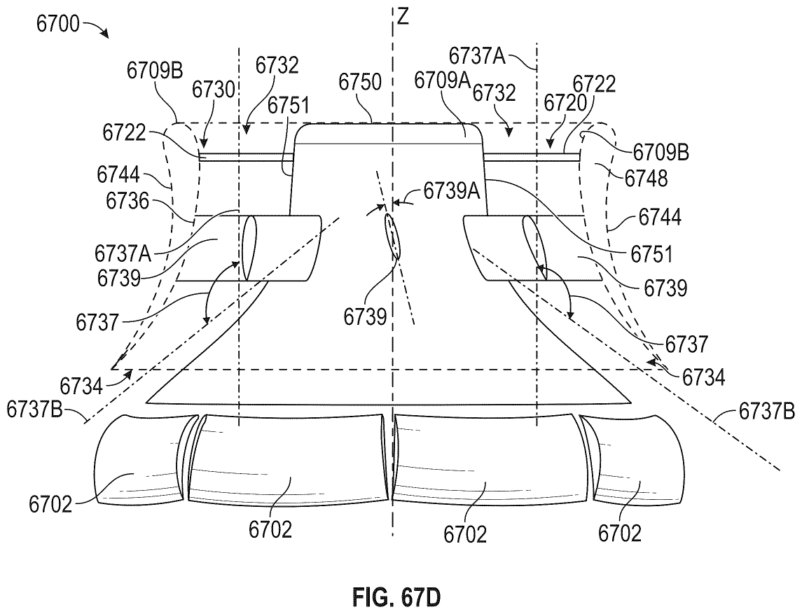

FIGS. 67A-67D illustrate various views of part of an additional embodiment of an aircraft 6700 having an annular airflow duct 6730. FIG. 67A is a top perspective view of the aircraft 6700. FIG. 67B is a bottom perspective view of the aircraft 6700. 67C is a cross section view of the aircraft 6700. FIG. 67D is a partial transparent view of the aircraft 6700 with portions removed for illustrative purposes. The aircraft 6700 may have any or all of the same or similar features as aircraft 100, 6300, 6300A, 6500, 6600 or any other aircraft disclosed herein, and vice vera, except as otherwise described. Similar reference numbers are used to refer to the same or similar features. For example, the aircraft 6700 may include an annular airflow duct 6730, an annular inlet 6732, an annular outlet 6734, an inner inlet lip 6709A, an outer inlet lip 6709B, an outer lip 6748, an outer wall 6744, a central body 6750, and the lifting bodies 6702. Although shown schematically, the aircraft 6700 may further include any other features of the various aircraft described herein, such as a propulsion system 6720 having a plurality of blades 6722 similar to other propulsion systems as disclosed herein, including for example, propulsion units 120, 6320.

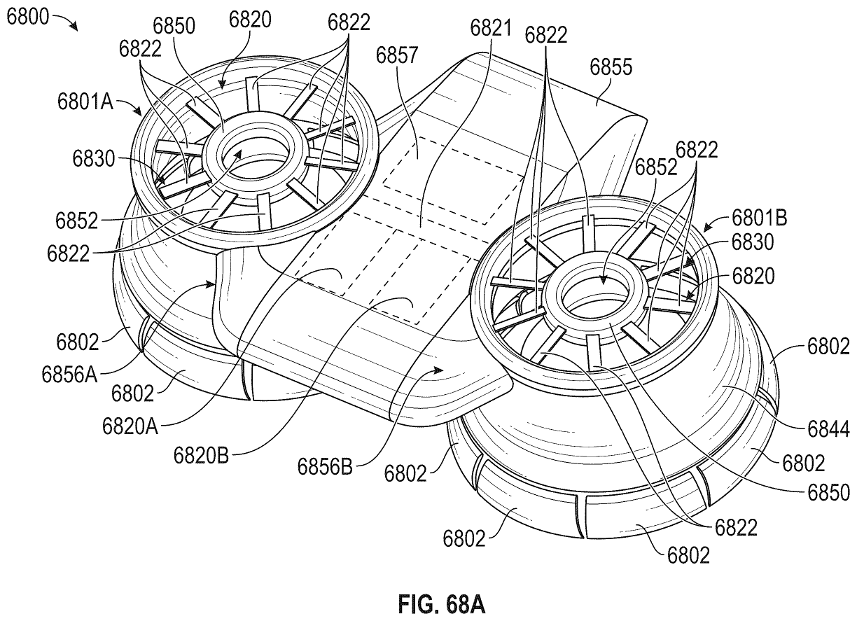

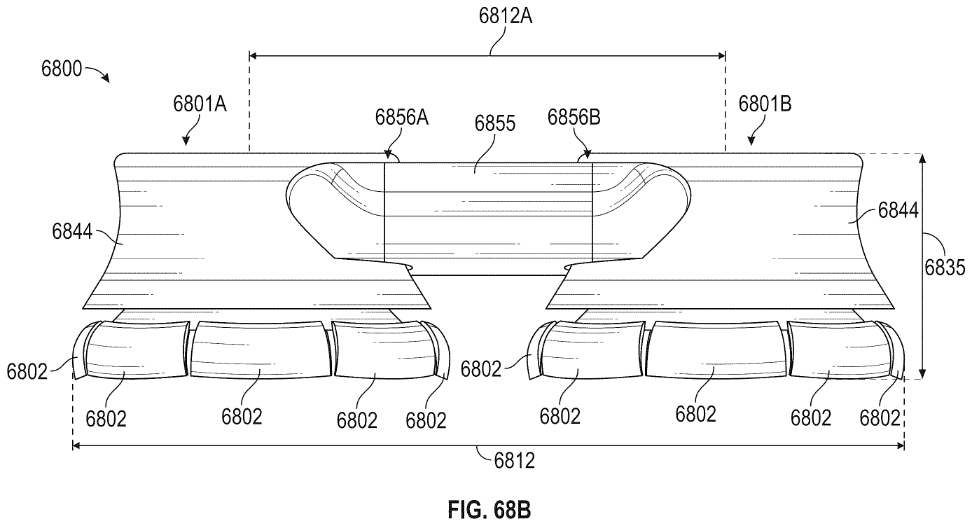

The central body 6750 may be an open hollow body. In some examples, the central body 6750 may be closed on the top (e.g., as shown in FIG. 63A). The central body 6750 may have a trumpet shape or a generally conical shape. The central body 6750 may have an opening 6752 that extends along the longitudinal axis Z of the aircraft 6700. The propulsion system 6720 and/or other components may be located at least partially within the opening 6752. The central body 6750 may be open at a top and at a bottom of the central body 6750. The central body 6750 may have an outer surface 6751 and an inner surface 6753. The outer surface 6751 may be radially or outwardly opposite to the inner surface 6753. The outer surface 6751 may form an inner part of the annular airflow duct 6730 (with another outer part of the annular airflow duct 6730 being formed by inner surface 6736). The central body 6750 may be symmetrical (or generally symmetrical) about the longitudinal axis Z. The opening 6752 may reduce the overall weight of the aircraft 6700. The aircraft 6700 may have an external motor or transmission (discussed herein with respect to FIG. 68) that may extend into the opening 6752.

The outer surface 6751 may extend from the annular inlet 6732 along the entire length of the annular airflow duct 6730 and to the annular outlet 6734. The annular inlet 6732 may be angled relative to the annular outlet 6734. The angle between the annular inlet 6732 and the annular outlet 6734 may be defined by a turn angle 6737. The outer surface 6751 may have a curved profile. The curved profile of the outer surface 6751 may be partially defined by the turn angle 6737. The turn angle 6737 may be measured based on the angle between the inlet axis 6737A and the outlet axis 6737B. The turn angle 6737 may be approximately 40 degrees or any other values as described herein with respect to turn angles of rother embodiments. More details about the turn angle 6737 are disclosed herein, and with reference to the features shown in or described with respect to FIGS. 31A, 35B, and 54C, and the value of the turn angle 6737 may include any of turn angle values discussed elsewhere herein.

The aircraft 6700 may have one or more stators 6739 that extend from the outer surface 6751 and to the inner surface 6736 of the annular airflow duct 6730. The stators 6739 may be flat, straight, or radial (e.g., have no twist or curve as the stators 6739 extend from the outer surface 6351 to the inner surface 6336). The stators 6739 may twist and/or have an angle 6739A of least ten degrees from the outer surface 6751 and to the inner surface 6736. The stators 6739 may twist or have an angle 6739A of at least 2 degrees, at least 4 degrees, at least 5 degrees, at least 6 degrees, at least 14 degrees, and/or at least 20 degrees, and/or within a range from 2 degrees to 20 degrees. Additional information about the stators can be found and disclosed herein and with reference to FIGS. 63A-63G (e.g., with reference to stators 6339), and such other disclosure also applies to stators 6739. In some embodiments, the stators 6739 comprise an airfoil shape.

The inner inlet lip 6709A and outer inlet lip 6709B may be curved in order to allow and/or form a smooth transition for the flow of air into the annular airflow duct 6730. The outer lip 6748 may include the outer inlet lip 6709B. The inner inlet lip 6709A may have a radius. The radius of the inner inlet lip 6709A may be at least four inches. The radius of the inner inlet lip 6709A may be at least five inches, at least seven inches, at least eight inches, at least nine inches, and/or at least ten inches. The profile and curvature of the inner inlet lip 6709A may be designed to optimize the flow of air into the annular airflow duct 6730 in order to generate a desired amount of lift. The outer lip 6748 may have a radius. The outer lip 6748 may be elliptical. The outer inlet lip 6709B may have a contoured profile, such that the radius of the outer inlet lip 6709B is at least four inches. The radius of the outer inlet lip 6709B may also be at least five inches, at least seven inches, at least eight inches, at least nine inches, and/or at least ten inches. The outer lip 6748, when elliptical, may have a major radius and minor radius. The major radius and minor radius of the outer lip 6748, may each be from four inches to nine inches. For example, the major radius of the outer lip 6748 may be approximately four inches and the minor radius of the outer lip 6748 may be approximately nine inches. The aircraft 6700 may have a ratio of the width of the annular inlet 6732 to the radius of the outer lip 6748. The ratio of the width of the annular inlet 6732 to the radius of the outer lip 6748 may be from 1.5 to 3 (e.g., the width may be greater than the radius of the outer lip 6748).

FIGS. 68A and 68B illustrate an example tandem aircraft system 6800. The tandem aircraft system 6800 may have any or all of the same or similar features as any other aircraft disclosed herein, and vice vera, except as otherwise described. The same or similar reference numbers are used to refer to the same or similar features. FIG. 68A shows a top perspective view of the tandem aircraft system 6800. FIG. 68B shows a front view of the tandem aircraft system 6800.

The tandem aircraft system 6800 may include multiple aircrafts (or multiple propulsion systems, or multiple aerolift systems). The tandem aircraft system 6800 may include a first aircraft 6801A and a second aircraft 6801B. The first aircraft 6801A and the second aircraft 6801B may have many or all of the same features as any other aircraft disclosed herein, including but not limited to any of aircrafts 100, 6300, 6300A, 6400, 6500, 6600, and 6700. For example, the first aircraft 6801A and the second aircraft 6801B may each include one or more lifting bodies 6802, a propulsion system 6820, blades 6822, and an outer wall 6844. The first aircraft 6801A and the second aircraft 6801B may be coupled or interconnected via a main body 6855. The main body 6855 may extend between the first aircraft 6801A and second aircraft 6801B.

The main body 6855 may connect to the first aircraft 6801A at a first connection region 6856A. The first connection region 6856A may be curved in order to conform to the outer profile of the first aircraft 6801A. The first connection region 6856A may extend annularly around and/or along, and be coupled to, the outer wall 6844 of the first aircraft 6801A. The main body 6855 may connect to the second aircraft 6801B at a second connection region 6856B. The second connection region 6856B may have a shape or profile designed to form around the second aircraft 6801B. The second connection region 6856B may extend annularly around and/or along, and may couple, to the outer wall 6844 of the second aircraft 6801B.

The main body 6855 may contain equipment to power the propulsion system 6820 of the first aircraft 6801A and the second aircraft 6801B. The main body 6855 may contain one or more engines. For example, the main body 6855 may contain a first engine 6820A to power the propulsion system 6820 of the first aircraft 6801A. The main body 6855 may contain a second engine 6820B to power the propulsion system 6820 of the second aircraft 6801B. The main body 6855 may also include a transmission 6821 connected to the first engine 6820A and the second engine 6820B. The transmission 6821 may operate to deliver the power from the engines 6820A, 6820B to the propulsion systems 6820 and rotate the blades 6822 in order to generate a lifting force (e.g., by rotating the blades 6822 for the first aircraft 6801A and the second aircraft 6801B). The transmission 6821 may extend from within the main body 6855 and into the openings 6852 of the first aircraft 6801A and the second aircraft 6801B. Positioning the first engine 6820A, the second engine 6820B, and the transmission 6821 externally to the first aircraft 6801A and the second aircraft 6801B may reduce the amount of power necessary to power the tandem aircraft system 6800. In some embodiments, the engines 6820A, 6820B are redundant, with each of them capable of powering both aircrafts 6801A, 6801B, such as for safety purposes. In some embodiments, a single engine that powers both aircrafts 6801A, 6801B is used, such as for weight reduction purposes.

The first aircraft 6801A and the second aircraft 6801B may function as lifting and propulsion elements for the tandem aircraft system 6800. For example, since the first engine 6820A and the second engine 6820B are located within the main body 6855 (and externally to the first aircraft 6801A and the second aircraft 6801B), the tandem aircraft system 6800 may have improved lift characteristics. Having the first engine 6820A, the second engine 6820B, and the transmission 6821 in the main body 6855 may allow for additional space for the propulsion system 6820 (e.g., larger blades 6822 since the engines can be positioned externally to the central body 6850). Positioning the first engine 6820A, the second engine 6820B, and the transmission 6821 within the main body 6855 may improve and/or increase power delivered to the tandem aircraft system 6800 while maintaining an optimal weight distribution. For example, the tandem aircraft system 6800 may weigh between 1.2 to 3.4 times greater than a single aircraft (e.g., aircraft 6300). The tandem aircraft system 6800 may have increased pitch and yaw control due to the positioning of the first engine 6820A, the second engine 6820B, and the transmission 6821. The main body 6855 may also include a payload compartment or area 6857. The payload compartment or area 6857 may be capable of containing persons, cargo, and/or other materials. The main body 6855 may also be shaped to minimize drag on the tandem aircraft system 6800 by streaming a flow of air along the tandem aircraft system 6800.

The tandem aircraft system 6800 may have a total width 6812 of approximately 33 feet. The tandem aircraft system 6800 may have a total width 6812 of at least 20 feet, at least 30 feet, at least 35 feet, at least 40 feet, from 10 feet to 50 feet, no more than 50 feet, no more than 40 feet, or no more than 30 feet. The tandem aircraft system 6800 may have a total height 6835 of approximately nine feet. The tandem aircraft system 6800 may have a total height 6835 of at least 5 feet, at least 6 feet, at least 7 feet, at least 8 feet, at least 10 feet, at least 11 feet, from 5 to 20 feet, no more than 20 feet, or no more than 10 feet. The tandem aircraft system 6800 may have a depth (e.g., perpendicular to the width 6812 and height 6835) of approximately 20 feet, from ten to thirty feet, no more than thirty feet, or no more than twenty feet. The first aircraft 6801A and the second aircraft 6801B may be spaced apart a distance 6812A as measured between respective axes via the main body 6855, by approximately 20 feet. The first aircraft 6801A and the second aircraft 6801B may be spaced apart a distance 6812A of at least 18 feet, at least 21 feet, at least 25 feet, at least 30 feet, from 10 to 50 feet, from 15 to 40 feet, no more than 50 feet, no more than 40 feet, or no more than 30 feet. A ratio of the total height 6835 to the distance 6812A may be from approximately 0.4 to 0.9 (e.g., the total height 6835 may be less than the distance 6812A).

The tandem aircraft system 6800 may be operable (e.g., powered) for sustained flight for approximately 1 hour or at least 1 hour on a single provision of power (e.g. a single charge, or single tank of fuel). The first engine 6820A and the second engine 6820B may be able to hold approximately 60 gallons or at least 60 gallons of fuel. In some examples, the first aircraft 6801A and the second aircraft 6801B may be spaced apart by a distance 6812A of approximately 20 feet. The tandem aircraft system 6800 may have a total weight from 2100 lbs, and 2700 lbs. The tandem aircraft system 6800 may have a total weight from 2700 lbs. and 4200 lbs. The distance between the center of the first aircraft 6801A or the second aircraft 6801B and the center of gravity of the tandem aircraft system 6800 may be approximately 10 feet. The distance (e.g., horizontal distance) between the center of the first aircraft 6801A or the second aircraft 6801B and the center of gravity of the tandem aircraft system 6800 may be at least 9 feet, at least 11 feet, or at least 12 feet. A ratio of i) the distance from a center of the first aircraft 6801A or the second aircraft 6801B to the center of gravity of the tandem aircraft system 6800 to ii) the total height 6835, may be from 0.9 to 1.2.

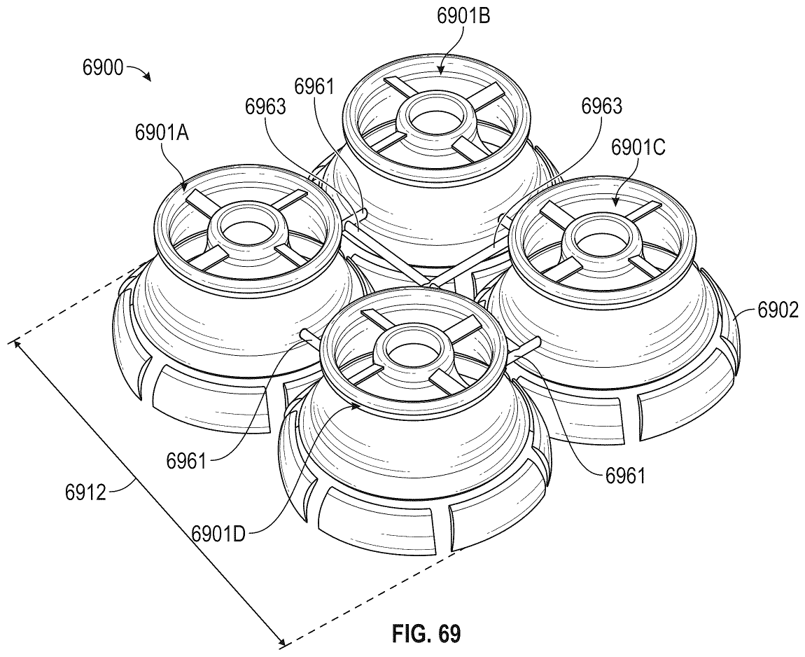

FIG. 69 illustrates another example of an aircraft system 6900. The aircraft system 6900 may have any or all of the same or similar features as any other aircraft disclosed herein, and vice vera, except as otherwise described. For example, the aircraft system 6900 may have many or all of the same features as aircraft 100, 6300, 6400, 6600, 6700, and/or tandem aircraft system 6800 and vice versa. Similar reference numbers are used to refer to the same or similar features. For example, the aircraft system 6900 may include one or more lifting bodies 6902, etc.

The aircraft system 6900 may include multiple aircrafts (or multiple propulsion systems, or multiple aerolift systems). The aircraft system 6900 may include a first aircraft 6901A, a second aircraft 6901B, a third aircraft 6901C, and a fourth aircraft 6901D. One or more of the aircrafts 6901A, 6901B, 6901C, 6901D may include any of the same or similar features and/or functions as any of the other aircraft described herein, such as those shown in and described with respect to FIGS. 63A-68B. The multiple aircrafts 6901A, 6901B, 6910C, 6901D may be arranged in a grid like formation (e.g., in a 2×2 formation). The multiple aircrafts 6901A, 6901B, 6910C, 6901D may be arranged in a square, rectangular, trapezoidal, diamond, or other four cornered arrangement. The multiple aircrafts 6901A, 6901B, 6910C, 6901D may be arranged in order to generate a desired amount of lift in order to power the aircraft system 6900. In some embodiments, the aircrafts 6901A, 6901B, 6910C, 6901D are arranged symmetrically about a central axis of the overall aircraft system 6900. In some embodiments, more or fewer than the four aircrafts 6901A, 6901B, 6910C, 6901D may be included in the overall aircraft system 6900. There may be three, four, five, six, seven, eight or more of the aircrafts 6901 forming the larger aircraft system 6900. In some examples, each of the multiple aircrafts 6901A, 6901B, 6910C, 6901D may have their own engine and transmission system (e.g., independently operated propulsion systems, such as propulsion system 6320).

The multiple aircrafts 6901A, 6901B, 6910C, 6901D may be connected via a first set of support rods 6961 (and/or other support structures) and a second set of support rods 6963 (and/or other support structures). The first set of support rods 6961 may extend between adjacent aircrafts of the multiple aircrafts (e.g., between the first aircraft 6901A and the fourth aircraft 6901D, etc.). The second set of support rods 6963 may extend between and interconnect the first set of support rods 6961. The second set of support rods 6963 may provide additional stability for the aircraft system 6900. The aircraft system 6900 may be able to generate additional power to lift the aircraft system 6900. The aircraft system 6900 may have a width or depth 6912 of approximately 7 feet. The aircraft system 6900 may have a width or depth 6912 of at least four feet, at least five feet, at least six feet, at least nine feet, at least ten feet, at least 20 feet, at least 30 feet, at least 40 feet, from four to 60 feet, from 10 to 50 feet, no more than 50 feet, no more than 40 feet, no more than 20 feet, or no more than 10 feet. The aircraft system 6900 may be designed to pick up and lift objects between 150 lbs. to 2500 lbs. Although not shown, one or more arms may extend from a bottom of the aircraft system 6900 and may grab and pick up one or more objects.

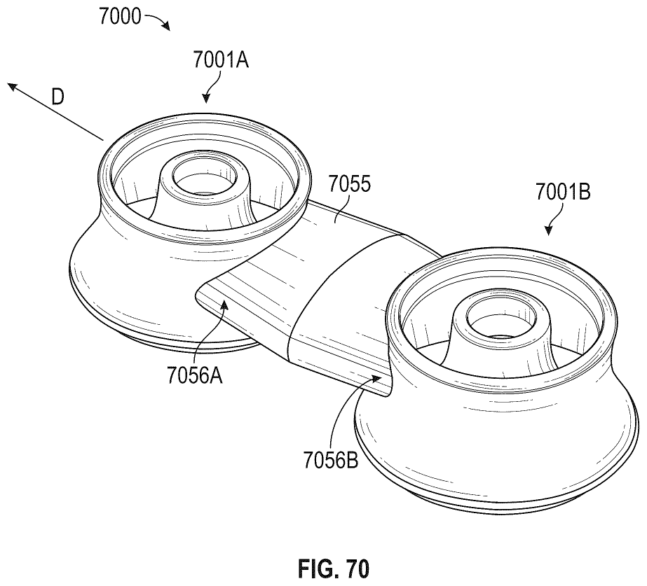

FIG. 70 illustrates another example tandem aircraft 7000. The tandem aircraft 7000 may have any or all of the same or similar features as any other aircraft disclosed herein, and vice vera, except as otherwise described. The same or similar reference numbers are used to refer to the same or similar features. For example, the aircraft 7000 may have many or all of the same features as aircraft 6800 and vice versa.

The tandem aircraft 7000 may include multiple aircrafts (or multiple propulsion systems, or multiple aerolift systems). The aircraft 7000 may include a first aircraft 7001A and a second aircraft 7001B. The features of the first aircraft 7001A and the second aircraft 7001B may have many or all of the same features as the as aircrafts 100, 6300, 6300A, 6500, 6600, 6700, 6801A, or 6801B. The first aircraft 7001A and second aircraft 7001B are interconnected by a main body 7055. The first connection region 7056A of the main body 7055 may be connected to the first aircraft 7001A. The second connection region 7056B of the main body 7055 may be connected the second aircraft 7001B. For simplicity, the propulsion system and lifting bodies, such as propulsion system 6820 and lifting bodies 6802, are not shown, but may be included in the aircraft 7000, along with any other features described herein.

The tandem aircraft 7000 may be configured to move (e.g. translate) in a direction D (e.g., a forward direction). The direction D may span along the length of the main body 7055 spacing the first aircraft 7001A from the second aircraft 7001B. The tandem aircraft 7000 may also move opposite the direction D (e.g., in an aft direction). In some examples, the tandem aircraft 7000 may be designed to move (e.g., translate) in a direction perpendicular to the direction D. The tandem aircraft 7000 may be able to travel speeds up to 10 mph, 20 mph, 30 mph, or 40 mph. The tandem aircraft 7000 may be able to pick up and move passengers, cargo, boxes, construction material, and the like. The tandem aircraft 7000 may be able to lift objects from 150 lbs. to 2500 lbs.

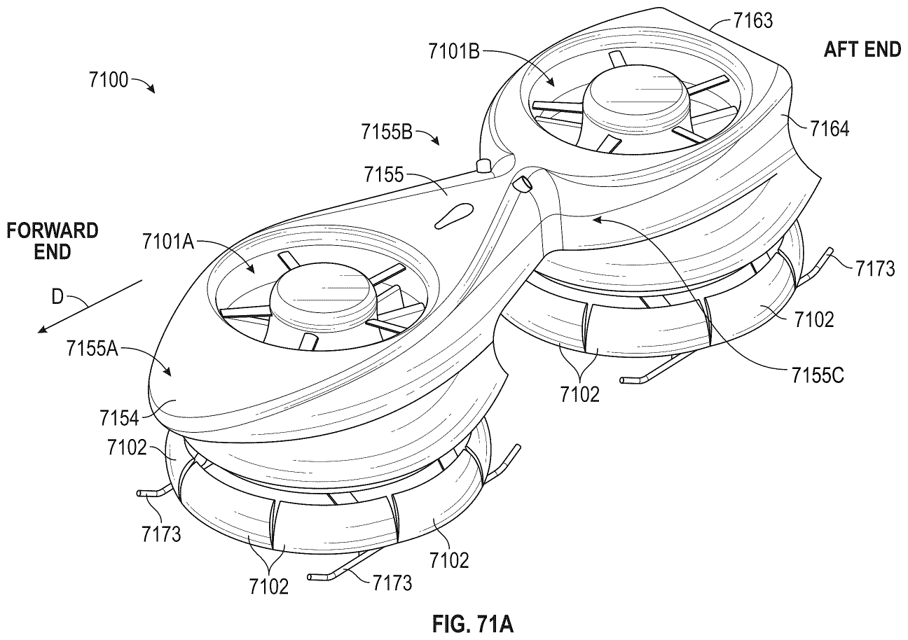

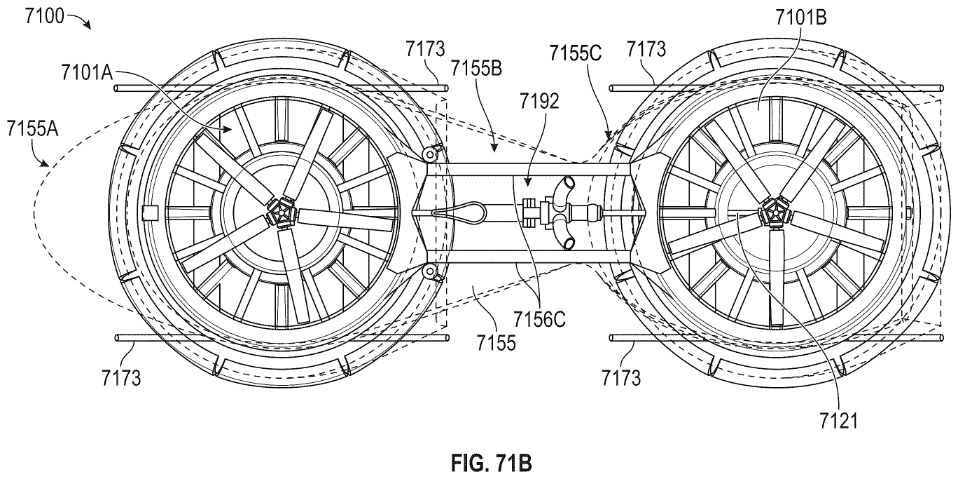

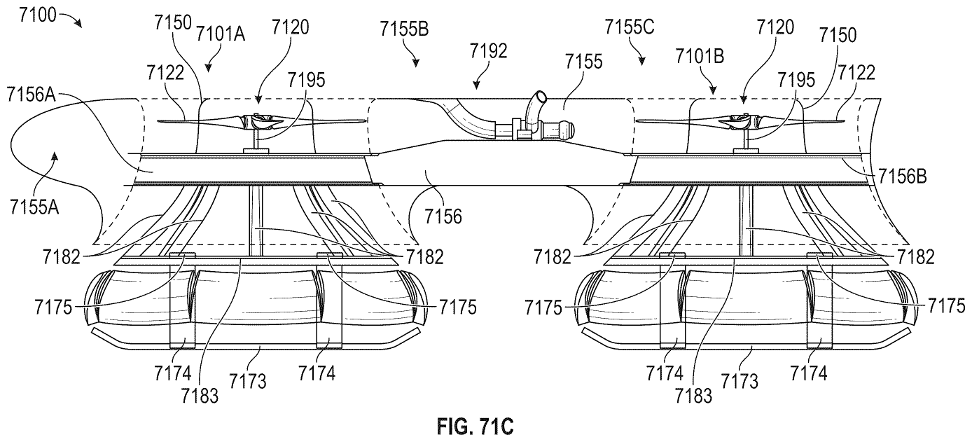

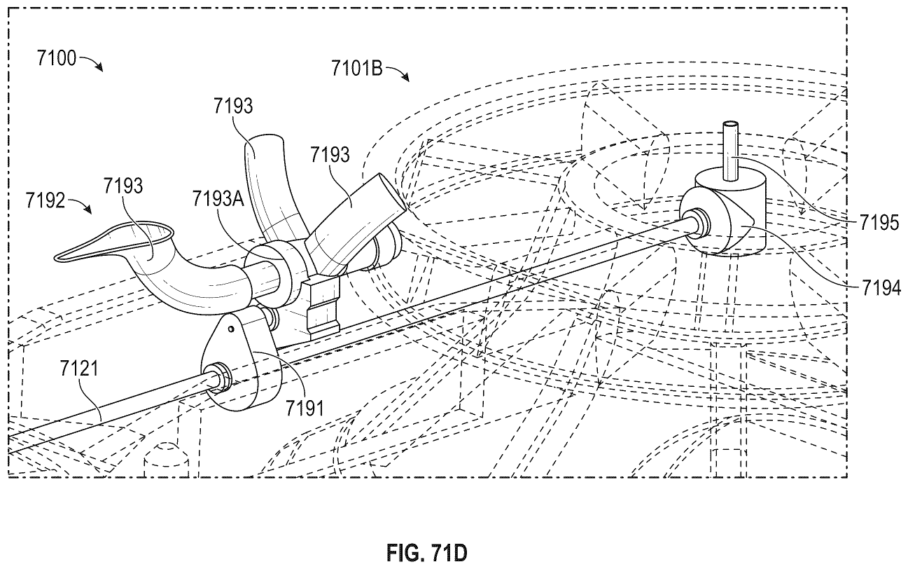

FIGS. 71A-71D illustrate another example of a tandem aircraft system 7100. FIG. 71B illustrates a top view of the tandem aircraft system of FIG. 71A, where the main body is transparent and shown in dashed lines. FIG. 71C illustrates a side view of the tandem aircraft system of FIG. 71A, where the main body is transparent. FIG. 71D illustrates a detail view of the tandem aircraft system of FIG. 71A, with the main body and other portions transparent, so show more detail of the drivetrain. The aircraft system 7100 may have any or all of the same or similar features as any other aircraft disclosed herein, and vice vera, except as otherwise described. For example, the aircraft system 7100 may have many or all of the same features as aircraft 100, 6300, 6400, 6600, 6700, and/or tandem aircraft systems 6800, 7000 and vice versa. Similar reference numbers are used to refer to the same or similar features. For example, the tandem aircraft system 7100 may include one or more lifting bodies 7102, etc.

The tandem aircraft system 7100 may include multiple aircrafts (or multiple propulsion systems, or multiple aerolift systems). The tandem aircraft system 7100 may be designed to fly/translate/move in various directions, with the direction D being the forward direction (e.g., aircraft 7101A is at a forward end and aircraft 7101B is at an aft end). In some examples, the tandem aircraft system 7100 may be designed to move (e.g., translate) in a direction perpendicular to the direction D. The tandem aircraft system 7100 may be able to move in any spatial direction. The direction the tandem aircraft system 7100 travels may be based on a movement or rotation of vanes and/or endplates (e.g., endplates 6349, vanes 6340, as discussed in connection with FIGS. 63A-63H). The tandem aircraft system 7000 may include a first aircraft 7101A and a second aircraft 7101B. The first aircraft 7101A and the second aircraft 7101B may be aligned along a longitudinal axis of the tandem aircraft system 7100 (e.g., in the direction D of the aircraft). The features of the first aircraft 7101A and the second aircraft 7101B may have many or all of the same features as the as aircrafts 100, 6300, 6300A, 6500, 6600, 6700, 6801A, 6801B, 7001A, 7001B. The first aircraft 7101A and second aircraft 7101B are interconnected by a main body 7155. In some examples, the inlet lip, such as inlet lip 7109B (further described herein with respect to FIG. 63C, for example) may be flush with (e.g., parallel to, not protruding from) the main body 7155.

The main body 7155 may have a front region 7155A, a middle region 7155B, and a rear or aft region 7155C. The front region 7155A may have a curved nose or a nose cap 7154 at the foremost part of the tandem aircraft system 7100. The front region 7155A may be designed to reduce or minimize drag on the tandem aircraft system 7100 by streamlining a flow of air along the main body 7155 from the front region 7155A to the aft region 7155C. For example, the nose cap 7154 may allow for a smooth or laminar flow of air to flow around the front region 7155A. The front region 7155A may also have a shape or contour that allows the flow of air to easily move around the front region 7155A and to the middle region 7155B.

The middle region 7155B may extend between the first aircraft 7101A and the second aircraft 7101B. The middle region 7155B may taper as it extends from the first aircraft 7101A. The middle region 7155B may contain a drivetrain 7192 (and/or a portion of the drivetrain 7192). The drivetrain 7192, as discussed further herein, may be used to power the propulsion system 7120 of the first aircraft 7101A and the second aircraft 7101B. Although not shown, a coupling system (e.g., a cargo hook) and/or a cargo bay/passenger bay, may be positioned beneath the middle region 7155B.

The rear or aft region 7155C may extend from the middle region 7155B. The rear or aft region 7155C may also have a curved forward end (e.g., forward of the second aircraft 7101B). The rear or aft region 7155C may be contoured such that the flow of air traveling around the tandem aircraft system 7100 (e.g., as the tandem aircraft system 7100 travels in the direction D) remains laminar (e.g., from the front region 7155A). The transition from the middle region 7155B to the rear or aft region 7155C is designed to, among other things, reduce the weight of the tandem aircraft system 7100. The transition from the middle region 7155B to the rear or aft region 7155C may reduce or minimize the surface area of the main body 7155 around the drivetrain 7192. The smaller amount of surface area of the main body 7155 may improve flight characteristics of the tandem aircraft system 7100 (e.g., improved lift characteristics, higher top speeds, minimal drag, increased yaw control, etc.). The rear or aft region 7155C may have a back profile 7163. The back profile 7163 may be flat or generally linear. The rear or aft region 7155C may also have a side profile 7164. The side profile 7164 may be designed to perform similarly to an airfoil (e.g., a truncated airfoil). For example, the side profile 7164 may be able to generate additional lift for the tandem aircraft system 7100 to improve flight characteristics.

The tandem aircraft system 7100 may have a connector 7156 (see, e.g., FIG. 71C). The connector 7156 may extend along the tandem aircraft system 7100 from the forward end to the aft end. The connector 7156 may couple (e.g., connect) the first aircraft 7101A to the second aircraft 7101B. The connector 7156 may have a first connecting region 7156A. The first connecting region 7156A may be coupled to the first aircraft 7101A. For example, the first connecting region 7156A may extend around the body 7150 of the first aircraft 7101A. The connector 7156 may have a second connecting region 7156B. The second connecting region 7156B may be coupled to the second aircraft 7101B. For example, the second connecting region 7156B may extend around the body 7150 of the second aircraft 7101B. The second connecting region 7156B may be interconnected with the first connecting region 7156A with a middle connecting bar or bars 7156C (see, e.g., FIG. 71B). The middle connecting bar 7156C may extend through the middle region 7155B of the front region 7155A. The middle connecting bar 7156C may comprise two bars extending between the first connecting region 7156A and the second connecting region 7156B

The tandem aircraft system 7100 may have one or more ribs 7182 (see, e.g., FIG. 71C) which may provide support for the tandem aircraft system 7100. The one or more ribs 7182 may extend from the connector 7156 and to a lower hoop 7183. The one or more ribs 7182 may extend along the body 7150 of the first aircraft 7101A and/or the second aircraft 7101B. The one or more ribs 7182 may provide additional support and rigidity for the tandem aircraft system 7100. The one or more ribs 7182 may prevent the first aircraft 7101A or the second aircraft 7101B from moving or warping during flight.

The tandem aircraft system 7100 may include a landing system. The landing system may be positioned underneath the first aircraft 7101A and the second aircraft 7101B. The landing system may include bows 7174 extending from underneath the first aircraft 7101A and the second aircraft 7101B. The bows 7174 may extend from skids 7175 coupled to the bottom of the first aircraft 7101A and the second aircraft 7101B and to landing skis 7173. The landing skis 7173 may allow for the tandem aircraft system 7100 to land safely on different terrains (e.g., land, forest, dirt, sand, etc.).

The drivetrain 7192 may be used to power the propulsion system 7120 of the first aircraft 7101A and the second aircraft 7101B. The drivetrain 7192 may be connected to an engine (e.g., via a combustion chamber 7193A and one or more intake pipes 7193—see FIG. 71D). The drivetrain 7192 may include a main gearbox 7191. The main gearbox 7191 may be connected to a driveshaft 7121 (or multiple driveshafts 7121) extending between the propulsion systems 7120 and the main gearbox 7191. The driveshaft 7121 may rotate to power a second gearbox or a pylon gearbox 7194 at each of the propulsion systems 7120 (e.g., of the first aircraft 7101A and the second aircraft 7101B). The pylon gearbox 7194 of the second aircraft 7101B is shown in FIG. 71D, and a same or similar pylon gearbox may be included with the first aircraft 7101A. Each of the pylon gearboxes 7194 may rotate a propulsion shaft 7195 of the propulsion system 7120 in order to rotate one or more blades 7122 of the first aircraft 7101A and the second aircraft 7101B. The one or more blades 7122 may generate a flow of air in order to generate lift for the first aircraft 7101A and the second aircraft 7101B (as disclosed and discussed herein with respect to various aircrafts). The main gearbox 7191 may have a helical gear design or be a helical gearbox. The main gearbox 7191 may have a gear ratio of 2:1. The main gearbox 7191 may have a gear ratio of at least 1:1, at least 3:2, at least 5:2, or at least 3:1. The pylon gearbox 7194 may have a spiral bevel design or be a spiral bevel gearbox. The pylon gearbox 7194 may have a 3:1 gear reduction. The pylon gearbox 7194 may have a gear ratio of at least 1:1, at least 3:2, at least 5:2, or at least 4:1. The tandem aircraft system 7100 may be able to travel speeds up to 10 mph, 20 mph, 30 mph, or 40 mph.

### NUMBERED EXAMPLE EMBODIMENTS (NEE)

The following are numbered example embodiments (NEE) of the technology described herein. This list is exemplary only and is not exhaustive.

NEE 1. An aircraft comprising: a central body defining a reference axis; and one or more aerolift systems attached with the central body, each aerolift system comprising: a propulsion unit configured to move air; a duct configured to receive the air moved by the propulsion unit into an inlet of the duct and to expel the air out of an outlet of the duct, wherein the inlet extends along an inlet axis and the outlet extends along an outlet axis, wherein the inlet axis and the outlet axis define a turn angle therebetween, and wherein the duct comprises one or more sections having an open cross-sectional profile; and a lifting body configured to receive the air expelled from the outlet of the duct such that the air imparts a lifting force on the lifting body.

NEE 2. The aircraft of NEE 1, wherein the inlet axis is angled no more than 45 degrees relative to a reference axis.

NEE 3. The aircraft of NEE 1, wherein the turn angle is from 20 degrees to 45 degrees.

NEE 4. The aircraft of NEE 1, wherein the lifting body defines a chord that is angled no more than 45 degrees relative to a reference axis.

NEE 5. The aircraft of NEE 1, comprising a plurality of the one or more aerolift systems distributed annularly about the central body.

NEE 6. The aircraft of NEE 1, comprising a plurality of the one or more aerolift systems and wherein the lifting body of each aerolift system is a segment of an annular wing of the aircraft.

NEE 7. The aircraft of NEE 6, wherein the annular wing is a discontinuous, multi-segment wing of the aircraft.

NEE 8. The aircraft of NEE 6, wherein the annular wing is polygonal.

NEE 9. The aircraft of NEE 1, comprising a plurality of the one or more aerolift systems spaced outwardly from the central body to define an airflow channel between the central body and the plurality of the one or more aerolift systems.

NEE 10. The aircraft of NEE 1, comprising a plurality of the one or more aerolift systems spaced circumferentially from each other to define airflow channels between adjacent aerolift systems.

NEE 11. The aircraft of NEE 1, further comprising supporting structure attaching one or more of the one or more aerolift systems with the central body.

NEE 12. The aircraft of NEE 11, wherein the supporting structure is configured to expand or collapse.

NEE 13. The aircraft of NEE 1, comprising a plurality of the one or more aerolift systems and wherein the central body is located at least partially between the plurality of the one or more aerolift systems.

NEE 14. The aircraft of NEE 1, wherein the central body is located at least partially below the one or more aerolift systems.

NEE 15. The aircraft of NEE 1, wherein the outlet extends from a vertically lower portion to a vertically higher portion, and wherein the lifting body comprises a leading edge positioned closer to the vertically lower portion than to the vertically higher portion.

NEE 16. The aircraft of NEE 1, wherein the outlet extends from a vertically lower portion to a vertically higher portion, and wherein the lifting body comprises a leading edge positioned closer to the vertically higher portion than to the vertically lower portion.

NEE 17. The aircraft of NEE 1, where a cross-sectional area of the outlet of the duct is greater than a cross-sectional area of the inlet of the duct.

NEE 18. The aircraft of NEE 1, wherein the propulsion unit comprises an electric motor configured to rotate one or more blades.

NEE 19. The aircraft of NEE 1, wherein the lifting body is a first lifting body, and wherein each aerolift system further comprises a second lifting body configured to receive the air expelled from the outlet of the duct such that the air imparts a lifting force on the second lifting body, wherein the second lifting body is positioned farther away from the outlet of the duct than the first lifting body.

NEE 20. The aircraft of NEE 19, wherein each aerolift system further comprises a third lifting body configured to receive the air expelled from the outlet of the duct such that the air imparts a lifting force on the third lifting body, wherein the third lifting body is positioned farther away from the outlet of the duct than the second lifting body.

NEE 21. The aircraft of NEE 19, wherein the outlet of the duct extends from a vertically lower portion to a vertically higher portion, and wherein the first lifting body comprises a leading edge positioned closer to the vertically lower portion than to the vertically higher portion.

NEE 22. The aircraft of NEE 1, wherein the lifting body comprises a stationary forward portion and a moveable rearward portion rotatably attached to the stationary forward portion.

NEE 23. The aircraft of NEE 1, the duct comprising a series of openings along a bottom portion thereof at the outlet of the duct.

NEE 24. The aircraft of NEE 1, wherein the central body comprises a passenger compartment or a cargo compartment.

NEE 25. The aircraft of NEE 1, comprising a plurality of the one or more aerolift systems, and wherein two or more ducts of the plurality of the one or more aerolift systems are fluidly connected to each other.

NEE 26. The aircraft of NEE 1, further comprising one or more additional propulsion units configured to provide a thrust force in a direction for forward flight.

NEE 27. The aircraft of NEE 1, further comprising landing gear.

NEE 28. The aircraft of NEE 1, further comprising one or more deployable parachutes.

NEE 29. The aircraft of NEE 1, further comprising one or more solar panels.

NEE 30. The aircraft of NEE 1, further comprising one or more skirts.

NEE 31. The aircraft of NEE 1, further comprising one or more blades extending from a bottom surface of the central body.

NEE 32. The aircraft of NEE 31, wherein the one or more blades are symmetrical about a central axis of the central body.

NEE 33. The aircraft off NEE 1, further comprising one or more movable wall portions coupled to the outlet of the duct configured to control a yaw of the aircraft.

NEE 34. The aircraft of NEE 1, further comprising a movable wall portion of the duct and/or a moveable plate positioned at least partially within the outlet of the duct.

NEE 35. The aircraft of NEE 1, further comprising a first lip and a second lip radially outward of the first lip, wherein the first lip and the second lip protrude above the inlet and are rounded and configured to deliver a smoother flow of air into the inlet of the duct.

NEE 36. The aircraft of NEE 1, wherein the duct comprises one or more openings along a wall of the duct between the inlet and the outlet configured to receive air there through and into an interior of the duct.

NEE 37. The aircraft of NEE 1, wherein the outlet of the duct has a rectangular profile.

NEE 38. The aircraft of any preceding NEE, wherein the duct comprises an elongated opening extending along a radially-outward side of the duct.

NEE 39. The aircraft of NEE 38, wherein the elongated opening extends over the entire radially-outward side of the duct.

NEE 40. The aircraft of NEE 38 or 39, wherein the elongated opening extends along opposed, lateral sides of the duct.

NEE 41. The aircraft of any preceding NEE, wherein the open cross-sectional profile defines a trough extending from the inlet to the outlet.

NEE 42. The aircraft of any preceding NEE, wherein the duct comprises one or more closed cross-sectional profiles.

NEE 43. The aircraft of NEE 42, wherein the one or more closed cross-sectional profiles comprises a first closed cross-sectional profile that extends from an upstream portion of the duct in a downstream direction.

NEE 44. The aircraft of NEE 43, wherein the first closed cross-sectional profile extends from the propulsion unit in the downstream direction.

NEE 45. The aircraft of any of NEEs 42-44, wherein the one or more closed cross-sectional profiles comprises a second closed cross-sectional profile that extends from a downstream stream portion of the duct in an upstream direction.

NEE 46. The aircraft of NEE 45, wherein the second closed cross-sectional profile extends from the outlet in the upstream direction.

NEE 47. The aircraft of any of NEEs 42-46, wherein one or more of the one or more closed cross-sectional profile extends along no more than 20% of a length along the duct from the inlet to the outlet.

NEE 48. The aircraft of any preceding NEE further comprising a tether extending from the aircraft to the ground.

NEE 49. The aircraft of NEE 48, wherein the tether comprises one or more electrical cables configured to provide electrical power to the aircraft.

NEE 50. The aircraft of NEEs 48 or 49, wherein the tether is coupled at a first end with an electrical coupling region of the aircraft and at a second end with a power supply.

NEE 51. The aircraft of any preceding NEE, wherein the propulsion unit is shrouded.

NEE 52. The aircraft of any preceding NEE, wherein the propulsion unit is a ducted fan.

NEE 53. The aircraft of any preceding NEE, wherein the propulsion unit is unshrouded.

NEE 54. An aerolift system comprising: a propulsion unit configured to move air; a duct configured to receive the air moved by the propulsion unit into an inlet of the duct and to expel the air out of an outlet of the duct, wherein the inlet extends along an inlet axis and the outlet extends along an outlet axis, wherein the inlet axis and the outlet axis define a turn angle therebetween, and wherein the duct comprises one or more sections having an open cross-sectional profile; and a lifting body configured to receive the air expelled from the outlet of the duct such that the air imparts a lifting force on the lifting body.

NEE 55. The aerolift system of NEE 54, wherein the inlet axis is angled no more than 45 degrees relative to a reference axis.

NEE 56. The aerolift system of NEE 54, wherein the turn angle is from 20 degrees to 45 degrees.

NEE 57. The aerolift system of NEE 54, wherein the lifting body defines a chord that is angled no more than 45 degrees relative to a reference axis.

NEE 58. The aerolift system of NEE 54, wherein the outlet extends from a vertically lower portion to a vertically higher portion, and wherein the lifting body comprises a leading edge positioned closer to the vertically lower portion than to the vertically higher portion.

NEE 59. The aerolift system of NEE 54, wherein the outlet extends from a vertically lower portion to a vertically higher portion, and wherein the lifting body comprises a leading edge positioned closer to the vertically higher portion than to the vertically lower portion.

NEE 60. The aerolift system of NEE 54, wherein the propulsion unit comprises an electric motor configured to rotate one or more blades.

NEE 61. The aerolift system of NEE 54, wherein the lifting body comprises a stationary forward portion and a moveable rearward portion rotatably attached to the stationary forward portion.

NEE 62. The aerolift system of NEE 54, further comprising one or more movable wall portions coupled to the outlet of the duct configured to control a yaw force.

NEE 63. The aerolift system of NEE 54, further comprising a movable wall portion of the duct and/or a moveable plate positioned at least partially within the outlet of the duct.

NEE 64. The aerolift system of NEE 54, wherein the duct comprises an elongated opening extending along a radially-outward side of the duct.

NEE 65. The aerolift system of NEE 64, wherein the elongated opening extends over the entire radially-outward side of the duct.

NEE 66. The aerolift system of NEE 64 or 65, wherein the elongated opening extends along opposed, lateral sides of the duct.

NEE 67. The aerolift system of any of NEEs 54-66, wherein the open cross-sectional profile defines a trough extending from the inlet to the outlet.

NEE 68. The aerolift system of any of NEEs 54-67, wherein the duct comprises one or more closed cross-sectional profiles.

NEE 69. The aerolift system of NEE 68, wherein the one or more closed cross-sectional profiles comprises a first closed cross-sectional profile that extends from an upstream portion of the duct in a downstream direction.

NEE 70. The aerolift system of NEE 69, wherein the first closed cross-sectional profile extends from the propulsion unit in the downstream direction.

NEE 71. The aerolift system of any of NEEs 68-70, wherein the one or more closed cross-sectional profiles comprises a second closed cross-sectional profile that extends from a downstream stream portion of the duct in an upstream direction.

NEE 72. The aerolift system of NEE 71, wherein the second closed cross-sectional profile extends from the outlet in the upstream direction.

NEE 73. The aerolift system of any of NEEs 68-72, wherein one or more of the one or more closed cross-sectional profile extends along no more than 20% of a length along the duct from the inlet to the outlet.

NEE 74. An aerolift system comprising: a central body; a propulsion unit configured to move air; a duct having an annular inlet extending around the central body, the annular inlet configured to receive the air moved by the propulsion unit and to expel the air out of an annular outlet of the duct, wherein the annular inlet extends along an inlet axis and the annular outlet extends along an outlet axis, wherein the inlet axis and the outlet axis define a turn angle therebetween; and at least one lifting body configured to receive the air expelled from the annular outlet of the duct such that the air imparts a lifting force on the lifting body.

NEE 75. The aerolift system of NEE 74, wherein the annular outlet includes a plurality of vanes.

NEE 76. The aerolift system of NEE 75, wherein the plurality of vanes comprises one or more vanes that are movable to adjust an angle at which the one or more vanes are oriented with respect to the outlet axis.

NEE 77. The aerolift system of NEE 75, wherein the plurality of vanes comprises one or more vanes that are fixed at an angle with respect to the outlet axis.

NEE 78. The aerolift system of NEE 74, wherein the annular inlet includes a plurality of stators.

NEE 79. The aerolift system of NEE 78, wherein the plurality of stators comprises one or more stators that are fixed with respect to the inlet axis.

NEE 80. The aerolift system of NEE 78, wherein the plurality of stators comprises one or more stators that comprise an airfoil shape.

NEE 81. The aerolift system of NEE 74, wherein the propulsion unit comprises a first hub having a first plurality of blades extending therefrom configured to rotate about a longitudinal axis of the central body in a first direction, and wherein the aerolift system further comprises: a second propulsion unit comprising a second hub coaxial with the first hub, the second hub having a plurality of blades extending therefrom configured to rotate about the longitudinal axis of the central body in a second direction that is opposite to the first direction.

NEE 82. The aerolift system of NEE 74, further comprising one or more baffles located at a bottom of the aerolift system.

NEE 83. The aerolift system of NEE 74, further comprising a lip positioned at the annular inlet and configured to direct a flow of air into the duct.

NEE 84. The aerolift system of NEE 74, wherein an angle of attack between the at least one lifting body and the outlet axis is from 5 degrees to 25 degrees.

NEE 85. The aerolift system of NEE 84, wherein an angle of attack between the at least one lifting body and the outlet axis is from 10 degrees to 20 degrees.

NEE 86. The aerolift system of any of NEEs 74 to 85, wherein the duct defines a conical flow path from the annular inlet to the annular outlet.

NEE 87. The aerolift system of any of NEEs 74 to 85, wherein the duct defines a flared trumpet bell flow path from the annular inlet to the annular outlet.

NEE 88. The aerolift system of any of NEEs 74 to 87, wherein the duct is unobstructed in a central region between the annular inlet and the annular outlet.

NEE 89. The aerolift system of NEE 88, wherein the central region is unobstructed circumferentially 360 degrees around the central body.

NEE 90. An aerolift system comprising: a first propulsion system and a second propulsion system, the first propulsion system and the second propulsion system interconnected by a main body, the first propulsion system and the second propulsion system each comprising: a central body; a propulsion unit connected to the central body and configured to move air; a duct having an annular inlet extending around the central body, the annular inlet configured to receive the air moved by the propulsion unit and to expel the air out of an annular outlet of the duct, wherein the annular inlet extends along an inlet axis and the annular outlet extends along an outlet axis, wherein the inlet axis and the outlet axis define a turn angle therebetween; and at least one lifting body configured to receive the air expelled from the annular outlet of the duct such that the air imparts a lifting force on the lifting body a motor positioned within the main body; and a transmission positioned within the main body connecting the motor to the first propulsion system and the second propulsion system to power the propulsion unit of the first propulsion system and the second propulsion system.

NEE 91. The aerolift system of NEE 90, further comprising a lip positioned at the annular inlet and configured to direct a flow of air into the duct.

NEE 92. The aerolift system of NEE 90, wherein an angle of attack between the at least one lifting body and the outlet axis is from 5 degrees to 25 degrees.

NEE 93. The aerolift system of NEE 92, wherein an angle of attack between the at least one lifting body and the outlet axis is from 10 degrees to 20 degrees.

NEE 94. The aerolift system of any of NEEs 90 to 93, wherein the duct defines a conical flow path from the annular inlet to the annular outlet.

NEE 95. The aerolift system of any of NEEs 90 to 94, wherein the duct defines a flared trumpet bell flow path from the annular inlet to the annular outlet.

NEE 96. The aerolift system of any of NEEs 90 to 95, wherein the duct is unobstructed in a central region between the annular inlet and the annular outlet.

NEE 97. The aerolift system of NEEs 90 to 96, wherein the annular outlet includes a plurality of vanes.

NEE 98. The aerolift system of NEE 97, wherein the plurality of vanes comprises one or more vanes that are movable to adjust an angle at which the one or more vanes are oriented with respect to the outlet axis.

NEE 99. The aerolift system of NEE 97, wherein the plurality of vanes comprises one or more vanes that are fixed at an angle with respect to the outlet axis.

NEE 100. The aerolift system of NEE 90-99, wherein the annular inlet includes a plurality of stators.

NEE 101. The aerolift system of NEE 100, wherein the plurality of stators comprises one or more stators that are fixed with respect to the inlet axis.

NEE 102. The aerolift system of NEE 100, wherein the plurality of stators comprises one or more stators that comprise an airfoil shape.

NEE 103. The aerolift system of NEEs 90-102, wherein the main body includes a cargo area.

NEE 104. An aerolift system comprising: a plurality of propulsion systems arranged in a grid about a central axis, the plurality of propulsion systems are interconnected by a plurality of support rods, the plurality of propulsion systems each comprising: a central body; a propulsion unit connected to the central body and configured to move air; a duct having an annular inlet extending around the central body, the annular inlet configured to receive the air moved by the propulsion unit and to expel the air out of an annular outlet of the duct, wherein the annular inlet extends along an inlet axis and the annular outlet extends along an outlet axis, wherein the inlet axis and the outlet axis define a turn angle therebetween; and at least one lifting body configured to receive the air expelled from the annular outlet of the duct such that the air imparts a lifting force on the lifting body.

NEE 105. The aerolift system of NEE 104, further comprising a lip positioned at the annular inlet and configured to direct a flow of air into the duct.

NEE 106. The aerolift system of any of NEEs 104-105, wherein an angle of attack between the at least one lifting body and the outlet axis is from 5 degrees to 25 degrees.

NEE 107. The aerolift system of any of NEEs 104-105, wherein an angle of attack between the at least one lifting body and the outlet axis is from 10 degrees to 20 degrees.

NEE 108. The aerolift system of any of NEEs 104 to 107, wherein the duct defines a conical flow path from the annular inlet to the annular outlet.

### Implementations and Language

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described may be incorporated in the example methods and processes. For example, one or more additional operations may be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems may generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications may be made without departing from the spirit and scope of the present invention. Moreover, the devices described herein need not feature all of the objects, advantages, features and aspects discussed above. Thus, for example, those of skill in the art will recognize that the invention may be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments may be combined with or substituted for one another in order to form varying modes of the discussed devices.

What is claimed is:

1. An aerolift system comprising:
a central body;
a propulsion unit configured to move air;
a duct having an annular inlet extending around the central body, the annular inlet configured to receive the air moved by the propulsion unit and to expel the air out of an annular outlet of the duct, wherein the annular inlet extends along an inlet axis and the annular outlet extends along an outlet axis, wherein the inlet axis and the outlet axis define a turn angle therebetween; and
at least one lifting body configured to receive the air expelled from the annular outlet of the duct such that the air imparts a lifting force on the at least one lifting body.

2. The aerolift system of claim 1, wherein the annular outlet includes a plurality of vanes.

3. The aerolift system of claim 2, wherein the plurality of vanes comprises one or more vanes that are movable to adjust an angle at which the one or more vanes are oriented with respect to the outlet axis.

4. The aerolift system of claim 2, wherein the plurality of vanes comprises one or more vanes that are fixed at an angle with respect to the outlet axis.

5. The aerolift system of claim 1, wherein the annular inlet includes a plurality of stators.

6. The aerolift system of claim 5, wherein the plurality of stators comprises one or more stators that are fixed with respect to the inlet axis.

7. The aerolift system of claim 5, wherein the plurality of stators comprises one or more stators that comprise an airfoil shape.

8. The aerolift system of claim 1, wherein the propulsion unit comprises a first hub having a first plurality of blades extending therefrom configured to rotate about a longitudinal axis of the central body in a first direction, and wherein the aerolift system further comprises:
a second propulsion unit comprising a second hub coaxial with the first hub, the second hub having a plurality of blades extending therefrom configured to rotate about the longitudinal axis of the central body in a second direction that is opposite to the first direction.

9. The aerolift system of claim 1, further comprising one or more baffles located at a bottom of the aerolift system.

10. The aerolift system of claim 1, further comprising a lip positioned at the annular inlet and configured to direct a flow of air into the duct.

11. The aerolift system of claim 1, wherein an angle of attack between the at least one lifting body and the outlet axis is from 5 degrees to 25 degrees.

12. The aerolift system of claim 1, wherein the duct defines a trumpet bell flow path from the annular inlet to the annular outlet.

13. The aerolift system of claim 1, wherein the at least one lifting body is oriented substantially vertical relative to a longitudinal axis of the central body.

14. An aerolift system comprising:
a main body;
a first propulsion system and a second propulsion system, the first propulsion system and the second propulsion system interconnected by the main body, the first propulsion system and the second propulsion system each comprising:
a central body;
a propulsion unit connected to the central body and configured to move air;
a duct having an annular inlet extending around the central body, the annular inlet configured to receive the air moved by the propulsion unit and to expel the air out of an annular outlet of the duct, wherein the annular inlet extends along an inlet axis and the annular outlet extends along an outlet axis, wherein the inlet axis and the outlet axis define a turn angle therebetween; and
at least one lifting body configured to receive the air expelled from the annular outlet of the duct such that the air imparts a lifting force on the at least one lifting body;
a motor positioned within the main body; and
a transmission positioned within the main body connecting the motor to the first propulsion system and to the second propulsion system to power the propulsion unit of the first propulsion system and the second propulsion system.

15. The aerolift system of claim 14, wherein an angle of attack between the at least one lifting body and the outlet axis is from 5 degrees to 25 degrees.

16. The aerolift system of any of claim 14, wherein the duct defines a conical flow path from the annular inlet to the annular outlet.

17. The aerolift system of claim 14, wherein the annular outlet includes a plurality of vanes.

18. The aerolift system of claim 14, wherein the annular inlet includes a plurality of stators.

19. The aerolift system of claim 18, wherein the plurality of stators comprises one or more stators that comprise an airfoil shape.

20. An aerolift system comprising:
a plurality of propulsion systems arranged in a grid about a central axis, the plurality of propulsion systems interconnected by a plurality of support rods, the plurality of propulsion systems each comprising:
a central body;
a propulsion unit connected to the central body and configured to move air;
a duct having an annular inlet extending around the central body, the annular inlet configured to receive the air moved by the propulsion unit and to expel the air out of an annular outlet of the duct, wherein the annular inlet extends along an inlet axis and the annular outlet extends along an outlet axis, wherein the inlet axis and the outlet axis define a turn angle therebetween; and
at least one lifting body configured to receive the air expelled from the annular outlet of the duct such that the air imparts a lifting force on the at least one lifting body.

21. The aerolift system of claim 20, wherein the at least one lifting body is oriented vertically downward relative to a longitudinal axis of the central body.

22. The aerolift system of claim 20, wherein the duct defines a conical flow path from the annular inlet to the annular outlet.
